(19) United States
(12) Patent Application Publication
(10) Pub. No.: US 2025/0278138 A1
(43) Pub. Date: Sep. 4, 2025

(54) HAPTIC PLATFORM AND ECOSYSTEM FOR IMMERSIVE COMPUTER MEDIATED ENVIRONMENTS

(71) Applicant: Hatpx, Inc., San Luis Obispo, CA (US)

(72) Inventors: Jacob A. Rubin, Morro Bay, CA (US); Robert S. Crockett, San Luis Obispo, CA (US); Edward Leo Foley, Redmond, WA (US); Donald Jeong Lee, San Luis Obispo, CA (US); Joseph R. Marino, San Luis Obispo, CA (US); Michael C. Eichermueller, Arroyo Grande, CA (US); Madeline K. Rubin, Morro Bay, CA (US); Joanna Jin Liu, San Luis Obispo, CA (US); Leif Einar Kjos, Mercer Island, WA (US); Charles Howard Cella, Pembroke, MA (US); Mitchell Stanley Butzer, Coeur d'Alene, ID (US); Christopher Todd Weber, Coeur d'Alene, ID (US); Benjamin John Medeiros, Coeur d'Alene, ID (US); Eric Alexander Ballew, Post Falls, ID (US); Bodin Limsowan Rojanachaichanin, San Diego, CA (US); Teyvon John Hershey Brooks, San Luis Obispo, CA (US); Johnathan Baird, Portland, OR (US); Keenan Reimer, San Diego, CA (US)

(21) Appl. No.: 18/858,721

(22) PCT Filed: Aug. 4, 2023
(86) PCT No.: PCT/US23/29559

§ 371 Date: Oct. 21, 2024

Related U.S. Application Data
(60) Provisional application No. 63/395,747, filed on Aug. 5, 2022.
(60) Provisional application No. 63/464,118, filed on May 4, 2023.
(60) Provisional application No. 63/467,560, filed on May 18, 2023.
(60) Provisional application No. 63/395,747, filed on Aug. 5, 2022.
(60) Provisional application No. 63/338,345, filed on May 4, 2022.

(51) Int. Cl. G06F 3/01; G06N 3/008

(52) U.S. Cl. CPC G06F 3/016; G06F 3/011; G06F 3/017; G06N 3/008

(57) ABSTRACT

A device may receive, by a haptic interface module that is configured to interact with one or more haptic interface devices and an application that generates a computer-mediated environment comprising an avatar corresponding to a user wearing the one or more haptic interface devices, respective sensor data for each respective haptic interface device, wherein the respective sensor data for a respective haptic interface device indicates respective positioning of respective sensors of the respective wearable haptic interface. A device may process, by the haptic interface module, the respective sensor data to generate respective relative location data for each respective haptic interface device, wherein the relative location data is relative to a reference location defined with respect to the corresponding wearable haptic interface. A device may receive, by the haptic interface module, tracked location data from one or more motion tracking sensors, wherein the tracked location data indicates respective locations of the one or more haptic interface devices relative to a spatial environment of the user. A device may generate, by the haptic interface module, a series of motion capture frames based on the tracked location data and the respective relative location data for each respective haptic interface device, wherein each respective motion capture frame indicates a set of locations and orientations for each respective haptic interface device at a given time. A device may generate, by the haptic interface module, a series of kinematic frames based on the series of motion capture frames and one or more mediation processes that collectively convert, for each of the motion capture frames, the set of locations and orientations of the one or more respective haptic interface devices into a set of intended locations and intended orientations for configuring the avatar in the computer-mediated environment. A device may output the series of kinematic frames to the application, wherein the kinematic frames are provided to the application as user input.

### CROSS-REFERENCE TO RELATED APPLICATIONS

This application claims the benefit of priority to U.S. Provisional Application Nos. 63/334,010, filed Apr. 22, 2022; 63/338,010 filed May 4, 2022; 63/395,747, filed Aug. 5, 2022; 63/464,118, filed May 4, 2023; and 63/467,560, filed May 18, 2023, as well as International Patent Application Nos. PCT/US23/19494, filed Apr. 21, 2023; and PCT/US23/21015, filed May 4, 2023. The entire disclosures of the above applications are incorporated by reference.

### BACKGROUND

Many conventional haptic systems are primitive both from a hardware and software/firmware perspective. Moreover, many existing haptic solutions provide limited use cases, such as inducing a symbolic vibration upon occurrence of an event, rather than realistically simulating a touch experience. Also, many existing haptic solutions do not integrate with a wide variety of applications and hardware. Although virtual reality (VR) and other types of simulations are a promising use case, existing haptic solutions often do not provide a high level of immersion into these simulations such that users can truly feel the presence of objects and other entities within the simulation via the coordination of various types of haptic feedback with other sensory interactions. Additionally, techniques for capturing motion tracking inputs from users are primitive and error prone. As a result of these and other factors, many of the most powerful use cases for haptic hardware and software remain unrealized.

Solutions that move the field of haptics forward by providing a higher level of immersion, better integration between haptic interfaces and applications, and a platform containing reusable components for rapid prototyping and development, among other uses are needed.

### BRIEF DESCRIPTION OF THE DRAWINGS

The accompanying drawings, which are included to provide a better understanding of the disclosure, illustrate embodiment(s) of the disclosure and together with the description serve to explain the principle of the disclosure. In the drawings:

FIG. 1 is a schematic illustrating an example haptic platform according to some embodiments of the disclosure.

FIG. 2 is a schematic illustrating a whole-body immersion system according to some embodiments of the disclosure.

FIG. 3 is a data diagram illustrating a user profile for personalizing the operation of a haptic platform according to some embodiments of the disclosure.

FIG. 4 is a schematic illustrating a wearable haptic user interface according to some embodiments of the disclosure.

FIG. 5 is a schematic illustrating a wearable haptic glove according to some embodiments of the disclosure.

FIG. 6 is a schematic illustrating a wearable haptic exoskeleton according to some embodiments of the disclosure.

FIG. 7 is a schematic illustrating an electrical system for a haptic interface according to some embodiments of the disclosure.

FIG. 8 is a schematic illustrating a network connecting several devices of a haptic platform within a haptic ecosystem according to some embodiments of the disclosure.

FIG. 9 is a schematic illustrating details of an example application programming interface according to some embodiments of the disclosure.

FIG. 10 is a schematic illustrating an example contact interpreter according to some embodiments of the disclosure.

FIG. 11 is an example method of performing motion capture according to some embodiments of the disclosure.

FIG. 12 is an example method of providing haptic feedback according to some embodiments of the disclosure.

FIG. 13 is an example method of performing grasp detection according to some embodiments of the disclosure.

FIG. 14 is a schematic illustrating an example telerobotic platform according to some embodiments of the disclosure.

FIG. 15 is a perspective view of a whole-body haptic device in accordance with an example embodiment in an exemplary pose illustrating operation of a simulated vehicle.

FIG. 16 is a perspective view of a whole-body haptic device in accordance with an example embodiment.

FIG. 17 is a perspective view of a motion platform in accordance with an example embodiment.

FIG. 18 is a perspective view of a lower-body exoskeleton in accordance with an example embodiment.

FIG. 19 is a perspective view of an actuated degree of freedom configured to permit translation along a frontal axis of a user's body and an actuated degree of freedom configured to permit translation along the sagittal axis of a user's body of the lower-body exoskeleton in accordance with the example embodiment of FIG. 18.

FIG. 20A is a perspective view of actuated degrees of freedom of the lower-body exoskeleton of the example embodiment of FIG. 18 configured to permit rotation about a longitudinal axis passing through the center of rotation of the user's foot, an actuated degree of freedom configured to permit rotation about a sagittal axis passing through the center of rotation of the user's foot, and an actuated degree of freedom configured to permit rotation about the frontal axis passing through the center of rotation of the user's foot in accordance with an example embodiment.

FIG. 20B is a perspective view of the underside of a top portion of a platform of the lower-body exoskeleton in accordance with the example embodiment of FIG. 20A.

FIG. 21A is a perspective view of an actuated degree of freedom of a torso exoskeleton configured to permit translation along the longitudinal axis of a user's body in accordance with an example embodiment.

FIG. 21B is a perspective cutaway view of the actuated degree of freedom of the torso exoskeleton in accordance with the example embodiment of FIG. 21A.

FIG. 22A is a perspective view of an upper-body exoskeleton in accordance with an example embodiment.

FIG. 22B is a rear perspective cutaway view of the upper-body exoskeleton in accordance with the example embodiment of FIG. 22A.

FIG. 23 is a perspective view of another whole-body haptic device in accordance with an example embodiment in an exemplary pose illustrating operation of a simulation.

FIG. 24 is a perspective view of another motion platform of the whole-body haptic device of FIG. 23 in accordance with an example embodiment.

FIG. 25 is a perspective view of a motion platform motor of the motion platform of FIG. 24 in accordance with an example embodiment.

FIG. 26 is a perspective view of a base assembly of the whole-body haptic device of FIG. 23 in accordance with an example embodiment.

FIG. 27 is a perspective view of a gantry and a footplate form in accordance with an example embodiment.

FIG. 28 is a perspective view of a foot platform actuator of FIG. 27 in accordance with an example embodiment.

FIG. 29 is a perspective view of actuated degrees of freedom of the lower-body exoskeleton in accordance with an example embodiment configured to permit rotation about a longitudinal axis passing through the center of rotation of the user's foot, actuated degrees of freedom configured to permit rotation about a sagittal axis passing through the center of rotation of the user's foot, actuated degrees of freedom configured to permit rotation about the frontal axis passing through the center of rotation of the user's foot, and actuated degrees of freedom configured to permit translation along a longitudinal axis of the user's foot in accordance with an example embodiment.

FIG. 30 is a perspective view of a core assembly of FIG. 23 in accordance with an example embodiment.

FIG. 31 is a perspective view of an interface portion of the core assembly of FIG. 30 in accordance with an example embodiment.

FIG. 32 is a perspective view of a torso portion of the core assembly of FIG. 30 in accordance with an example embodiment.

FIG. 33 is a perspective view of a pneumatic actuator of the core assembly of FIGS. 30 and 32 in accordance with an example embodiment.

FIG. 34 is a block diagram of a human-computer interface, according to some embodiments.

FIG. 35 is a schematic of an electronic system suitable for use with a haptic glove, according to some embodiments.

FIG. 36 is a simplified diagram of a production test flow, according to some embodiments.

FIG. 37 is an exploded view of components of a drive system, according to some embodiments.

FIG. 38 is a block diagram of wiring and electronics of a drive system, according to some embodiments.

FIGS. 39-40 are exploded views of a valve core-compressor assembly, according to some embodiments.

FIG. 41 is a perspective view of a strap system, according to some embodiments.

FIGS. 42-44 illustrate an exploded view of a manifold assemblies of a vale core, according to some embodiments.

FIGS. 45-46 are pneumatic diagrams for a pneumatic circuit, according to some embodiments.

FIG. 47 is a top view of a compressor, according to some embodiments.

FIG. 48 is a perspective view of a pneumatic circuit, according to some embodiments.

FIG. 49 is a process diagram of testing and assembly in a drive system, according to some embodiments.

FIG. 50 is a simplified block diagram of a glove assembly, according to some embodiments.

FIG. 51 is a testing and assembly process for a glove assembly, according to some embodiments.

FIG. 52 is a simplified block diagram of a replaceable-durable assembly, according to some embodiments.

FIG. 53 is a perspective view of a replaceable-durable assembly, according to some embodiments.

FIG. 54 is an exploded view of a multi-channel pneumatic connector, according to some embodiments.

FIGS. 55-57 illustrate a cutaway view of a multi-channel pneumatic connector, according to some embodiments.

FIG. 58 is an exploded view of a tactile panel assembly, according to some embodiments.

FIG. 59 is a flow diagram of a finger panel fabrication process, according to some embodiments.

FIG. 60 is a flow diagram of a palm panel fabrication process, according to some embodiments.

FIG. 61 is a simplified diagram of a tactile panel, according to some embodiments.

FIG. 62 is an exploded view of a fingertip assembly, according to some embodiments.

FIGS. 63-64 are a simplified cutaway side view and a perspective view of a glove assembly, according to some embodiments.

FIG. 65 is an exploded view of a tendon guide assembly, according to some embodiments.

FIGS. 66-67 are perspective views of a wrist assembly, according to some embodiments.

FIG. 68 is a perspective view of an opisthenar, assembly according to some embodiments.

FIG. 69 is an exploded view of a manipulation actuator, according to some embodiments.

FIG. 70 is a simplified block diagram of glove electronics, according to some embodiments.

FIG. 71-72 are perspective views of a palm assembly, according to some embodiments.

FIG. 73 is a perspective view of an outer glove, according to some embodiments.

FIG. 74 is a front view of a palm tactile, according to some embodiments.

FIG. 75 is a simplified diagram of a glove assembly, according to some embodiments.

FIGS. 76-77 are perspective views of an opisthenar and glove assembly, according to some embodiments.

FIG. 78-79 is a perspective view of a glove assembly, according to some embodiments.

FIG. 80 is a simplified diagram of a pneumatic routing assembly, according to some embodiments.

FIG. 81 is a perspective view of a tubing harness, according to some embodiments.

FIGS. 82-84 are exploded views of a compressor assembly, according to some embodiments.

FIG. 85 is a side view of the compressor of FIG. 82, according to some embodiments.

### DETAILED DESCRIPTION

In some aspects, the techniques described herein relate to a method of providing haptic feedback to one or more haptic interface devices, the method including: receiving, by a haptic feedback controller: first data indicating properties of one or more objects within a computer-mediated environment including an avatar corresponding to a user wearing the one or more haptic interface devices; and second data indicating a haptic effect associated with a current state of the computer-mediated environment; processing, by the haptic feedback controller, the first data and the second data to determine haptic feedback for the user based on an amount and type of contact of the avatar with the one or more objects within the computer-mediated environment and the haptic effect associated with the current state of the computer-mediated environment; generating, by the haptic feedback controller a series of haptic frames based on the determined haptic feedback, each haptic frame specifying a plurality of displacement distances for simulating the amount and type of contact and the haptic effect at a particular point in time; generating, by the haptic feedback controller, a series of actuator frames based on the series of haptic frames, each actuator frame specifying respective amounts of pressure to be provided to tactile actuators of the one or more haptic interface devices to provide a high precision simulation of the amount and type of contact and the haptic effect; and transmitting a plurality of instructions to respective actuator controls of the haptic interface devices, wherein the plurality of instructions are configured to cause actuation of the tactile actuators using the specified respective amounts of pressure to provide the high precision simulation of the amount and type of contact and the haptic effect to the user.

In some aspects, the techniques described herein relate to a system for interfacing between a haptic glove and a computer-mediated environment generated by an application, the system including: a motion capture module configured to perform steps including: receiving sensor data from a plurality of sensors arranged on the haptic glove and at least one tracked location determined by a motion tracker arranged on the haptic glove; processing the sensor data to generate relative location data specifying relative locations and orientations of a plurality of components of the haptic glove; generating a series of motion capture frames based on the at least one tracked location and the relative locations and orientations, wherein each motion capture frame indicates a spatial arrangement of the plurality of components of the haptic glove at a specific point in time; generating a series of kinematic frames based on the series of motion capture frames, wherein the series of kinematic frames map the spatial arrangement of the plurality of components of the haptic glove to a hand model corresponding to an avatar within the computer-mediated environment; and outputting the series of kinematic frames to the application, wherein the series of kinematic frames cause the application to reposition a hand of the avatar within the computer-mediated environment; and a haptic feedback module configured to perform steps including: receiving data indicating properties of one or more objects within the computer-mediated environment; processing the received data to determine an amount and type of contact of the hand of the avatar with the one or more objects within the computer-mediated environment; generating a series of haptic frames, each haptic frame specifying a plurality of displacement distances for simulating the amount and type of contact at a particular point in time; generating a series of actuator frames based on the series of haptic frames, each actuator frame specifying: respective amounts of pressure to be provided to tactile actuators of the haptic glove; and respective amounts of resistance to be applied to actuate finger brakes of the haptic glove; and transmitting a plurality of instructions to respective actuator controls of the haptic glove based on the series of actuator frames, wherein the plurality of instructions are configured to cause actuation of the tactile actuators using the specified respective amounts of pressure and the finger brakes using the specified amount of resistance to provide a high precision simulation of the amount and type of contact to the user.

In some aspects, the techniques described herein relate to a system for interfacing between a haptic glove and a computer-mediated application for controlling a telerobot, the system including: a motion capture module configured to perform steps including: receiving sensor data from a plurality of sensors arranged on one or more haptic interface devices and at least one tracked location determined by respective motion trackers arranged on the one or more haptic interface devices; processing the sensor data to generate relative location data specifying relative locations and orientations of a plurality of components of each respective haptic interface device; generating a series of motion capture frames based on the at least one tracked location and the relative locations and orientations, wherein each motion capture frame indicates a spatial arrangement of the plurality of components of each respective haptic interface device at a specific point in time; generating a series of kinematic frames based on the series of motion capture frames, wherein the series of kinematic frames map the spatial arrangement of the plurality of components of the respective haptic interface device to a model of an avatar of the user; and outputting the series of kinematic frames to the application, wherein the series of kinematic frames cause the application to reposition the avatar within a haptic digital twin of the environment of the telerobot based on the series of kinematic frames, wherein the application is further configured to transmit commands to reposition the telerobot based on the avatar; and a haptic feedback module configured to perform steps including: receiving data that is descriptive of one or more objects within an environment of the telerobot, wherein the data is generated by the application using the haptic digital twin of the environment of the telerobot; processing the received data to determine an amount and type of simulated contact of the avatar with the one or more objects; generating a series of haptic frames, each haptic frame specifying a plurality of displacement distances for simulating the contact at a particular point in time; generating a series of actuator frames based on the series of haptic frames, each actuator frame specifying respective amounts of pressure to be provided to tactile actuators of the one or more haptic interface devices to provide a high precision simulation of the contact; and transmitting a plurality of instructions to respective actuator controls of the haptic interface devices, wherein the plurality of instructions are configured to cause actuation of the tactile actuators using the specified respective amounts of pressure to provide the high precision simulation of the contact to the user.

In some aspects, the techniques described herein relate to a compressor assembly, including: a first compressor with a first motor having an axis of rotation; a second compressor with a second motor, the second motor opposing and coaxial with the first motor by having the axis of rotation; a pneumatic circuit body in pneumatic communication with the first compressor and the second compressor; an assembly mounting plate coupled to the pneumatic circuit body; at least one compressor damper coupled to damp vibration between the pneumatic circuit body and both the first compressor and the second compressor; and at least one pneumatic body damper coupled to damp vibration between the pneumatic circuit body and the assembly mounting plate.

In some aspects, the techniques described herein relate to a method of controlling a compressor assembly, the method including: commanding a first compressor to operate at a first frequency; commanding a second compressor vibrationally coupled with the first compressor to operate at the first frequency; phase shifting of second compressor components of the second compressor relative to the first compressor by commanding the second compressor to operate at a second frequency that is different from the first frequency; aligning the second compressor components to be substantially opposing momentum from operation of first compressor components of the first compressor using the phase shifting; and operating the first compressor and the second compressor at the first frequency in response to aligning the second compressor components to be substantially opposing momentum from operation of first compressor components.

In some aspects, the techniques described herein relate to a method of performing motion capture on sensor data received from a wearable haptic interface, the method including: receiving, by a simulation engine, the sensor data from the wearable haptic interface, wherein the sensor data indicates one or more locations associated with the wearable haptic interface; processing, by the simulation engine, the sensor data to generate a motion capture frame, wherein the processing includes: mapping the location data to a model corresponding to an avatar that is simulated by the simulation engine; and adjusting the mapped data to compensate for the wearable haptic interface; and modifying the simulated avatar based on the motion capture frame.

In some aspects, the techniques described herein relate to a method of providing haptic feedback to a wearable haptic interface, the method including: receiving, from a simulation application, first data indicating a state of an avatar and second data indicating a state of a simulated environment containing the avatar; processing the first data and the second data to detect a contact of the avatar with an entity that exists within the simulated environment; calculating an estimated soft-body deformation resulting from the contact; and actuating a plurality of tactile actuators of the wearable haptic interface based on the estimated soft-body deformation.

In some aspects, the techniques described herein relate to a method of providing interaction assistance within a simulated environment for a user of a wearable haptic interface, the method including: determining, based on first data indicating a state of an avatar corresponding to the user and second data indicating a state of a simulated entity within the simulated environment, an intended interaction of the avatar with the simulated entity; adjusting one or more simulated physics properties within a region of the simulated environment that corresponds to the avatar and the simulated entity; determining an end of the intended interaction of the avatar with the simulated entity; and resetting the one or more adjusted simulated physics properties.

In some aspects, the techniques described herein relate to a method of providing haptic feedback to a wearable haptic interface, the method including: receiving, from a simulation application, first data indicating a state of an avatar and second data indicating a state of a simulated environment containing the avatar; processing the first data and the second data to detect a contact of the avatar with an entity that exists within the simulated environment; determining haptic feedback instructions to provide to the wearable haptic interface based on a simulated force associated with the contact; determining, based on one or more governance standards, to modify the haptic feedback instructions in order to reduce an amount of haptic feedback applied to a user of the wearable haptic interface; and providing the modified haptic feedback instructions to the wearable haptic interface.

### OVERVIEW

According to embodiments of the present disclosure, a haptic device hardware, software and intelligence platform (referred to herein for simplicity as the “haptic platform”) may be provided for interfacing with, exchanging data with, and otherwise coordinating a set of haptic interface devices to enable various use cases within an ecosystem that may include various other devices and systems. Haptic interface devices may include devices that capture data based on user interactions with the haptic interface devices (e.g., a user moving a hand inserted into a haptic glove, a user moving while wearing a haptic exoskeleton, a user pressing buttons on VR controllers, etc.) and use the captured data as input to an immersive haptic system. Additionally or alternatively, haptic interface devices may provide haptic feedback data (e.g., actuation of tactile actuators, force feedback, thermal feedback, etc.) to users based on a state of an application (e.g., to simulate the experience of a virtual avatar in a VR application). Haptic interface devices may also be used for telerobotic applications in which a user may use the haptic interface devices to control a telerobot (e.g., a robot in a different location from the user) and/or receive haptic feedback based on data sensed by the telerobot. Examples of haptic interface devices may include haptic gloves (also referred to as a wearable haptic glove or haptic feedback glove), haptic exoskeletons, and whole-body haptic systems, among others. Other example configurations of haptic interface devices may be found in the application below.

As used herein, the term “exoskeleton” or “haptic exoskeleton” may refer to a wearable haptic interface that may include a plurality of components for interfacing with various user body parts (e.g., arm interfaces, hand interfaces, leg interfaces, torso interfaces, etc.) that are configured to track user movements for motion capture purposes and to provide different forms of haptic feedback, including force feedback, tactile feedback, etc. The exoskeleton may use one or more of various types of actuators, including magnetorheological (MR) actuators, hydraulic actuators, pneumatic actuators, electric actuators, and/or other types of actuators. It should be noted that an exoskeleton may include haptic gloves as part of the exoskeleton. Accordingly, when the specification refers to a haptic exoskeleton and/or haptic gloves, it should be understood that the haptic gloves may be used alone (e.g., without using an exoskeleton) and/or as part of an exoskeleton.

As used herein, the term “whole-body haptic interface” (or whole-body haptic device or system) may refer to an exoskeleton connected to various physical and/or application interfaces. These interfaces may include a motion platform that allows for increased freedom of movement and/or allows haptic feedback to be used to simulate various actions such as climbing, flying, falling, etc. In embodiments, a whole-body haptic interface may include an interface to an application that may provide a virtual environment, a haptic digital twin of a telerobot, and/or any other haptic interface application. An example whole-body haptic interface (including the associated exoskeleton, mechanical ground, etc.) is described in more detail below.

As used herein, the term “whole-body immersion system” may refer to system comprising an exoskeleton and/or whole-body haptic system, one or more VR/AR headsets, additional immersion systems (e.g., headphones), and/or an application for simulating a virtual environment and/or interacting with a telerobot. The various components of the whole-body immersion system in combination may enable realistic and immersive engagement with a virtual environment generated by an application and/or a telerobot controlled by an application, as described in further detail herein.

As used herein, the term “haptic digital twin” may refer to a computer-mediated environment that may include one or more virtual objects or surfaces, where at least some of the virtual objects or surfaces are generated based on sensor information received from a telerobot. For example, the virtual objects or surfaces may correspond to real objects or surfaces within sensor range of the telerobot as indicated by the sensor information. In some cases, the virtual objects or surfaces may be accurate representations of the real objects or surfaces. However, the haptic digital twin may also include virtual objects or surfaces that are generated by transforming sensor data indicating a real object or surface (e.g., to scale the virtual object up or down compared to the real object, change the location/state of a virtual object to a predicted new location/state, change one or more other attributes of the virtual object, and otherwise modify the object/surface in various ways that are further explored below).

Additionally or alternatively, in some cases, a haptic digital twin may include virtual objects or surfaces that do not correspond to any real object or surface. Thus, a haptic digital twin may blend virtual representations of real objects with virtual representations of simulated objects (e.g., for AR/MR use cases that mix simulations with virtual representations of real environments). Regardless of how the virtual objects/surfaces are generated by the haptic digital twin, a user of a whole-body haptic system and/or whole-body immersion system may be able to interact with the environment within the haptic digital twin and receive haptic feedback based on the interactions as described in more detail below. The haptic platform may support the development, operation, monitoring, analysis, and refinement of these and other applications described herein. According to embodiments described herein, reusable and configurable software/hardware modules may be provided to enable and simplify the creation of haptic interface systems that provide highly immersive simulations, control of telerobots, and other computer mediated environments. Accordingly, several techniques for improving the operation of haptic interface systems to provide highly immersive applications are described herein. Additionally, reusable and configurable software/hardware modules may be provided to enable immersive applications for specific use cases, such as training, gaming, simulation, telerobotics, and other use cases.

Furthermore, techniques described herein enable and simplify the provision of monitoring and analysis capabilities for observing user behaviors and operations of haptic interface systems, analyzing the behaviors and operations, and effectively using the results of the analysis. For example, user behaviors may be used to generate user profiles that may be used to personalize the operations of a haptic interface system. Additionally or alternatively, artificial intelligence systems may be used to monitor user performance in training simulations to determine, for example, if training is effective for a particular user and/or how a training environment can be improved. These and other monitoring and analysis capabilities are described in detail herein.

In embodiments described herein, a whole-body immersion system may generate a virtual environment to create an immersive “holodeck” in which a user can be fully immersed within a computer-mediated environment. In these embodiments, the whole-body immersion system may allow a user to interact with objects or other entities within a computer-mediated environment (e.g., avatars controlled by other users or entities coupled to real-world systems such as teleoperated robotic systems) via haptic interface devices such that a user can feel the weight and pressure of the objects, the texture of the objects, the temperature of the objects, and/or otherwise realistically interact with the objects/entities in the environment.

In embodiments described herein, techniques are described for improving the operation of haptic interface devices, such as a wearable haptic glove and/or wearable haptic exoskeleton. Additionally, software development kits (SDKs) that are configured to provide an interface between the haptic interface devices and a haptic system application (e.g., a game engine or simulation of a virtual environment, an application for controlling a telerobot, etc.) are described in detail. Furthermore, techniques for improving interfaces (e.g., application programming interfaces) between the haptic interface devices and the haptic system applications are described.

In embodiments described herein, techniques for improving the operation of electrical systems used to power haptic interface devices are described. Additionally, networking techniques for improving the interoperability of various devices in the haptic platform and/or within a haptic ecosystem are described.

In embodiments, various use cases are described for a haptic platform within a haptic ecosystem. A haptic platform may enable a plurality of non-telerobotic use cases including training, gaming, and other virtual reality/augmented reality/mixed reality (VR/AR/MR/XR) use cases. Additionally or alternatively, a haptic platform may enable a variety of uses cases in conjunction with the control of a telerobot.

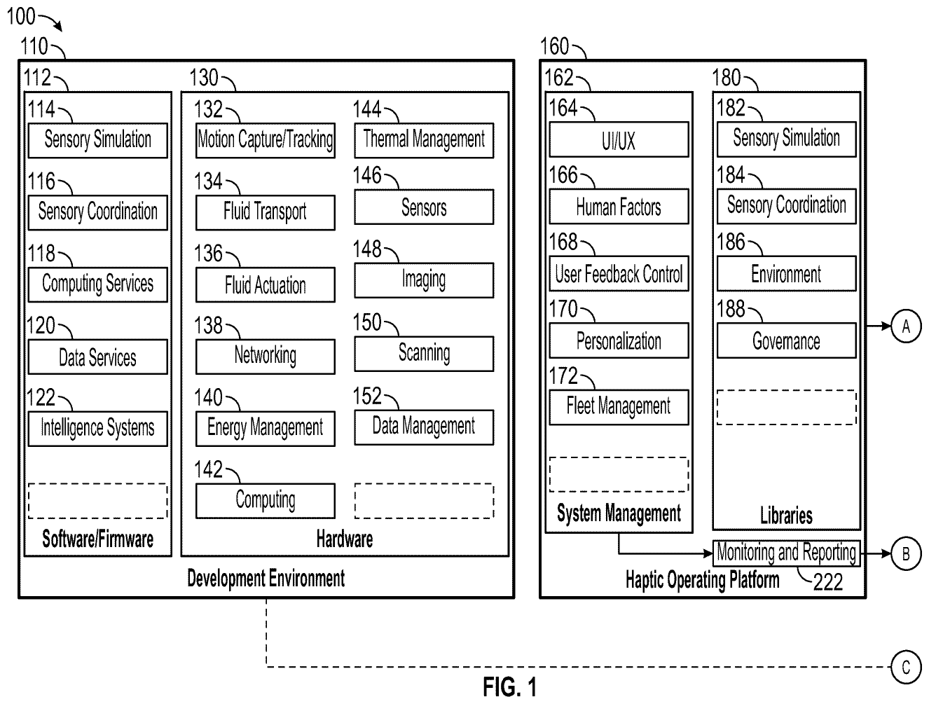

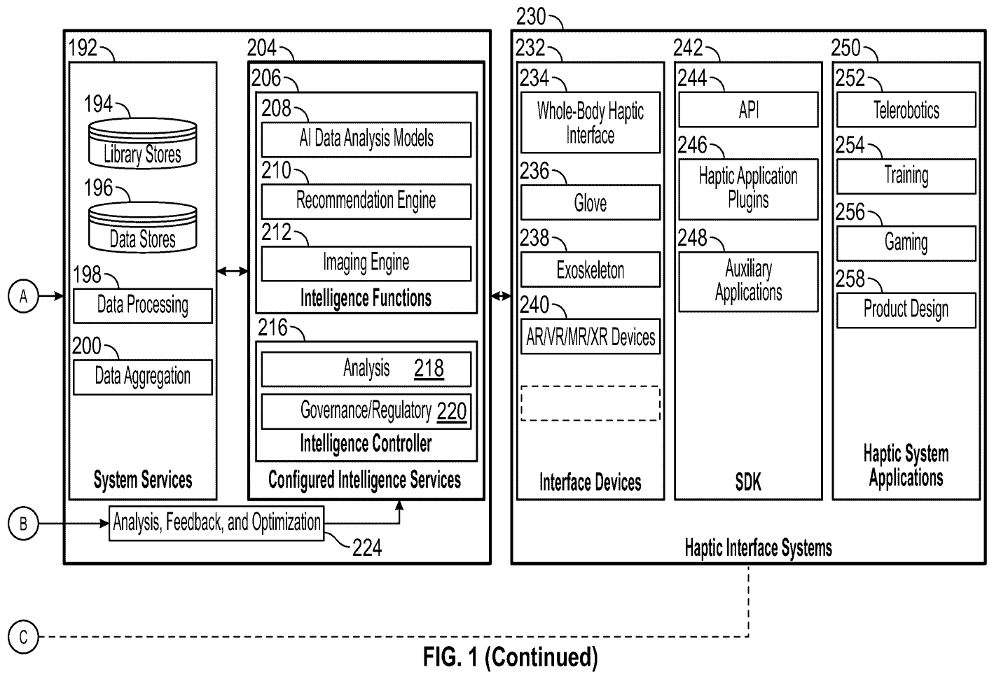

FIG. 1 illustrates an example haptic platform 100 for developing, deploying, and operating haptic interface systems. The haptic platform 100 may include a development environment 110 that may be used to develop and deploy one or more haptic interface systems 230, which may include one or more interface devices 232, one or more haptic system applications 250, and/or an SDK 242 for interfacing between the interface devices 232 and the haptic system applications 250. In embodiments, the haptic platform 100 may include an operating platform 160, which may include systems, libraries, and components for monitoring, analyzing, supervising, and/or otherwise managing the operation of the haptic interface systems 230.

As shown in FIG. 1, the operating platform 160 may be a separate system from the SDK 242 that sits between the interface devices 232 and haptic system applications 250. Additionally or alternatively, the haptic operating platform 160 may implement elements configured or generated by the SDK 242, such that the functions ascribed to the SDK 242 may be performed by the operating platform 160 or vice versa. In other words, in some embodiments (not shown in FIG. 1), the haptic operating platform 160 may “sit between” the interface devices 232 and the haptic system applications 250, applying various processing operations to data as it flows from the interface devices to the haptic system applications (e.g., input operations) and/or to data as it flows from the haptic system applications to the interface devices (e.g., haptic feedback operations). Such operations may include modifying the data to enhance an immersive simulation, monitoring/analyzing operations (e.g., monitoring and analyzing performance of a user in a training simulation), applying safety or governance-based controls (e.g., ensuring force feedback is kept below safe limits, ensuring users do not break operator rules in a multi-user simulation, etc.), mapping user movements to control of a telerobot, using telerobot sensor data to generate haptic feedback, and/or other operations for integrating a haptic interface with a computer-mediated environment that are described in more detail herein.

The development environment 110 may include one or more software/firmware components 112 that may be configured and deployed to the interface devices 232, the haptic system applications 250, the SDK 242, and/or one or more systems/modules/libraries of the operating platform 160. For example, a sensory simulation component 114 may provide software and/or firmware (e.g., software modules, libraries, deployable firmware, etc.) for simulating various sensory experiences, such as functions for translating data for haptic system applications 250 into haptic feedback data for actuating an interface device 232, video data for display via a AR/VR/MR/XR device 240, etc. Similarly, a sensory coordination component 116 may provide software and/or firmware for coordinating multiple sensory experiences with each other (e.g., generating and synchronizing audio feedback with haptic feedback, etc.), as described in more detail below.

The development environment 110 may further include a multitude of software/firmware components 112 of various types, such as various computing services 118, data services 120, and/or intelligence systems 122. In embodiments, some of these components may be specific to certain use cases, such as telerobotic use cases, VR games, training simulations of various types, and/or the like. Various software/firmware functionalities described herein in connection with various embodiments may thus be configured and/or deployed from a development environment 110, where they may be stored as various computing services 118, data services 120, and/or intelligence systems 122. The software/firmware functionalities may be deployed to configure any of the devices described herein as appropriate for each use case described herein.

In embodiments, the software/firmware components 112 may include functionalities that may be deployed to multiple of the various haptic interface systems 230 and/or various components of the operating platform 160. For example, sensory simulation components 114 may include a first software component for translating application data to digital haptic feedback data, and a second firmware component that may be deployable (e.g., to a haptic glove 236 and/or exoskeleton 238) in order to translate the digital haptic feedback data to outputs for controlling microfluidics actuators, exoskeleton actuators, force feedback actuators, and/or the like. Additionally or alternatively, a first sensory simulation component 114 may be used to provide haptic feedback data for a first haptic device (e.g., a first haptic glove 236), while a second sensory simulation component 114 may be used to provide haptic feedback data for a second haptic device (e.g., a second haptic glove 236).

In embodiments, the development environment 110 may further include one or more hardware components 130, which may be combined together and/or with other components to provide functionalities to one or more haptic interface systems 230. For example, the hardware components 130 may include one or more motion capture/tracking component 132, which may include hardware configured to track users and/or other hardware components (e.g., cameras, photovoltaic sensors, infrared sensors, etc.) and/or hardware configured to allow other components to track themselves (e.g., magnetic sensors, lasers, and/or other emitters that may be used for orientation and/or positioning). The hardware components 130 may include fluidics-based hardware (e.g., microfluidics hardware), such as fluid transport 134 components and/or fluid actuation components 136 for routing and re-routing fluids (e.g., to actuate haptic actuators). The hardware components 130 may further include various networking components 138 (e.g., networking interfaces, routers, etc.), energy management components 140 (e.g., battery charging components, power distribution components, and/or the like), computing components 142 (e.g., processors, controllers, integrated circuits, etc.), thermal management components 144 (e.g., heat sinks, fans, active and/or passive cooling systems, etc.), sensors 146 (e.g., positioning sensors, pressure sensors, temperature/environmental sensors, force sensors, vibration sensors, piezo sensors, fluidics sensors, photo sensors, and/or any other type of sensor) imaging components 148 (e.g., image and/or video cameras), scanning components 150 (e.g., sonar, radar, LIDAR, etc.), data management components 152 (e.g., various types of memory, caches, cables, etc.), and/or other such components.

In embodiments, the components may be configured, combined, and/or deployed to create and/or configure various haptic interface systems 230 to enable various haptic use cases and user experiences. For example, various software/firmware components 112 may be configured and deployed to a whole-body haptic interface 234, such as various sensory simulation components 114 and/or sensory coordination components 116 (e.g., for generating, coordinating, and/or supplementing sensory feedback to a user of the whole-body haptic interface 234), various computing services 118 (e.g., for calculating positioning data based on sensors of the whole-body haptic interface 234, for converting force feedback signals into instructions to reposition components of the whole-body haptic interface 234, etc.), various intelligence systems 122 (e.g., which may be used to modify and/or predict a state of a haptic system application 250 and/or the feedback provided to a user of the whole-body haptic interface 234), and/or the like. Additionally or alternatively, various hardware components 130 may be used by the whole-body haptic interface 234 (e.g., the hardware components 130 may be provided to a manufacturer of the whole-body haptic interface 234), such as motion capture/tracking components 132 for tracking user movements, fluid transport 134 components and/or fluid actuation components 136 for providing a microfluidics-based haptic interface of the whole-body haptic interface 234, networking components 138 for allowing the whole-body haptic interface 234 to communicate with other whole-body haptic interfaces 234, a haptic operating platform 160, and/or various haptic system applications 250, energy management components 140 for distributing power to the components of the whole-body haptic interface 234, computing components 142 for processing data generated and received by the whole-body haptic interface 234, thermal management components 144 for heating or cooling components of the whole-body haptic interface 234 (e.g., including for use in a thermal feedback interface), various sensors 146 for use in the whole-body haptic interface 234, various imaging components 148 and/or scanning components 150 for obtaining data about a user of the whole body haptic interface (e.g., for positioning purposes), data management components 152 for transmitting, receiving, and storing data generated by and/or received by the whole-body haptic interface 234, and/or the like. In a similar manner, some or all of the software/firmware components 112 and/or hardware components 130 may be used to configure and/or manufacture a haptic glove 236 (or other wearable item), a haptic exoskeleton 238, various AR/VR/MR/XR devices 240, and/or other interface devices.

Various software/firmware components 112 may also be deployed to generate a configured SDK 242, which may be used to interface between the interface devices 232 and the haptic system applications 250. The SDK 242 may include one or more application programming interfaces (APIs) 244, which may include functions for converting interface device 232 data to input data for the haptic system applications 250 (e.g., a motion capture API for translating movements captured by an interface device 232 to movements of a user avatar within a haptic system application 250), converting state data provided by the haptic system application 250 to the interface device 232 (e.g., a haptics API for translating state data from the haptic system application 250 into haptic feedback data for the interface device 232), and/or the like. The SDK 242 may further include a haptic application plugin 246 configured to interface with various simulation engines (e.g., gaming engines). The functions of the API 244 and haptic application plugins 246 are described in more detail below.

In embodiments, haptic system applications 250 may include a variety of applications for different use cases. Telerobotic applications 252 may allow an interface device 232 to control and receive feedback from a robotic device in a remote location. Training applications 254 may provide various haptic simulations that may be used to train users to perform various skilled tasks that benefit from expert touch, such as flying aircraft or piloting other vehicles, performing dangerous activities (e.g., surgeries, working with hazardous materials, military operations), performing tasks that benefit from “muscle memory” (e.g., movements in sports), and/or the like. Gaming applications 256 may provide various virtual reality, augmented reality, or other gaming experiences for users. Product design applications 258 may allow users to design, model, interact with, test, and/or revise various real or simulated physical objects (e.g., tools, furniture, buildings), machines (e.g., vehicles), or the like within a computer-mediated environment. In embodiments, product design applications 258 may provide a virtual equivalent of a computer-aided drafting (CAD) tool. Additionally or alternatively, the product design applications 258 may integrate with external CAD tools (e.g., to generate virtual objects based on CAD data, allow testing and editing of virtual objects based on CAD data, export created or edited virtual objects to CAD formats, etc.). In embodiments, the haptic systems application 250 may leverage various software components 112, which may provide functionality for receiving interface device 232 inputs and/or outputting state data that may be converted to haptic or other feedback data for interface devices 232. These and other use cases are described in more detail below.

In embodiments, the haptic interface systems 230 may be managed and/or supported by a haptic operating platform 160. The haptic operating platform 160 may include various modules and/or components for performing system management components 162, various libraries 180 that may be accessed to provide various functionalities, various system services 192, and/or various configured intelligence services 204. In embodiments, the operating platform 160 may perform monitoring and reporting 222 and may further leverage the monitoring and reporting 222 to perform analysis, feedback, and optimization 224. In embodiments, the monitoring and reporting 222 may receive inputs generated by various system management modules/components 162, and may provide inputs to the analysis, feedback, and optimization 224. In embodiments, the analysis, feedback, and optimization 224 may be used to further train/optimize the configured intelligence services 204 in order to improve their operation over time. The haptic operating platform 160 may further communicate with any of the haptic interface systems 230 to perform various functions described herein.

In embodiments, the system management modules/components 162 may monitor and/or manage various functionalities for the haptic interface systems 230. In embodiments, a UI/UX module 164 may monitor and/or manage user interactions with interface devices 232 and/or haptic systems applications 250, such as by monitoring and/or managing user interactions with virtual interactive objects provided by haptic system applications 250. For example, a UI/UX module/component 164 may collect data on user interactions with various virtual objects, assist certain users in interacting with virtual objects (e.g., providing interactive assistance to impaired users, modifying physics simulations to make objects easier to pick up, etc.), and/or the like. In embodiments, a human factors module 166 may provide various data for adapting the operation of various haptic interface systems 230. For example, a human factors module 166 may use various factors to configure interface devices 232, such as estimating the size of a user's hand to configure a haptic glove 236, observing user movement within a haptic exoskeleton 238 to determine whether a user has any impairments or range of motion limitations, and/or the like. In embodiments, a user feedback control module 168 may personalize and/or limit various aspects of feedback that may be provided by interface devices 232, such as a maximum amount of force feedback that a user may receive, various amounts of force feedback that may be applied to various body parts, temperature limitations for thermal interfaces, whether a VR display is allowed to flash images at high frequencies, and/or the like. In embodiments, a personalization module 170 may define various preferences for generating a user avatar, customizing interactions with the haptic system applications 250, and/or the like. In embodiments, the human factors module 166, user feedback control module 168, and/or personalization module 170 may receive and/or leverage a user profile that is tailored to a particular user, type of user, and/or the like. In embodiments, user profiles may be stored (e.g., at least temporarily) in the haptic operating platform 160 (e.g., in data stores 196), may be generated based on inputs provided by users, which may include direct input of settings and/or implicit determination of user preferences based on other user inputs, observed ranges of motions, observed reactions to stimuli, etc. In embodiments, a fleet management module 172 may monitor and/or manage groups of interface devices 232, such as by monitoring a number of times a particular interface device 232 has been used, a number of users that have interacted with an interface device 232, a status of an interface device 232 (available, being repaired, etc.), by assigning a particular interface device 232 to a particular user, and/or the like.

In embodiments, various libraries 180 may be used to provide functionalities to haptic interface system 230. For example, a sensory simulation library 182 and/or sensory coordination library 184 may provide various functionalities for simulating various sensory experiences and/or for coordinating multiple sensory experiences during an immersive simulation. In embodiments, the sensory simulation library 182 and/or sensory coordination library 184 may be configured for particular applications (e.g., flight simulation, training environments, vehicle design testing environments, video game environments, etc.). In embodiments, environment libraries 186 may be used to provide functionalities for modeling specific environments (e.g., flight simulation, training environments, vehicle design testing environments, video game environments, etc.). The environment libraries 186 may include audio, visual, tactile, and/or other suitable sensory content/properties that may be used to provide a multi-sensory computer-mediated environment. For example, an environment library 186 for providing vehicle design testing environment may include shapes, surfaces, and other visual properties for 3D rendering of the interior of a vehicle, 3D renderings of environments (e.g., road/landscape) in which the vehicle can be driven, tactile properties of the various components in the interior of the vehicle (e.g., density, texture, temperature, and/or other tactile properties of a seat, steering wheel, airbags, dashboard, control buttons, and/or the like). In embodiments, governance libraries 188 may include code and/or parameters that may be leveraged to limit or otherwise control the haptic response of the haptic interface systems 230, such as to monitor, detect, and prevent dangerous conditions, monitor, detect, and prevent illegal activity, and/or the like.

In embodiments, the haptic operating platform 160 may include various system services 192 for storing various data and providing various operating functions. The system services 192 may include storage services for storing data in storage, such as library stores 194 (e.g., for storing the various libraries 180) and data stores 196 (e.g., for storing various data leveraged by the operating platform 160, such as user profiles, various monitoring and reporting data, training data for intelligence services, etc.). The system services 192 may further include data processing 198 services and/or data aggregation services 200, which may provide processing (e.g., for analysis tasks such as those performed at 224) and/or aggregation functionalities (e.g., for monitoring and reporting 222).

In embodiments, the haptic operating platform 160 may include various configured intelligence services 204, which may include intelligence functions 206 and/or an intelligence controller 216. The intelligence functions 206 may include various machine learning and/or other artificial intelligence components for providing functionalities for the haptic operating platform 160. AI data analysis models 208 may be trained to perform data analysis tasks, such as analyzing user behavior and/or interactions with an interface device 232, user behavior within a haptic system application 250, and/or the like. In embodiments, the intelligence functions 206 may further include a recommendation engine 210 for generating recommendations. The intelligence functions 206 may further include an imaging engine 212 that may be configured for object recognition (e.g., for telerobotic use cases in which a telerobot includes an image sensor). The configured intelligence services 204 may further include an intelligence controller 216, which may include analysis 218 and governance/regulatory 220 components.

### Whole-Body Immersion System

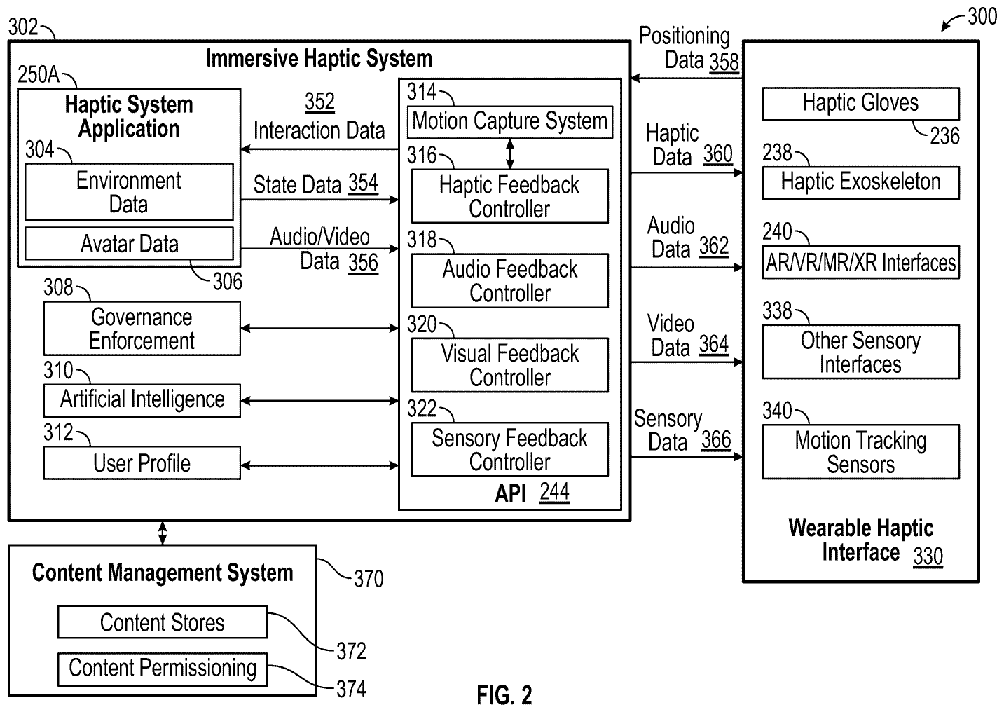

FIG. 2 illustrates an example whole-body immersion system 300 that may be configured to provide immersive full-body control of an avatar within a computer-mediated environment to a user of a whole-body haptic interface 234 (e.g., a full-body interface) and/or various other haptic and/or sensory interfaces, such as haptic gloves 236, an exoskeleton 238, AR/VR/MR/XR interfaces 240, other sensory interfaces 338, etc. The whole-body immersion system 300 may comprise a wearable haptic interface 330 (which may be a whole-body haptic interface 234 or any components thereof) including one or more devices that may be configured to interface with an immersive haptic system 302. In embodiments, the whole-body haptic immersion system may further include a “mechanical ground” (not shown in FIG. 2, but shown and described in more detail below) that anchors at least a portion of the user to the system in order to allow simulations of weight, solidity, and inertia of objects in the computer-mediated environment. In embodiments, the whole-body haptic immersion system may further include a motion platform (not shown in FIG. 2, but shown and described in more detail below) as part of the mechanical ground in order to allow simulations of running, climbing, flying, driving, or other such movements that would be difficult or impossible to simulate without the motion platform and mechanical ground. For example, if a user were testing the design of a car, the whole-body immersion system may be capable of positioning the user in a seated position (e.g., by arranging the components of a haptic exoskeleton, which may be connected to the mechanical ground (which may or may not include a motion platform), such that the user is a seated position), simulating acceleration forces via the motion platform (e.g., by tilting the user in various directions), and the like. Similarly, if a user were testing a simulated airplane, the whole-body immersion system (if it includes a motion platform) may be capable of rotating the user to simulate the pitch, roll, etc. of an aircraft. A detailed description of example hardware featuring a mechanical ground and motion platform is described below.

In embodiments, the immersive haptic system 302 may use an API 244 to interface between the wearable haptic interface 330 and one or more haptic system applications 250 (e.g., haptic system application 250A). In embodiments, the wearable haptic interface 330 may be a full-body interface wearable by a user. For example, the wearable haptic interface 330 may be a component of a whole-body haptic interface 234 that further includes various other components as described elsewhere herein. In other examples, the wearable haptic interface 330 may be a partial-body interface (e.g., covering a torso and arms of the user or any other subset of haptic interfaces). In embodiments, a content management system 370 may further communicate with the immersive haptic system 302 to store, manage, and authorize access to content, among other functions.

In embodiments, the immersive haptic system 302 may execute one or more haptic systems applications 250. As used herein, a haptic systems application 250 (or “haptic application”) may be any application that is configured to output data to a wearable haptic interface (e.g., wearable haptic interface 330) that is used by the wearable haptic interface to provide haptic feedback (e.g., tactile feedback, force-feedback, and/or thermal feedback). Examples of haptic applications may include, but are not limited to telerobotic applications 252, training applications 254, gaming applications 256, product design applications 258, metaverse applications, and/or any other type of haptic system applications 250. For example, a first haptic system application 250A may be a VR game, a second haptic system application may be a telerobotic application that allows a user of the whole-body immersion system to control one or more remote robots, a third haptic system application may be a training application that simulates a training environment with which one or more users interact, and the like. The hardware and software capabilities of the whole-body immersion system 300 may enable the haptic system applications 250 to provide high quality haptic feedback, which allows for the development of muscle memory and therefore allows training, prototyping, and other simulations in a safe and controlled environment. In the illustrated example, the first haptic system application 250A includes environment data 304 (e.g., objects, surfaces, entities, etc. that a user may interact with in the computer-mediated environment via the full-body interface) and avatar data 306 representing the user within the environment. However, other types of applications may be used with the whole-body immersion system 300, such as telerobotic applications, virtual applications without a user avatar, etc.

In embodiments, the immersive haptic system 302 may further include a governance enforcement 308 that enforces one or more governance policies relating to the sensory experiences that are defined in a respective policy library. In embodiments, a policy library may include governance policies that define safety and/or legal limits on different types of haptic feedback (e.g., force-feedback, thermal feedback, and/or tactile feedback). In some embodiments, a governance enforcement 308 may be configured to enforce safety standards that may define, for example, one or more rules specifying maximum amounts of force feedback that may be applied to various body parts, maximum ranges of motion per joint or body part, maximum amounts of acceleration that may be applied per joint or body part, and/or the like. For example, the governance enforcement 308 may limit the amount of force feedback that may be applied to a joint or other body part of a user so that the force feedback does not break the joint or other body part. Additionally or alternatively, the governance enforcement 308 may be configured to enforce safety standards that may define, for example, one or more rules specifying limits on thermal feedback and/or tactile feedback that may be applied to a user. For instance, if a haptic application is configured to train a firefighter the haptic feedback may include thermal feedback that simulates heat transfer from a fire and tactile/force-feedback that simulates forces associated with fighting a fire (e.g., explosions, items falling on the firefighter, using firefighting equipment, and the like). In this example, the governance enforcement 308 may be configured with limits on the temperatures that a user may be exposed to and the physical forces that may be applied to a user in response to the state of the application (e.g., limiting the amount of tactile force that may be applied to the user if a large piece of wood falls on a firefighter in a simulation). In embodiments, the various policy libraries containing the safety standards may be obtained from a haptic operating platform 160 (e.g., libraries 180). It is noted that in some embodiments, the policy libraries may be defined for different types of scenarios and/or different types of users. For example, a governance policy associated with training simulations for training a professional (e.g., pilot, firefighter, military professional, or the like) in a simulated environment may define higher limits for the magnitudes of haptic feedback that a user may be subjected to than the limits for the magnitudes of haptic feedback defined in a governance policy associated with similar environments but for non-professionals. For instance, if simulating a fire-fighting scenario for trained firefighters, a first governance policy may allow a user to be exposed to temperatures that do not exceed 55° C., while if simulating a fire-fighting scenario for non-firefighters a second governance policy may allow a user to only be exposed to temperatures that do not exceed 45° C. A governance policy may thus provide haptic feedback configurations that are customized by role, by degree of experience, by type of user, or based on the personal characteristics of a user.

In embodiments, whole-body immersion system 300 may include a high-quality haptic interface featuring a plurality of microfluidics tactile actuators that may be variably actuated to provide precise contact simulations using different pressure amounts at different locations. In some cases, the fluid may be variable temperature (e.g., it may be mixed using varying proportions of hot and cold fluid) to simulate the feeling of contact with objects of varying temperature and material (which may affect thermal flux). Additionally or alternatively, the haptic interface may feature passive and/or active force feedback that may accurately simulate the feel of interacting with solid objects made of varying materials and weights. In embodiments described herein, the haptic interfaces may be configured to receive an output state from an immersive haptic system 302 (e.g., one or more of haptic data 360, audio data 362, video data 364, sensor data 366, etc.) and to actuate a set of haptic feedback components based on the output state, wherein the magnitude of the haptic response by the set of haptic feedback components is selectively adjusted to comport with a set of safety standards. In embodiments, the haptic interfaces described herein may include a flexible textile laminate that includes a microfluidic actuation layer that is configured to provide realistic haptic response (e.g., tactile and/or thermal feedback) with minimal latency.

In embodiments, an immersive haptic system 302 may include an artificial intelligence module 310, which may be leveraged to provide functionalities used by the API 244, as discussed in more detail below. The immersive haptic system 302 may further include a user profile 312, which may be used to personalize an application in accordance with preferences, abilities, and/or other settings corresponding to specific users, as discussed in more detail below.

In embodiments, the immersive haptic system 302 may interface with a haptic operating platform 160, and accordingly may leverage functionality of the governance enforcement 308 and artificial intelligence 310 (e.g., using system management components 162, libraries 180, and/or configured intelligence services 204). For example in some embodiments, the governance enforcement 308 and/or artificial intelligence 310 of the immersive haptic system 302 may be configured by the haptic operating platform 160 (e.g., by downloading libraries therefrom). Additionally or alternatively, the haptic operating platform 160 may be in real-time communication with an immersive haptic system, such that the haptic operating platform 160 is responsible for enforcing governance policies and/or providing certain intelligence services to the immersive haptic system 302.

In embodiments, the wearable haptic interface 330 may include several components, such as one or a pair of haptic gloves 236, one or more other interfaces of a haptic exoskeleton 238 such as arm/leg/torso interfaces, AR/VR/MR/XR interfaces 240 (e.g., a VR headset), other sensory interfaces 338, and/or one or more motion trackers 340. In some embodiments, the haptic exoskeleton 238 may include large-muscle haptics that may provide haptic feedback to various parts of a user's limbs, torso, etc.

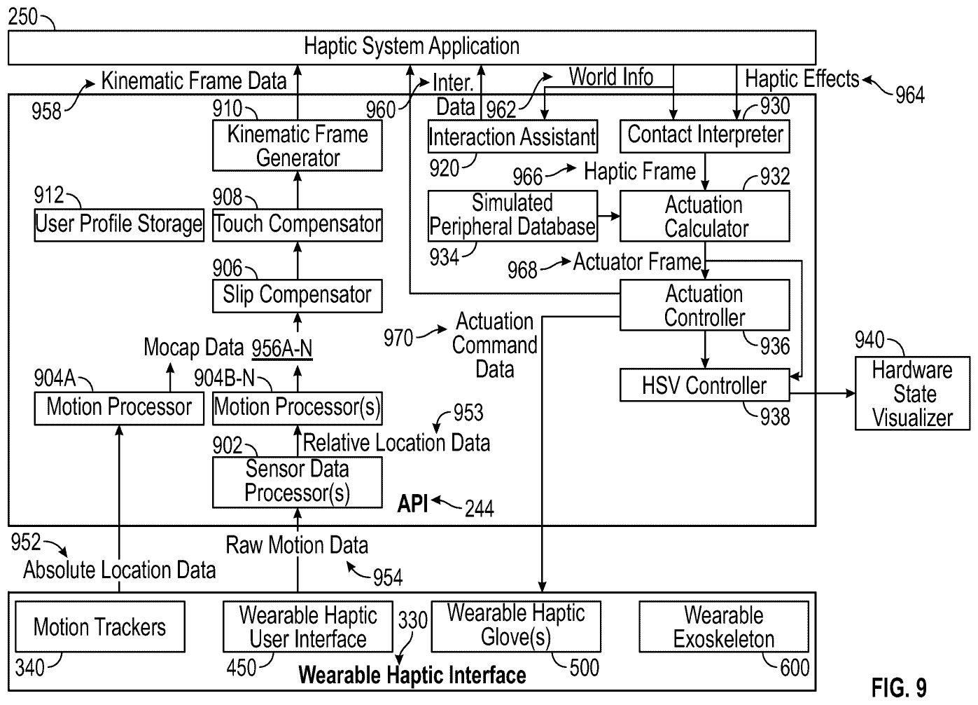

In embodiments, the API 244 may include and/or be implemented by one or more modules, systems, and/or controllers for interfacing between the haptic system applications 250 and the various components of the wearable haptic interface 330. Some or all of the modules/systems/controllers of the API 244 may transmit and process data generated by the wearable haptic interface 330 so that the data may be provided as inputs to a haptic system application 250. Additionally or alternatively, some or all of the modules/systems/controllers of the API 244 may transmit and process data generated by the haptic system applications 250 so that the data may be provided as feedback to one or more components of the wearable haptic interface 330. In embodiments, the modules/systems/controllers of the API 244 may process any of the data based on the user profile 312, which may be used to customize various aspects of the data flowing in either direction. Additional details regarding functionalities of the API 244 are provided with respect to FIG. 9 below.

In embodiments, the immersive haptic system 302 may provide interaction data 352 to the haptic system applications 250 via the API 244 and may provide state data 354 from the haptic system applications 250 to the API 244. Interaction data 352 may specify movement and/or positioning data for an avatar, interactions between the avatar and the environment, a status of the avatar, and/or the like. For example, the interaction data 352 may specify position data for various parts of a user avatar, speed/direction data for moving the avatar, status data indicating current actions for an avatar (e.g., that a particular hand is performing a grasp), contact points for parts of an avatar (e.g., that one hand is touching the other hand), user status data (e.g., that a user is applying pressure in a particular direction but being prevented from moving by force feedback), user limits data (e.g., limits of a user's range of motion), and/or any other such data that may be used to render the avatar and/or interactions between the avatar and the environment. Additionally, although examples herein may refer to a user avatar, it should be understood that a haptic system application 250 may be used to control a telerobotic system or the like such that interaction data 352 may be used to control a telerobot instead of or in addition to an avatar.

In embodiments, the interaction data 352 may be generated by a motion capture system 314 and/or other components of the API 244. The motion capture system 314 may receive six degree of freedom (6DOF) positioning data 358 from the wearable haptic interface 330 (e.g., from one or more motion trackers 340 and/or from sensors integrated into the haptic gloves 236, haptic exoskeleton 238, AR/VR/MR/XR interfaces 240, other sensory interfaces 338, etc.). The positioning data 358 may include relative positioning data, absolute positioning data, orientation data, velocity/acceleration data, pressure data, force feedback data, and/or other such data that may be measured by various sensors of the components of the wearable haptic interface 330. For example, the haptic gloves 236 may measure the relative position of a user's fingertips, the position and orientation of the user's hand, the angle of one or more of the user's finger joints, pressure applied to one or more parts of the haptics gloves 236, and other such data, which may be transmitted to the motion capture system 314 as positioning data 358. The motion capture system 314, in turn, may use the data to develop a data structure that details the current position of the user or part of the user (e.g., the user's hand and/or each joint of the hand if the position data is received from a haptic glove 236). In embodiments, the motion capture system 314 may use prediction models (e.g., a model trained to predict hand position based on various position sensor data, as discussed elsewhere herein), user dimensions (e.g., a size of the user hand), anatomical models (e.g., a model corresponding to a human hand), and/or the like to generate the data structure. Additionally or alternatively, a haptic exoskeleton 238 may measure various positions of the user's head, various part of the user's limbs, torso, facial expressions, etc., and supply such data to the motion capture system 314 to generate data structures describing the positioning of the user's body as a whole and/or of body parts. The motion capture system 314 may then generate interaction data 352 indicating current positioning/movement data for an avatar corresponding to the user and/or other interaction data 352 for the haptic system application 250.

In embodiments, the motion capture system 314 of the API 244 may further receive data from haptic feedback controller 316, which may indicate, for example, when force feedback data is being used to limit or restrain user movement. The force feedback data and other such haptic feedback data may be used to modify user positioning data or other interaction data 352. Additional details describing motion capture techniques that may be performed by the motion capture system 314 of the API 244 are provided below with respect to FIG. 9.

In embodiments, a haptic system application 250 may output state data 354, which may be used by the various feedback controllers to provide haptic data 360, audio data 362, video data 364, and/or sensor data 366. In some embodiments, a haptic system application 250 may further output audio/video data 356, which may be passed through the API 244 and rendered by an AR/VR/MR/XR interface 240 and/or may be modified by audio feedback controller 318 and/or visual feedback controller 320 before being output by the API 244 and rendered by an AR/VR/MR/XR interface 240.

In embodiments, the API 244 and/or various controllers may coordinate variable haptic feedback data that is distributed to and from various components of the wearable haptic interface 330 in order to simulate a fully immersive interaction between the user of the wearable haptic interface 330 and the environment generated by the haptic system applications 250. As a simple example, a user may move and maneuver the user's body (e.g., thereby moving one or more components of the haptic exoskeleton 238) to cause the user's avatar to approach an object that exists within the environment (which the user may view via the AR/VR/MR/XR interface 240), extend the user's arm and touch the object (e.g., by moving the haptic glove 236). As the system detects the co-location of the position of user's hand and the position of object in the computer-mediated environment, the system may cause the user to “feel” the object by inducing haptic feedback provided by the gloves 236. The user may then grasp the object (e.g., by moving the user's fingers within the haptic glove) and lift the object, and the haptic exoskeleton 238 and/or haptic gloves 236 may provide force feedback to simulate the weight of the object. The user may then, for example, drop the object, and if the object contacts the user's avatar as it falls within the computer-mediated environment, haptic feedback may be applied so the user feels the impact of the object. In embodiments, other cues such as audio cues, visual cues, or other sensory cues may be generated by the immersive haptic system 302, audio feedback controller 318, visual feedback controller 320, and/or sensory feedback controller 322 to simulate certain interactions. For example, any of these controllers may be configured using sensory simulation components 114 and/or sensory coordination components 116, as well as other software/firmware components 112. Additionally or alternatively (e.g., in embodiments in which the API 244 is implemented by a haptic operating platform 160), the feedback controllers may leverage libraries 180, such as sensory simulation libraries 182 and/or sensory coordination libraries 184. For example, objects may be associated with sensory data within the environment, such that if a user touches, for example, a hot object, a thermal sensory interface may provide thermal haptic feedback to the user at or nearby the simulated point of contact.

In embodiments, the haptic feedback may be variable/proportional in order to provide for a more immersive whole-body environment. For example, haptic feedback provided by microfluidic actuators of a haptic glove 236 may provide variable pressure to simulate a certain amount of force applied to a user's fingers or hands. Similarly, haptic feedback provided by a thermal actuator (which may be a microfluidic tactile actuator or a separate actuator) may be variable in order to simulate a certain amount of thermal flux dependent on simulated temperature and/or thermal conductivity properties of a virtual object. Thus, for example, a user may be able to feel the difference between virtual objects/materials in a way that simulates the texture, weight, velocity, temperature, material, and/or other properties of a virtual object or virtual environment. Moreover, the various types of haptic feedback (including microfluidics, force feedback, thermal, visual, audio, and/or other sensory experiences) may be coordinated to provide a highly immersive and realistic computer-mediated environment. As discussed in more detail below, these haptic feedback actuators may also be limited in accordance with a set of governance settings defined in a governance library and/or in accordance with other settings (e.g., preferences or other settings). The types of haptic feedback may be configured based on an understanding of how the brain reacts to sensory stimulus; for example, a change in temperature may be induced that simulates, rather than exactly matches, a change in temperature of an object. This may provide immersive and realistic computer-mediated environments while maintaining safety of the user, such as by not fully matching a change in temperature that would burn the hand of a user.

Thus, the whole-body immersion system 300 may generate a fully immersive computer-mediated environment using one or more combinations of several techniques that may vary by application, by context of a particular environment, and/or by the hardware/software/firmware functionalities that are available for a given embodiment of a haptic platform. In embodiments, the whole-body immersion system 300 combines various types of inputs and feedback data in a coordinated manner in order to generate a fully immersive environment that includes touch interactions and various other interactions between the human user and physical entities within the environment. Moreover, by coordinating positioning data 358 (including relative position data, actual position data and/or other types of motion tracking data) received from haptic gloves 236, a haptic exoskeleton 238, and/or other interfaces, and coordinating the positioning data to generate inputs to an immersive haptic system, a user may cause interactions within a computer-mediated environment by controlling an avatar corresponding to the user, according to some embodiments of the present disclosure. Additionally, the whole-body immersion system 300 generates haptic feedback such that the state data received from the computer-mediated environment is processed and coordinated to cause variable haptic feedback at specific locations of the wearable haptic interface 330, including the haptic gloves 236, haptic exoskeleton 238, and any other haptic interfaces. In particular, the coordinated variable haptic feedback may be provided by a haptic feedback controller and may simulate interactions between the user and objects or other aspects of an environment.

In embodiments, the wearable haptic interface 330 may include one or more EEG components (e.g., sensory interfaces 338 may include EEG interfaces) configured to monitor brain activity of a user. Additionally or alternatively, the wearable haptic interface 330 may include various types of biometric sensors (e.g., eye tracking, perspiration sensors, heartbeat/pulse sensors, temperature sensors, accelerometers, audio sensors, etc.) configured to measure biometric activity of a user.

In some embodiments, the motion capture system 314 and/or some other component of the API 244 may be configured to receive and monitor EEG signals measuring user brain activity and generate interaction data 352 based on the monitored EEG signals. For example, a particular haptic system application 250 may be configured to use an EEG signal as interaction data 352 to change the location or state of a user avatar, interaction with the environment, or otherwise modify the environment data 304 and/or avatar data 306. For example, users may be able to control an avatar using an EEG interface.

Accordingly, a wearable haptic human interface device may have a set of haptic components integrated into a wearable component of the interface device (e.g., haptic gloves 236 and/or a haptic exoskeleton 238) that realistically simulate a human sensory interaction with a physical entity based on a set of actuation commands determined from a haptic feedback response corresponding to an interaction of an avatar and an environment, and further may have a set of EEG components that monitor brain activity of a user wearing the interface device.

In some embodiments, the EEG components may monitor the brain activity of a user and may output EEG signals to the haptic operating platform 160, which monitors user brain activity in conjunction with the state of a computer-mediated environment (e.g., a simulated scenario that the user is presented), the haptic feedback data (e.g., what is the user being subjected to), and/or biometric signals (e.g., heartbeat, breath rate, temperature, and/or the like). In some of these embodiments, the haptic operating platform 160 may analyze the user brain activity in conjunction with the haptic feedback and biometric signals to determine acceptable levels of haptic feedback (e.g., tactile, force feedback, and/or thermal feedback). In some embodiments, the operating platform 160 may train machine-learning models to determine acceptable levels of haptic feedback for a specific user (e.g., personalized limits), class of users (e.g., trained professionals, novices, children, and/or the like), or for all users.

In some embodiments, the haptic operating platform 160 may analyze the user brain activity in conjunction with a state of a computer-mediated environment, motion capture data, the haptic feedback, and/or biometric signals to improve training outcomes. In these embodiments, the haptic operating platform 160 may monitor and analyze user responses to the current environment or state of an environment, particular locations with the environment, particular positions that a user and/or user avatar is in, amounts and/or magnitudes of haptic feedback applied, and/or other conditions of the environment, the user avatar in the environment, or the user (e.g., as measured by various sensors of a wearable haptic interface 330). The haptic operating platform 160 may thus analyze and detect which types of conditions cause less or more brain activity, cause certain types of brain activity, and/or the like. In embodiments, the haptic operating platform 160 may therefore provide analysis and metrics for detecting a level of training or learning effectiveness (e.g., which parts of a training simulation may be most memorable), whether certain conditions may be over-stimulating or under-stimulating, and/or the like. Thus, the haptic operating platform 160 may provide analysis and metrics that may be used to further develop the effectiveness of a training simulation, improve outcomes, and/or the like.

In some embodiments, the haptic operating platform 160 may analyze the user brain activity in conjunction with motion capture data, haptic feedback data, and/or an environment that controls telerobots (which may be a haptic digital twin that includes a representation of a physical environment including the telerobot) to train robotic process automation (RPA) models. In these embodiments, the haptic operating platform 160 may monitor and analyze user responses to the current environment or state of a computer-mediated environment (e.g., a game, a simulation, and/or a haptic digital twin environment for a telerobot), particular locations of the telerobot within a simulated environment or digital twin, particular positions that a user and/or telerobot is in, amounts and/or magnitudes of haptic feedback applied to the user, and/or other conditions of the simulated environment and/or telerobot, the telerobot, or the user (e.g., as measured by various sensors of a wearable haptic interface 330). In these embodiments, the haptic operating platform 160 may provide analysis and metrics for detecting different responses to different conditions of the telerobot, including training models for controlling a telerobot for RPA. For example, the haptic operating platform 160 may detect which types of conditions are routine or exceptional based on monitoring brain activity of a user. Thus, the haptic operating platform 160 may provide analysis, metrics, and training data that may be used to train models for RPA that may be capable of detecting certain conditions and responding accordingly.

In embodiments, the immersive haptic system 302 and/or haptic operating platform 160 may be configured to analyze various user responses (e.g., including EEG signals and other user measurements) to various conditions and to model a reaction of a human (e.g., the specific user and/or a typical user) to various types of sensory stimulus. The immersive haptic system 302 and/or haptic operating platform 160 may then determine a set of parameters for configuration of a haptic experience for the human based on the reaction parameters and/or based on a set of inputs relating to an environment or entity within the environment. In embodiments, the haptic experience may be configured using data stored in a user profile 312, as described in more detail below.

In embodiments, the whole-body immersion system 300 may further include a content management system 370, which may include one or more of content stores 372 for storing content (e.g., haptic system applications 250 and/or content that may be accessed via the haptic system applications 250) and/or a content permissions module/system 374. In embodiments, the content management system 370 serves immersive content that includes haptic, audio, visual, and/or any other sensory experience content. Additionally or alternatively, the content management system 370 (e.g., using the content permissions module 374) manages the permissions required to execute the immersive content in the environment. In embodiments, the immersive haptic system 302 interfaces with the wearable haptic interface 330 and the content management system 370 that serves immersive content that includes haptic, audio, visual, and any other sensory experience content. In these embodiments, the content management system may manage the delivery of the content including any caching, compressing, and/or streaming of the immersive content.

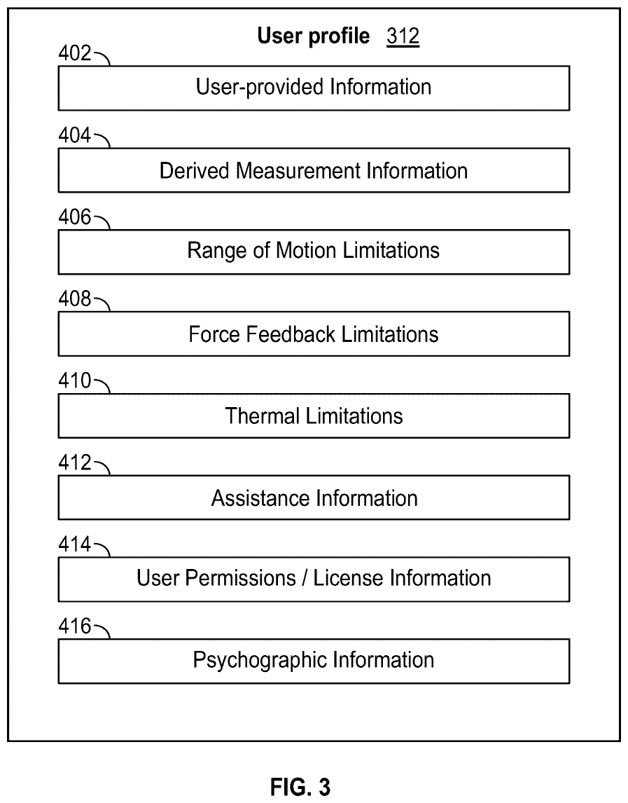

In embodiments, haptic experiences may be personalized to a particular user. FIG. 3 illustrates an example user profile 312 that may be used to personalize or otherwise customize the operation of the various haptic interface systems 230 described herein, including various interface devices 232, an SDK 242, and/or various haptic system applications 250. In embodiments, the user profile 312 may be set up using a user profile (which may be an auxiliary application 248). In some embodiments, the user profile 312 may be leveraged partially or entirely by components of the SDK 242 (e.g., API 244 and/or haptic application plugins 246) such that interface devices 232 and/or haptic system applications 250 may not need to implement personalization features. For example, an API 244 may be configured to modify data received from interface devices 232 (e.g., extending a stride length or input speed for a user who wishes to move their avatar faster) before generating inputs to haptic system applications 250 and/or may be configured to modify haptic feedback or other data output by the haptic system applications 250 (e.g., in order to limit the amount or type of force feedback that may be applied to a particular user) before providing it to interface devices 232.

As shown in FIG. 3, the user profile 312 may specify a variety of data that may be used to personalize any of the haptic applications described herein. In embodiments, the user profile 312 may include a variety of parameters as described in more detail below.

In embodiments, the user profile 312 may include user-provided information 402, which may be used by haptic system applications 250 to generate a user avatar (e.g., the user avatar may be generated based on user-provided measurements, such as height, hand size, etc., and/or one or more user preferences for configuring the avatar). Additionally or alternatively, the user-provided information 402 may be used by an API 244 or haptic application plugins 246 to predict movement data for a user. For example, an API 244 may be configured to estimate the location and angle of a user's fingers (e.g., from motion capture data received from a haptic glove 236) based in part on user-provided information 402 such as a width and length of the user's hand. In some cases, user-provided measurement information 402 may or may not correspond to a user's dimensions, but may specify one or more user preferences that may be used to configure the user's avatar. For example, a user may specify a preferred size of the avatar (and/or the avatar's hand for a haptic glove), gender, skin color, and/or any other attribute of the avatar. In embodiments, the user-provided information 402 may indicate, for example, if the user has missing or extra digits or other such user-provided information 402 for configuring a hand of the avatar.

In embodiments, the user profile 312 may include derived measurement information 404 that may be implicitly generated (e.g., without explicit input by a user) based on user interactions with one or more interface devices 232. For example, based on a user's motions as captured by a whole-body haptic interface 234, haptic glove 236, and/or haptic exoskeleton 238, user measurements such as a length of a user's limbs or fingers, a preferred range of motion, etc. may be implicitly estimated. The derived measurement information 404 may then be used by haptic system applications 250 to generate a user avatar, may be used by an API 244 to modify motion data received from interface devices 232, etc.

In embodiments, the user profile 312 may further include range of motion limitations 406 that may limit active force feedback that may be applied to a user by one or more interface devices 232. For example, active force feedback may be used to simulate a user's avatar and a virtual object colliding in a computer-mediated environment. In these embodiments, a haptic system application 250, API 244 or haptic application plugins 246, and/or interface device 232 may ensure that the force feedback is limited such that it does not strain or injure a user, such as by overextending a user's limb or causing an unnatural movement. The range of motion limitations 406 may define directions/angles that are safe and/or comfortable for a particular user's joints, limbs, and/or other body parts, such that the various haptic interface system 230 do not exceed the defined range of motion limitations 406.

In embodiments, the user profile 312 may include force feedback limitations 408 that may further limit active or passive force feedback that may be applied to a user by one or more interface devices 232. For example, active force feedback may be limited by the user profile specifying a maximum magnitude of force feedback to be applied, a maximum acceleration to be applied via force feedback, and/or the like. In embodiments, the maximums may be separately defined for individual body parts and may be defined in terms of force/velocity/acceleration, angular force/velocity/acceleration, and/or the like. The force feedback limitations 408 may be used by a haptic system application 250, API 244 or haptic application plugin 246, and/or interface device 232 in order to limit haptic feedback applied to a user.

In embodiments, the user profile 312 may include thermal limitations 410 that may limit thermal feedback that may be applied to a user by a thermal feedback interface of the one or more interface devices 232. For example, the thermal limitations 410 may specify a maximum or minimum temperature and/or thermal flux that may be provided by the thermal interface, and/or whether thermal feedback may be provided at all, in particular situations, etc. The thermal limitations 410 may be used by a haptic system application 250, API 244 or haptic application plugin 246, and/or interface device 232 in order to limit haptic feedback applied to a user.

In embodiments, the user profile 312 may include assistance information 412 that may be used to modify movement and/or interaction data provided to haptic system applications 250 and/or to modify haptic feedback provided to a user of interface devices 232. For example, the assistance information 412 may indicate that certain movements of a user of a whole-body haptic interface 234, haptic glove 236, and/or haptic exoskeleton 238 should be amplified. For example, if a user “walks” a one-meter stride in a whole-body haptic interface 234 or haptic exoskeleton 238, and a user's assistance information 412 indicates a 3× movement scaling factor, the user's avatar in a haptic system application 250 may move by three meters in a computer-mediated environment. In embodiments, assistance information 412 may use separate scaling factors for vertical and horizontal movement, such that certain movements (e.g., climbing) may be made easier or harder. In embodiments, the assistance information 412 may be used to simulate reduced gravity. In embodiments, the assistance information 412 may be used to limit haptic feedback provided to a user. For example, if the assistance information 412 indicates that a user has a disability related to a particular limb or body part, haptic feedback corresponding to that body part may be reduced or eliminated. Additionally or alternatively, if the assistance information 412 is used to simulate reduced gravity, then haptic feedback may comport with the simulated reduced gravity.

In embodiments, a user profile 312 may include license user permissions/license information 414 that may authorize user access to particular content and/or types of content. The user permissions/license information 414 may include, for example, credentials for accessing protected content (e.g., subscription content, purchased content, etc.), a user account that may have permissions to modify or delete user-generated content, and/or the like. Additionally or alternatively, the user permissions/license information 414 may include content restrictions, such as parental controls, which may be used to restrict access to certain types of content.

In embodiments, a user profile 312 may include psychographic information 416 that may specify, for example, that a user is sensitive to certain haptic or visual stimuli, that a user prefers less or more haptic feedback of certain types, and/or the like. The psychographic information 416 may be used to tailor haptic feedback to a particular user (e.g., increasing certain types of haptic feedback to promote muscle memory, decreasing certain types of haptic feedback to avoid overwhelming a user, etc.).

### “Point of View” Immersive Environmental Interaction

In embodiments, the wearable haptic interface 330 may include motion trackers 340 that are used to track the motion of respective body parts of a user. In some embodiments, the motion trackers 340 include magnetic motion tracking sensors with sub-millimeter tracing precision. The magnetic motion tracking sensors may be arranged into magnetic sensor arrays, which may measure angular displacement and/or relative position of components of the wearable haptic interface 330. For example, a first set of motion trackers 340 arranged in a first magnetic sensor array may track the angular displacement and/or relative position of a first limb and/or joint of a user, a second set of motion trackers 340 arranged in a second magnetic sensor array may track the angular displacement and/or relative position of a second limb and/or joint of a user, and/or the like. Tracked joints may include a user's finger joints, shoulder/arm joints, hip/leg joints, neck, spine, and/or the like.

In embodiments, the motion trackers 340 may be magnetometers that may be positioned adjacent to corresponding magnets, such as on opposing sides of an articulation of an exoskeleton. Additionally or alternatively, the magnetometers may sense a magnetic field originating externally to a respective component of the wearable haptic interface 330, to determine an orientation of the respective component with respect to an entity other than the wearable haptic interface 330, such as an object, an infrastructure element, a fixture or the like. Thus, motion trackers 340 may track relative movements of the corresponding magnets and/or orientation of the corresponding component of the wearable haptic interface 330 and provide information on the relative movements and/or orientations as positioning data 358 to the API 244. In turn, the API 244 may determine (e.g., using the motion capture system 314) a position, orientation, and/or movement of the user (or part of the user, such as a hand joint, a limb, etc.) and corresponding interaction data 352 for an avatar, telerobot, and/or the like. The use of magnetometers as described herein may enable sub-millimeter tracking precision for orientation and/or relative movement, and thus may allow accurate and immersive positioning of an avatar within an environment.

In embodiments, the whole-body immersion system 300 may be configured to simulate a non-linear relationship between an anatomy of a human using the wearable haptic interface 330 and the anatomy of an avatar that exists within a haptic system application 250 and/or the anatomy of a telerobot. For example, an avatar and/or telerobot may be taller than the human user, may have larger fingers or hands, may have more or less digits, may have tools or accessories of various types attached to limbs instead of hands, and/or the like. In these embodiments, the immersive haptic system 302 may be configured to provide an immersive environment that allows the user to control the corresponding avatar/telerobot, interact with objects within the environment, etc. despite any dimensional, morphological, or other differences between the user and the avatar and/or telerobot. In these embodiments, the API 244 (e.g., using the motion capture system 314 or some other motion tracking component described herein) may receive sensor data and/or other positioning data 358 from the components of the wearable haptic interface 330 and may determine one or more respective joint angles of one or more respective joints (e.g., of a hand) based on the sensor data and a model of the physical and mechanical characteristics and/or other parameters of a human hand. In these embodiments, the motion tracking sensors 340 and/or motion capture system 314 may provide the one or more joint angles to the immersive haptic system 302 in lieu of or in addition to positional data of the joint and corresponding body part (e.g., the interaction data 352 may include finger joint angle data instead of or in addition to a motion capture data structure representing the position of a user avatar or hand, for example) when there is a non-linear relationship between an anatomy of the human and a corresponding anatomy of the avatar. Accordingly, the immersive haptic system 302 may be configured to map the user joint angles to the anatomy of the avatar.

In embodiments, the artificial intelligence module/system 310 may provide features and functionalities to the immersive haptic system 302 to improve the immersive environment, such as by adjusting data provided as inputs to the haptic system applications 250 and/or the wearable haptic interface 330. For example, the artificial intelligence system 310 may be configured to adjust the output state sent to the haptic human interface components of the wearable haptic interface 330 (e.g., as haptic actuation commands or other haptic data 360 or sensor data 366) to optimize the sensory experiences of the user of the wearable haptic interface 330 with respect to one or more factors. Additionally or alternatively, the artificial intelligence system 310 may be configured to translate raw motion and/or tracking data (e.g., corresponding to motions of a user) output by the components of the wearable haptic interface 330) into high accuracy motion capture data.

In embodiments, the immersive haptic system 302 may model a set of attributes of a set of objects in an environment (e.g., the environment data 304) and may determine a position of a set of elements of an avatar of a user (e.g., the avatar data 306) in the environment based on a state of a haptic interface worn by a user. For example, the immersive haptic system 302 may, in response to detecting that a position of the avatar intersects with a position of an object within the computer-mediated environment, be configured to output a set of sensory simulation data related to the object (e.g., haptic data 360, audio data 362, video data 364, and/or sensor data 366). In some embodiments, the immersive haptic system 302 may be configured to output a set of sensory simulation data related to the object that intersects with the user avatar such that the immersive haptic system outputs are configured as a set of haptic actuation instructions (e.g., haptic data 360). Additionally or alternatively, the immersive haptic system 302 may be configured to output a set of sensory simulation data related to the object that intersects with the user avatar such that the immersive haptic system outputs a set of thermal sensory simulation data related to the object. Additionally or alternatively, the immersive haptic system 302 may be configured to output a set of sensory simulation data related to the object that intersects with the user avatar such that the sensory simulation data include a set of deformation parameters based on which a set of haptic actuators simulate touching of the object.

In embodiments, the whole-body immersion system 300 may be configured to provide a multi-sensory user experience by providing an immersive haptic system 302 that models a set of attributes of a set of objects in an environment (e.g., environment data 304) and determines a position of a set of elements of an avatar of a user in the environment (e.g., avatar data 306) based on a state of a haptic interface worn by a user (e.g., haptic gloves 236, a haptic exoskeleton 238, and/or other components of a wearable interface 33). In these embodiments, the immersive haptic system may be configured to detect that a position of the avatar intersects with a position of an object within the environment (e.g., when the avatar represented by the avatar data 306 is in the same space, or within a threshold distance, of an object of the environment represented by the environment data 304). When the immersive haptic system 302 detects that the position of the avatar intersects with the position of an object (e.g., the avatar and object are touching inside the environment), the immersive haptic system 302 may output a set of sensory simulation data related to the object (e.g., haptic data 360 for allowing a user to feel the object, audio data 362 representing a sound of the collision between the avatar and the environment or data for rendering such a sound, etc.). The sensory simulation data may be coordinated in order to provide an immersive feedback experience. In embodiments, immersive haptic system outputs related to the object may be configured as a set of haptic actuation instructions (e.g., haptic data 360) and a set of audio instructions (e.g., audio data 362) that characterize audio characteristics of the environment. Additionally or alternatively, when an immersive haptic system 302 detects that a position of the avatar intersects with a position of an object with the environment, the immersive haptic system 302 may be configured to output sensory simulation data related to the object that includes a set of haptic actuation instructions and a set of video or imaging instructions that characterize visual characteristics of the environment. Additionally or alternatively, when an immersive haptic system 302 detects that a position of the avatar intersects with a position of an object within the environment, the immersive haptic system 302 may be configured to output sensory simulation data related to the object that includes a set of haptic actuation instructions and a set of virtual reality instructions that characterize a virtual reality representation of the environment. Additionally or alternatively, when an immersive haptic system 302 detects that a position of the avatar intersects with a position of an object, the immersive haptic system 302 may be configured to output sensory simulation data related to the object that includes haptic actuation instructions and a set of augmented or mixed reality instructions that characterize augmented reality or mixed reality elements for the environment. Additionally or alternatively, when an immersive haptic system 302 detects that a position of the avatar intersects with a position of an object, the immersive haptic system 302 may be configured to output sensory simulation data related to the object that includes a set of haptic actuation instructions and a set of taste instructions that characterize taste characteristics of the environment. Additionally or alternatively, when an immersive haptic system 302 detects that a position of the avatar intersects with a position of an object, the immersive haptic system 302 may be configured to output sensory simulation data related to the object that includes a set of haptic actuation instructions and a set of scent instructions that characterize scent characteristics of the environment.

### “Skin Out” Wearable Technology and Tactile Surfaces

In embodiments, a haptic platform may use one or more haptic user interface devices that provide direct haptic feedback through tactile actuators, thermal actuators and/or other actuators (e.g., electrical, biochemical, chemical, or the like) in contact with a user's skin. Software, firmware, data and intelligence techniques for leveraging these technologies to generate immersive computer-mediated environments are described in more detail herein.

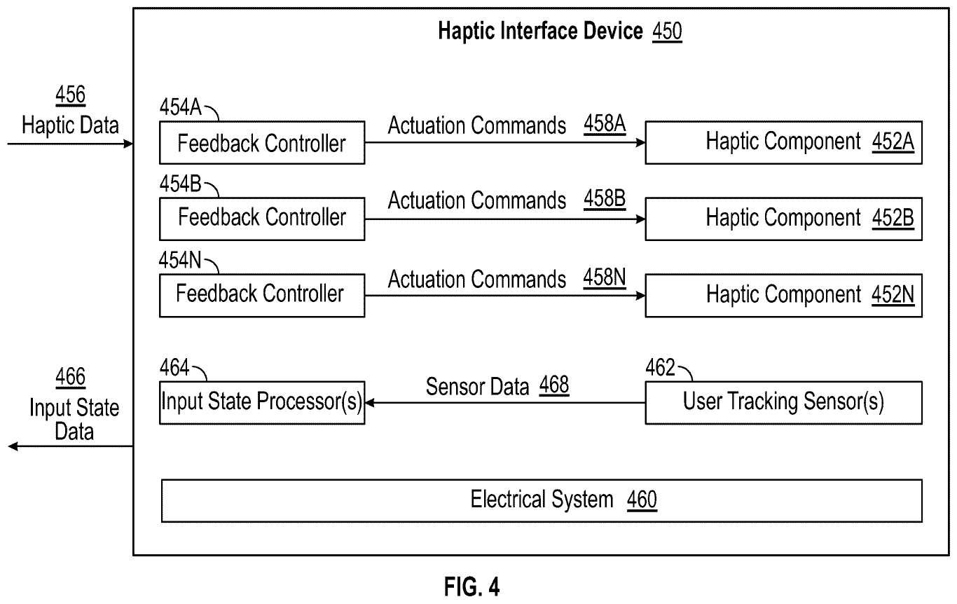

FIG. 4 illustrates an example haptic interface device 450, which may be any component of a wearable haptic interface 330 or any other device that leverages smart surface technology to receive haptic system inputs and/or provide haptic feedback. The haptic interface device 450 may, in embodiments, be configured as haptic gloves 236, a haptic exoskeleton 238, or any other haptic interface device. In embodiments, the haptic interface device 450 may include a plurality of haptic components 452 that may include a first glove component, a second glove component, a haptic vest, haptic arm/leg components, other smart surface components, etc., where each haptic component may feature a plurality of microfluidics tactile actuators as described herein. In other words, the haptic interface device 450 may be implemented as various haptic user interface form factors by using different hardware components in different combinations as desired. Thus, the haptic interface device 450 may have one or more haptic components 452, which may be different combinations of components in different embodiments.

In embodiments, the haptic interface device 450 may include one or more feedback controllers 454, which may receive haptic data 456 as inputs and generate actuation commands 458 for controlling actuators of the haptic component(s) 452 to simulate a sensation of interacting with a physical object. In embodiments, if the haptic interface device 450 includes a plurality of haptic components 452, then each haptic component 452 may be associated with a corresponding feedback controller. Additionally or alternatively, multiple haptic components 452 may be controlled by a single feedback controller 454 (e.g., a single feedback controller 454 may generate actuation commands 458 for two different glove components).

In embodiments, haptic data 456 may be received (e.g., from an immersive haptic system 302) and processed by the feedback controller 454 to generate actuation commands. The haptic data 456 may include one or more of haptic data 360, audio data 362, video data 364, sensor data 366, and/or other output data that represents some aspect of a current state of an immersive haptic system. Accordingly, haptic actuation commands 458 may be generated based on processing any of the data output by an immersive haptic system (e.g., immersive haptic system 302). Additionally or alternatively, in embodiments a feedback controller 454 may implement any of the features ascribed to an API 244 herein. In other words, the functions of an API 244 may be implemented in full or in part by an immersive haptic system 302, and/or in full or in part by a feedback controller of a haptic interface device 450.

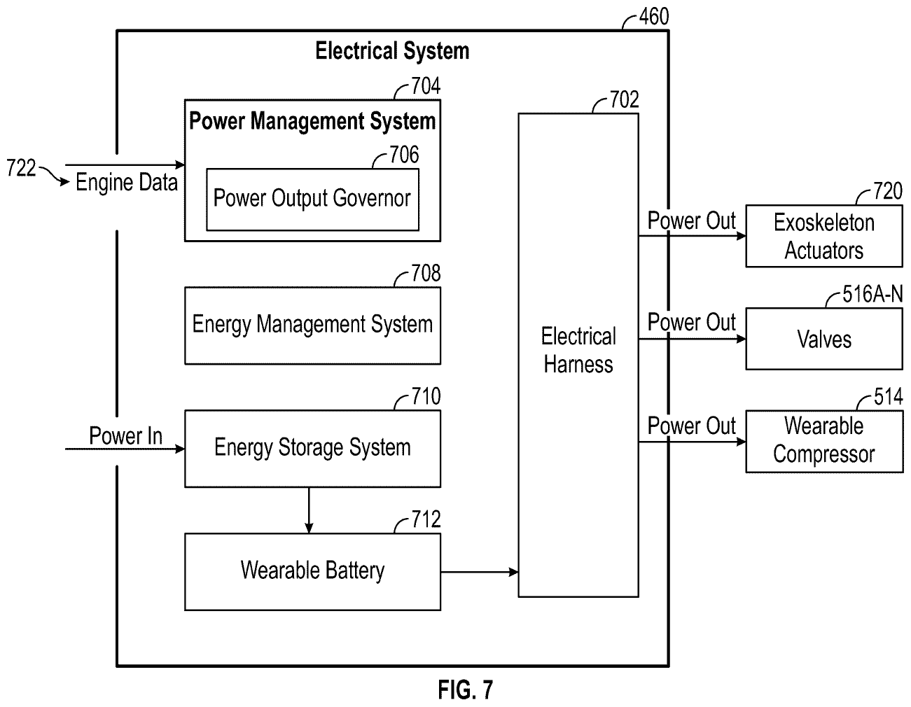

Power may be supplied to various components (e.g., the feedback controllers 454, the haptic components 452) by an electrical system 460. Functions and capabilities of the electrical system 460 are discussed in more detail below with respect to FIG. 7.

In embodiments, the haptic interface device 450 may include user tracking sensor(s) 462 for tracking the location or status of the user or various joints/body parts of the user (e.g., finger tracking sensors). The user tracking sensors 462 may detect absolute or relative position or orientation, velocity/acceleration data, pressure data, force feedback data, temperature data, EEG signals, and/or other such data, and may transmit corresponding sensor data 468 to one or more input state processors 464. The input state processors, in turn, may determine and send input state data 466 indicating a state of the user or parts of the user based on the sensor data 468. The input state data 466 may include, for example, positioning data 358, a data structure indicating a pose of the user, location of the user, motion of the user, temperature of the user, and/or any other such data describing the user. In embodiments, the input state data 466 may be output to an immersive haptic system 302. In embodiments, the input state processors 464 may use various techniques to determine the input state, as described in more detail elsewhere herein. In some embodiments, the input state processors 464 may perform motion detection and/or other functionalities that may be ascribed to the API 244 elsewhere herein. Additionally or alternatively, the input state processor 464 may partially process the sensor data 468 before outputting the input state data, and the motion capture system 314 or some other module of the API 244 may complete the processing of the sensor data 468.

Accordingly, a haptic interface device may have a human computer interface terminal that includes input transducers that receive a set of sensor values from a set of sensors disposed within a wearable interface and determine a user input state based thereon (e.g., input state data 466). Additionally or alternatively, a haptic interface device may have a human computer interface terminal that includes output transducers that receive a user output state from a computing device executing a VR simulation (e.g., haptic data 456) and that actuates one or more actuators of a haptic component based on the user output state.

In embodiments, a haptic interface device (e.g., the haptic interface device 450) may include a set of haptic components (e.g., haptic components 452) that realistically simulate a human sensory interaction with a physical entity of a haptic virtual application (e.g., an entity that corresponds to data within a haptic system application 250) based on a set of actuation commands (e.g., actuation commands 458) determined from a haptic feedback response (e.g., haptic data 456) corresponding to an interaction of an avatar (e.g., as represented by avatar data 306) and an environment (e.g., as represented by environment data 304).

In embodiments, the haptic interface device may include a haptic component that is in contact with a skin surface of a human user, and a feedback controller that controls actuation of the haptic component in response to receiving an output state from an immersive haptic system (e.g., haptic data 456) that indicates an interaction between an avatar of the user with an object in an environment. In some of these embodiments, one or more of the haptic components 452 that are in contact with a skin surface of a human user may provide multi-resolution sensory stimulation. In these embodiments, the feedback controller may be configured to determine a respective magnitude, resolution (e.g., spatial granularity, timing granularity, or the like) with respect to each type of sensory stimulation that is used for the haptic feedback for each region of the haptic interface device based on the output state from the immersive haptic system. Additionally or alternatively, the magnitude, resolution or the like of a respective section of the haptic component may be based on portion of the human user that it contacts. In other words, the multi-resolution sensory stimulation may be position aware. For example, sensory stimulation for the fingertips may be provided with very high spatial granularity, reflecting the high density of nerve endings there, while sensory stimulation for the torso, shins, or the like may be provided with less granularity, reflecting lower density of nerve endings. Additionally or alternatively, sensory stimulation may be provided with magnitude or resolution that is related to the purpose of the simulation; for example, higher granularity may be provided to the feet in a simulation that is intended to provide training in footwork, or the like.

Additionally or alternatively, the haptic component that is on contact with a skin surface of a human user may provide multiple modes of sensory stimulation. In these embodiments, the multiple modes may include one or more of pressure stimulation, thermal stimulation, electrical stimulation, chemical stimulation, biochemical stimulation and/or frictional stimulation. Thus, the actuation commands 458 may include various haptic modes generated based on the feedback controller 454 processing the haptic data 456. Thus, contact with various objects with differing properties may be simulated by providing corresponding actuation commands 458 to the haptic components 452.

In embodiments, the haptic component 452 that is in contact with a skin surface of a human user may be configured to simulate temperature flux. In embodiments, simulation of temperature flux may involve providing a change in temperature of a haptic component that is monotonically related to, but different from, the actual temperature change of an object that is being simulated, such as based on an understanding of perceptual contrast (i.e., how the brain perceives changes in sensory parameters like temperature and sound more readily than it perceives absolute levels of such parameters). Such techniques allow for certain efficiency advantages in haptic hardware system design. For example, a system can be designed to render highly immersive environments without requiring the fluid conduction system to be capable of generating very large heat flux (which could otherwise require large volumes of heavy fluids and/or large, expensive heating elements). Additionally or alternatively, the haptic component that is in contact with a skin surface of a human user may be configured to simulate the absolute temperature of a physical entity. Thus, for example, contacts with objects with various thermal properties (e.g., varying temperatures, varying thermal conductivity, etc.) may be realistically and immersively simulated via a haptic component 452.

In embodiments, the haptic component 452 that is in contact with a skin surface of a human user may be configured to simulate the weight of a physical entity. Thus, by varying the pressure applied, for example, contacts with objects of varying weight may be realistically and immersively simulated via a haptic component 452. In embodiments, the haptic component 452 may simulate the perceived experience of bearing weight (such as to train a user in weight-bearing tasks like carrying a fire hose) while providing actual forces that are lower than would be experienced by a real physical interaction with the object. Again, awareness of how the brain experiences perceptual contrast can be used to provide a realistic experience (e.g., one that generates valuable muscle memory) without requiring the hardware system design to generate very large forces. This can provide advantages in system design (allowing for less expensive components) and safety (e.g., allowing forces to be used that are safe for the user). In other embodiments, the haptic component 452 can in fact provide highly accurate rendering of forces that precisely match the forces a user would experience in the real world when interacting with the object. In embodiments the haptic component 452 can be configured, customized and/or personalized as noted above, such as to generate forces that correspond to a particular user profile, a profile for a role or type of user, or other characteristics.

In embodiments, the haptic component that is in contact with a skin surface of a human user may be configured to simulate the surface texture of a physical entity (e.g., by applying more or less pressure via various actuators to simulate details of an object's texture). Additionally or alternatively, the haptic component that is in contact with a skin surface of a human user may be configured to simulate the flexibility or rigidity of a physical entity (e.g., by applying varying levels of feedback when a user manipulates the entity). Additionally or alternatively, the haptic component that is in contact with a skin surface of a human user may be configured to simulate the frictional characteristics of a physical entity (e.g., by applying more or less pressure when the object slides against a user's skin in the environment). Thus, for example, contacts with objects of varying properties and textures may be realistically and immersively simulated via a haptic component 452.

In embodiments, a haptic component that is in contact with a skin surface of a human user may provide multi-resolution sensory stimulation, and the finger portions of the haptic component have the highest respective resolution sensory simulation. Because fingers have a large number of specially adapted sensory nerve endings and receptors, high resolution haptic data may provide particularly effective immersion via haptic systems that provide haptic feedback to the fingers.

In embodiments, a haptic interface device 450 may be any type of haptic interface, including a non-wearable haptic interface. For example, one or more haptic components (e.g., featuring microfluidic tactile actuators and/or thermal actuators, as described in more detail below) may be arranged on a surface of a theater chair or other chair to provide haptic feedback that may be synchronized to a movie, game, or other interactive experience. Additionally or alternatively, one or more haptic components may be used for a tactile display, which may use tactile actuators to simulate controls such as buttons and/or various features such as raised surfaces. The tactile display may also use the techniques described herein to provide haptic feedback to simulate button presses or other interactions. In embodiments, haptic interface devices 450 that are configured as tactile displays may include additional components, such as a backlight and/or a proximity sensor, that may help tailor the haptic interface device 450 for use as a tactile display.

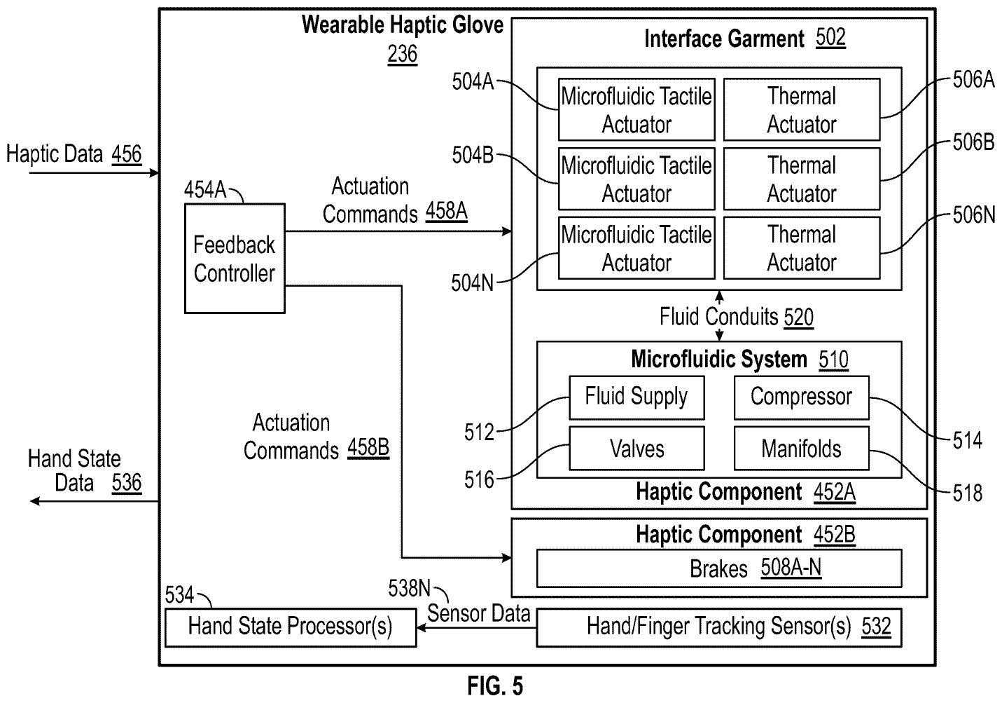

FIG. 5 illustrates an example embodiment where the haptic interface device 450 of FIG. 4 is a wearable haptic glove 236. In the example embodiment shown at FIG. 5, the wearable haptic glove 236 receives haptic data 456, generates actuation commands 458A-B using a feedback controller 454A, and provides the actuation commands 458A-B to respective haptic components 452A-B. One or more of the haptic components (e.g., haptic component 452A) may include an interface garment 502 that includes a plurality of actuators in contact with various regions of a user's hand and/or arm and/or a microfluidic system 510 for interfacing with the interface garment 502. For example, a first subset of the actuators may be disposed to be in contact with a user's first finger, a second subset of the actuators may be disposed to be in contact with a user's second finger, and the like, with multiple subsets of actuators arranged to provide an immersive tactile experience. Additionally or alternatively, one or more of the haptic components (e.g., haptic component 452B) may include brakes 508 that may be used to provide feedback to simulate interactions with objects or other entities within a computer-mediated environment.

In embodiments, an interface garment 502 may comprise a plurality of microfluidic tactile actuators 504 and/or thermal actuators 506. In some embodiments, an actuator may be both a microfluidic actuator 504 and a thermal actuator 506. In other words, a single actuator may provide both tactile (e.g., pressure) and temperature feedback to the skin of a user (e.g., by using temperature-variable fluid). Additionally or alternatively, instead of using microfluidic actuators 504, other types of actuators may be used.

Accordingly, in embodiments, a wearable glove may have a haptic component that includes a set of specifically located microfluidic tactile actuators. Each subset of microfluidic tactile actuators may be configured to simulate a tactile sensation at a specific contact point of the hand of the user.

In embodiments, a wearable glove may have a haptic component that includes an interface garment that includes a set of specifically located microfluidic tactile actuators. In some embodiments, each subset of tactile actuators may be configured to simulate a tactile sensation at a specific contact point of the hand of the user. Additionally or alternatively, each subset of microfluidic tactile actuators may be configured to simulate a tactile sensation at a specific contact point of the hand of the user. Additionally or alternatively, the set of specifically located microfluidic tactile actuators may include a set of thermal actuators that control a localized thermal flux at respective contact points with hands of the user.

The tactile actuators 504 may be arranged such that they are grouped using a varying tactile density with a spacing that is sufficiently small to be within a somatosensory “two-point threshold” for various parts of, for example, a user hand. The two-point threshold is a measure of the minimum distance at which the human skin can discriminate between two separate points, and varies for different regions (e.g., about 1 centimeter at the palm of the hand and several millimeters at the fingertip). If two pressure points are applied at a distance below the two-point threshold distance, the two pressure points will be perceived as a single larger pressure point rather than two distinct points. Thus, by arranging actuators according to the two-point threshold (e.g., using varying density corresponding to different parts of a user hand, for example), the tactical actuators may be configured to simulate contact with a single solid surface, multiple objects, or permutations in between).

Accordingly, in embodiments a haptic glove interface may have a plurality of tactile actuators arranged to oppose a hand of a user of the haptic glove and having a varying tactile density with spacing between adjacent tactile actuators based on a somatosensory two-point discrimination of a human hand at a corresponding location in the haptic glove. In embodiments the somatosensory two-point discrimination may be based on a model of the human hand or based on the measured characteristics of the hand of a specific user.

In embodiments, the wearable haptic glove 236 may include hand and/or finger tracking sensor(s) 532 for tracking the location or status of the user's hands and/or fingers. The hand/finger tracking sensors 532 may detect absolute or relative position or orientation of the hands and/or fingers, velocity/acceleration data for the hands and/or fingers, pressure data for the hands and/or fingers, force feedback data for the hands and/or fingers, temperature data for the hands and/or fingers, and/or other such data, and may transmit corresponding sensor data 538 to one or more hand state processors 534. The hand state processors, in turn, may determine and output hand state data 536 indicating a state of the user or parts of the user based on the sensor data 538.

In embodiments, fluidics-based actuators of the interface garment 502 may be supplied with fluid by a microfluidics system 510 that is connected via one or more fluid conduits 520 with the one or more microfluidic tactile actuators 504. The tactile actuators may use fluids and/or air provided by the microfluidic system 510. In embodiments, the microfluidics system 510 may include a fluid supply 512 (e.g., an air supply if the microfluidics system uses air) containing a pressurized working fluid, a compressor 514 for pressurizing the working fluid, a plurality of valves 516 (e.g., piezo valves) operatively coupled to the supply 512 and the fluid conduits 520 for selectively actuating the microfluidics actuators, and a manifold 518 coupled to each of the valves 516. In embodiments, the fluid supply 512 may include separated hot and cold fluid supplies that may be used to provide variable temperature fluids for thermal feedback. Although the microfluidics system 510 may be a component of a wearable haptic glove 236, in some embodiments some or all of the components of the microfluidics system 510 may instead be part of a separate component that is connected to the wearable haptic glove via one or more conduits 520. For example, a compressor 514 may be separate from the wearable haptic glove 236 (e.g., it may be contained within a wearable backpack) and connected to the fluid supply 512 via a conduit 520.

Accordingly, in embodiments a haptic glove interface may have a set of tactile actuators with a microscale configuration, a pressurized fluid supply, a fluid conduit coupled for fluid communication between the set of tactile actuators and the pressurized fluid supply, and a set of valves operatively coupled with the pressurized fluid supply and the fluid conduit to selectively actuate the set of tactile actuators with a working fluid from the pressurized fluid supply.

In embodiments, a haptic interface device may have a plurality of tactile actuators, a plurality of fluid conduits each coupled with at least one of the plurality of tactile actuators, a plurality of valves each coupled to at least one of the plurality of fluid conduits, a manifold coupled to each of the plurality of valves, and a wearable compressor configured to supply a pressurized working fluid to the manifold.

In embodiments, the wearable haptic glove 236 may further comprise one or more additional haptic components (e.g., haptic component 452B) that comprise one or more brakes 508A-N. In embodiments, the brakes 508 may be tendon type resistance brakes, magnetorheological brakes, or other types of brakes that may be used to limit user movement. The brakes may be coupled with various parts of a user's hand to provide passive and/or variable feedback to restrain a user's fingers or other parts of a user's hand (e.g., a wrist). Thus, separate brakes may be provided at least for each finger of a user's hand. For example, a brake may be activated to prevent the movement of a finger when the finger of the corresponding avatar touches or applies pressure to an object or entity within a computer-mediated environment (e.g., if the object or entity is rigid). Thus, the sensation of gripping, holding, squeezing, or otherwise applying pressure to physical objects with the fingers may be realistically simulated. The brakes may be capable of binary (e.g., on/off) and/or variable (e.g., proportional) braking. In embodiments, instead of or in addition to using brakes 508, active force feedback actuators may be used, which may be capable of providing force feedback to a user's fingers (e.g., to simulate the active feedback pressure applied to a user's fingers when squeezing a spring or rubber ball, for example). However, in other embodiments the haptic interface device (e.g., haptic glove) may have a tendon type resistance brake coupled with a finger of a user and configured to selectively resist movement of the finger.

In embodiments, the wearable haptic glove 236 may include hand and/or finger tracking sensor(s) 532 for tracking the location or status of the user's hands and/or fingers. The hand/finger tracking sensors 532 may detect absolute or relative position or orientation of the hands and/or fingers, velocity/acceleration data for the hands and/or fingers, pressure data for the hands and/or fingers, force feedback data for the hands and/or fingers, temperature data for the hands and/or fingers, and/or other such data, and may transmit corresponding sensor data 538 to one or more hand state processors 534. The hand state processors, in turn, may determine and output hand state data 536 indicating a state of the user or parts of the user based on the sensor data 538.

Although FIG. 5 shows an example embodiment in which the haptic interface device 450 is a wearable haptic glove 236, the components shown in FIG. 5 may be used in other embodiments of a haptic interface device 450. For example, a microfluidics system 510 connected via fluid conduits 520 to an interface garment 502 having one or more microfluidic tactile actuators 504 and/or one or more thermal actuators 506 may also be part of any type of haptic interface device 450, such as an exoskeleton. Thus, an interface garment 502 may be arranged such that the actuators of the textile layer provide tactile and/or thermal feedback at any body part of a user (e.g., head, torso, limbs, etc.) or may be arranged on other surfaces that a user may contact. Moreover, as shown at FIG. 4, a haptic interface device 450 may include multiple haptic components 452 (e.g., one per body part).

Accordingly, in embodiments, a wearable haptic system may have a haptic component that includes an interface garment that includes a set of specifically located microfluidic tactile actuators. Each subset of microfluidic tactile actuators may be configured to simulate a tactile sensation and/or control a localized thermal flux at a specific contact point of a body part of a user.

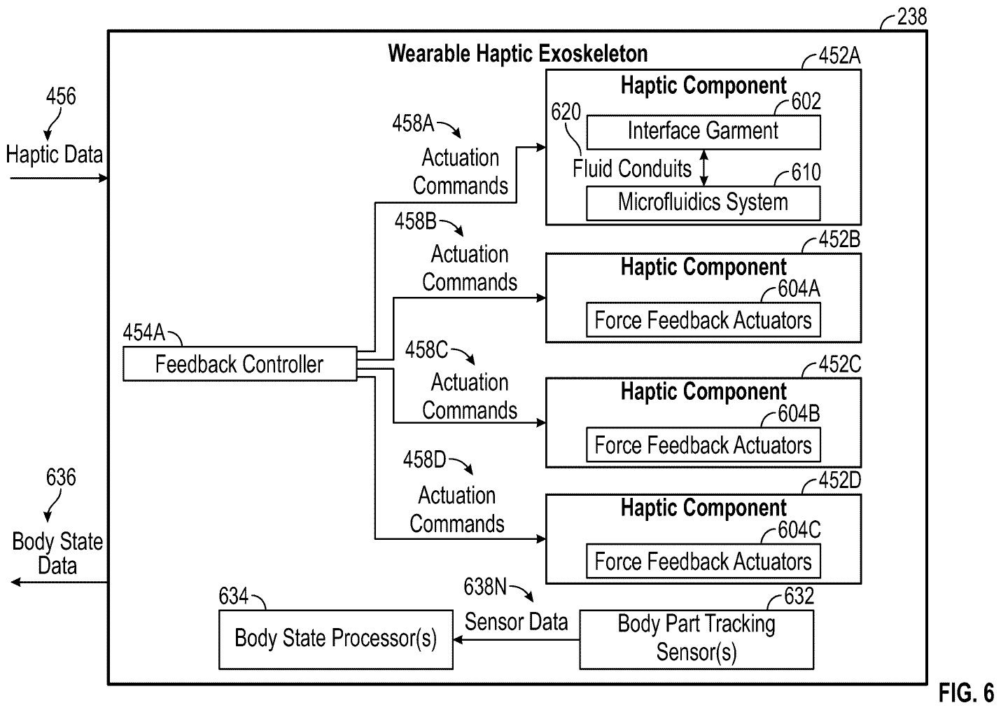

FIG. 6 illustrates an example embodiment where the haptic interface device 450 of FIG. 4 is a haptic exoskeleton 238. In embodiments, an exoskeleton 238 may include one or more haptic gloves 236. In other words, the glove(s) 236 (not shown in FIG. 6) may be subcomponents of the exoskeleton 238. In the example embodiment shown at FIG. 6, the haptic exoskeleton 238 receives haptic data 456, generates actuation commands 458A-D using a feedback controller 454A, and provides the actuation commands 458A-D to respective haptic components 452A-D. Additionally or alternatively, multiple feedback controllers 454 may be used to provide respective actuation commands to each haptic component. The haptic exoskeleton 238 may include one or more haptic components that include an interface garment 502 (e.g., haptic component 452A) in communication with a microfluidics system 610 via one or more fluid conduits 620, which may be configured as discussed above for FIG. 5. Additionally or alternatively, the haptic exoskeleton may include one or more haptic components that include force feedback actuators 604 (e.g., magnetorheological (MR) actuators, pneumatic actuators, electric actuators, and/or other types of force feedback actuators). In embodiments, the various force feedback actuators 604 (e.g., MR actuators, pneumatic actuators, electric actuators, etc.) may be configured to provide force feedback to various body parts (e.g., arms, legs, etc.) in order to realistically simulate a human touch sensory system interaction with a physical object or entity. In embodiments, this sensory system interaction may be further enhanced by the use of tactile actuators as part of the interface garment 602. For example, when a user's avatar (e.g., as represented by avatar data 306) braces their arm and leans against a wall in an environment (e.g., as represented by environment data 304), a force feedback actuator may provide force feedback that correspondingly allows the user to brace the user's arm against an arm component of the exoskeleton. At the same time, the tactile actuators of the interface garment 602 may realistically contact with various surface features of wall (e.g., based on the texture or geometry of the wall). Thus, the haptic actuators (e.g., including the tactile and force feedback actuators) may provide a synchronized simulation of an interaction with a wall. Similar interactions between a user's avatar and an environment may be realistically simulated by force feedback actuators in contact with other body parts of a user (e.g., force feedback to a user's foot when the user's avatar kicks a ball within the environment or the like), either alone or in combination with tactile actuators (e.g., depending on body part and coverage of an interface garment). In embodiments, data representing the interactions between the avatar and the environment are provided by the immersive haptic system as haptic data 456, and the one or more feedback controllers 454 of the wearable haptic exoskeleton may determine and synchronize the haptic actuation commands to be distributed to the various components of the haptic exoskeleton in order to realistically simulate the interactions.

Accordingly, in embodiments, a wearable haptic exoskeleton device may have a set of haptic actuators that realistically simulate a human touch sensory system interaction with a physical entity (e.g., an object/entity within a computer-mediated environment). In some of these embodiments, the haptic actuators may be force feedback actuators that may be MR haptic actuators, pneumatic actuators, electrical actuators, and/or other types of actuators. Additionally or alternatively, the haptic actuators may be tactile actuators. In some embodiments, at least a subset of the haptic actuators of the exoskeleton system may be in contact with the arms of the wearer. Additionally or alternatively, at least a subset of the haptic actuators of the exoskeleton system may be in contact with the legs of the wearer. Additionally or alternatively, at least a subset of the haptic actuators of the exoskeleton system may be in contact with the neck of the wearer. Additionally or alternatively, at least a subset of the haptic actuators of the exoskeleton system may be in contact with the head of the wearer. Additionally or alternatively, at least a subset of the haptic actuators of the exoskeleton system may be in contact with the torso of the wearer. Additionally or alternatively, at least a subset of the haptic actuators of the exoskeleton system may be in contact with at least one foot of the wearer. In any of these embodiments, the haptic actuators may realistically simulate a human touch sensory system force feedback and/or tactile interaction with a physical entity.

In embodiments, the haptic exoskeleton and motion platform may support and move a user's center of mass (e.g., the exoskeleton may be able to lift the user, move the user, and/or orient the user in various ways) via one or more contacts with the user's limbs and/or torso. In these embodiments, the haptic exoskeleton and motion platform may be capable of realistically simulating a range of movements and/or accelerations through an environment such as flying, falling, climbing, and other such movements/accelerations. Accordingly, the wearable haptic exoskeleton device may have a set of force feedback actuators that, in conjunction with a motion platform, generate a set of movements that help simulate a movement or acceleration of a center of mass of the body of the wearer.

In embodiments, a wearable haptic interface may have an exoskeleton connected to a motion platform, one or more force feedback actuators 604 (e.g., magnetorheological actuators or other types of actuators), one or more microfluidic layers (e.g., interface garments 602), and/or one or more microfluidic tactile actuators (e.g., as shown in FIG. 5, but not shown in FIG. 6). The microfluidic layer(s) may be coupled to the exoskeleton large-scale actuator(s) and/or the microfluidic actuator(s) (e.g., such that they form a single haptic exoskeleton 238).

In embodiments, the haptic exoskeleton 238 may include body part tracking sensor(s) 632 for tracking the location or status of various parts and/or joints of the user's body. The body part tracking sensors 632 may detect absolute or relative position or orientation, velocity/acceleration data, pressure data, force feedback data, temperature data, EEG signals, and/or other such data, and may transmit corresponding sensor data 538 to one or more body state processors 634. The hand state processors, in turn, may determine and output body state data 636 indicating a state of the user or parts of the user based on the sensor data 638.

FIG. 7 illustrates an example electrical system 460 of a haptic device (which may be a wearable haptic interface 330, a haptic interface device 450, a wearable haptic glove 236, a haptic exoskeleton 238, and/or some other haptic device described herein) together with example devices that may receive power from the electrical system 460. The electrical system 460 may be battery-powered, may be chargeable using an energy storage system 710, may manage energy and/or power delivery via energy management system 708 and/or power management system 704, and may include an electrical harness 702 for carrying power to electrically powered devices, such as one or more exoskeleton actuators 720, fluidic valves 516, a wearable compressor 514, and/or any other electrically powered device that is described herein.

In embodiments, the electrical system 460 may include a wearable battery 712, which may be a conformal wearable battery (e.g., a flexible and wearable battery). In embodiments, the wearable battery 712 may receive charge via an energy storage system 710, which may receive power (e.g., from an external charging connection that is connected to the electrical system 460 when not in use by a user) and manage the delivery of power to the wearable battery 712 to recharge the battery. In embodiments, the energy storage system 710 may be configured to determine whether to charge the wearable battery 712, how much current and/or power to deliver, and/or the like. The energy storage system 710 may manage charging of the wearable battery 712 in order to prioritize different objectives, such as quick charging, battery longevity, and/or the like. In embodiments, the wearable battery 712 may be connected to an electrical harness 702, which may include electrical conductors shaped and routed to avoid interference with the movements of a user of the wearable haptic interface that includes the electrical system 460. The electrical harness 702 may include a plurality of distinct electrically conductive pathways for routing power to various components, including the components described herein that promote immersive haptics. The electrical harness 702 may further be configured to limit immersion interference through physical forces between the electrical harness and body borne portions of the wearable user interface.

In embodiments, the output of the wearable battery 712 may be managed by the energy management system 708 and/or the power management system 704. The energy management system 708, for example, may prioritize delivery of power to specific high-priority components and/or for specific high-priority operations if/when the wearable battery 712 is not capable of supplying enough energy to all of the components (e.g., because of a low charge falling below a threshold, because of a current/power draw exceeding the output capability of the wearable battery 712, and/or the like). Additionally or alternatively, the energy management system 708 may cause the electrical system to operate in various modes based on a haptic operation to be performed by the wearable interface, such as a high-power operation mode and a high voltage transient operation mode.

Additionally or alternatively, a power management system 704 may limit the delivery of power to certain components using a power output governor to ensure safe operation of the wearable haptic interface, such as by limiting the delivery of power to exoskeleton actuators 720 to avoid applying too much force feedback to a user of the exoskeleton. In embodiments, the power management system 704 may receive immersive haptic system data 722, which it may process to determine whether any feedback to be delivered to a haptic device may exceed a safety threshold such that the power output governor 706 may limit the delivery of power to the corresponding haptic device. Additionally or alternatively, the power management system 704 may monitor the capability and/or status of a power source (e.g., the wearable battery 712). For example, the power management system 704 may determine whether the power source is capable of exceeding a safety margin or threshold. Thus, the power management system 704 may manage power distribution based on a status of a power supply of the wearable user interface and output states received from an immersive haptic system that generates an environment. In embodiments, the power output governor 706 may use a set of rules (which may be default rules and/or user-specific rules that may be obtained configured based on data within a user profile 312) to determine a maximum amount of force that may be applied to various body parts of a user via an exoskeleton or any other haptic component with a force feedback component.

In embodiments, power may be supplied (e.g., via the electrical harness 702) to one or more exoskeleton actuators 720, which may move components connected to various body parts of a user to simulate interactions with an environment or entities within the environment, provide force feedback, simulate different gravity configurations, etc. Additionally or alternatively, power may be supplied from the wearable battery 712 (e.g., via the electrical harness 702) to one or more valves 516A-N (e.g., piezo valves of a microfluidics system 510) that selectively control the delivery of working fluid to a microfluidic actuator. Additionally or alternatively, power may be supplied from the wearable battery 712 (e.g., via the electrical harness 702) to a wearable compressor 514, which may compress a working fluid for a microfluidics system. In embodiments, any other electrically powered components may also receive power from the electrical system 460.

Although the example electrical system 460 shows a wearable battery 712, in embodiments the electrical system 460 may operate without a battery (e.g., using mains power) and/or may operate in either battery-power mode and/or via a connection to another power source. For example, a wearable haptic interface 330 for a whole-body haptic system may operate in a fixed position and therefore lack the need for a wearable battery 712.

Accordingly, a haptic interface device may have a plurality of electrically actuated valves, a body borne electric compressor, and an electrical harness including a plurality of distinct electrically conductive pathways routed to promote immersive haptics and limit immersion interference through physical forces between the electrical harness and body borne portions of the wearable user interface.

In embodiments, a haptic interface device may have an energy storage system and an energy management system. The energy management system may be programmed to dynamically configure the energy storage system for one of a high-power operation and a high voltage transient operation based on a haptic operation to be performed by the wearable interface, and the energy management system may be configured to prioritize predefined high priority haptic operations when energy stored in the energy storage system falls below a threshold amount.

In embodiments, the haptic interface device may have a wearable component and a conformable battery incorporated into the wearable component.

In embodiments, the haptic interface device may have a power management system that manages power distribution to components of the wearable user interface based on a status of a power supply of the wearable user interface and output states received from an immersive haptic system that generates an environment.

In embodiments, the haptic interface device may have an exoskeleton and a power management system. The exoskeleton may be configured for applying forces to a body of the user and the power management system including a power output governor configured to limit a power output to the exoskeleton based on a set of rules and a portion of the body of the user to which the forces will be applied.

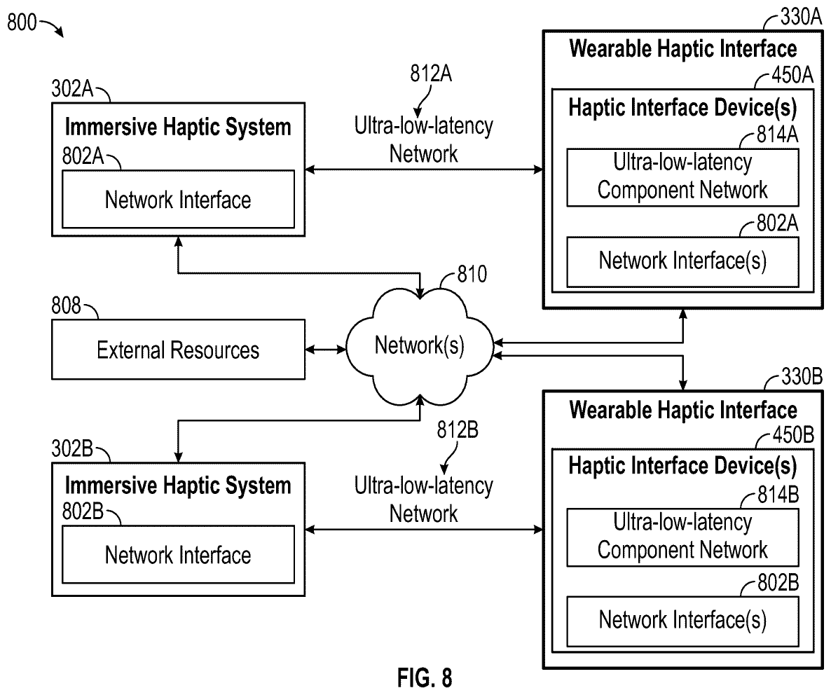

FIG. 8 shows an example embodiment of an immersive haptic system 800 in which various components, including one or more immersive haptic systems 302, one or more wearable haptic interfaces 330, and/or one or more external resources 808 are connected via one or more networks 810. Each immersive haptic system 302 may have a network interface 802 that facilitates communications with other devices via the network(s) 810. The wearable haptic interface 330 may include one or more haptic interface devices 450 (e.g., haptic gloves 236, a haptic exoskeleton 238, AR/VR/MR/XR interfaces 336, other sensory interfaces 338, motion tracking sensors 340, etc.), each of which may also have a network interface 802 for communicating with other devices via the network(s) 810. In embodiments, although network(s) 810 may be used to connect some or all of the separate devices (including the devices shown in FIG. 8 and/or any other devices described herein), the immersive haptic system 302 may also be capable of communicating with a wearable haptic interface 330 using a low-error ultra-low-latency network 812, which may be a short range link, rather than routing communications through a network 810. The use of the ultra-low-latency network 812 may provide a more immersive experience by providing a better connection between user movements and feedback provided to the wearable haptic interface 330 (e.g., audio/video and/or force feedback). For example, networks that provide less than one millisecond ( 1/1000 second) latency may be used as the ultra-low-latency network 812.

In embodiments, the haptic interface devices 450 may comprise a low-error ultra-low-latency component network 814 for interconnecting various components of the haptic interface devices 450, such as interfaces, actuators, processors, and/or related components. For example, the ultra-low-latency component network 814 may be used to communicate actuation commands 458 from a feedback controller 454 to a haptic component 452, as discussed above for FIGS. 4-6.

Various immersive haptic systems 302 may connect to and communicate with each other via the networks 810, for example, to facilitate a multi-user haptic system application 250, such as a multiplayer game, a collaborative simulation, and the like. The immersive haptic systems 302 may communicate with each other and/or a centralized server to synchronize a state of the haptic system application 250 among the immersive haptic systems. For example, one of the immersive haptic systems 302 may act as the host and other immersive haptic systems 302 may act as clients for the host. Additionally or alternatively, the immersive haptic systems 302 may communicate with an external host (e.g., an external resource 808 that includes a host system).

Similarly, multiple wearable haptic interfaces 330 may communicate with each other and/or with external resources to provide multi-user immersive experiences. In example embodiments, user data (e.g., user input data captured by one or more haptic interface devices 450 based on user movements) may be transmitted directly to other wearable haptic interfaces 330, to other immersive haptic systems 302, to external resources 808, and/or the like.

In embodiments, multi-user haptic applications may allow one or more user(s) to interact with the application using wearable haptic interfaces 330 while one or more other user(s) may interact with the application without using a haptic interface. For example, a training application may allow one or more trainers to engage with a computer-mediated environment and/or a user avatar within the computer-mediated environment without using a haptic interface. Additionally or alternatively, some of the users of the multi-user haptic application may be non-human agents, such as artificial intelligence agents.

In embodiments, external resources 808 may include devices that may provide data to the immersive haptic system 302. For example, the external resources 808 may include an edge networking system that receives data from IoT edge devices. The IoT edge devices may provide data about an environment that may be incorporated into the environment by the immersive haptic system 302. Such data may represent, for example, locations and/or states of real objects or entities that may be rendered as objects or entities in the environment. As a specific example, IoT edge devices may be attached to doors of a physical environment, such that the state of the real doors (e.g., open, closed, locked) may be correctly rendered in a VR simulation or haptic digital twin, thus allowing users to interact with the real doors while participating in the VR simulation and/or controlling a telerobot.

In embodiments, the network 810 may be an RF network, a hard-wire network, an edge network connecting IoT devices (e.g., the external resources 808 that may be IoT edge devices), a 5G/cellular network, a mesh network, a peer-to-peer network, and/or the like. In embodiments, the network 810 may include a networking system that may optimize and/or re-route communications between devices. For example, such a networking system may select an optimum network and/or routing scenarios for a given set of available networks in real-time. The network(s) 810 may connect to external networks. The networks(s) 810 may include at least one ultra-low-latency network. The network interfaces 802 may include systems that are configured to support one or more of the various types of networks as needed for any given embodiment.

Accordingly, an immersive haptic system may have a low-error-ultra-low-latency network that connects a set of interfaces of an immersive haptic system to a corresponding set of interfaces of a wearable haptic interface, such that packet latency is less than one millisecond ( 1/1000 of a second). Additionally or alternatively, a haptic interface device may have a low-error-ultra-low-latency network that interconnects a set of interfaces, actuators, processors, or and related components of a wearable haptic device, such that packet latency is less than one millisecond ( 1/1000 of a second).

In embodiments, an immersive haptic system may have a radio frequency (RF) network that interconnects one or more immersive haptic systems, one or more haptic interface devices, and/or one or more external resources for RF communications. Additionally or alternatively, an immersive haptic system may have a fixed networking system that interconnects one or more immersive haptic systems, one or more haptic interface devices, and/or one or more external resources for hard-wire communications. Additionally or alternatively, an immersive haptic system may have a 5G/cellular networking system that interconnects one or more haptic interface devices with one or more of an immersive haptic system and one or more external networks. Additionally or alternatively, an immersive haptic system may have a mesh networking system that interconnects one or more immersive haptic systems, one or more haptic interface devices, and/or one or more external networks. Additionally or alternatively, an immersive haptic system may have a peer-to-peer networking system that interconnects one or more immersive haptic systems, one or more haptic interface devices, and/or one or more external networks.

In embodiments, an immersive haptic system may have an immersive haptic system that interfaces with a wearable haptic interface and with an edge networking system that provides data relating to an environment obtained from IoT devices within the environment to the immersive haptic system, wherein the immersive haptic system generates the environment corresponding to the edge networking system and updates the environment based on the data received from the edge networking system.

In embodiments, an immersive haptic system may have a networking system that adaptively selects an optimum network and routing scenarios for a given set of available networks in real-time, wherein the networks interconnect one or more immersive haptic systems, one or more haptic interface devices, and/or one or more external networks.

### SDK and Intelligence Platform

In embodiments, an immersive haptic system may leverage an SDK 242 that includes and/or integrates with the API 244 and that is configured to provide an interface for integrating a wearable haptic interface with one or more other systems, such as other haptic system applications 250 (e.g., game engines, robotics systems, simulation systems, AR/VR systems, training systems, enterprise database systems, or many others), as well as for designing applications, user experiences and use cases involving such other haptic system applications 250. The foregoing may be deployed in an ecosystem that benefits from various haptic interactions, use cases and applications, where the SDK 242 and/or API 244 provide a set of modules, components and capabilities for linking and integration with other systems to enable them. FIG. 9 illustrates an example diagram showing additional functions of the API 244 that sits between one or more haptic system applications 250 and a wearable haptic interface 330. The API 244 includes a plurality of various functional units, which may be embodied as hardware and/or software modules. The API 244 may perform motion capture (“Mocap”) functions for converting motion data into inputs to the haptic system application 250, may perform haptic functions for converting haptic system application 250 state data into haptic feedback, and may perform other functions. Thus, the API 244 may be bidirectional, providing the translation (e.g., including extraction, transformation, loading, normalization and the like) between sensory stimulation information of a wearable or other haptic system and information about objects and entities from a computer-mediated environment. In embodiments, the motion capture functions may be performed by a motion capture system 314 (e.g., components 902, 904A-N, 906, 908, and/or 910 may be part of or executed by a motion capture system 314) and the functional units that perform haptic feedback functions may be performed by a haptic feedback controller 316 (e.g., components 930, 932, 934, and/or 936 may be part of or executed by a haptic feedback controller 316). The API 244 may be responsible for a variety of functions beyond those illustrated in FIG. 9. The wearable haptic interface 330 may comprise one or more motion tracking sensors 340, any type of haptic interface device 450, a wearable haptic glove 236, a haptic exoskeleton 238, and/or the like.

In embodiments, the API 244 may be configured to receive data from various sensors (e.g., motion tracking sensors 340, which may be optical sensors or other types of motion tracking sensors, and/or sensors that are part of a haptic interface device 450, a wearable haptic glove(s) 236, and/or a haptic exoskeleton 238) and process the data to generate animated frame data 958 that may be used to position one or more entities that exist inside the haptic system application 250 (e.g., a user avatar). Furthermore, the API 244 may be configured to receive world information 962 (e.g., data describing the state of avatar and/or objects within an environment) and/or haptic effects 964 from the haptic system application and process the data to generate microfluidic data 970 for providing tactile feedback and/or force feedback to various actuators of the haptic interface device 450, the wearable haptic glove(s) 236, the haptic exoskeleton 238, and/or the like. In embodiments, the API 244 may be configured to interface with haptic system applications 250, for example by providing animated frame data 958 in a format understandable by the application and/or a plugin for the application and by receiving and processing world information 962 and/or haptic effects 964 from the application and/or a plugin to the application. For example, the API 244 may leverage a haptic application plugin 246 to input data to and/or receive data from a telerobotics application 252, training application 254, gaming application 256, product design application 258, and/or any specific other type of application 250.

Although the API 244 is shown as existing between the wearable haptic interface 330 and the haptic system application 250, in other example embodiments various functions attributed to the API 244 may be performed by components of the wearable haptic interface 330 and/or by the haptic system application 250. For example, some components and functionalities of the API may be executed by a plugin to a haptic system application (e.g., a game engine plugin). Additionally or alternatively, some components and functionalities of the API may be executed by hardware onboard a wearable haptic device. Accordingly, it should be understood that the various functionalities described herein may be located on different devices in different implementations.

In embodiments, the API 244 may include one or more sensor data processors 902 for processing raw motion data 954 receiving from one or more hardware sensors and executing sensor processing workflows to process the raw motion data 954 into relative location data 953. The raw motion data 954 may comprise a plurality of data streams received from different sensors, including low-level motion capture data. For example, a first sensor data processor 902 may be configured with a sensor processing workflow for processing raw motion data captured by finger-tracking sensors of a haptic glove, a second sensor data process may be configured with a sensor processing workflow for processing raw motion data captured by arm tracking sensors of a wearable exoskeleton, etc. Various types of motion sensors that output raw motion data 954 in various formats may be used by the wearable haptic interface, and the sensor data processors 902 may accordingly use various workflows to perform various processing functions. The sensor data processors may perform error checking, formatting, normalization, prediction, integration, and/or other types of functions for converting raw motion data 954 into relative location data 953. The relative location data 953 may include relative positioning, orientation, velocity, and/or acceleration data for one or more body parts (e.g., fingers, arms, legs, head, torso, etc.) and/or other tracked locations (e.g., one or more locations of a prop held by a user).

In some embodiments, sensors of the wearable haptic interface 330 may perform onboard sensor data processing. In the illustrated example of FIG. 9, the motion tracking sensors 340 may perform onboard sensor data processing such that absolute location data 952 may be output to the API. In embodiments, the absolute location data 952 may include a tracking data stream that is indicative of an absolute location of the user with respect to the 3D environment of the user, as detected by the motion tracking sensors 340. Thus, in some embodiments, data received from haptic hardware may not need to be processed using some or all of the sensor data processing workflows.

The API 244 may further include one or more motion processors 904 for generating mocap data 956 from the absolute location data 952 and/or relative location data 953. The mocap data 956, for example, may include a data structure describing the positioning and/or motion (e.g., velocity, acceleration, etc.) of the user and/or various part of the user. Thus, for example, the motion processors 904 may generate mocap data 956 that relates the positioning of various body parts (or other tracked locations, such as for props) to each other (e.g., based on the absolute location data 952 and/or relative location data 953). In embodiments, the mocap data 956 may include a skeleton data structure indicating how the user is positioned.

In some embodiments, the one or more motion processors 904 may optionally use artificial intelligence and/or machine learning (AI/ML) techniques to generate models that predict the mocap data 956 based on the absolute location data 952 and/or relative location data 953. For example, the location data may be taken from a set of sensors that does not exactly measure every body part and/or joint of the user. Accordingly, an ML model (e.g., a neural network) may be trained to output a data structure indicating a user's current and/or future position (e.g., a skeletal data structure) based on the location and/or raw motion data. For example, the model may predict the current angle of each joint of a user's hand based on location data indicating the location of a user's fingertips and the location of the palm of the hand. Such a model may be trained based on training data and/or may use rules that define, for example, how human hand joints typically or most likely bend to obtain various positions. Similar AI/ML models and techniques may be developed and deployed for other body parts and/or joints, such as leg joints (e.g., hips, knees, ankles, etc.), arm joints, and the like.

In some embodiments, the mocap data 956A-N may optionally be adjusted using one or more compensators, such as a glove slip compensator 906 and/or a touch compensator 908. For example, the glove slip compensator 906 may adjust the motion capture data based on glove slip caused by the glove shifting position on the user's hand. Furthermore, the touch compensator 908 may adjust the motion capture data to detect whether a user intends to touch one hand or finger to another, for example. In this example, the user may be prevented from bringing a sensor on one hand or finger to within a minimum distance of a sensor on another hand or finger (e.g., because of the thickness of the wearable haptic gloves 236 and/or the positioning of the sensors thereon). The touch compensator 908 may thus determine that a user intends to touch one body part (or a tracked prop) to another body part even when the user is prevented from doing so by the haptic interface device 450. In embodiments, the slip compensator 906 and/or touch compensator 908 may use machine learning algorithms to adjust the motion capture data. Additional details regarding the operation of the compensators are provided below.

Finally, the animation frame generator 910 may generate and output animated frame data 958, which may include structured location and/or motion data that may be used to modify a user avatar that exists within the haptic system application 250. In some embodiments, the animated frame data 958 may be generated by reformatting the compensated motion capture data (e.g., after processing by the slip compensator 906 and/or touch compensator 908) into a format that is compatible with the haptic system application. The animated frame data 958 may include, for example, positioning and/or motion data for each part of a user's body. As one example, the animated frame data 958 may include skeletal animation data that may be used for positioning the user avatar. In embodiments, the animation frame generator 910 may compensate for dimensional And/or skeletal differences between the user and the user avatar using animation retargeting. For example, if a user avatar is taller and has longer limbs than the user, the motion capture data may be adapted to fit the dimensions of the avatar. As another example, if the user avatar has a different skeletal structure than the user (e.g., the user avatar may be an animal, robot, etc. with different numbers of arms, legs, digits, etc. than the user), the animation frame generator 910 may use various techniques for mapping between human skeletal data and avatar skeletal data.

The above-described process for converting sensor data received from a wearable haptic interface 330, such as raw motion data 954 and/or location data 952, into more structured data for input into a haptic system application 250, such as a game engine, may be referred to herein as a “Mocap stack.”

The API 244 may receive data from the haptic system application 250 to generate haptic feedback. For example, a contact interpreter 930 may receive state information from the haptic system application 250, such as world information 962 and/or haptic effects 964. The world information 962 may include environment data 304 and/or avatar data 306. In these embodiments, the contact interpreter 930 may calculate whether a part of the user avatar is in contact with (and/or nearby) any objects or entities in the environment and/or with another part of the avatar (e.g., the avatar's hands may be in contact with each other). The contact interpreter 930 may further calculate a relative force applied to the avatar by the contact. Additionally or alternatively, the haptic system application 250 may determine and output such contact information. Furthermore, in some embodiments, the haptic system application may perform some or all of the haptic feedback processing described herein natively and may output the haptic data as haptic effects 964.

In embodiments, the contact interpreter 930 may output a haptic frame 966 indicating where haptic feedback should be applied to a user (e.g., a force vector specifying a magnitude and direction of force feedback, actuation patterns specifying multiple points of contact with a user hand or other location and an amount of pressure applied at each point, etc.) and/or which actuators should be activated. In some embodiments, the haptic feedback locations of the haptic frame may not necessarily correspond to the locations of actuators on the wearable haptic interface. For example, a haptic frame may indicate a particular haptic feedback location (e.g., for simulating a virtual “needle prick”) that may not correspond to any tactile actuator. In this example, the haptic feedback may be provided to a user using multiple actuators near the corresponding location. Additionally or alternatively, even if a haptic feedback location corresponds to an actuator, multiple other nearby actuators may be actuated to provide a stronger haptic feedback response. In other examples, a haptic frame may specify haptic feedback over an area, which may be simulated by actuating multiple actuators that may be within the corresponding area and/or outside the corresponding area. Accordingly, it should be understood that the haptic feedback specified by the haptic frame may not map exactly to the locations of the tactile actuators. In embodiments, the contact interpreter 930 may be configured to extract contour information from the world information 962 at a sufficient rate to perform real-time haptic control. The contact interpreter may use various strategies to transform the contour data extracted from the world information into actuation patterns. These strategies may be based on various rules and/or algorithms for simulating human tactile perception in a way that may be used to maximize the realism of a sensation, as discussed in further detail below. Additionally or alternatively, the haptic feedback may be provided in a way that departs from a realistic simulation of a sensation. For example, an application may use one or more haptic effects to rapidly turn actuators on and off (e.g., “flutter” the actuators) to provide a signal to the user for various reasons.

An actuation calculator 932 may then determine an actuator frame 968 including data for causing various components and/or actuators of the wearable haptic interface 330 to actuate based on the haptic frame 966. In embodiments, the actuation calculator 932 may use simulated peripheral data from a simulated peripheral database 934 to perform the generation of the actuator frame 968. The actuation controller 936 may then output actuator command data 970 (e.g., various actuation commands addressing individual actuators) to various components of the wearable haptic interface). In some embodiments, the actuation commands may be used to adjust microfluidic actuators. Additionally or alternatively, the actuation commands may be used to adjust MR actuators, pneumatic actuators, finger brakes, or other types of force feedback actuators. In embodiments, the actuator command data 970 may cause actuation of one or more tactile actuators 504 and/or thermal actuators 506 of an interface garment 502. Additionally or alternatively, the actuator command data 970 may cause actuation of one or more brakes 508. Additionally or alternatively, the actuator command data 970 may cause actuation of one or more force feedback actuators 604.

In embodiments, instead of outputting actuator command data 970 to the wearable interface devices, the actuation controller may cause a separate microfluidic system to actuate external microfluidic valves that are connected (e.g., via fluid/air conduits) directly to the wearable haptic interface components.

In embodiments, the actuation calculator 932 and/or the actuation controller 936 may output data to a hardware state visualizer (HSV) controller 938, which may output to a hardware state visualizer 940. The hardware state visualizer may be an example of an auxiliary application 248. The hardware state visualizer may allow viewing the state of any of the components of the wearable haptic interface 330 (e.g., the current or past positioning of the component, current or past actuation of the valve and/or actuators, etc.), which may be used for monitoring, debugging, and/or other such purposes. In embodiments, the actuation controller 936 may also output haptic feedback data back to the haptic system application 250 (e.g., so that the haptic system application 250 may use the haptic feedback data for in-engine purposes).

The above-described process for converting application data received from a haptic system application 250, such as world information 962 and/or haptic effects 964, into data for providing haptic feedback to a wearable haptic interface 330 may be referred to herein as a “Haptic stack.”

Accordingly, in embodiments, an immersive haptic system may have an SDK (e.g., including an API and/or haptic application plugin) that is configured to process raw motion data received from a wearable human interface into structured motion data using a set of sensor data processing workflows, the structured motion data being input into a game engine/simulation engine/haptic digital twin, and to process an output state of an environment generated by the game engine/simulation engine/haptic digital twin into a set of haptic control commands that are input to the wearable human interface.

In embodiments, an immersive haptic system may leverage an SDK including an API that performs a set of sensor data processing workflows on sensor data received from a set of sensors of a wearable haptic interface to obtain structured motion data and inputs the structured motion data that indicates a motion of a user wearing the wearable haptic interface to a haptic application.

In embodiments, an immersive haptic system may have an SDK including an API that performs a set of sensor data processing workflows on a set of data streams to obtain structured motion data and inputs structured motion data that indicates a motion of a user wearing the wearable haptic interface to a haptic application. The set of data streams may include a low-level motion capture data stream that is indicative of a relative position of specific body parts of a user wearing the wearable haptic interface (and/or a tracked prop) and a tracking data stream that is indicative of an absolute location of the user with respect to the 3D environment of the user. In some of these embodiments, the SDK/API may be configured with a set of modules for determining an intent of the user's motion based on the absolute location and the relative location of the user. Additionally or alternatively, the SDK/API may include a machine-learning component that determines an intent of the user's motion based on the absolute location and the relative location of the user.

The touch compensator 908 may be configured to detect a self-touch state (e.g., an intent to touch one finger to another finger) and adjust the motion capture data accordingly as mentioned earlier. In some cases, a user wearing the wearable haptic interface 330 may be physically unable to touch two body parts together due to the thickness of the wearable haptic interface 330 and/or movement restrictions imposed by the wearable haptic interface 330. For example, when wearing a haptic glove 236, a user's fingertips may be placed inside thimbles that are connected to fingertip tracking sensors. Accordingly, if the user tries to perform a pinch motion by contacting two fingers together, the thimbles on the two fingers may prevent the fingertip sensors from coming closer than a minimum distance depending on the thickness of the thimbles. In this example case, the touch compensator 908 may be configured to detect that the user wishes to pinch two fingertips together even when the fingertip sensors indicate that the fingertips are some distance apart. For example, the touch compensator 908 may detect that two fingertips are approaching each other and subsequently that they stop moving towards each other when they reach a minimum possible distance. The touch compensator 908, in such a situation, may adjust the motion capture data so that the motion capture data indicates that the two fingers are touching.

Similarly, the touch compensator 908 may be configured to detect that two hands are touching each other even though hand sensors indicate that the hands are some distance apart (e.g., due to the thickness of the wearable haptic gloves 236). As another example, the touch compensator 908 may be configured to detect that a hand is touching the user's body even though the motion capture data indicates that the hand is some distance from the body (e.g., due to the thickness of the haptic glove 236 and/or the thickness of other components of a haptic exoskeleton 238). In embodiments, the touch compensator 908 may leverage a neural network or some other machine learning algorithm to detect a self-touch. The neural network may be trained using data that correlates motion capture data to target data indicating a self-touch state and/or a type of the self-touch state (e.g., a pinch or other thimble collision state, a clap or other hand-to-hand contact state, hand-to-body contact state, etc.). Thus, the trained neural network may be able to detect various types of self-touch states and then apply compensation when they are detected. Additionally or alternatively, non-ML based approaches may be used to detect self-touch (e.g., a non-ML algorithm that monitors distances between certain sets of sensors).

Accordingly, an immersive haptic system that interfaces with a wearable user interface may have an SDK including an API that performs a set of sensor data processing workflows on a set of data streams to obtain structured motion data and inputs structured motion data that indicates a motion of a user wearing the wearable haptic interface to a haptic application. The set of sensor data processing workflows may include detecting a self-touch state when one or more of the data streams indicates that a first portion of the user is physically unable to contact another portion of the user, and in response to detecting the self-touch state, compensating the structured motion data to indicate that the first portion and the other portion of the user are in contact.

In embodiments, the immersive haptic system may interface with a wearable haptic interface that includes at least a glove that includes a set of finger thimbles that respectively track motions of a respective finger. In these embodiments, the immersive haptic system may have an SDK including an API that performs a set of sensor data processing workflows on a set of data streams to obtain structured motion data and inputs structured motion data that indicates a motion of a user wearing the wearable haptic interface to a haptic application. The set of sensor data processing workflows may include a thimble compensation that detects a thimble collision state when one or more of the data streams indicates that a first finger of the user is physically unable to contact a second finger of the user do to the physical thickness of the finger thimbles of the wearable haptic interface and in response to detecting the thimble collision state, compensates the structured motion data to indicate that the first portion and the other portion of the user are in contact.

In embodiments, wearable user interface that interfaces with an immersive haptic system may include at least a first glove and a second glove. In these embodiments, the immersive haptic system may have an SDK including an API that performs a set of sensor data processing workflows on a set of data streams to obtain structured motion data and inputs structured motion data that indicates a motion of a user wearing the wearable haptic interface to a haptic application. The set of sensor data processing workflows may include detecting a hand-to-hand contact state when one or more of the data streams indicates that a first hand of the user is physically unable to contact the other hand of the user due to a thickness of the first and second glove, and in response to detecting the hand-to-hand contact state, compensating the structured motion data to indicate that the first hand and the other hand are in contact at a location corresponding to the hand-to-hand contact state

In embodiments, a wearable haptic interface may include an exoskeleton with at least one glove. In these embodiments, the immersive haptic system may have an SDK including an API that performs a set of sensor data processing workflows on a set of data streams to obtain structured motion data and inputs structured motion data that indicates a motion of a user wearing the wearable haptic interface to an immersive haptic system. The set of sensor data processing workflows may include detecting a hand-to-body contact state when one or more of the data streams indicates that a hand of the user is physically unable to contact the other hand of the user due to a thickness of the glove and/or a thickness of other components of the exoskeleton at the location where the hand-to-body contact is detected, and in response to detecting the hand-to-hand contact state, compensating the structured motion data to indicate that the first hand and the body of the user are in contact at a location corresponding to the hand-to-body contact state.

The API 244 may include an interaction assistant 920 that assists in simulating the interactions between an avatar and an environment. Some haptic system applications 250 may have difficulty in providing immersive and realistic interactions between an avatar and one or more objects or entities in an environment for a variety of reasons. For example, a physics engine of the haptic system application 250 may run at a lower than optimal rate due to processing constraints and/or the physics engine may use simplified physics (e.g., simulating an avatar's hand using a simplified rigid body), which may create unrealistic interactions between the user and the environment. The interaction assistant 920 may be configured to compensate for rigid-body assumptions and other limitations of such physics engines. For example, it may simulate physical interactions of the body with elements of the world based on the nature of the interaction, rather than just the geometry. The interaction assistant 920 may use a variety of techniques to improve the simulation of these interactions.

The interaction assistant 920 may receive world information from the haptic system application 250 to determine when a user avatar is interacting with an object or entity in the environment. In embodiments, the interaction assistant 920 may perform grasp detection by detecting when a user is attempting to grab an object (e.g., when the user's fingers or hands is near the object and the user is applying pressure in the direction of the object). The interaction assistant 920 may thus include a grasp detector algorithm configured to find contact forces that indicate that the user wants to pick up something (e.g., pinch, pick up or otherwise move something). Specifically, the interaction assistant 920 may detect pairs of forces (e.g., from two fingers, two hands, two parts of a hand) or more (e.g., three forces, four forces, etc.) associated with a user avatar that indicates the user wishes to pick up something.

In embodiments, the interaction assistant may use one or more AI/ML techniques to detect a grasp intent or other interaction. For example, the interaction assistant may leverage a model trained using data that correlates avatar data to data indicating an intended interaction (e.g., a grasp, etc.). Thus, the trained model may be able to detect various types of interactions states and notify the haptic system application 250 when they are detected.

After detecting a grasp intent, the interaction assistant 920 may then output interaction data 960 indicating to the haptic system application 250 that the object/entity is being grasped by the user. Additionally, the interaction assistant 920 may modify physics parameters in the vicinity of the contact points between the hand and the object/entity in order to secure the object/entity in the avatar's grasp (e.g., by increasing friction or some other motion resistance such as air resistance and/or affixing the object to a contact point of the user's hand until the grasp ends), may deform the hand model for the user avatar in order to simulate how a real hand would slightly deform when pressure is applied to an object, and/or the like. In embodiments, the modifications may include damping the contact by increasing the resistance to the motion of the object/entity being grasped (e.g., so that it is not as inclined to move or slip from the grasp). Thus, by adding artificial contact damping to the object/entity, the effects of the assumptions of the physics engine about rigidity may be mitigated and entities may become easier to pick up and hold within the environment. Accordingly, one or more forces may be applied to influence the object/entity to move in a way that matches the motion of the avatar grasping the object/entity, thus allowing the user's avatar to maintain the object/entity in the grasp.

In embodiments, contact dampening may be applied to the haptic feedback applied to a user's hand (e.g., via a wearable haptic glove 236, also referred to herein as a haptic glove 236) such that the dampened feedback is also felt realistically by the user.

In embodiments, the modifications performed by the interaction assistant 920 may be based on a set of characteristics of the avatar's hand (which may be customized based on a user's hand) and a set of characteristics of the object/entity (which may have varying hardness/softness, slipperiness, etc.). The interaction assistant may also perform other types of interaction assistance in addition to grasp detection, such as improving the interaction between a user's avatar and a simulated clothing item or accessory worn by the avatar or otherwise attached to the avatar. In these embodiments, the interaction assistant may use a set of characteristics of various parts of the human body (e.g., either default characteristics that correspond to an avatar or custom characteristics specified by a user profile 312) depending on the interaction.

In embodiments, the interaction assistant may use an on-board physics engine (discussed elsewhere herein) to improve an interaction simulation. For example, a haptic system application 250 may use rigid physics models, which may not always accurately simulate interactions involving a human hand or other human body parts. In one example, a user may move a haptic glove 236 in a way such that the corresponding avatar's hand would go through an object in the environment. In this case, an on-board physics engine may control the virtual avatar hand using a spring damper constraint (e.g., a virtual spring that controls the position and a virtual damper that controls velocity and instability). Thus, if the user causes the virtual hand to move to a position that is incompatible with the virtual environment, the user may see (e.g., on a VR headset) the virtual hand rest on the surface as determined by the soft-body physics engine. In this case, the physics engine may use a virtual spring force to effectively “pull” the hand back from the incompatible location. In some cases, the on-board physics engine may be a soft-body physics engine that may be capable of deforming meshes (which may include avatar meshes and/or object meshes) to simulate interactions between an avatar and one or more deformable objects/entities within the environment (e.g., depending on a set of properties associated with the objects/entities such as material, stiffness, etc.).

Accordingly, an immersive haptic system that interfaces with a wearable user interface that includes at least one glove may have an SDK including an API and/or haptic application plugin that receives an output state of an environment being generated by an immersive haptic system and executes a set of workflows to translate the output state into a set of actuation commands for a haptic controller of a haptic interface. The set of workflows may include an interaction detection stage that identifies an occurrence of an interaction between an avatar of a user wearing the haptic interface and an object in the environment and, in response to identifying the occurrence of the interaction, compensates for any rigid-body assumptions made by the immersive haptic system when simulating the interaction between the avatar and the object such that the compensation is based on a set of characteristics of the human body (e.g., based on the avatar, which may be customized based on user dimensions, preferences, etc. as described elsewhere herein) and a set of characteristics of the object. In some of these embodiments, the set of workflows may, in response to identifying that the type of interaction is a grasping interaction, compensate for any rigid-body assumptions made by the immersive haptic system when simulating the grasping of object by the avatar such that the compensation is based on a set of characteristics of the human body and a set of characteristics of the object. In these embodiments, the compensation may include providing a physical constraint to the immersive haptic system instructing the immersive haptic system to influence a location of the object within the environment relative to a location of a hand of the avatar (e.g., fixing the object to the hand or otherwise influencing its location and behavior) for a duration of the grasping interaction. Additionally or alternatively, the set of workflows may, in response to identifying that the type of interaction is a hand contact interaction with an object, compensate for any rigid-body assumptions made by the immersive haptic system when simulating the contact with the object by the avatar such that the compensation is based on a set of characteristics of the human body and a set of characteristics of the object. In these embodiments, the compensation may correspond to a dampening of the feedback force applied by the haptic interface to a hand of the user to account for the non-rigidity of the human hand.

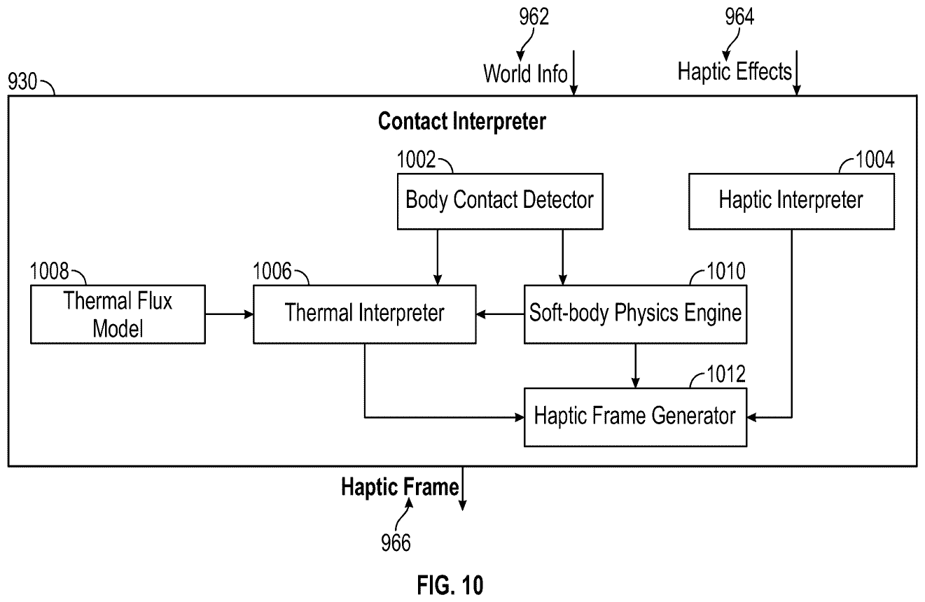

FIG. 10 shows a more detailed view of example components of a contact interpreter 930. A body contact detector 1002 may detect contact points between a user avatar and one or more objects/entities within a computer-mediated environment. For example, the body contact detector 1002 may use a ray cast mechanism to determine contact occurrences and locations (e.g., where contact may be based on an actual overlap and/or based on the avatar being within a certain proximity of the objects/entities) and/or may use haptic effects 964 information generated by the haptic system application 250.

In example embodiments, the body contact detector 1002 may generate a field of ray traces, where each ray trace originates from a plane attached to the avatar. The plane may be referred to herein as a “sampling plane.” In embodiments, the spatial resolution of the ray traces may be adjusted to achieve different levels of fidelity. Each ray trace may extend forward until either contacting another body or reaching a maximum ray trace length. For those ray traces that contact another body (e.g., an object within the environment), the contact interpreter 930 may record the length along that trace between the contour of the body and the contour of the avatar. This distance information may be collected in a structure which may be referred to as a “separation field.” The separation field therefore may include a plurality of measurements of the distance between the avatar and a second body (e.g., object/entity). A measurement of zero may indicate that the avatar and the second body are directly contacting one another along that sample. There may be only one shared collision point (e.g., because game engines may natively model virtual objects as rigid).

In embodiments, a soft-body physics engine 1010 and/or haptic frame generator 1012 may process the body contacts using simulations that provide more accurate and immersive contact simulations than a rigid body physics engine (which may be used by the haptic system application 250). The soft-body physics engine 1010 may simulate, for example, an interaction between a virtual hand of the user's avatar and an object in the environment using soft body physics, as indicated by world information 962. The engine 1010 may thus determine how a body part (e.g., a hand) would realistically be deformed by contact with an object and/or how the object would be deformed by contact with the body part and may thus generate more realistic haptic feedback data. In embodiments, the soft-body physics engine 1010 may perform a determination of how an interaction between a body part (e.g., a hand) and an object (e.g., a complex shape like a rock with many nooks and crannies) should be represented (e.g., a particular pressure on the hand). The pressure may increase as a user applies increasing force to the object (e.g., by grasping the rock harder with the user's hand), and the contact area may broaden as the soft-body physics engine 1010 calculates deformations for the avatar's hand. The engine 1010 may output the soft body contact information to the haptic frame generator 1012.

In an example embodiment, in order to simulate flexibility of the user avatar, the soft-body physics engine 1010 and/or haptic frame generator 1012 may treat the separation between the objects as a negative measure of how much the two objects would interpenetrate were they both modeled as flexible. For example, the smallest separations would lead to the most interpenetration and the largest separations would lead to the least interpenetration. In embodiments, the avatar may be treated as flexible and the contacting objects as rigid, meaning the interpenetration value may be a measure of avatar surface deflection. Additionally or alternatively, the contact interpreter may perform real-time flexible body simulations.

In embodiments, the amount of modeled avatar contour deflection normal to a ray trace can be calculated as:

$$d ( z ) = \{ \begin{matrix}\frac{{S}_{max} - z}{k} , & z < {S}_{max} \\ 0 , & z \geq {S}_{max}\end{matrix}$$

In this example equation, d is the avatar's deflection at the given sample, z is the ray trace length at the given sample, Sₘₐₓ is the largest separation at which the avatar's contour should be deflected, and k is some constant that represents the modeled stiffness of the avatar. In embodiments, if a single actuator corresponds to the calculated sample, the actuator may be instructed to press down a distance d on the user's skin based on the calculation above.

In many cases, a single actuator may not correspond to a single sample. In these cases, a function may be used that provides virtual separation data and converts it into displacement commands for actuators. Many strategies may be used to accomplish this function. In an example approach, an “influence list” may be built for each actuator that contains all ray trace samples that are geometrically closer to that actuator than to any other actuator. In embodiments, if any actuator is left without an associated sample, the contact interpreter 930 may associate the actuator with the sample closest to it. When calculating the displacement d for an actuator, the haptic frame generator 1012 may supply as the argument the smallest separation of all samples in that actuator's influence list.

In some embodiments, the contact interpreter 930 may calculate an actuator displacement as a weighted sum of separations, for example. Additionally or alternatively, the contact interpreter may scale the displacement by the magnitude of the virtual reaction force at the interface of the avatar and the second body.

In embodiments, approaches and techniques for translating contact into haptic actuation patterns may be modified by the use of various techniques, including digital filtering (e.g., using a low pass filter on body contour data of an entity to emphasize large detail, using a high pass filter on body contour data of an entity to emphasize fine detail) and other such techniques. In embodiments, these techniques may be used in different scenarios in order make elements of an object's virtual geometry more noticeable to a user. For example, these filters might be configured on a virtual-object-by-virtual-object basis. Additionally or alternatively, different filters may be used for the sake of enhancing perception for the user. For example, a user with some nerve damage may have greater difficulty detecting fine-scale features such as surface texture. Regardless of any filter associated with a virtual object being contacted, an additional high-pass filter could be used to further accentuate all details from all interactions. This could aid the hard-of-touch user to feel objects in greater fidelity than the user would be able to otherwise.

In embodiments, contacts detected by the body contact detector 1002 may also be processed by a thermal interpreter 1006, which may use one or more thermal flux models 1008 to determine the thermal flux resulting from the contact. Additionally or alternatively, the thermal interpreter 1006 may determine an amount of thermal flux based on soft-body contact information generated by the soft-body physics engine 1010. The thermal interpreter 1006 may determine, for each point or area of contact, how much thermal flux should be applied as haptic feedback and output this information to the haptic frame generator 1012. The thermal interpreter 1006 may also determine that thermal feedback should be applied based on other interactions or world information 962, such as the user avatar standing in a hot location and/or near a hot item in the environment or the sun shining on the user avatar in the environment, etc. The thermal interpreters 1006 may determine an amount of thermal flux using the thermal flux model 1008 based on thermal data associated with the user avatar, thermal data associated with an object in contact with the user avatar, and/or thermal data of other objects/entities in the environment (where thermal data may include temperature, material, or other properties that may affect thermal flux). The thermal haptic information generated by the thermal interpreter 1006 may later be used to actuate thermal actuators and/or microfluidics actuators with temperature-variable fluid, as discussed elsewhere herein.

In embodiments, a haptic interpreter 1004 may determine other types of contact that may not be accurately simulated by a physics simulation. For example, the haptic interpreter 1004 may determine that haptic feedback should be applied based on the presence of wind in the environment. As another example, the haptic interpreter 1004 may determine that haptic feedback simulating a vibration should applied based on a user avatar being nearby or in contact with a machine (e.g., the avatar may be holding a powered drill or sitting in a vehicle with a running motor). The haptic interpreter 1004 may detect these situations and determine areas of the body that would be affected (e.g., a hand and arm when a user holds a powered drill). The haptic interpreter 1004 may output the haptic feedback data to a haptic frame generator 1012. A haptic frame generator 1012 may process, combine, and output the various data regarding haptic feedback to generate a haptic frame 966, as described earlier.

Accordingly, a wearable human interface may have a set of sensors and an on-board processing system that is configured to execute an API and a physics engine. The API may be configured to process sensor data to obtain motion capture data indicating motion of a user wearing the wearable human interface. Furthermore, the physics engine may be configured to generate an environment that includes an avatar of the user that is controlled within the environment by the physics engine based on the motion capture data.

In embodiments, an immersive haptic system may be configured to simulate an environment including an avatar of a user of a wearable haptic interface. The immersive haptic system may execute a soft-body simulation of the environment and may determine an output state of the environment with respect to the avatar based on interactions between the avatar and the environment. Furthermore, a contact interpreter may monitor the output state of the environment to identify contact events between the avatar and an object in the environment and, in response to identifying the contact event, may determine a corresponding haptic feedback response based on the contact event, wherein the haptic feedback response is transformed into a set of actuation commands that are provided to the wearable haptic interface.

In embodiments, an immersive haptic system may have an immersive haptic system that is configured to generate an environment including an avatar of a user of a wearable haptic interface. The immersive haptic system may handle the physics-based calculations for the environment and may determine an output state of the environment with respect to the avatar based on interactions between the avatar and the environment. Furthermore, a haptic interpreter may maintain a set of physical characteristics of the environment and objects contained therein and may apply one or more haptic augmentations to the output state based on the set of physical characteristics and the interactions between the avatar and the environment.

In embodiments, an immersive haptic system may have an immersive haptic system that is configured to simulate an environment including thermal characteristics of the environment/objects in the environment and simulate an avatar of a user of a wearable haptic interface. The immersive haptic system may handle the physics-based calculations for the environment and may determine an output state of the environment with respect to the avatar based on interactions between the avatar and the environment. The output state may include one or more thermal states of the environment, of objects in the environment, and/or of the avatar. Furthermore, a haptic interpreter may maintain a set of thermal characteristics of the environment and of objects contained therein and may apply one or more thermal augmentations to the output state based on the set of physical characteristics and the interactions between the avatar and the environment. The thermal augmentations may be used to determine a thermal feedback response that is used to actuate one or more thermal actuators.

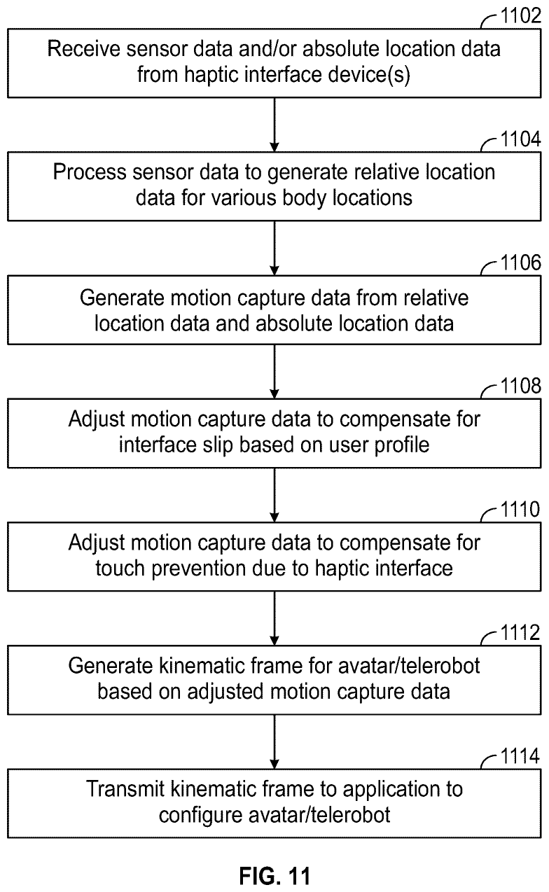

FIG. 11 illustrates an example method for implementing motion capture based on sensor data received from haptic interface devices. For example, the method of FIG. 11 may allow one or more haptic interface devices to be used as input to control an avatar in a virtual environment and/or a telerobot. The functions shown in FIG. 11 may be implemented by an application programming interface (API) that receives information from a wearable haptic interface 330, processes the information, and provides the processed information to a haptic system application 250. In other words, the API may provide a computer-mediated interface between a haptic interface device and a virtual environment and/or telerobot. In embodiments, the various functions of FIG. 11 may be implemented by an SDK that may integrate with a haptic system application 250 (e.g., a game engine SDK or plugin for a game application). Additionally or alternatively, the method may be implemented by the application 250 itself (e.g., as a module or plugin of the application 250). Additionally or alternatively, the method may be implemented by a device onboard the wearable haptic interface 330 and/or components thereof. In the descriptions below, the method steps are performed by a motion capture system 314 of the API 244, which may execute on a device that runs the application 250 and/or a separate device. The motion capture system may comprise one or more sensor data processors 902, motion processors 904, a slip compensator 906, a touch compensator 908, and/or a kinematic frame generator 910, described elsewhere herein. However, it should be understood that the method and the functions thereof may be implemented at various hardware devices and/or sub-systems thereof.

At 1102, the motion capture system receives sensor data and/or location data from the one or more haptic interface devices of the wearable haptic interface 330. For example, the haptic interface devices may comprise an exoskeleton, one or more haptic gloves, and/or any other haptic interface devices. The sensor data may comprise raw sensor data from various types of sensors that may be arranged on the haptic interface, such as accelerometers, gyroscopes, magnetometers, and/or positional trackers. For example, a haptic glove may have a sensor arranged on each fingertip of the glove, on a palm of the glove, on various finger joints, etc. Similarly, sensors may be arranged at various locations on an exoskeleton or other haptic interface device. Accordingly, the sensor data may include various raw sensor data streams corresponding to a plurality of different sensors. Additionally or alternatively, the wearable haptic interface 330 may comprise motion trackers 340 that may perform sensor processing and output absolute location data (e.g., location and orientation within a 3d space around the user) using various techniques (e.g., visual tracking based on a signal emitted by a lighthouse or base station, inside-out visual tracking, etc.). Motion trackers may be arranged at various anatomical locations of the haptic interface devices (e.g., one tracker on each hand of respective gloves, one tracker on a torso of an exoskeleton, etc.). Thus, the motion capture system may receive both raw sensor data as well as absolute location data output by various trackers and/or associated lighthouses/base stations. In embodiments, the location data may be received by the motion capture system as ongoing data streams including a plurality of time-specific measurements. Thus, the data streams may, over time, indicate whether the user is moving or not. Additionally or alternatively, some of the sensors (e.g., inertial measurement units with gyroscopes) may estimate velocity directly, and thus the data streams may further include motion/velocity data.

At 1104, the motion capture system may process any raw sensor data using various data processing techniques to generate detailed relative location data for one or more body parts, such as fingertips, finger joints, palms, one or more locations on the arms and legs, torso, head, etc. The sensor data processing may involve filtering, normalization, and/or the like to remove the influences of noise or interference, generate location data in a usable format, etc. The sensor data processing may further involve various calculations to determine relative locations depending on the type of raw sensor data (e.g., dead reckoning, trilateration, triangulation, inertial navigation, optical tracking, magnetic tracking, time of arrival or time of distance arrival measurement, and/or the like). In embodiments, the sensor processing may involve sensor fusion to determine location data based on sensor data from multiple sensors. Additionally or alternatively, the sensor processing may involve compensation for sensor slip.

In embodiments, the motion capture system may generate relative location data 953 that is indicative of a relative position and/or orientation with respect to some common reference point. For example, the motion capture system may generate location data including positions and orientations of each sensor of a haptic glove relative to a single common reference point, such as a metacarpophalangeal joint of a middle finger (which may be referred to as “MCP 3”) for the hand. The motion capture system may apply a similar technique to calculate relative positions for other body parts with respect to other common points and/or to a single common point for all body parts. In other words, each tracked location may be relative to a single reference point or to different reference points that may be used for different purposes (e.g., hand tracking, body tracking, etc.).

At 1106, the motion capture system may perform motion processing on the absolute and relative location data to integrate the location data into a single coordinate system and store the data as a motion capture data frame 956. The motion capture frames may be time-based, such that the motion capture system continually generates a series of motion capture frames, where each motion capture frame corresponds to a particular timestamp or period of time. Each motion capture frame may include absolute and/or relative location data for various body parts corresponding to the haptic interface devices, including an absolute position and orientation of a reference point and/or a plurality of relative position and orientation data for particular key points with respect to the reference point (e.g., position offsets) and a particular time. As an example using a haptic glove, the motion capture system may generate a motion capture frame that indicates all of the tracked positions of one hand at a particular time calculated as relative positions with respect to a selected common point such as MCP 3 for that hand. A single motion capture frame may correspond to a single body part at a given time (e.g., a first motion capture frame for a left glove and a second motion capture frame for a right glove, with additional frames for legs, torso etc.). Additionally or alternatively, a motion capture frame may include motion capture data for multiple tracked body parts. The motion capture system may continuously generate a series of motion capture frames over time, where each motion capture frame corresponds to a particular timestamp and/or time period, in order to provide a series of frames that can be used to control an avatar/telerobot over time.

At 1108, the motion capture system may compensate for interface slip (e.g., glove slip) by adjusting a generated motion capture frame based on various factors that may indicate slip. For example, a glove slip may occur when the user's hands move within a glove but the glove does not move or vice versa (e.g., the glove slips with respect to the hand). Similar interface slips may occur with respect to an exoskeleton (e.g., torso slip). The motion capture system may detect glove slip using techniques such as observing inconsistencies in motion capture frames over time (e.g., if a sensor on the back of the hand moves but the fingers do not move, a glove slip may be detected). Additionally or alternatively, the motion capture system may detect glove slip using redundant sensors or other techniques. Based on the detected glove slip, the motion capture system may adjust relative position and/or orientation data of a motion capture frame to correct for the detected slip (e.g., depending on where the slip is detected). In embodiments, the motion capture system may take user profile data into account when detecting and compensating for glove slip. For example, the motion capture system may perform glove slip compensation based on data indicating the size of the user's hand, the length of the user's fingers, and/or other factors that may affect glove slip.

At 1110, the motion capture system may compensate for touch intents based on the haptic interfaces. For example, as described above, fingertip thimbles of a haptic glove may make it impossible for a user's fingers to physically touch when making a “pinch” motion. In this example, when the measured position of two of a user's fingertips come within a threshold distance of each other (e.g., a minimum distance that may be defined based on the size of fingertip thimbles), the relative position offsets for the two fingertips may be adjusted to indicate that they are touching (e.g., such that an avatar's fingers will touch as intended by the user). Similar touch compensations may be performed for hand-to-hand touch intents, hand to body intents, leg to leg touch intents, and/or the like. In each example, position data may be adjusted to cause a touch if two contact points are within a certain distance of each other (e.g., which may indicate a touch intent), where the distance may vary depending on various features and/or dimensions of the haptic interface (e.g., because a glove interface may be more or less thick than a leg interface for an exoskeleton).

The motion capture system may also detect other intents and cause performance of other actions (e.g., either instead of or in addition to touch compensation) in response to the detected intents. For example, certain predefined gestures (e.g., a pinch or other movement or one or more fingers) may be interpreted as a command that may cause an arbitrary action within the application. In these embodiments, the motion capture system may detect the predefined gesture and store a separate indication of the detected gesture and/or a command associated with the gesture (e.g., within the motion capture frame and/or kinematic frames provided to the application). In embodiments, the command associated with the gesture may be user-configurable (e.g., the user profile may indicate which gesture is associated with which command). In embodiments, the motion capture system may use AI and/or machine learning techniques (e.g., trained models) to detect gestures based on any of the data received by and/or generated by the motion capture system (e.g., the location data and/or raw sensor data, relative position and orientation data, motion capture frames, etc.).

At 1112, the motion capture system may generate a series of time-based kinematic frames based on the series of time-based motion capture frames (with any relevant compensations applied), where the kinematic frames may be fed into an application to control the movement of an avatar and/or telerobot. The motion capture system may use the motion capture frame data to generate a model including an intended position and orientation of each body part that corresponds to a haptic interface device based on the user movements and positioning. For example, if the wearable haptic interface 330 comprises haptic gloves 500, the kinematic frames may include corresponding hand models. If the wearable haptic interface 330 includes an exoskeleton 600, the kinematic frames may include a full body model. In embodiments, the kinematic frame may further indicate any detected gestures and/or commands associated with the detected gesture.

In embodiments, the motion capture system may optimize a kinematic frame to account for any differences in a model based on the user's inputs and a model of the avatar and/or telerobot. For example, the avatar and/or telerobot may have a different hand size, different finger lengths, limb size, height, and/or the like. In these embodiments, the motion capture system may perform optimization to reconcile the differences between the models/dimensions, such as by mapping (e.g., interpolating) from the user model to the avatar and/or telerobot model. In embodiments, the mapping may be limited by one or more animation capabilities of the avatar model (e.g., extension and/or flexion limits). In embodiments, an avatar and/or telerobot may have a different morphology (e.g., different number of fingers, different number and/or type of limbs, etc.). As an example, a user may be controlling a telerobot that is a surgical instrument, robotic arm, etc. In these embodiments, the user's movements may be mapped to the telerobot using various strategies. For example, the avatar may mirror the telerobot such that the kinematic frame generator maps between the morphology of the user and the morphology of the telerobot (e.g., such that certain user motions cause certain motions of the avatar and telerobot).

Alternatively, the avatar may share a morphology of the user even when the telerobot does not. For example, an application may generate a human avatar that allows a user to simulate moving around within a haptic digital twin and perform various actions for controlling a surgical instrument telerobot. As a more illustrative example, a haptic digital twin may allow a surgeon to control a human avatar to move around within a haptic digital twin of a real body undergoing surgery, cause the avatar to touch certain tissue within the haptic digital twin to cause the surgical telerobot to touch the tissue, perform certain actions within the haptic digital twin to cause the surgical telerobot to perform corresponding actions, and/or the like. In these embodiments, because the computer-mediated haptic digital twin may change a scale of the user with respect to the avatar, for example, the surgeon may be able to simulate moving around within an organ, blood vessel, or other small space via the haptic digital twin, may very finely control motion and/or operation of the telerobot at a very small scale, etc. Although this example is illustrative, many other examples of using haptic digital twins to control telerobots with different scales and/or morphologies are enabled by the motion capture system. As another brief example, a user avatar may be “scaled up” in a haptic digital twin to allow the user to interact with a large construction site, control heavy equipment with various morphologies by moving the avatar, and/or the like. Accordingly, it should be understood that a haptic digital twin may generate a computer-mediated environment that allows a user to interact with a digital twin of a real environment using avatars that do not exist in the real world.

In embodiments, an avatar model may be generated and/or adjusted based on user profile data. For example, a user profile may indicate an actual or preferred height, size, etc. of an avatar for the user, including various user-specified dimensions for constructing the avatar. In these embodiments, the motion capture system may generate a kinematic frame using the avatar model by mapping a user model generated based on motion capture data to the avatar model. In some embodiments, as described above, this process may involve the use of ML models that may assist in mapping the user model to the avatar model. In embodiments, the mapping may involve animation retargeting or other approaches.

At 1114, the motion capture system may transmit the kinematic frame(s) to the application for use in adjusting the avatar/telerobot. The motion capture system may send a series of kinematic frames as they are generated so that the application may continuously update the avatar/telerobot. In embodiments, the motion capture system may communicate with a plugin/module that is integrated with the application, for example by calling an update function provided by the plugin/module. In embodiments, an SDK may provide the integration for the application.

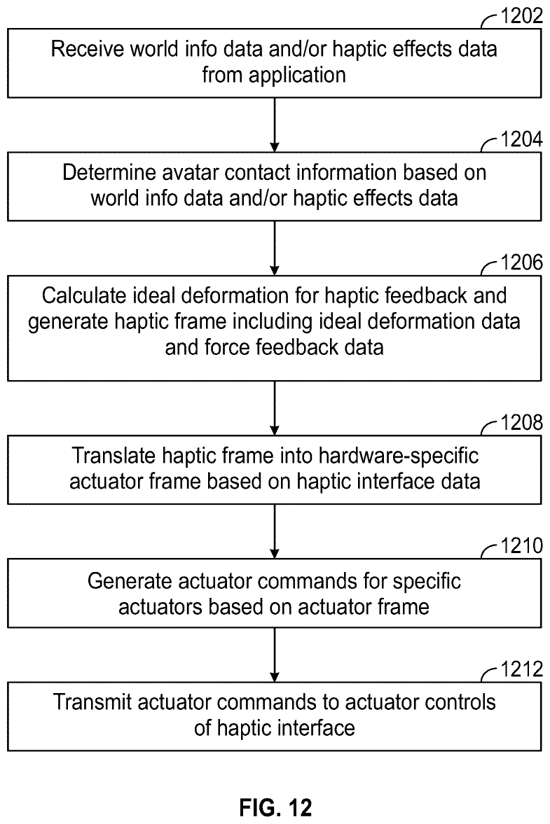

FIG. 12 illustrates an example method for implementing haptic feedback based on world information and/or haptic effects data that is received from an application. The functions shown in FIG. 12 may be implemented by the same API that implements the method of FIG. 11. As described above, the API may provide a computer-mediated interface between a haptic interface device and a virtual environment and/or telerobot. In embodiments, the various functions of FIG. 12 may be implemented by an SDK that may integrate with a haptic system application 250 (e.g., a game engine SDK or plugin for a game application). Additionally or alternatively, the method may be implemented by the application 250 itself (e.g., as a module or plugin of the application 250). Additionally or alternatively, the method may be implemented by a device onboard the wearable haptic interface 330 and/or components thereof. In the descriptions below, the method steps are performed by a haptic feedback controller 316 of the API 244, which may execute on a device that runs the application 250 and/or a separate device. The haptic feedback controller may comprise a contact interpreter 930 and/or components thereof, an actuation calculator 932, an actuation controller 936, and/or other components as described elsewhere herein. It should be understood that the method and the functions thereof may be implemented at various hardware devices and/or sub-systems thereof.

The haptic feedback method of FIG. 12 may be used to provide different types of haptic feedback depending on the haptic actuators present within the one or more haptic interface devices. For example, as described herein, a haptic glove may include a plurality of microfluidic tactile actuators and resistive brakes that provide force feedback to a user's fingers. Accordingly, the haptic feedback method may generate commands for controlling the microfluidic tactile actuators and/or activating one or more of the resistive brakes. Additionally or alternatively, an exoskeleton may include active force feedback actuators that may resist user movement and/or actively reposition a user. Accordingly, the haptic feedback method may generate tactile actuation commands, braking commands, and/or active force feedback commands for controlling one or more actuators of the exoskeleton.

At 1202, the haptic feedback controller may receive data that is relevant to haptic feedback from an application (e.g., a game, a simulation, and/or a haptic digital twin for a telerobot). The haptic feedback controller may continuously receive haptic feedback data in order to provide continuous haptic feedback. In other words, the method of FIG. 12 may act as a pipeline, with new data continuously being received at step 1202 and processed according to the described method. The haptic data may include world info data (e.g., data about an avatar and/or objects near the avatar within a virtual environment and/or haptic digital twin) and/or haptic effects data, which may be used together to provide detailed information about the haptic state of a virtual environment generated by the application. For example, world info data may include attributes of virtual objects within the environment (e.g., within a threshold distance of a user's avatar). Each virtual object may be associated with certain physical characteristics, which may or may be not represented by the application (e.g., a plugin to the application may store and maintain the attributes, which may be used specifically for haptic feedback). These attributes may describe various characteristics of the object that may be used for generating haptic feedback, such as a compliance or softness of the object, a texture of the object, a weight of the object, etc., along with a unique ID number for lookup purposes. The world info data may further include avatar data describing, for example, objects associated with the avatar, such as fingers of the avatar, a hand of the avatar, etc.

The haptic effects data may include information related to specific haptic interactions within a computer-mediated environment. The haptic feedback data may specify object effects, such as haptic actuation patterns for controlling microfluidic tactile actuators when a user avatar contacts an object (e.g., a first waveform that mimics the feeling of holding a drill that is turned on, a second waveform that mimics other haptic patterns, etc., where the object effect may specify a preset and/or arbitrary waveform). Additionally or alternatively, the haptic feedback data may specify spatial effects that may be activated when the avatar enters a certain control volume (e.g., a waveform that simulates wind from a fan when a user is near a fan, etc.). Additionally or alternatively, the haptic feedback data may specify direct effects that indicate direct pass-through command(s) to a haptic interface (e.g., which may indicate various patterns of activations of haptic feedback actuators, such as tactile actuators).

At 1204, the haptic feedback controller may determine contact information based on the world info data and/or the haptic effects data. For example, the haptic feedback controller may interpret the state of an environment (and/or a haptic digital twin that represents the current state of a telerobot and/or the surrounding environment) and determine any contact information for use in generating haptic feedback. The haptic feedback controller may generate the contact information using several techniques (including any of the techniques described elsewhere herein with respect to the contact interpreter and/or interaction assistant).

In embodiments, the haptic feedback controller may determine contact information based on world info 962 that indicates contact between a user avatar and one or more virtual objects within a virtual environment including the user avatar. Additionally or alternatively, when controlling a haptic digital twin for a telerobot, the haptic feedback controller may determine contact information based on world info 962 for various objects within the haptic digital twin, where the objects may be real objects detected by sensors of the telerobot. The haptic feedback controller may determine the contact information (e.g., points of contact and attributes thereof) using various techniques. For example, as described elsewhere herein, the haptic feedback controller (e.g., using a contact interpreter 930) may use the world info to construct a local environment for the avatar (e.g., including the avatar and objects near the avatar within the virtual environment and/or haptic digital twin). Within the local environment, the haptic feedback controller may generate a field of ray traces that originate from a sampling plane associated with the avatar and thereby determine a separation field that measures the distance of variants points on the avatar to one or more objects. Additionally or alternatively, instead of or in addition to using a sampling plane, the haptic feedback controller may generate ray traces from each point of an avatar model that corresponds to a tactile actuator on a corresponding haptic interface device. For example, if a haptic glove has 20 tactile actuators in a particular arrangement on a palm of the glove, then the contact interpreter 930 may generate 20 ray traces on corresponding points of the avatar's palm to determine a distance from each point to a virtual object in order to generate contact information.

In embodiments, the contact interpreter may generate contact information that takes into account one or more haptic attributes of the virtual objects and/or haptic digital twin objects as specified by the world info 962 (e.g., attributes that indicate a compliance or softness of the object, a texture of the object, a weight of the object, etc.). In embodiments, the haptic feedback controller may also generate contact information that indicates an object's temperature, a thermal flux between the object and the avatar (which may depend on distance, a virtual material of the object, a temperature difference between the object and a temperature associated with the avatar, etc.). In these embodiments, the object properties may be generated by a virtual environment (e.g., game or simulation), sensed by a telerobot, predicted using machine learning techniques, and/or the like.

In embodiments, in some cases the haptic feedback controller may generate updated object properties based on the contact and provide the updated object properties back to the application 250. For example, if a user avatar is contacting a “cold” object associated with a low temperature, the temperature of the item may be warmed through the contact with the avatar. In some cases, the application 250 may handle updates to the item properties on its own. Additionally or alternatively, the haptic feedback controller may update the properties and transmit the updated properties to the application.

At 1206, based on the various contact information generated based on world info 962 and/or based on various haptic effects 964, the haptic feedback controller may calculate an amount of deformation to be applied as haptic feedback at particular locations for a particular time and compile such information into a haptic frame, as well as any force feedback that may be applied to force feedback actuators. The amount of deformation may be measured using a distance metric (e.g., in millimeters) that is hardware-agnostic (e.g., it may not comprise specific units of pressure or instructions to provide the specified amount of pressure to a specific actuator). Thus, for example, the haptic frame may specify an ideal amount and/or type of haptic feedback that may be later translated into a specific set of actuation commands that may be used to simulate the ideal haptic feedback.

In embodiments, the haptic frame may specify deformations for the one or more points associated with the various ray traces used to determine contact information. The haptic feedback controller may determine the amount of deformation based on a distance to a virtual object (e.g., as indicated by the length of the ray trace), where the distance may be a negative distance (e.g., indicating that the object is in contact with the avatar and thus should be deforming the avatar). The haptic feedback controller may further determine the amount of deformation based on the attributes indicating, for example, a stiffness or softness of the virtual object, texture of the virtual object, etc. (e.g., where contact a more compliant virtual object may produce less deformation, etc.). In embodiments, the deformations may be calculated using any of the techniques described with respect to the contact interpreter 930 and/or interaction assistant 920 (e.g., soft-body deformation, use of an on-board physics engine, etc.).

In embodiments, the haptic feedback controller may modify the deformation amounts based on one or more haptic effects. As discussed above, some of the haptic effects may be associated with time-varying waveforms, such as sine waves, square waves, etc. In these examples, the haptic feedback controller may add or subtract different amounts of deformation to different time-based haptic frames in a series of haptic frames as indicated by the waveforms. For example, to simulate a square wave (e.g., which may simulate the feeling of holding a drill that is turned on), the haptic feedback controller may increase the amount of deformation applied to certain haptic feedback points for a first period of time, then reduce the amount of deformation applies to the haptic feedback points for a second period, increase the deformation for a third period, and so on.

In some examples, certain haptic feedback points are not in contact with any virtual objects, but are associated with a spatial effect (e.g., a “wind” spatial effect). In these examples, the haptic feedback controller may use the waveform associated with the spatial effect to determine a displacement distance for each of the points. In some examples, certain haptic feedback points are associated with deformations (e.g., due to simulated contact with a virtual objects) as well as an object effect (e.g., as in the example where the avatar's hand is holding a virtual drill object that is turned on). In these examples, the haptic feedback controller may use the waveform associated with the object effect to temporarily increase the displacement distance that simulates the contact to further simulate the object effect. In other words, the displacement that simulates an object effect may be added to the displacement that simulates contact (at least for some of the time-based haptic frames).

In some cases, a displacement that simulates a contact for a particular point may already be “maxed out” (e.g., the displacement is beyond a threshold distance that would cause a maximum haptic feedback to be applied). In these cases, to further simulate a haptic effect, the displacement that simulates the contact may be reduced prior to adding the displacement that simulates the object effect. In other words, the contact displacement may be reduced enough so that it can be temporarily increased and then decreased following an object effect waveform. Other similar strategies may be used; thus, the contact displacement and the haptic effects displacement may be combined using calculations other than simple addition (e.g., the combination may be akin to using a compression filter).

In embodiments, the haptic frame may further include an indication of thermal flux for any or all of the contact points. Thus, the haptic feedback controller may generate a haptic frame that includes, for each contact point, a displacement and/or a thermal flux.

In embodiments, the haptic feedback controller may calculate brake and/or other force feedback behavior based on contact information and/or object attributes, and add the brake and/or other force feedback behavior to the haptic frame. For example, if an avatar's hand is holding a virtual object associated with a high stiffness attribute (e.g., a billiards ball), the haptic feedback controller may generate a value indicating a maximum braking resistance for each finger in contact with the object (e.g., to prevent the user from further flexing their fingers and thereby simulate the feel of holding a billiards ball). As another example, if an avatar's hand is holding a virtual object associated with a high compliance attribute (e.g., a plush toy), the haptic feedback controller may generate a value indicating a lesser amount of braking resistance to accurately simulate the feel of holding the object. In some cases, the haptic feedback controller may generate active force feedback based on object properties (e.g., to simulate the active opposing force vector created by applying force to a spring or rubber ball, for example) and/or the movement of virtual objects into the user (e.g., if a virtual object collides with the avatar or otherwise applies force to the avatar). As discussed elsewhere herein, the haptic feedback controller may limit the force feedback based on various user preferences, safety and governance standards, and/or using other techniques to prevent discomfort or injury to the user of the wearable haptic interface. Furthermore, although some of the examples described above refer to haptic feedback to actuators (e.g., tactile actuators and/or brakes) of a haptic glove, the haptic frame may specify ideal haptic feedback for any part of a user's body associated with a haptic interface (e.g., hands, limbs, torso, etc.).

At 1208, the haptic feedback controller may translate the haptic frame into a hardware-specific actuator frame that indicates the type of feedback that may be applied based on the actuator configuration of the haptic interface units. For example, if the haptic interface unit comprises a number of microfluidic tactile actuators that can be pressurized within a minimum and maximum range, the haptic feedback controller may generate an actuator frame specifying the amount of pressure applied to each actuator based on a corresponding displacement distance of the haptic frame. Additionally or alternatively, if the microfluidics tactile actuators use varying-temperature fluids to provide thermal feedback, the haptic feedback controller may generate an indicator of a mixture amount of various temperature fluids (e.g., hot, cold, and/or room-temperature fluids) to simulate a particular thermal flux. Additionally or alternatively, if the haptic interface device includes brakes and/or other force feedback actuators, the haptic feedback controller may generate amounts of braking (e.g., a percent resistance) and/or other force feedback (e.g., a force feedback vector and/or offset specifying a direction and/or location that may be used to apply force feedback). The haptic feedback controller may use a “peripheral” database that models the behavior of each haptic interface device (e.g., a left glove, a right glove, other components of an exoskeleton, etc.) for this purpose. For example, the database may specify, for each haptic interface device, the number and type of actuators, the minimum and maximum amount of pressure that may be applied to each actuator, an amount of thermal flux that may be simulated using the actuator, amounts of force feedback available, and/or the like.

At 1210, the haptic feedback controller may generate individual actuator commands for specific actuators based on the actuator frame and, at 1212, transmit the actuator commands to actuator controls (e.g., a microfluidics control unit that provide microfluid to a plurality of tactile actuators, a controller for each actuator, etc.). The haptic feedback controller may continuously transmit commands based on time-based haptic frames and corresponding actuator frames as they are generated, thereby providing continuous haptic feedback that simulates interactions with virtual objects.

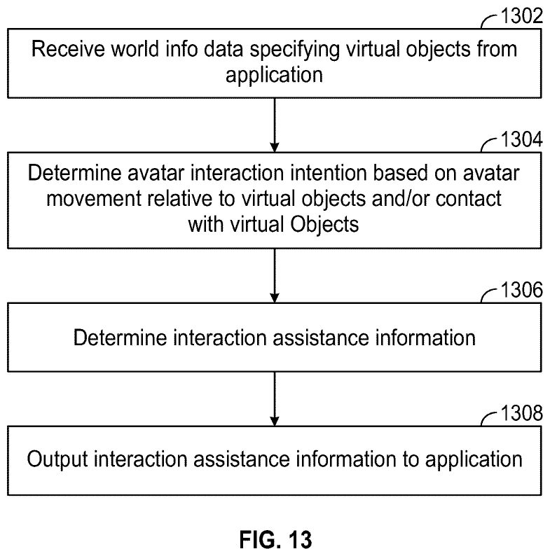

FIG. 13 illustrates an example method for implementing interaction detection and assistance feedback based on avatar and/or world information that is received from an application. For example, the method may detect a grasp intent and implement grasp assistance (e.g., by adjusting one or more physics properties of a computer-mediated environment to allow the user's avatar to more easily maintain a grasp of a virtual object with an environment). Other such interaction assistance may include assistance in engaging with a virtual user interface that exists with a simulated environment and/or the like. The functions shown in FIG. 13 may be implemented by the same API that implements the method of FIGS. 11-12. As described above, the API may provide a computer-mediated interface between a haptic interface device and a virtual environment and/or telerobot. In embodiments, the various functions of FIG. 13 may be implemented by an SDK that may integrate with a haptic system application 250 (e.g., a game engine SDK or plugin for a game application). Additionally or alternatively, the method may be implemented by the application 250 itself (e.g., as a module or plugin of the application 250). Additionally or alternatively, the method may be implemented by a device onboard the wearable haptic interface 330 and/or components thereof. In the descriptions below, the method steps are performed by an interaction assistant of the API 244, which may execute on a device that runs the application 250 and/or a separate device. It should be understood that the method and the functions thereof may be implemented at various hardware devices and/or sub-systems thereof.

At 1302, the interaction assistant may receive world information 962, which may comprise data that is indicative of the structure, location, and/or other properties of objects within an environment generated by an application 250. The world information 962 may further include information about an avatar within the environment (e.g., a position and/or orientation of the avatar). Additionally or alternatively, the interaction assistant may receive information about the avatar in the form of one or more kinematic frames generated by a kinematic frame generator 910, as described elsewhere herein. For example, the kinematic frames may indicate one or more positions and/or orientations associated with an avatar.

At 1304, the interaction assistant may determine an avatar interaction intention with one or more of the virtual objects as indicated by the world information 962. For example, if the avatar information indicates that at least two fingers of the avatar are moving inwards towards a virtual object in between the fingers (e.g., as in a grasp) and/or contacting the virtual object, the interaction assistant may detect a grasp intent. Other similar interactions, such as contacting objects at one or more locations, pushing virtual buttons, turning virtual knobs or controls, throwing virtual objects, or performing other movements in relation to virtual objects and/or contact with the virtual objects may be detected by the interaction assistant in similar ways (e.g., based on the movement of the avatar with respect to the virtual objects and/or contacts with the virtual objects). In embodiments, as described above, one or more AI-assisted and/or machine learning models may be used to detect one or more interaction intents, such as a grasp intent.

At 1306, the interaction assistant may determine interaction data 960 comprising one or more instructions for modifying the environment generated by the application in order to assist the detected interaction. For example, for a grasp interaction, as described elsewhere herein, the interaction assistant may include contact dampening, increasing friction or similar physics parameters to make the grasp easier to maintain, and/or affixing the grasped object to the avatar. For other similar interactions, other physics parameters and/or environment parameters may be modified in appropriate ways.

In embodiments, the instructions may include instructions for modifying the positioning of an avatar, such as using a spring force to pull a part of an avatar (e.g., a hand) into a position that is compatible with the virtual environment (e.g., moving the hand so that it is resting on the surface of a wall or other surface that the hand would otherwise intersect with). In these embodiments, the interaction assistant may output avatar configuration instructions to a kinematic frame generator 910 and/or a directly to the application 250 to cause modification of the positioning of the avatar.

At 1308, the interaction assistant may output the interaction assistance information to the application. For example, the interaction assistant may transmit instruction(s) as interaction data 960 to the application 250, which may cause the application 250 to modify the virtual environment to assist the interaction (e.g., via contact dampening, adjustment of other physics properties, attachment of virtual objects to the avatar, movement of virtual objects, movement of parts of the avatar, and/or the like).

The immersive haptic system 302 and/or API 244 may have additional features and functionalities. For example, in embodiments the immersive haptic system 302 and/or API 244 may be configured to identify and/or predict hazard characteristics implied by interactions within an environment that contains an avatar of the user of a wearable haptic interface. This functionality may be used for governance, training, and/or injury avoidance associated with wearable device limitations. In these embodiments, the immersive haptic system may handle the physics-based calculations for the environment and may determine one or more predefined hazard output states, wherein the output state includes one or more predetermined haptic hazard warnings that are translated to the user.

Additionally or alternatively, the immersive haptic system and/or API may be specifically configured to simulate one or more medical environments that contain an avatar of the user of a wearable haptic interface and soft objects representing the subject of a medical procedure. For example, a training environment may be configured to simulate a surgery for training a surgeon. In this example use case, the training environment may be configured to include haptics that are designed to vary by tissue type, position, and/or the like, and that may be based on digital data such as CT, MRI, or other scans. Moreover, the environment may provide real-time feedback for actual procedures. Additionally or alternatively, the environment may use machine learning and/or expert training to improve various models. In these embodiments, the immersive haptic system/API may handle the physics-based calculations for the environment and may determine one or more predefined haptic output states that are translated to the user.

Additionally or alternatively, the immersive haptic system/API may be specifically configured to identify and/or predict wearable user health characteristics implied by avatar interactions within an environment. Identified and/or analyzed aspects of the user's health may include a range of motion detected based on user movements, an amount of force that the user is capable of generating with various limbs/muscle groups (e.g., in short bursts or over time), an overall fitness of the user based on an amount of activity over a period of time, and/or the like. In these embodiments, the immersive haptic system/API may handle the physics-based calculations for the environment and may determine one or more predefined health notification output states. The output states may include one or more predetermined outputs such as haptic health warnings, automated haptic parameter adjustments, and the like.

Additionally or alternatively, the immersive haptic system and/or API may be specifically configured to identify soft objects within a computer-mediated environment. In these embodiments, the immersive haptic system/API may handle the physics-based calculations for the environment and object and may determine one or more predefined haptic outputs associated with that object that are conveyed to the wearable user.

Returning to FIG. 1, in embodiments, the operation of the haptic system application, SDK 242 and/or API 244, wearable haptic interface 330, and other components of haptic interface system 230 may be monitored by the haptic operating platform 160. The haptic operating platform 160 may monitor 222 and analyze 224 the data received from the haptic interface systems 230 using one or more configured intelligence services 204, as discussed elsewhere herein. In embodiments, the analytics may involve any of the data described herein, including motion capture data, interaction data, and/or haptic feedback data generated by the API 244, in various contexts including training environments and scenarios, gaming, telerobotics, and other contexts described herein. The analytics may involve governance, standards, and/or other approved evaluation methods.

As one example of monitoring and analytics, the haptic operating platform 160 may be configured to score a user's performance in a training task, such as a user's performance in a medical simulation, a piloting/driving simulation, and/or the like. Additionally or alternatively, the scoring tasks may be carried out by the haptic system application 250 and/or some other component of an immersive haptic system 302.

As another example of monitoring and analytics, the haptic operating platform 160 may be configured to gather user data for a user of the wearable haptic interface 330 or other user devices described herein to analyze and optimize haptic parameter settings for the user. Thus, for example, any data stored in a user profile 312 may be determined either explicitly or implicitly by the haptic operating platform 160 based on monitoring and analyzing a user's interactions with the haptic systems described herein. In embodiments, a predefined set of environments, scenarios, and associated haptic cues that are designed to gather wearable user data may be used to obtain the necessary data for explicitly or implicitly defining a user profile 312.

Accordingly, an immersive haptic system may have an analytics system designed to analyze, report, and visualize the results of haptics-based training environments and scenarios.

In embodiments, an immersive haptic system may have a series of predefined environments, scenarios, and associated haptic cues that are designed to gather wearable user data, wherein the data is analyzed to identify and implement user-specific optimized haptic parameter settings.

In embodiments, an immersive haptic system may have an analytics system that automatically monitors, detects, predicts, and reports on a set of conditions of a haptic user interface device system. For example, the analytics system may generate reports for safety reasons and/or for fleet management.

Returning to FIG. 8, in embodiments the networked immersive haptic systems 302, wearable haptic interface 330, and/or external resources 808 may be part of a multi-user haptic system. The multi-user haptic system may include multiple immersive haptic systems, such as immersive haptic system 302A, immersive haptic system 302B, and/or other immersive haptic systems. The multiple immersive haptic systems may be executed by a single device or multiple devices. In embodiments, the multiple immersive haptic systems may share resources. Additionally or alternatively, a single immersive haptic system 302 may be configured to interface with multiple wearable haptic interfaces 330 by simulating multiple user avatars in a computer-mediated environment and providing haptic feedback to multiple users corresponding to one of the multiple user avatars. In some embodiments, haptic feedback may be distributed among multiple devices based on individual user locations within an environment. For example, an event (e.g., an explosion in a gaming or training simulation) near a group of users would provide a range of individual haptic experiences to various users. In multi-user embodiments, it should be noted that different users may optionally have different interfaces with different levels of haptic capability (e.g., VR headset+haptic glove, VR headset+haptic exoskeleton+one or two haptic gloves, etc.). Additionally, some users (e.g., instructors for a training simulation, AI agents, etc.) may interact with the computer-mediate environment without using a haptic interface. Accordingly, the immersive haptic system(s) 302 may tailor the haptic feedback for events or interactions within the computer-mediated environment to the various users based on any differences in haptic capability and/or whether the users have any haptic capability at all.

In embodiments, multiple wearable haptic interfaces 330 may be connected via peer-to-peer networks such that at least one of the haptic interface devices provides sensory feedback data intended for another haptic interface device to the other haptic interface device.

In embodiments, the external resources 808 may include a configuration system that may configure one or more immersive haptic systems and/or a plurality of haptic interface devices using a set of parameters, governance libraries, policies, and other/or configuration data. For example, the configuration system may configure the wearable haptic interface using data from user profile(s) 312 for respective users of the wearable haptic interface, may configure each wearable haptic interface 330 with libraries that are specific to a haptic system application, and/or the like. The configuration system may also perform fleet configurations that include sets of parameters, governance, policies, scenarios, etc. for a specific task, scenario, and/or the like. Additionally or alternatively, the configuration system may configure a network 810 that connects the plurality of wearable haptic interfaces 330 (e.g., by configuring various network protocols, topologies, routing rules, routing priorities, and/or the like).

Accordingly, a multi-user haptic system may have an immersive haptic system that executes a multi-user simulation of an environment and interfaces with multiple wearable haptic interfaces. The immersive haptic system may determine a respective output state corresponding to each respective user. Each respective output state may be translated to provide a respective sensory feedback response that is specific to a respective user based on a state of an avatar of the user within the environment and/or based on the haptic capabilities of the wearable haptic interface 330 (if any) used by the user.

In embodiments, a multi-user haptic system may have an immersive haptic system that executes a multi-user simulation of an environment and determines a respective output state corresponding to each respective user that is translated to provide a respective sensory feedback response that is specific to the respective user. In these embodiments, a plurality of haptic interface devices may be interconnected with a peer-to-peer network such that at least one of the haptic user interface devices provides sensory feedback data intended for another haptic interface device to the other haptic interface device. Additionally or alternatively, a configuration system may configure the immersive haptic system and a plurality of haptic interface devices with a set of parameters, governance libraries, policies, and other/or configuration data. Additionally or alternatively, the configuration system may configure a network that interconnects the immersive haptic system with a plurality of haptic interface devices.

Returning to FIG. 1, the haptic operating platform 160 may be configured to perform various regulatory, governance, and/or compliance automation tasks in conjunction with the operation of various haptic interface systems 230. For example, the haptic operating platform 160 (e.g., using various configured intelligence services 204, which may leverage other haptic operating platform 160 capabilities such as system management components 162, libraries 180, system services 192, etc.) may perform training compliance validation by monitoring the performance of a user inside one or more haptic system applications 250, such as training applications 254. In embodiments, the haptic operating platform 160 may use one or more approved training libraries for a range of applications such as surgical procedures, hazardous material handling, and the like. The libraries may also include libraries for a range of medical, environmental, and/or safety standards and the like. The haptic operating platform 160 may thus be or include a compliance system that may receive tactile and/or motion capture data for a user and/or may analyze the data to validate compliance with a set of tests for a training simulation.

In embodiments, the haptic operating platform 160 may be further configured to perform health compliance monitoring (e.g., using various configured intelligence services 204, which may leverage other haptic operating platform 160 capabilities such as system management components 162, libraries 180, system services 192, etc.). For example, the haptic operating platform 160 may leverage libraries for ergonomic modeling, physical safety limit testing, and the like. Moreover, by monitoring and analyzing sensor data capture by sensors of the various interface devices 232, the haptic operating platform 160 may be configured to monitor, analyze, and report on one or more metrics of user health. Thus, the haptic operating platform 160 may be or include a compliance system that may receive user tactile and/or motion capture data and may analyze the data to validate compliance with safety or other health standards.

In embodiments, the haptic operating platform 160 may be further configured to monitor user data for other reasons, such as for governance reasons (e.g., leveraging governance libraries 188). Additionally or alternatively, the haptic operating platform 160 may be further configured to validate compliance with governance standards, such as safety standards, haptic feedback limits, and/or the like. For example, the haptic operating platform 160 may be configured to receive data generated by an immersive haptic system 302 and/or by a wearable haptic interface 330 (e.g., sensor data, motion data, location data, biometric data, etc.), analyze the data to monitor and/or validate compliance with safety standards, such as by monitoring and/or reducing amounts of haptic feedback, monitoring and/or limiting force feedback to certain ranges of motion, monitoring and/or prohibiting display of certain content (e.g., rapidly-flashing images), and/or otherwise monitoring, validating, and/or enforcing compliance with governance standards.

Accordingly, an immersive haptic system/platform may be configured to execute a series of approved predefined environments, scenarios, and associated haptic cues that are executed in connection with a training simulation. The system/platform may further include a compliance system that may receive data captured from a wearable user interface worn by a user and/or data captured from an immersive haptic system and that may analyze the captured data to validate compliance with a set of tests relating to the training simulation. For example, a haptic operating platform 160 may be configured to receive sensor data, motion data, location data, haptic feedback data, biometric data, and/or the like and analyze the data to monitor and/or validate compliance with various tests. In embodiments, the tests may require specific reactions, performance of specific movements, and/or the like. Additionally or alternatively, the tests may require certain states to be achieved in a haptic system application 250 (e.g., the user causes the user avatar to move to a certain position, achieve a certain goal within the application, etc.). Accordingly, the haptic operating platform 160 may monitor and validate compliance based on both immersive haptic system data as well as data received from a wearable haptic interface.

In embodiments, an immersive haptic system/platform may be configured to execute a series of approved predefined environments, scenarios, and associated haptic cues that are executed in connection with a safety training simulation. In these embodiments, the system/platform may further include a compliance system that may data captured from a wearable user interface worn by a user and/or data captured from an immersive haptic system and that may analyze the captured data to validate compliance with a set of safety standards. For example, the haptic operating platform 160 may be configured to receive sensor data, motion data, location data, haptic feedback data, biometric data, and/or the like and analyze the data to monitor and/or validate compliance with safety standards. In embodiments, the standards may specify haptic feedback limits, range of motion limits, other force feedback limits, thermal limits, audio volume limits, vision limits, and/or the like.

In embodiments, an immersive haptic system/platform may be configured to execute a series of approved predefined environments, scenarios, and associated haptic cues that are executed in connection with a training simulation. In these embodiments, the platform may further include a compliance system that may receive data captured from a wearable user interface worn by a user and/or data captured from an immersive haptic system and that may analyze the captured data to validate compliance with a set of regulatory and/or governance standards. For example, the haptic operating platform 160 may be configured to receive sensor data, motion data, location data, haptic feedback data, biometric data, and/or the like and analyze the data to monitor and/or validate compliance with various regulatory and/or governance standards. In embodiments, the standards may prohibit and/or require certain actions, prohibit and/or require certain interactions with other users, prohibit certain unsafe conditions, and/or the like. Additionally or alternatively, the tests may require certain states to be achieved in a haptic system application 250.

In embodiments, an immersive haptic system/platform may be configured to execute a series of predefined environments, scenarios, and associated haptic cues that are designed to gather user health data from a wearable haptic human interface. In these embodiments, the platform may further include a monitoring system that may monitor a set of conditions of the user to ensure compliance with regulatory and governance standards associated with wearable haptic human interface. Additionally or alternatively, the monitoring system may monitor a set of conditions of the user to ensure the haptic interface is being used safely.

In some embodiments, a haptic operating platform 160 may be configured to provide and recommend different experiences to a user and to detect various user preferences to customize and optimize an immersive environment for a user. For example, the haptic operating platform 160 may maintain one or more libraries 180 that may be used to provide various experiences via the one or more haptic system applications 250. In one example, various libraries provided by the haptic operating platform 160 may configure a training application 254 to provide different simulation experiences. In example embodiments, the simulation experiences include a variety of predefined simulation experiences that each include a respective environment, one or more scenarios, and one or more associated haptic cues relating to the experience.

In embodiments, the haptic operating platform 160 may be or include a recommendation system (e.g., using recommendation engine 210) that may recommend one or more of the predefined simulation experiences to a user based on a set of learned preferences of the user. The learned preferences may include, for example, objects or entities that a user is observed to interact with in one or more simulation experiences (including, in some cases, other users of a multi-user simulation), types of interactions that the user frequently engages in, an observed health status of the user, and/or other observed user preferences.

Moreover, in embodiments the haptic operating platform 160 may include a preferences system (e.g., using a personalization module/component 170) that is configured to learn a set of haptic feedback preferences of the user based on user status data provided by a wearable haptic interface. For example, the status data may be provided in response to the user experiencing scenarios and associated haptic cues within the environment and may indicate whether the user enjoys certain scenarios or haptic cues, frequently interacts with certain scenarios or haptic cues, and/or the like. The preferences system may be used to generate data for a user profile 312 and/or to recommend other experiences/scenarios to a user (e.g., using a recommendation system).

Accordingly, an immersive haptic platform may have an immersive haptic system that may be configured to execute simulations that are designed to provide a user wearing a wearable haptic human interface with a multi-sensory experience with respect to an environment. The platform may further include an experience library that maintains a set of different predefined simulation experiences that each include a respective environment, one or more scenarios, and one or more associated haptic cues relating to the experience. Additionally or alternatively, the platform may include a recommendation system that recommends one or more of the predefined simulation experiences to a user based on a set of learned preferences of the user. Additionally or alternatively, the platform may include a preferences system that may learn a set of haptic feedback preferences of the user based on user status data provided by the wearable haptic human interface in response to the user experiencing scenarios and associated haptic cues within the environment. For example, the platform may detect a negative response to certain haptic feedback (e.g., amounts of force/thermal feedback above a certain limit, force feedback applied when a user is extending a limb in a certain direction, etc.), as detected by biometric sensors (e.g., perspiration sensors, eye sensors, audio sensors for picking up voice cues, etc.), by a user avoiding certain situations and/or locations within an environment, and/or the like. In embodiments, the platform may then analyze the negative responses over time (e.g., using one or more AI techniques and/or machine learning models) to determine the user haptic preferences and later use the user haptic preferences to adjust haptic feedback.

In embodiments, the SDK 242 (e.g., including the API 244 and/or a haptic application plugin 246) may be configured to allow integration of third-party content into one or more haptic system applications 250. For example, an SDK 242 may be configured to receive third-party content from a haptic operating platform 160 and/or from some other computing device. The SDK 242 may facilitate the integration of the third-party content into one or more environments (e.g., by providing a haptic application plugin 246 for an immersive haptic system 302). In embodiments, the third-party content may include physical attributes of respective entities in the content such that the immersive haptic system can determine a haptic response corresponding to one or more entities based on the physical attributes thereof in response to the user interacting with the one or more entities in an environment.

In some embodiments, the third-party content may include computer-aided design (CAD) objects. Thus, for example, a haptic system application 250 may be configured to render and allow a user avatar to interact with virtual buildings, items, and other such CAD objects. Moreover, in some embodiments, the user may be able to virtually edit the CAD objects. An SDK 242 (e.g., using a haptic application plugin 246) may allow third-party CAD objects to be integrated into the haptic system application 250 and rendered therein such that the user can interact with objects and receive haptic feedback relating to the interactions. Moreover, the user may be able to change the CAD objects, and the SDK 242 may cause the changes to be transmitted to a third-party content repository. In embodiments, the third-party CAD objects may include physical attributes that may be used in generating a haptic feedback response. In embodiments, the physical attributes may include the density of objects, the texture of objects, the malleability of objects, and/or the like.

Accordingly, an immersive haptic platform may have an immersive haptic system that is configured to execute a series of predefined environments, scenarios, and associated haptic cues that are designed to provide a user wearing a wearable haptic human interface with a multi-sensory experience with respect to the environment. The platform may further include an SDK that facilitates integration of third-party content into one or more environments. The third-party content may include physical attributes of respective entities represented in the content such that the immersive haptic system can determine a haptic response corresponding to one or more entities based on the physical attributes thereof in response to the user interacting with the one or more entities in an environment. In some embodiments, the third-party content may include CAD objects that include a set of physical attributes of a respective entity represented by the CAD object such that the immersive haptic system can determine a haptic response corresponding to the CAD object based on the physical attributes thereof in response to the user interacting with the respective CAD object in a computer-mediated environment.

In embodiments, user profiles 312 may be used to customize motion capture operations. For example, a slip compensator 906 and/or touch compensator 908 may use user profile 312 data indicating dimensions of a user's body, hands, etc. in order to better determine when slip or touch compensation is needed. Similarly, motion processors 904 may use measured, estimated, or provided data about a user's hand size, arm length, leg length, height, etc. to estimate a position of one or more user body parts, an angle of one or more joints, and/or the like using the absolute location data 952 and/or relative location data 953 received from sensors.

In embodiments, the API 244 may be configured to estimate various body measurements based on absolute location data 952 and/or relative location data 953 after asking the user to assume different poses or make different motions. For example, by asking or requiring the user to assume a starting pose and then an ending pose, the API 244 may collect location data describing the movement from one to the other and use a model of the relationship connecting certain poses to the positioning of various sensors, brakes (e.g., which may unspool by certain amounts when a user flexes a joint), and the like. In a specific example, the API 244 may use a model of the relationship connecting hand pose to how a brake wheel rotates to measure finger length by recording the change in spool rotation between known postures. A process for measuring the hand in this way may include a user donning a haptic glove 236 and holding their fingers out straight (e.g., a first pose) such that the positions of the brake drums may be recorded. Next, the user may curl their index through pinky fingers as much as possible simultaneously (e.g., a second pose) such that positions of the brake drums at the point of greatest fingertip angle may be recorded. Next, the user may curl their thumb such that a drum position may be recorded at the most extreme thumb tip angle. Then, using a model of how the amount of string drawn via the brake correlates to finger length via tendon guide heights, the API 244 may calculate the lengths of all user fingers, including the thumb. Such a process may then be repeated for the opposite hand. Similar processes may be used to measure the length of user limbs or other body parts.

Returning to FIG. 9, in embodiments, an API 244 may use user profiles 312 in a user profile storage 912 to customize one or more haptic feedback operations of the API 244. Although FIG. 9 illustrates the user profile storage 912 within the API 244, the user profiles may be stored in storage that is separate from the API 244 (e.g., in a different module or different device). For example, when the API 244 detects a contact between the user avatar and an object/entity within the environment, the API 244 may generate haptic feedback data taking into account a set of physical traits of the user. This customized feedback response may be provided for safety reasons (e.g., to avoid providing too much haptic feedback to a user who is injured or impaired in some way), to account for sizing issues of the wearable haptic interface 330, and/or the like. Additionally or alternatively, the API may individualize the haptic feedback based on one or more stimulus response traits of the user. For example, a user profile 312 may indicate that a user is sensitive to certain amounts or forms of haptic feedback such that the haptic feedback should be reduced, or vice versa that a haptic feedback response should be increased for certain types of haptic feedback. Additionally or alternatively, the API may individualize the haptic feedback based on one or more psychographic traits of the user (e.g., whether the user detects, responds, and/or learns from certain types of feedback better than others), preference traits of the user (e.g., explicit settings provided by the user for haptic feedback response), and/or stimulus behavioral traits of the user (e.g., whether the user reacts more to certain types of haptic feedback than others).

Accordingly, a system coordinating haptics in a simulated sensory experience may have an immersive haptic system that may model a set of attributes of a set of objects in an environment and may determine a position of a set of elements of an avatar of a user in the environment based on a state of a haptic interface worn by a user. In these embodiments, in response to detecting that a position of the avatar intersects with a position of an object, the immersive haptic system may output a set of sensory simulation data related to the object. In some of these embodiments, the immersive haptic system may determine an individualized haptic response for the user based on the attributes of the intersected object and a set of physical traits of the user. Additionally or alternatively, the immersive haptic system may determine an individualized haptic response for the user based on the attributes of the intersected object and one or more of a set of stimulus response traits of the user, a set of psychographic traits of the user, a set of preference traits of the user, a set of stimulus behavioral traits of the user, and/or the like.

### Non-Telerobotic Use Cases

The haptic operating platform 160 and/or haptic interface system 230 may be applied to a variety of use cases. These use cases may generally be grouped into telerobotic uses cases (e.g., use cases that involve controlling a remote robot from a distance and/or interacting with a haptic digital twin generated based on data received from the robot) and non-telerobotic uses cases, such as virtual reality applications, non-telerobotic training simulations, non-telerobotic gaming, and/or the like. Within non-telerobotic use cases, the various applications may operate using purely virtual environments (e.g., where the computer-mediated environment is not a digital twin of any real-world environment) and/or AR/MR use cases, where a user may interact with both real objects in the user's environment and simulated objects (e.g., such as where a virtual user interface with virtual controls overlays a real physical object). For example, a user may have a wearable haptic interface 330 that allows the user to move within a real environment (e.g., the user may be wearing a AR/MR headset and haptic gloves 236 that allow the user to move freely without any tethers) that may be enhanced with simulated objects, such that the user can physically interact with the real environment and interact via a simulated environment with the simulated objects using motion capture and haptic feedback.

As described above, the platform and/or interface systems may provide integration of CAD objects into computer-mediated (e.g., VR/AR/MR/XR) environments. For example, an SDK 242 may be configured to interpret CAD objects data and generate object/entity data therefrom in a format that may be used by a haptic system application 250 (e.g., a game engine) to render the CAD object in an environment, allowing a user to virtually observe and interact with the CAD object using a haptic interface, receive haptic feedback based on interactions with the CAD object, and/or the like. For example, such an application may be used to test ergonomics of tools and/or physical interfaces by allowing a user to interact with a CAD object simulating the ergonomics of the tool or physical interface. As a specific example, a user may be able to hold and operate a handheld tool within the environment (e.g., an electronic device such as a laptop or game controller, a construction tool, a firearm, etc.), with the environment providing a realistic sense of weight, tactile feedback when operating physical buttons or other controls, tactile feedback when gripping the tool in various positions, and otherwise allowing ergonomic testing. As a second example, a user may be able to operate a simulated driver's or pilot's interface of a vehicle, with the platform and/or interface allowing a user to sit in a simulated seat (e.g., with an exoskeleton providing force feedback to lock certain actuators, such as magnetorheological actuators or pneumatic actuators, so that the user can sit), providing realistic interaction with a simulated steering wheel or flight yoke, providing tactile feedback for various physical controls, and/or the like. In some of these embodiments, the haptic system application 250 may provide controls for creating and/or editing the tool and/or interface such that the user can easily generate, prototype, and test alternate designs (e.g., such as by moving buttons or controls within the environment, increasing or decreasing the size, resistance, responsiveness, etc. of the physical controls, and/or the like). Additional details concerning control of a vehicular telerobot are provided below.

In embodiments, CAD objects that are interpretable by the SDK 242 may include various properties that may be used to render the CAD object in the environment and that may affect haptic feedback responses generated based on a user avatar interacting with the rendered CAD object. For example, the CAD object may include physical attributes indicating, for example, a type of material used by the object or a component of the object, a surface texture of the object or component of the object, a temperature of the object or component of the object, different states of the object (e.g., on/off for a CAD object representing a machine), various properties associated with different states (e.g., a CAD object representing an item with a motor may generate noise and vibration when in an on status), different interactive components that may be used to adjust the state (e.g., interactive switches or other buttons on the CAD object), and/or the like.

In embodiments, the SDK 242 may further allow integration with mechanical and industrial design tools. For example, the API 244 may receive user inputs (e.g., via a motion capture stack of the API 244) and may use the inputs to create and/or edit the CAD object via a mechanical or industrial design tool. Thus, for example, the SDK 242 may act as a bridge between an environment generated by a haptic system application 250 and a CAD tool, allowing outputs to flow from one to the other to create an immersive CAD interface.

Accordingly, an immersive haptic platform may have an immersive haptic system that is configured to generate a set of environments, scenarios, and associated haptic cues that are designed to provide a user wearing a wearable haptic exoskeleton interface with a multi-sensory experience with respect to the environment. The platform may further include an SDK that may facilitate integration of computer-aided design (CAD) objects into one or more environments. In embodiments, each respective CAD object may model an ergonomic design of an item and may include a set of physical attributes of the item such that the immersive haptic system allows a user wearing the wearable haptic exoskeleton interface to test the ergonomics of the item in an environment, modify any of the attributes or other properties of the CAD object, etc.

In embodiments, the platform and/or interface systems may provide a training environment, such as training for surgical tools, medical or hazardous materials handling, and/or the like. In embodiments, a training application 254 may provide an environment for training in various scenarios and using various haptic cues. Moreover, the training application 254 may be configured using libraries of files that specify data for a specific training application, scenario, and/or environment. In embodiments, the SDK 242 may be configured to receive the libraries (e.g., from a haptic operating platform 160) and provide the libraries to a haptic system application 250 in order to configure the haptic system application 250 to provide the training.

In embodiments, the SDK 242 may provide data to the haptic operating platform 160 on one or more user interactions that take place within the training scenario (e.g., tactile and motion data generated by the API 244 and/or captured from a wearable interface) so that the haptic operating platform 160 may act as a testing system to monitor and report on the training (e.g., using monitoring and reporting 222), score the user's performance in the training (e.g., using analysis 218 to validate a user's compliance with training standards), generate feedback to refine the training scenarios (e.g., using various configured intelligence services 204), and the like.

Accordingly, an immersive haptic platform may have an immersive haptic system that is configured to execute a set of predefined environments, scenarios, and associated haptic cues that are executed in connection with one or more surgical training simulations. In these embodiments, the platform may further include a testing system that analyzes data captured from a wearable user interface worn by a user and/or data captured from an immersive haptic system to validate compliance with a set of standards associated with the surgical training simulations. For example, the testing system may analyze whether a user performed steps in a certain order, whether some or all of a set of assigned tasks were performed, whether any negative outcome states were detected by the simulation (e.g., whether a simulated nerve or artery was damaged), whether the simulated patient achieved a positive outcome, etc.

In embodiments, the immersive haptic platform may have an immersive haptic system that is configured to execute a set of predefined environments, scenarios, and associated haptic cues that are executed in connection with one or more training simulations relating to handling of hazardous materials. In these embodiments, the platform may further include a testing system that analyzes data captured from a wearable user interface worn by a user and/or data captured from an immersive haptic system to validate compliance with a set of standards associated with the handling of the hazardous materials. For example, the testing system may analyze whether a user properly handled the simulated hazardous materials, whether any simulated hazardous materials failed to be contained according to a specified procedure, whether a certain set of assigned tasks were performed in a certain sequence, and/or the like.

In testing embodiments as well as other embodiments, a user's performance may be observed by another user acting as a trainer, helper, or instructor. The trainer/helper/instructor may engage with the immersive simulation using a separate wearable haptic interface, which may be used to control another avatar, thus creating a multi-avatar simulation. Additionally or alternatively, the trainer/helper/instructor may engage with the immersive simulation using a non-haptic interface (e.g., a VR/AR/MR/XR headset, a computing device that renders the environment via an ordinary display, etc.). In some cases, one or more user avatars (e.g., a training avatar) may be controlled by an AI agent. Additionally or alternatively, an avatar may be controlled directly by a human user (e.g., using a wearable haptic interface or otherwise) at some times and by an AI agent at other times.

In embodiments, the platform and/or interface systems may provide immersive VR/AR/MR/XR simulations for various settings that may include enterprise settings (e.g., virtual meetings), retail settings (e.g., virtual shopping), and/or entertainment (e.g., a virtual theme park, theater, event, etc.). Again in these situations, different users may engage using different types of interfaces; for example, some users (e.g., customers) may use a wearable haptic interface 330, whereas other users (e.g., employees, salespeople, helpers, trainers, instructors, etc.) may use other interfaces, leverage AI agents (e.g., at least some of the time), etc.

In embodiments, by providing multi-user simulation capabilities that allow multiple users to interact with each other and with an environment, the platform beneficially allows for highly immersive remote meetings. The haptic platform may use various technologies discussed herein, including avatar rendering based on motion capture, interaction assistance, and/or haptic feedback, among other technologies discuss herein, to provide remote meetings that allow for simulating personal interaction, collaboration on various tasks (e.g., maintenance, document creation and editing, ideation, product assembly and repair, training, provision of customer assistance, and/or the like).

In embodiments, the platform may use the technologies described herein to provide immersive VR/AR/MR/XR simulations that allow businesses (e.g., retail businesses) to provide a range of services to help consumers with repair and maintenance tasks, product evaluation and purchasing decisions, enhanced virtual vacation experiences, etc., and/or other metaverse experiences. Additionally or alternatively, the platform may use the technologies described herein to provide immersive VR/AR/MR/XR simulations that allow for simulated theme park experiences (e.g., simulated roller coaster rides with multiple users, simulated theme park locations, etc.), event experiences, and/or the like. These various simulations and experiences may be provided by configured haptic system applications 250, which may be executed by the immersive haptic system 302.

Accordingly, an immersive haptic platform may have an immersive haptic system that is configured to execute a set of predefined environments, scenarios, and associated haptic cues that are executed in connection with an enterprise setting. In these embodiments, the immersive haptic system may interface with a plurality of haptic interface devices such that users of the haptic interface devices interact virtually in the enterprise setting.

In embodiments, an immersive haptic platform may have an immersive haptic system that is configured to execute a set of predefined environments, scenarios, and associated haptic cues that are executed in connection with a retail setting. In these embodiments, the immersive haptic system may interface with a plurality of wearable haptic interfaces such that users of the wearable haptic interfaces interact virtually with commercial goods in the enterprise setting, such that the immersive haptic system simulates interaction with virtual representations of physical goods. Additionally or alternatively, a haptic operating platform may monitor and/or analyze the interactions between users and the virtual representations of physical goods, for example to detect what goods or types of goods users are drawn to, interact with, frequently purchase, and/or the like. Accordingly, by receiving and analyzing data generated by an immersive simulation of a shopping experience, detailed and high-quality interaction data may be generated and used to improve product experiences, such as product packaging, organization of products, arrangement of shopping spaces, and/or the like.

In embodiments, an immersive simulation platform may have an immersive haptic system that is configured to execute a set of predefined environments, scenarios, and associated haptic cues that are executed in connection with a set of theme park entities. In these embodiments, the immersive haptic system may interface with one or more wearable haptic interfaces such that users of a respective wearable haptic interfaces can select a simulation from a set of predefined simulation themes for the theme park entities.

In embodiments, various haptic kits may be provided for specific industries and use cases. The haptic kits may include hardware items (e.g., one or more interface devices 232) and configured software, such as a configured SDK 242 for use in an immersive haptic system 302, one or more haptic system applications 250, and/or the like. The kits may be targeted to different industries and use cases by providing various haptic system applications 250, corresponding haptic application plugin 246, and/or the like. In embodiments, a purchaser or licensor of the kit may be licensed to interactively select and receive various libraries 180 from a haptic operating platform 160 that may configure one or more haptic system applications 250 to provide various use cases and experiences. Additionally or alternatively, the purchaser or licensor of the kit may be licensed to use monitoring and reporting 222 and/or analysis, feedback, and optimization 224 services provided by the haptic operating platform 160.

Accordingly, an immersive haptic platform may have a software development kit that includes a set of user experience design interfaces by which a user may select, configure and integrate a set of haptic sensory stimulus interactions and a set of environment entity interactions into an immersive multi-sensory simulation experience.

In embodiments, an immersive haptic platform may have a software development kit that includes a set of user experience design interfaces by which a user may select, configure and integrate a set of haptic sensory stimulus interactions and a set of telerobotics interactions into an immersive multi-sensory simulation experience.

### Telerobotic Platform

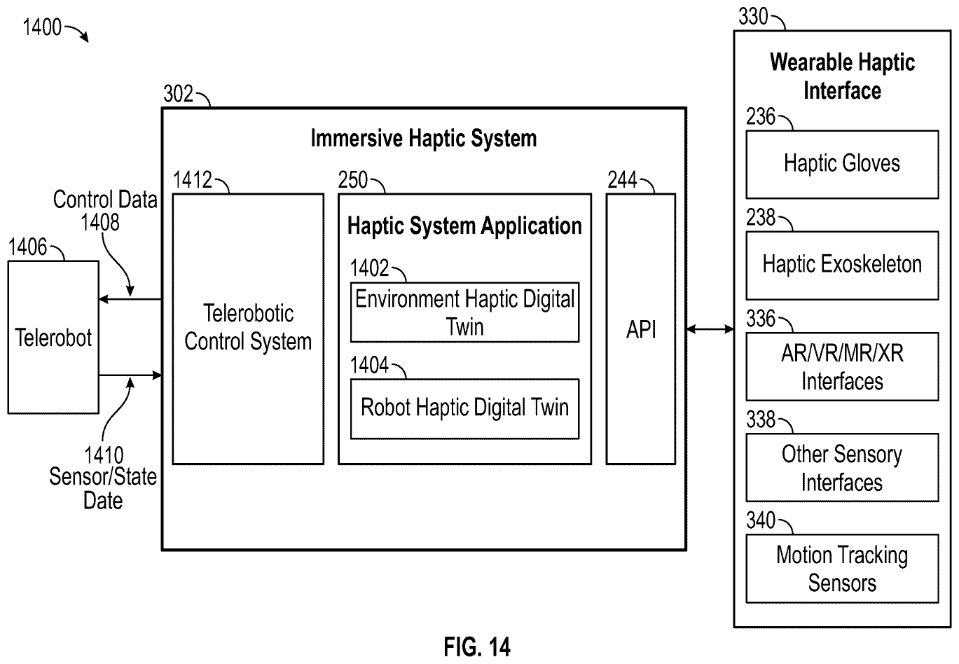

FIG. 14 illustrates an example telerobot platform 1400 in which the wearable haptic interface 330 is used to control a telerobot 1406 and receives haptic feedback based on the sensor data 1410 received from the telerobot 1406. It should be noted that a telerobot platform 1400 may be an example of a whole-body immersion system 300. In other words, the telerobot platform may include the API 244, implement the methods of FIGS. 11-13, etc. In embodiments, the wearable haptic interface 330 may interface with an immersive haptic system 302 running a haptic system application 250 as discussed above. The haptic system application 250 may simulate a state of the telerobot and an environment containing the telerobot using one or more haptic digital twins, such as an environment digital twin 1402 (e.g., a digital twin of the environment that the telerobot is in, which may be pre-stored and/or generated based on sensor/state data 1410 received from the telerobot 1406) and/or a robot digital twin 1404 (e.g., a digital twin of the telerobot 1406 that is synchronized to a current state of the telerobot 1406). In embodiments, a telerobot controls system 1412 may maintain synchronization between the haptic system application 250 and the telerobot 1406 by generating control data 1408 to control the telerobot and by receiving sensor/state data 1410 from the telerobot. Thus, the immersive haptic system 302 may provide a computer-mediated environment for both the telerobot 1406 and a haptic system (such as a wearable system), using various methods, systems and capabilities similar or identical to the ones noted throughout this disclosure. For example, the motion capture capabilities, the SDK 242 and the API 244 may provide for multi-directional translation of motion data among the haptic interface, the telerobot 1406, and the haptic system.

In embodiments, the term “robot” as used herein may refer to robots that are able to move, sense, and/or otherwise interact with a surrounding environment. For example, robots may include a simple single degree of freedom actuator, a stationary robotic arm, a device with legs, wheels, rotors, wings, propulsion systems for moving on the ground, in the air, through water, etc. Additionally or alternatively, the robots may have any number of sensors for sensing a surrounding environment and/or any number of tools or appendages for interacting with a surrounding environment. In specific embodiments, the telerobot may be a vehicle (e.g., a boat, plane, car, etc.) piloted by a user of a wearable haptic interface, may include one or more robotic arms adapted to perform certain tasks (e.g., surgery, industrial tasks, etc.), and/or the like.

In embodiments, a telerobot may be a humanoid robot that may be directly controlled by a user of a wearable haptic interface in at least some situations. For example, a user of the wearable haptic interface may directly control the humanoid robot, such that motion capture inputs are translated (e.g., by a haptic digital twin) into commands that cause the humanoid robot to perform the same motions as the user. At the same time, interactions between the humanoid robot and its surrounding environment may be used (e.g., by the haptic digital twin) to generate haptic feedback to provide a sensory simulation of the interactions for the user. In some embodiments, the humanoid robot may operate autonomously at least part of the time. For example, a user of a wearable haptic interface may directly control/pilot a humanoid robot during a training phase to repeatedly perform a task. The haptic operating platform 160 may gather and store sensor data from the humanoid robot and/or instructions for controlling the humanoid robot during the training phase to create a training data set. The haptic operating platform 160 (e.g., using one or more intelligence services 204) may then train one or more intelligence models to control the humanoid robot to autonomously perform the task using the training data set. Additionally or alternatively, humanoid robots may operate autonomously in some situations but may switch to human-piloted operations in other situations. For example, in some embodiments a fleet of humanoid robots may operate largely autonomously, but human users with wearable haptic interfaces 330 may be able to begin piloting the humanoid robots when needed or desired (e.g., if a robot gets stuck, is unable to perform some task, if an emergency occurs, etc.).

In embodiments, the haptic digital twin may be a computer-mediated environment where at least a subset of the virtual objects or surfaces are generated based at least in part on sensor data received from a telerobot. However, the computer-mediated environment may also include virtual objects that do not correspond to sensor data received from the telerobot (e.g., for AR and/or MR applications). The computer-mediated environment may further include a virtual representation of a telerobot, which may be generated based on a current state of a telerobot (e.g., a detected position, orientation, etc.). Moreover, in some cases, any of the objects or surfaces (e.g., including the telerobot) may be updated based on predicted future behavior. For example, when a haptic application is controlling a telerobot in a remote location, latency issues may cause delays when commanding a telerobot to perform some action. For example, a user of a wearable haptic interface may command a telerobot to move, interact with an object, etc. If the latency is high (e.g., because the telerobot is on another continent, in space, on another planet, etc.), then there may be a delay in receiving sensor data indicating that the telerobot moved, sensor data indicating the results of the interaction, etc. Therefore, the haptic digital twin may compensate for latency by predicting the outcome of an action (e.g., by modeling the robot moving within the environment before receiving sensor data indicating the robot has actually moved, by modeling the robot's interaction with a virtual representation of an object before receiving sensor data indicating the outcome of the real interaction, etc.). Thus, it should be understood that the haptic digital twin may be “scaled” in time with respect to a real environment by predicting a future state of the environment. In these cases, when sensor data indicating the outcome of some movement or interaction is later received, the haptic digital twin may then be reconciled to the actual outcome.

In embodiments, a haptic digital twin may include an avatar controlled by a user of the wearable haptic interface. In some embodiments, the avatar within the computer-mediated environment may correspond to the telerobot, for example by sharing a perspective of the telerobot (e.g., a video feed captured by one or more cameras of the telerobot 1406 may be displayed via an AR/VR/MR/XR interface 336 of the interface 330), by controlling movement of the telerobot based on motion capture inputs received from the wearable haptic interface 330, by providing haptic feedback based on sensor data received from the telerobot, etc. However, in some cases the avatar may be temporarily separated from the telerobot. For example, a user that is “seeing” from the perspective of the telerobot may, in some cases, be able to reposition the avatar's perspective within the environment without causing any corresponding movement of the telerobot. For example, when a telerobot is looking at an object, a user of a wearable haptic interface may use motion capture to control the avatar to “look around” the object in order to see behind it, for example. In these examples, the user may be able to see from differing perspectives because the haptic digital twin may include virtual representations of objects/surfaces that the telerobot has seen before (e.g., even if the telerobot cannot currently see the objects/surfaces) and/or because the immersive haptic system 302 may use machine learning model and/or environment models to predict additional objects/surfaces that are not in view.

Alternatively, an avatar may be fully separated from a telerobot such that a user may use a wearable haptic interface to move the avatar without necessarily moving the telerobot, may interact with objects/surfaces in the environment that the telerobot is not interacting with, etc. For example, a user may control the avatar to move about freely within a computer-mediated environment generated based on data sensed by the telerobot (e.g., a telerobot may be used for generation of a haptic digital twin even if a user is not directly controlling the telerobot). In some of these embodiments, a user may still perform actions that cause the telerobot to perform actions. For example, the user may issue commands that cause the telerobot to move to a particular location with an environment of the telerobot by pointing to a virtual representation of the location within the haptic digital twin and issuing a command (e.g., a gesture command, a voice command, a command issued via a virtual menu interface, etc.). In other cases, the telerobot may move or interact with objects based on the behavior of the user. For example, a telerobot may “follow” a user may moving within an environment such that it can use its sensors to update the haptic digital twin based on where the user moves within the environment.

In some cases, the avatar and/or environment may be scaled with respect to data sensed by the telerobot. For example, virtual objects and/or surfaces that are generated based on real objects/surfaces sensed by the telerobot may be scaled up or down with respect to a user avatar. Thus, for example, a user may be able to experience and interact with a computer-mediated environment at a much smaller or larger scale (e.g., such that the user may view and interact with the environment from the perspective of a giant or at a microscopic level). In one example embodiment, a surgeon may control a scaled-down avatar to move about within a computer-mediated environment containing a virtual representation of real tissue captured by a telerobotic surgical instrument. In this example, the user avatar may be much smaller than the user such that the user can more easily view and interact within a small and/or space-constrained environment. Moreover, the haptic digital twin may include transformations of objects/surfaces sensed by the telerobot. For example, the haptic digital twin may generate a virtual representation of plaque within a blood vessel that is sensed by a telerobot such that the virtual representation has a different color or shape (e.g., the plaque may appear as stalactites that a surgeon may “mine” with a virtual pickaxe, which may instruct the telerobot to perform an operation to remove the plaque at a spot the surgeon mines).

As another example, a haptic digital twin may transform a virtual representation of a real object to allow a user better control over interactions between a telerobot and the real object. For example, if a user is using motion capture to control a telerobot that is much stronger than a human, then a weight or inertia of a virtual representation of an object may be adjusted so that it feels much lighter or easier to move when haptic feedback is provided to the user (thereby allowing the user to experience the increased strength of the telerobot). Continuing the example, the haptic digital twin may also transform a virtual representation of a real object to make it less rigid, thus allowing the user to feel that they can easily damage or warp the object with the strength of the telerobot.

In embodiments, a haptic system application 250 may provide a virtual reality, augmented reality, and/or mixed reality (VR/AR/MR/XR) environment that allows a user to control the telerobot 1406 in real life and/or control the haptic robot digital twin within the environment provided by the haptic environment digital twin 1402. In embodiments, the telerobot 1406 and the robot digital twin 1404 are kept synchronized by a telerobotic control system 1412. Furthermore, the haptic system application 250 may update the digital twin(s) based on user inputs and/or motion capture data received from the wearable haptic interface 330 and may provide haptic feedback based on a state of the digital twin(s) and/or data captured by a respective robot (e.g., motion and/or sensor data captured by the respective robot). The haptic feedback may be generated by the API 244 as discussed elsewhere herein.

In embodiments, a telerobotic platform 1400 may use configured wearable haptic interfaces to 330 to provide more immersive control over the telerobot 1406 and feedback from the telerobot 1406. For example, if the telerobot is a vehicle, the wearable haptic interface 330 may be configured to position the user as if the user were sitting in the driver's seat and/or cockpit of the vehicle. In embodiments, an environment digital twin 1402 and/or a robot digital twin 1404 may simulate a set of real-life controls (e.g., a steering wheel and pedals for a car, a yoke, throttle, pedals etc. for an airplane, and the like) such that the user may rely on muscle memory already developed for controlling a vehicle in real life, develop new muscle memory, and the like. Additionally or alternatively, the haptic system application 250 may simulate alternate controls (e.g., controls that a user may be more accustomed to, such as a different size/shape/type of steering wheel or flight yoke than one provided in a corresponding vehicle or plane).

In embodiments, the immersive haptic system 302 (e.g., via the haptic system application 250 and/or API 244) may be configured to generate haptic or other feedback based on the control data 1408 sent to the telerobot 1406 and/or the sensor/state data 1410 received from the telerobot 1406. For example, if the control data instructs the telerobot 1406 to accelerate rapidly and/or the sensor/state data 1410 indicates the telerobot 1406 is accelerating rapidly, the immersive haptic system 302 may provide haptic feedback simulating the acceleration forces to the wearable haptic interface 330. In another example, if the control data instructs the telerobot 1406 to drill into an object and the sensor data/state data received from the telerobot 1406 indicates that the density of the object changes, the immersive haptic system 302 may provide haptic feedback simulating the change in density. In embodiments, the haptic system application 250 may synchronize one or more digital twins with the state of the telerobot and/or its surroundings in real time to provide immersive control of and feedback from the telerobot 1406.

Accordingly, a telerobotic platform may have a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In these embodiments, the telerobotic immersive haptic system may update a state of the digital twin of the environment in real-time based on user actions detected by the wearable haptic interface and sensor data received from the telerobotic control system.

In embodiments, a telerobot 1406 may have a plurality of sensors including cameras, force sensors, mapping/scanning sensors, location sensors, acceleration sensors, orientation sensors, and other types of sensors that may recognize a surrounding environment of the telerobot 1406 and/or a state of the telerobot 1406. These sensors may be built into the telerobot 1406 and/or may be provided by sensors that are in the environment of the robot (not shown in FIG. 11), such as base stations, networked cameras, IoT devices, and/or the like. In embodiments, the telerobot control system 1412 may process the sensor/state data received from the telerobot (and/or other devices in the environment of the telerobot) and provide the processed data to the haptic system application 250, which may correspondingly update the environment digital twin 1402 and/or robot digital twin 1404. Haptic feedback may then be provided (e.g., by the API 244) based on the environment, robot, or user avatar interfacing with the robot.

In some embodiments, the telerobot 1406 and/or immersive haptic system 302 may use real-time scanning (e.g., laser, white light, etc.) techniques and/or object recognition (artificial intelligence, machine learning, etc.) techniques to accurately map the environment of the telerobot and provide appropriate haptic feedback accordingly. Additionally or alternatively, artificial intelligence and/or machine learning may be applied by the immersive haptic system to generate control data 1408 for semi-autonomously controlling the telerobot 1406.

Accordingly, a telerobotic platform may have a set of digital scanning and image recognition tools that are used to construct digital surfaces and produce and recognize digital facsimiles of real environments and objects within the environment. The digital facsimiles may include associated haptic cues that are conveyed to the wearable user interface.

In embodiments, the immersive haptic system (e.g., the telerobotic control system 1412, haptic system application 250, and/or API 244) may leverage various libraries to improve feedback, reduce processing, provide consistency, facilitate governance, and/or perform other functions. As one example, a library for generating an environment based on scanning data may be leveraged by the haptic system application 250 to construct the environment digital twin. In embodiments, the libraries may be stored and retrieved from a haptic operating platform 160.

Accordingly, a telerobotic platform may have a set of object and environment libraries that directly translate real-world characteristics to haptic cues for a wearable user interface.

In embodiments, the telerobotic platform 1400 may leverage various toolkits to provide direct translation of specific sensor assemblies into appropriate haptic feedback cues. For example, such toolkits may reduce latency and/or certain processing requirements. The toolkit may be leveraged for use with structured and/or known real environments.

Accordingly, a telerobotic platform may have one or more purpose-built sets of remote sensors installed in the robot that may be built to understand and interpret certain environments, objects, and interactions. In these embodiments, haptic cues associated with the environments and objects are provided to the wearable user interface directly without additional processing.

In embodiments, the haptic system application 250 may leverage various libraries or other data collections for various environments, objects within an environment, sensor groupings, etc. to generate and update an environment digital twin 1402 and/or a robot digital twin 1404.

Accordingly, a telerobotic platform may have a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In these embodiments, the telerobotic immersive haptic system may be configured with collections of different digital twin libraries that are used to model the physical properties of the environment and objects depicted within the library. The telerobotic immersive haptic system may further be configured to update a state of the digital twin of the environment in real-time based on user actions detected by the wearable haptic interface, sensor data received from the telerobotic control system, and the digital twin libraries.

In embodiments, a wearable haptic interface 330 may include one or more sensors for receiving voice commands from a user (e.g., microphones) and the immersive haptic system 302 may be configured to interpret the voice commands and use them to update the environment digital twin 1402 and/or robot digital twin 1404 (and therefore the control the synchronized telerobot 1406), adjust operating parameters, adjust a haptic feedback response, or otherwise modify the environment.

Accordingly, a telerobotic platform may have a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In these embodiments, the telerobotic immersive haptic system may update a state of the digital twin of the environment in real-time based on voice-based commands detected by the wearable haptic interface and sensor data received from the telerobotic control system.

In embodiments, the immersive haptic system 302 may be configured (e.g., via the API 244) to interpret certain movements or gestures of the user wearing the wearable haptic interface 330 as commands to take some action, adjust an operating parameter, otherwise update an environment digital twin and/or robot digital twin inside a haptic system application 250.

Accordingly, a telerobotic platform may have a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In these embodiments, the telerobotic system may update a state of the digital twin of the environment in real-time based on gesture-based commands detected by the wearable haptic interface and sensor data received from the telerobotic control system.

In embodiments, various types and combinations of networking technologies may be used to network the telerobot 1406, immersive haptic system 302, and wearable haptic interface 330. In embodiments, a single network may be used to network all of the devices. In other embodiments, different networking technologies may be used to communicate between different combinations of devices/systems (e.g., when a telerobot 1406 is remote from an immersive haptic system 302 and/or wearable haptic interface 330).

In embodiments, any combination of radio frequency (RF) communication hardware and protocols may be used to interconnect the robotic and wearable haptic devices to systems, sensors, processors, other haptic devices and robots, or external networks. Additionally or alternatively, any combination of hard-wired communication hardware and protocols may be used to interconnect robotic and wearable haptic devices to systems, sensors, processors, other haptic devices and robots, or external networks. Additionally or alternatively, any combination of 5G communication hardware and protocols may be used to interconnect robotic and wearable haptic devices to systems, sensors, processors, other haptic devices and robots, or external networks. Additionally or alternatively, any combination of peer and mesh network communication hardware and protocols may be used to interconnect robotic and wearable haptic devices to systems, sensors, processors, other haptic devices and robots, or external networks. Additionally or alternatively, any combination of low-latency network communication hardware and protocols may be used to interconnect robotic and wearable haptic devices to systems, sensors, processors, other haptic devices and robots, or external networks. In embodiments, a low latency networking system may route data among the telerobotic control system, the haptic interface, and the immersive haptic system using a combination of different networks.

Accordingly, a telerobotic platform may have a radio frequency (RF) network that interconnects a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. Additionally or alternatively, the platform may include a fixed networking system that interconnects a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. Additionally or alternatively, the platform may include a 5G/cellular networking system that interconnects a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. Additionally or alternatively, the platform may include a mesh networking system that interconnects a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. Additionally or alternatively, the telerobotic platform may include a low latency networking system that interconnects a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In any of these embodiments, the telerobotic immersive haptic system may update the digital twin of the environment in real-time based on sensor data received from the telerobotic control system and actions taken by the user via the wearable haptic interface.

In embodiments, the telerobotic platform may leverage (alone or in combination) edge processing, data services, specialized processors, and other such networking techniques to optimize both communications and processing tasks to minimize I/O and processing latency for haptic response and associated robotic actions. For example, an intelligence service, purpose-built devices and chips, or other combinations may be used.

Accordingly, a telerobotic platform may have an edge networking system that interconnects a set of IoT devices with a telerobotic control system that controls a device, a telerobotic immersive haptic system that executes a digital twin of an environment of the device, and a haptic interface device that presents the digital twin to a user in a multi-sensory manner and provides a multi-medium user interface for controlling the device via the digital twin. In these embodiments, the telerobotic control system and the IoT devices may provide sensor data indicating a state of the device and/or the environment of the device to the telerobotic immersive haptic system and the telerobotic immersive haptic system may update the digital twin of the environment in real-time based on the sensor data.

In embodiments, the wearable haptic interface 330 may include one or more haptic components that engage a user's hands, torso, full body, etc. (e.g., a haptic exoskeleton 238 and/or haptic gloves 236). Inputs may be received from the haptic exoskeleton 238, processed by a motion capture stack of an API 244, and used to modify an environment digital twin 1402 and/or robot digital twin 1404. A telerobotic control system 1412 may then send control data 1408 to control a telerobot 1406 based on the state of haptic system application 250 and/or inputs from the haptic exoskeleton 238. In embodiments, the immersive haptic system 302 may be integrated into the haptic exoskeleton 238 (e.g., the immersive haptic system 302 may be executed by a computing device attached to the haptic exoskeleton 238).

Accordingly, a wearable haptic exoskeleton may have an interface to a telerobotic control system that controls a robotic device and to a telerobotic immersive haptic system that executes a digital twin of an environment of the robotic device. The exoskeleton may further include a haptic interface system that presents the digital twin to a user in a multi-sensory manner and provides a multi-medium user interface for controlling the robotic device via the digital twin. The exoskeleton may further include a set of tactile haptic actuators that realistically simulate a human touch sensory system as the robotic device interacts with a physical entity. Additionally or alternatively, at least a subset of the actuators of the exoskeleton are large-scale haptic actuators (e.g., magnetorheological actuators) configured to provide force feedback in response to a various forces detected by the robotic device.

In embodiments, the wearable haptic interface 330 may include an AR/VR/MR/XR interface 336 for viewing the environment digital twin and/or video received by sensors of the telerobot and one or more haptic gloves 236 for controlling the telerobot 1406 as described herein throughout.

In embodiments, a wearable haptic glove may have an interface to a telerobotic control system that controls a robotic device, a motion-based user interface for controlling the robotic device, and a set of haptic actuators that realistically simulate a human touch sensory system as the device interacts with a physical entity. In these embodiments, at least a subset of the actuators of the haptic glove are configured to provide force feedback resistance in response to a resistive force being detected by the robotic device.

In embodiments, a telerobotic platform 1400 may be used for robotic process automation. Robotic process automation may refer to a process whereby interactions with objects, machines, systems, or other entities in an environment may be automated by an artificially intelligence (AI) system that may observe human interactions and use the human interactions to train the AI system to perform similar interactions. For example, a human may use the telerobotic platform 1400 to control a robotic arm in an industrial setting (e.g., an assembly line) while an AI system observes the interaction to learn how to operate the robotic arm without human control. The telerobotic platform 1400 provides a tight coupling between the telerobot 1406 and the wearable haptic interface 330, enabling an AI system (e.g., part of an immersive haptic system 302 and/or a haptic operating platform 160) to learn how to autonomously or semi-autonomously operate the telerobot 1406. For example, the robotic system sensors and vision systems may operate with the intelligence system to identify objects, environments, etc. and to define appropriate haptic cues for virtual interaction with identified elements. Moreover, the human-provided operating inputs may be correlated with success metrics as part of a machine learning and/or training system. The trained model/system may enable an autonomous operation that may require limited or no user direction. In embodiments, the system may operate autonomously or semi-autonomously while still providing haptic feedback to a user wearing a wearable haptic interface 330 (e.g., such that the user may take over when necessary). In embodiments, the artificial intelligence functions may be performed by one or more configured intelligence functions 206 of the haptic operating platform 160.

Accordingly, a telerobotic platform may have a machine-learning component that monitors user actions via a wearable haptic human interface device that presents a digital twin of an environment of a telerobotic-controlled device via a multi-medium user interface for controlling the device via the digital twin of the environment and that outputs multi-sensory feedback responses based on output received from the digital twin. In these embodiments, the machine-learning component may train a robotic agent based on outcome data sets that respectively indicate a state of the device and/or a proximate environment of the device, a user actions performed by the user in response to the state, and a corresponding outcome of the user action.

In embodiments, the addition of a real physical system (e.g., the telerobot 1406 and its environment) into the haptic experience loop may be improved by using a high-rate physics system incorporated into the telerobot 1406 (or the immersive haptic system 302) that can be directly coupled or otherwise integrated with the haptic physics engine to produce the corresponding haptic cues with minimum latency.

Accordingly, a telerobotic platform may have a telerobotic control system that controls a device based on multi-medium input provided by a user via a wearable haptic interface. In embodiments, the telerobotic platform may include a high update-rate physics system that interfaces with a high update-rate haptic physics engine to produce the corresponding haptic cues that correspond to sensor data collected by the telerobotic control system with minimum latency.

In embodiments, the telerobotic platform 1400 may be configured for a variety of different use cases. In embodiments, libraries may be provided to the telerobotic platform (e.g., from the haptic operating platform 160) to configure the immersive haptic system 302 for different use cases. For example, the libraries may configure the telerobotic control system 1412 to interface with a variety of different types of robots, to receive and interpret data from a variety of different types of sensors, to use various protocols, etc. Additionally or alternatively, different haptic system applications 250 may be used to configure the immersive haptic system 302 to build/update/maintain different types of digital twins for different use cases. Additionally or alternatively, different pre-generated digital twins may be used to configure the immersive haptic system 302. Additionally or alternatively, an SDK 242 and/or an API 244 with different functionalities may be used to configure the immersive haptic system 302. In embodiments, data may be supplied by the haptic operating platform 160 to a telerobotic platform 1400 upon request depending on a use case associated with a telerobotic platform 1400.

In embodiments, a telerobotic platform 1400 may be used for remote maintenance. For example, an immersive haptic system 302 may be configured to interface with telerobots 1406 used for remote maintenance, to read and interpret diagnostics data taken by the telerobot 1406 (e.g., using sensors data captured by the telerobot, analyzing images taken by the telerobot 1406 to identify various conditions, etc.), to control the telerobot 1406 to carry out standardized maintenance actions of one or more maintenance workflows (e.g., automatically or upon request), and/or the like.

In embodiments, a telerobot platform 1400 may be used for combat or perimeter security workflows. For example, an immersive haptic system 302 may be configured to interface with telerobots 1406 to automatically analyze and identify potential threats (e.g., by analyzing images taken by the telerobot 1406), to perform patrols of scheduled areas or surveillance of particular areas, to interface with security systems, and/or the like.

In embodiments, a telerobot platform 1400 may be used for manufacturing workflows. For example, an immersive haptic system 302 may be configured to operate within an assembly line, maintain a telerobot 1406 in compliance with safety and other governance requirements, perform various standardized manufacturing actions, and/or the like.

In embodiments, a telerobot platform 1400 may be used for hazardous material handling workflows. For example, an immersive haptic system 302 may be configured to interpret data from hazardous materials sensors, maintain a telerobot 1406 in compliance with safety and other governance requirements, perform various hazardous materials handling actions, and/or the like. Hazardous materials handling may particularly benefit from remote supervision, piloting, and/or control of telerobots, including human robots, described in more detail above.

In embodiments, a telerobot platform 1400 may be used for first responder workflows. For example, an immersive haptic system 302 may be configured to receive and interpret health data from medical sensors and equipment, identify and prioritize potential response actions, perform various medical treatments, and/or the like.

Accordingly, a telerobotic platform may have a set of remote, immersive AR/VR interfaces and a set of wearable haptic interfaces to a telerobotic system. The haptic interfaces may include a set of actuators that simulate a set of fine motor or large-motor sensory experiences. Additionally or alternatively, the haptic interfaces may include a set of actuators that simulate a set of fine motor or large-motor sensory experiences for a set of remote maintenance workflows. Additionally or alternatively, the haptic interfaces may include a set of actuators that simulate a set of fine motor or large-motor sensory experiences for a set of combat or perimeter security workflows. Additionally or alternatively, the haptic interfaces may include a set of actuators that simulate a set of fine motor or large-motor sensory experiences for a set of manufacturing workflows. Additionally or alternatively, the haptic interfaces may include a set of actuators that simulate a set of fine motor or large-motor sensory experiences for a set of hazardous material handling workflows. Additionally or alternatively, the haptic interfaces may include a set of actuators that simulate a set of fine motor or large-motor sensory experiences for a set of first responder workflows.

### Whole-Body Haptic Interface

A whole-body haptic device 2000, which may be an example embodiment of a whole-body haptic interface 234, is described below. The whole-body haptic device 2000 may be used as (or instead of) a wearable haptic interface 330, wearable haptic glove 236, wearable haptic exoskeleton 238, and/or any other haptic interface described above.

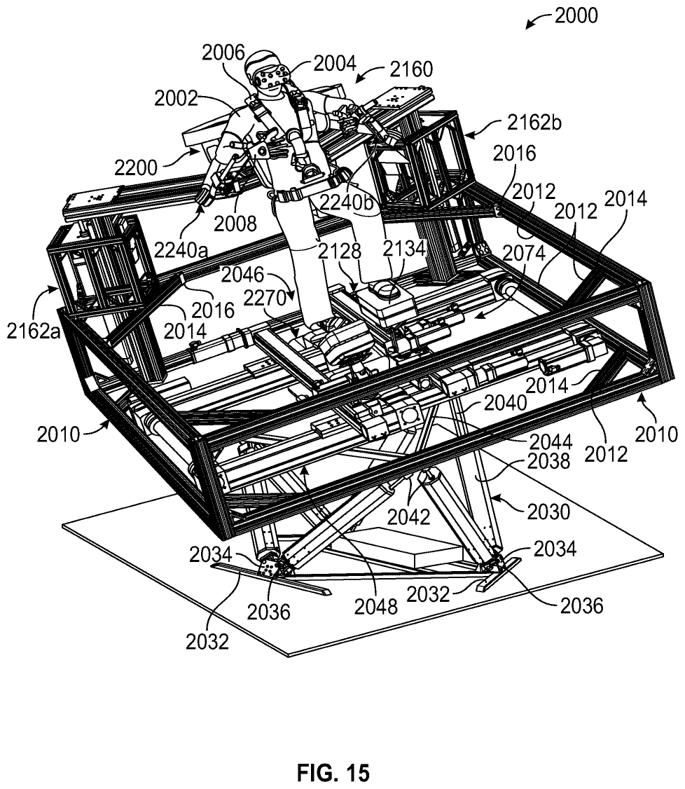

FIG. 15 shows a whole-body haptic device 2000 (may also be referred to as a whole-body haptic system 2000 or a full-body haptic system or device) in accordance with an example embodiment. To better illustrate the motion of the various degrees of freedom of the example embodiment of FIG. 15, the whole-body haptic device 2000 may be configured in an exemplary pose demonstrating operation of a simulated vehicle by a user 2002.

In example embodiments, the whole-body haptic device or system 2000 may be a holodeck type of system that may include a motion platform and a lower body exoskeleton that may provide various degrees of freedom. It will be appreciated in light of the disclosure that the whole-body haptic system 2000 and various portions contained therein and combinations thereof contain ornamental features individually and in combination that are separate and apart from the many functional aspects disclosed herein.

The whole-body haptic device 2000 may include a motion platform 2030, interface garments 2006, 2008 (e.g., haptic glove 2008), a lower-body exoskeleton 2046, a torso exoskeleton 2160, and an upper-body exoskeleton 2200. User 2002 wears a head-mounted display device 2004 to provide audiovisual feedback.

Motion platform 2030 is coupled to the lower-body exoskeleton 2046 by a structural frame 2010. In an example embodiment, the structural frame 2010 may include extruded aluminum structural members 2012 coupled by gussets 2016 and reinforced by diagonal braces 2014. In other example embodiments, the structural frame 2010 may include any suitably rigid structural member, including metals such as aluminum, steel, and titanium, and polymers or polymer composites, such as glass or carbon fiber reinforced polymers.

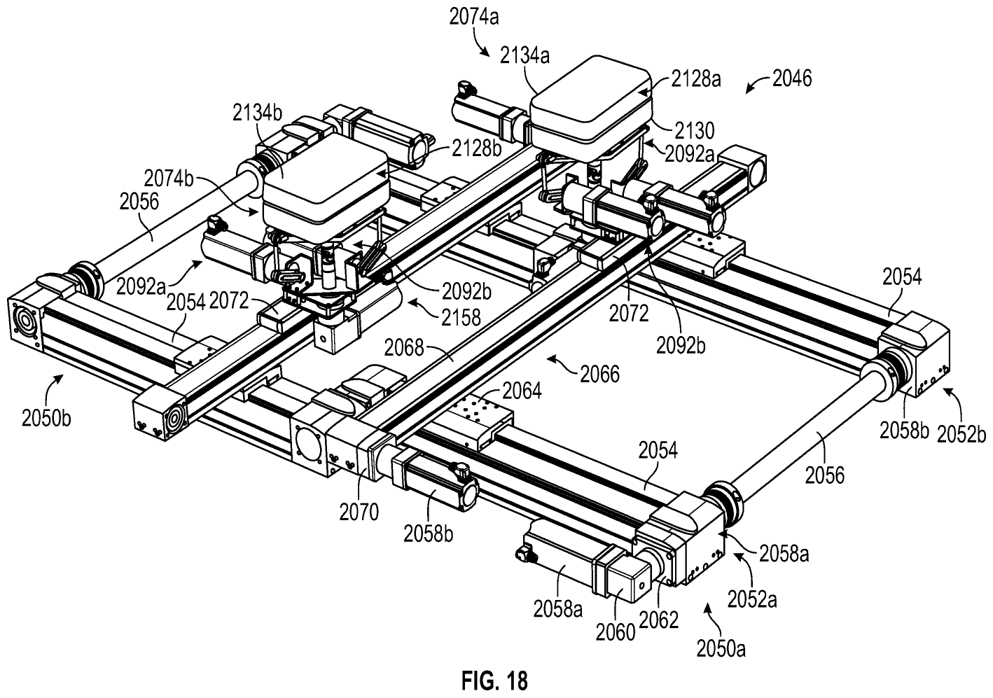

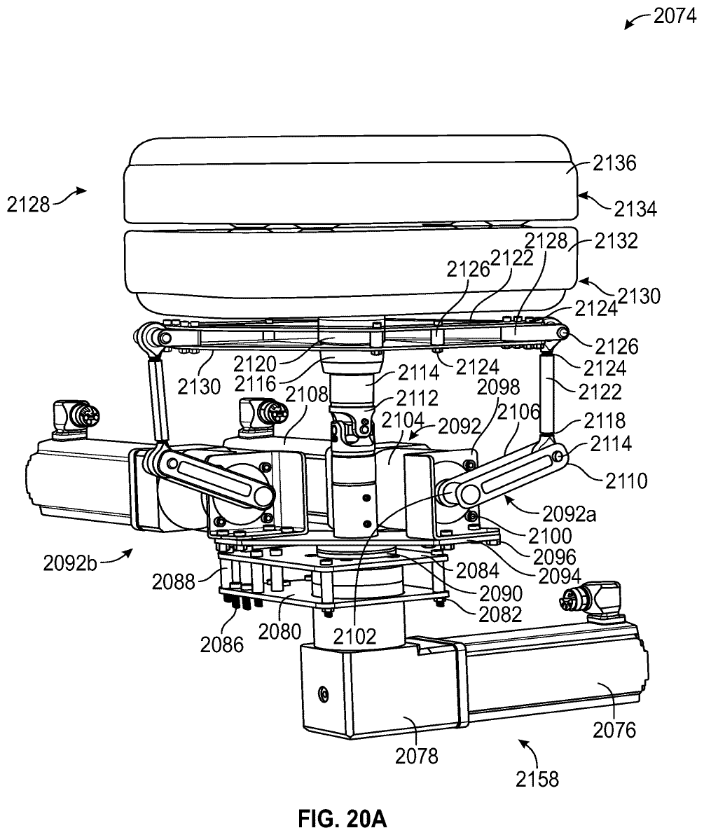

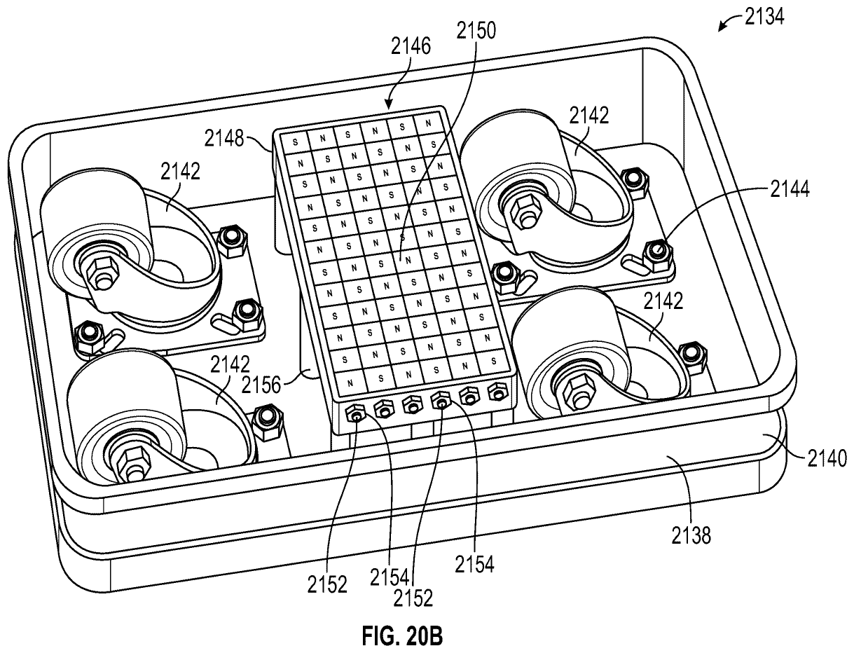

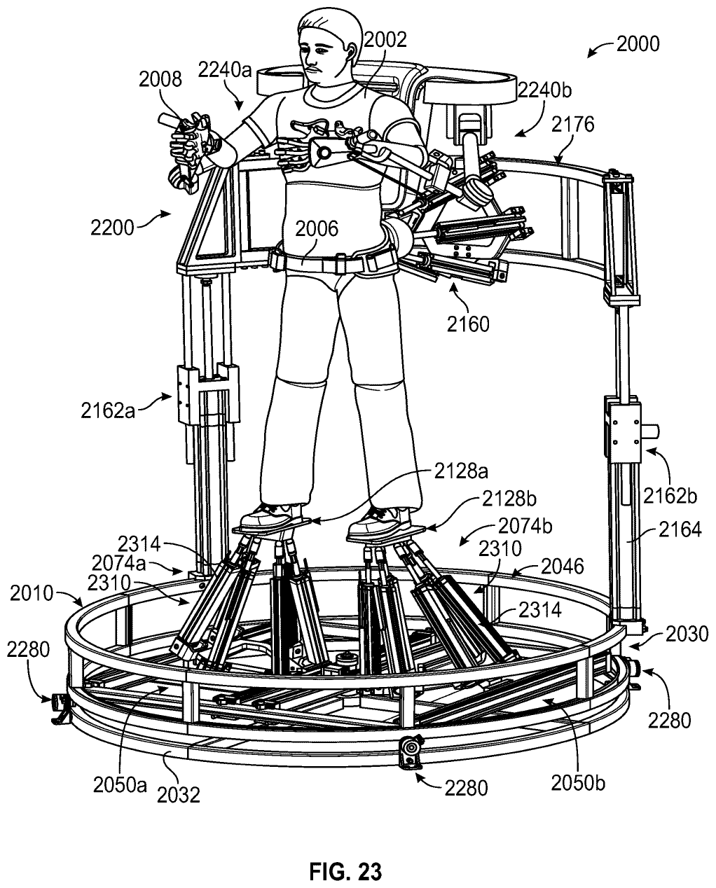

In example embodiments, the lower-body exoskeleton 2046 may include a footplate 2074 (as shown in FIGS. 18 and 20A). The footplate 2074 may include the platform 2128 as well as the actuated degrees of freedom between the gantry 2048 and the platform 2128. For example, the lower body exoskeleton 2046 may include the gantry 2048 and the footplate 2074, where the footplate 2074 may further include several actuated degrees of freedom that may collectively control the position of the platform 2128. In some example embodiments, the platform 2128 may have both a bottom portion 2130 and an upper portion 2134 that may be magnetically coupled through a membrane (as shown in FIGS. 18 and 20A and described in the disclosure). In other example embodiments (e.g., as shown in FIGS. 23-33), the platform 2128 may be monolithic.

The structural frame 2010 may be coupled to the torso exoskeleton 2160, which is in turn coupled to the upper-body exoskeleton 2200. The upper-body exoskeleton 2200 may include a first manipulator 2240a and second manipulator 2240b, each of which may be coupled to the haptic glove 2008 (e.g., as also referred to as one of the interface garments 2008).

### Enclosure

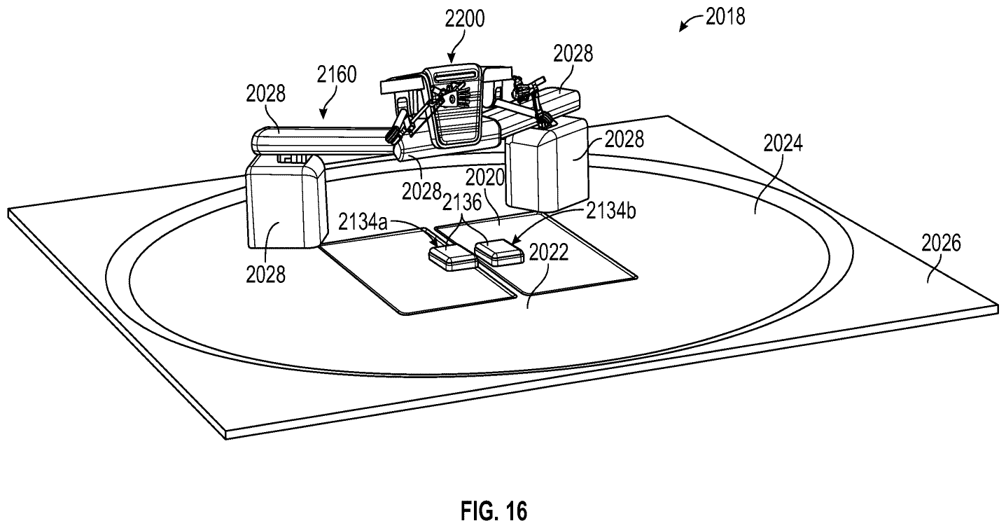

FIG. 16 shows a whole-body haptic device (e.g., the whole-body haptic device 2000) with an enclosure 2018 in accordance with an example embodiment. The enclosure 2018 may enhance user safety by physically isolating a user from potentially dangerous mechanisms of the whole-body haptic device without impeding the operation of the haptic device. The enclosure 2018 may also enhance aesthetic appeal of the whole-body haptic device.

In the example embodiment of FIG. 16, the whole-body haptic device may be configured to be partially recessed beneath a load-bearing surface 2026 capable of supporting the weight of a human. In an example embodiment, the load-bearing surface 2026 may include a modular access floor of the type commonly used in data centers, technical rooms, and offices of commercial buildings. Referring now to FIG. 15, the motion platform 2030, the structural frame 2010, and the lower-body exoskeleton 2046 except for an upper portion 2134 of a platform 2128 (e.g., foot platform 2128) may be recessed beneath the load-bearing surface 2026 (e.g., as shown in FIG. 16).

Referring again to FIG. 16, the load-bearing surface 2026 may be coupled to an outer membrane 2024, which is in turn coupled to the structural frame 2010. The outer edge of an inner membrane 2022 is coupled to the structural frame 2010 to form a continuous surface in combination with the outer membrane 2024 and the load-bearing surface 2026.

The membranes 2022, 2024 may include an elastomer, such as silicone rubber. The membranes 2022, 2024 may optionally include geometric features, such as corrugations, that may increase their displacement in the manner of a bellows. In another example embodiment, the membranes 2022, 2024 may include a substantially inelastic material, such as steel, aluminum, or fabric that may include a geometric feature of the type described in the disclosure permitting increased displacement.

The membranes 2022, 2024 may have a sufficiently high enough modulus of elasticity to allow a user to comfortably walk across their surface (e.g., when entering or exiting the whole-body haptic device), but a sufficiently low enough modulus of elasticity to permit displacement by the motion platform 2030 and the lower-body exoskeleton 2046 during operation.

In an example embodiment, the outer membrane 2024 may have a relatively higher modulus of elasticity as compared to a modulus of elasticity of the inner membrane 2022. The outer membrane 2024 may be primarily displaced by operation of the motion platform 2030, whereas the inner membrane 2022 may be primarily displaced by operation of the lower-body exoskeleton 2046. Given the substantially higher force output of a typical motion platform, an increased elastic modulus is appropriate for the outer membrane 2024. This increased modulus may be achieved by use of a sufficiently more rigid material or alternate geometry, such as by sufficiently increasing thickness.

The inner membrane 2022 may include a first portion having a relatively increased elastic modulus and a second portion having a relatively reduced elastic modulus. In example embodiments, a membrane (e.g., the inner membrane 2022) may include a first and second portion having substantially different elastic moduli. In the example embodiment of FIG. 16, inserts 2020 may include a substantially inelastic but flexible material with a geometry approximating the workspace of each foot of a user. The inserts 2020 may include a material with a sufficiently high yield strength and a sufficiently low magnetic susceptibility to avoid interfering with a magnetic coupling 2146 (e.g., as shown in FIG. 20B) of the foot platform 2128 (e.g., as shown in FIG. 20A) of the lower-body exoskeleton 2046. Suitable materials for inserts 2020 may include, but may not be limited to, thin sheets of substantially non-magnetic grades of stainless steel, such as 316 stainless steel, carbon, or glass fiber reinforced polymer sheets, and/or durable synthetic fabrics, such as nylon or polypropylene.

The upper portions 2134 (e.g., upper portions 2134a, 2134b as shown in FIG. 16) of the foot platforms 2128 (e.g., foot platforms 2128a, 2128b as shown in FIG. 18) of the lower-body exoskeleton 2046 may each include a cover 2136 (e.g., lower-body cover). The cover 2136 may include a material, such as silicone rubber, that may be substantially elastic. Furthermore, the edges of the upper portions 2134a, 2134b may be rounded or tapered, as shown in FIG. 16, such that an object impacting the edges may tend to be deflected up and away from the surface of the inserts 2020 and/or the membranes 2022, 2024. The combination of such a geometry with the substantially elastic material of the cover 2136 may help to enhance user safety by reducing the maximum amount of energy that upper portions 2134a, 2134b may transfer to a body part of a user in case of accidental contact with the sides of the upper portions 2134a, 2134b during operation. In example embodiments, as shown in FIG. 16, there are various covers 2028 (e.g., upper-body covers) for structural components of the upper-body exoskeleton 2200. In example embodiments, the platforms (e.g., foot platforms 2128) may include a relatively soft cover (e.g., providing sufficient flexibility when the platforms are in use by the user) as described in the disclosure. In example embodiments, the platforms 2128 may include a tapered edge or a rounded edge (e.g., edges of the upper portions 2134a, 2134b) as described in the disclosure.

### Motion Platform

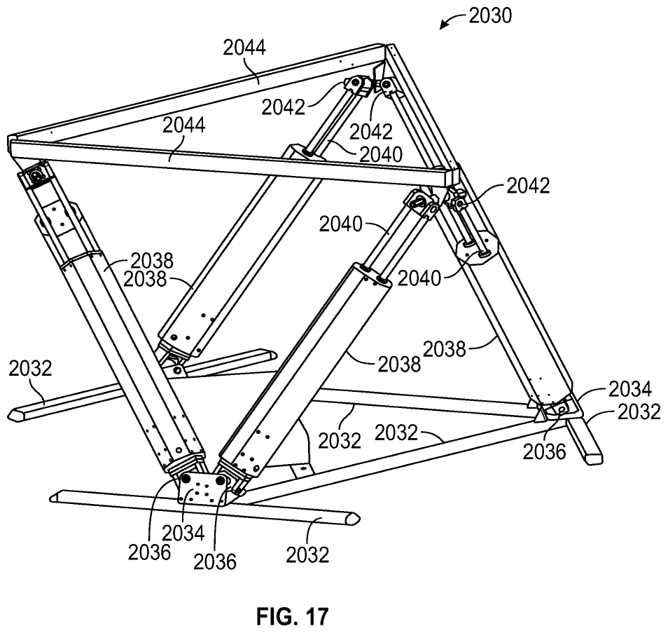

FIG. 17 shows the motion platform 2030 of the whole-body haptic device 2000 in accordance with an example embodiment. In the example embodiment of FIG. 17, the motion platform 2030 may be of a “Stewart-type” geometry that is known to those skilled in the art. Stewart-type motion platforms may provide high acceleration, force output, and/or positioning accuracy due to their parallel kinematic architecture. Stewart-type motion platforms may also be readily available commercially, making them particularly suitable for the whole-body haptic device 2000.

The motion platform 2030 may include a base 2032, coupled to brackets 2034, each of which may be coupled to universal joints 2036 (e.g., first universal joints 2036). The first universal joints 2036 may be coupled to ball-screw actuators 2038, which may drive structural members 2040. The structural members 2040 may be coupled to universal joints 2042 (e.g., second universal joints), which may in turn be coupled to a frame 2044. The combined motion of ball-screw actuators 2038 may control all six degrees of freedom of the frame 2044 within the mechanism's workspace.

Various alternate actuation mechanisms may be contemplated for the motion platform 2030, including but not limited to, lead screw and crank-based mechanisms. The motion platform 2030 may be driven by any appropriate actuator familiar to those skilled in the art, such as electromechanical, pneumatic, and/or hydraulic actuators.

In example embodiments, the motion platform 2030 may include at least an actuated degree of freedom configured to permit rotation about the longitudinal axis (or vertical axis) of a user's body. This degree of freedom may be provided to enable a user to change direction naturally during ambulation or other locomotion. As a user's center of mass rotates, this degree of freedom may be actuated such that components of a whole-body haptic device distal to the motion platform 2030 may remain substantially aligned with the longitudinal orientation of the user's center of mass.

In example embodiments, an actuated degree of freedom of the motion platform 2030 may be configured to permit rotation about the longitudinal axis of a user's body by including a rotary actuator at the distal end of the kinematic chain of the motion platform 2030 configured to permit a rotation of at least about 720 degrees. In other example embodiments, the degree of freedom may be configured to permit continuous rotation. In some example embodiments, the motion platform 2030 may include a rotary electrical coupling or connector, such as a slip ring, to enable power and data to pass through to other elements of a whole-body human-computer interface. For example, in some example embodiments, the motion platform 2030 may include the rotary electrical coupling or connector that may be configured to permit the actuated degree of freedom to continuously rotate at least about 720 degrees. In example embodiments, the actuated degrees of freedom (e.g., fourth and fifth actuated degrees of freedom as described in the disclosure) of the lower-body exoskeleton 2046 may include a parallel mechanism. The parallel mechanism may include a rotary actuator coupled to a crank. In example embodiments, as shown in FIG. 15, the rotary actuator may be a rotary actuator motor 2270 that provides the rotation-related one or more degree(s) of freedom corresponding to the rotational movement of the motion platform 2030.

In example embodiments, a whole-body haptic device having a motion platform with a single longitudinal degree of freedom, as described in the disclosure, may be sufficient to permit basic ambulation on a predominantly flat surface. However, additional degrees of freedom may be required to accurately simulate ambulation on slopes or uneven surfaces, as well as vehicle operation and other commercially important forms of non-ambulatory locomotion. Accordingly, in example embodiments, the motion platform 2030 of a whole-body haptic device (e.g., whole-body haptic device 2000) may include at least two additional actuated degrees of freedom, including: a first actuated degree of freedom configured to permit rotation about a sagittal axis of a user's body, and a second actuated degree of freedom configured to permit rotation about a frontal axis of a user's body.

In example embodiments, the sagittal and frontal degrees of freedom of the motion platform 2030 may be actuated such that the orientation of a top surface of the motion platform 2030 (e.g., the top surface of the frame 2044 of the motion platform 2030) may substantially match the orientation of a corresponding section of terrain of a computer-mediated environment during user ambulation. For example, the frame 2044 may be tilted so as to present a simulated uphill slope that matches a virtual hill encountered in a computer-mediated environment. In example embodiments, the sagittal and frontal degrees of freedom of the motion platform 2030 may be further actuated to emulate acceleration of a simulated vehicle via a three degree of freedom acceleration cueing algorithm of the type commonly known to those skilled in the art.

In an example embodiment, as shown in FIG. 17, a motion platform further includes: a first actuated degree of freedom configured to permit translation along the sagittal axis of a user's body, a second actuated degree of freedom configured to permit translation along the frontal axis of a user's body, and a third actuated degree of freedom configured to permit translation along the longitudinal axis of a user's body. The additional degrees of freedom, while not strictly necessary for simulating natural user locomotion in a computer-mediated environment, substantially improve the fidelity of the resulting simulation, particularly for motions that involve rapid accelerations. Six degrees of freedom motion cueing algorithms, as known to those skilled in the art, may be utilized to permit optimal use of both linear degrees of freedom (e.g., to simulate high frequency, short duration accelerations) and rotary degrees of freedom (e.g., to simulate low frequency, sustained accelerations).

### Exoskeleton

Referring now to FIG. 15, the whole-body haptic device 2000 may include the lower-body exoskeleton 2046, the torso exoskeleton 2160, and the upper-body exoskeleton 2200. The lower-body, torso, and upper-body exoskeletons form a continuous kinematic chain from the motion platform 2030 to the interface garments 2006, 2008 and ultimately to the body of the user 2002. Thus, the exoskeletons may enable the simulation of arbitrary grounded forces acting on the portions of the body of the user 2002 to which they are coupled. In conjunction with cutaneous feedback that may be provided by interface garments 2006, 2008 (including tactile and/or thermal feedback), at least one exoskeleton of the whole-body haptic device (e.g., whole-body haptic device 2000) may present a complete haptic representation of any simulated objects with which the user 2002 may interact in a computer-mediated environment, closely approximating the full set of haptic sensations which may be present in an interaction with a comparable real-world object.

### Lower-Body Exoskeleton

FIG. 18 shows the lower-body exoskeleton 2046 in accordance with an example embodiment. The lower-body exoskeleton 2046 may include a first gantry 2050a and a second gantry 2050b; one for each of a user's feet. In example embodiments, as described in the disclosure, the lower-body exoskeleton 2046 may include the footplate 2074 (e.g., 2074a, 2074b). Specifically, as shown in FIG. 18, there may be two separate footplates 2074a, 2074b for each foot (e.g., left foot and right foot). For example, the footplates 2074a, 2074b may be mirrored components that fit for the left and right feet, respectively.

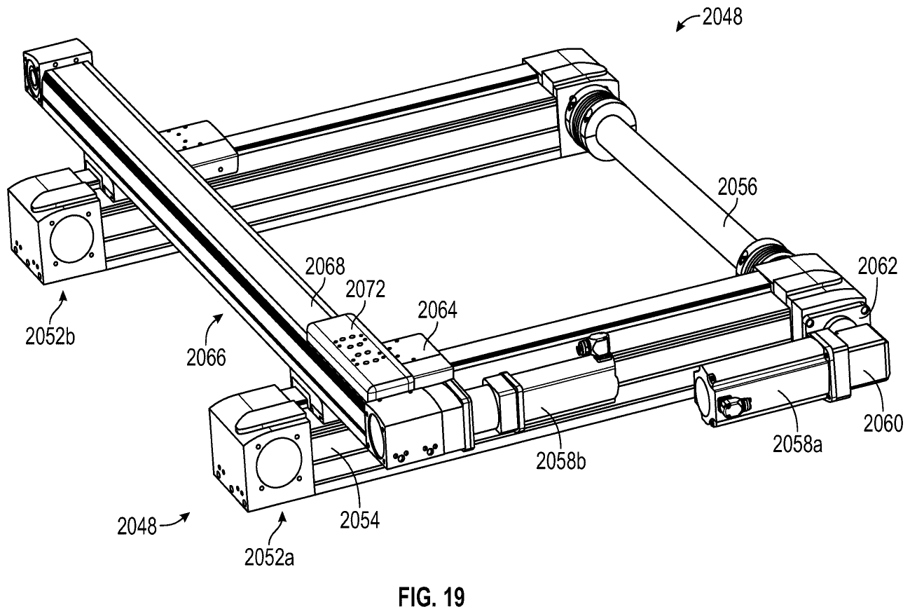

Referring now to FIG. 19, each gantry 2048 (e.g., first gantry 2050a or second gantry 2050b) may include a first actuated degree of freedom 2052 (e.g., degree of freedom 2052a, 2052b) configured to permit translation along the frontal axis of a user's body, and a second actuated degree of freedom 2066 configured to permit translation along the sagittal axis of a user's body.

Actuated degrees of freedom 2052 (e.g., degrees of freedom 2052a, 2052b), 2066 of each gantry 2048 (e.g., first gantry 2050a or second gantry 2050b) may include belt-driven actuators 2054, 2068. A servomotor 2058 (e.g., servomotor 2058a, 2058b) may be coupled to a gear reducer 2060, which may be in turn coupled to an input flange 2062 of the belt-driven actuator 2054. As the servomotor 2058 (e.g., servomotor 2058a, 2058b) rotates, it may rotate the belt of the belt-driven actuator 2054, which may in turn be coupled to a carriage 2064 to produce controlled linear motion. This controlled linear motion may produce the degrees of freedom 2052a, 2052b. In example embodiments, the degrees of freedom 2052a, 2052b may include an actuated degree of freedom 2052a that may be coupled to a second passive degree of freedom 2052b. This may occur through the use of an identical belt-driven actuator 2054 and by use of a coupling shaft 2056 in example embodiments as described in the disclosure and shown in FIGS. 18-19 for each gantry 2048 (e.g., gantry 2050a, 2050b). Pairing degrees of freedom 2052a and 2052b may provide a stable base for the lower-body exoskeleton 2046 (e.g., as shown in FIG. 18), permitting the exoskeleton to accommodate larger loads.

Each gantry 2048 (e.g., first gantry 2050a or second gantry 2050b) may further include an actuated degree of freedom 2066 (e.g., the second actuated degree of freedom 2066), including at least one belt-driven actuator 2068, the servomotor 2058 (e.g., the servomotor 2058b), a gear reducer 2070, and an output carriage 2072. Each belt-driven actuator 2068 may be coupled to the carriage 2064 of the actuated degrees of freedom 2052a, 2052b to produce a two degree of freedom planar gantry. In example embodiments, each belt-driven actuator 2068 may be coupled to the carriage 2064 and/or the output carriage 2072 to provide the actuated degree of freedom 2066 (e.g., the second actuated degree of freedom 2066) as shown in FIGS. 18-19 and described in the disclosure for each gantry 2048 (e.g., gantry 2050a, 2050b). Referring again to FIG. 18, in example embodiments, a third actuated degree of freedom 2158 may be configured to permit rotation about the longitudinal axis of a user's body that may be coupled to the output carriage 2072 of each gantry 2048. In example embodiments, as shown in FIGS. 18 and 20A, a servomotor 2076 (e.g., similar to the servomotors 2058a, 2058b) may be coupled to a gear reducer 2078, which may be in turn coupled to a crossed roller bearing 2090 to form the third actuated degree of freedom 2158.

In a first alternate example embodiment, the gantry 2048 (e.g., first gantry 2050a, second gantry 2050b) may include a holonomic drive system of the type commonly found in omnidirectional wheeled robots, including at least three and more preferably four independently actuated omnidirectional wheels (such as omni-wheels or mecanum wheels). In one variation of this example embodiment, the wheels of the holonomic drive system may be directly driven by actuators on board the gantry. In a second variation example embodiment, the wheels of the holonomic drive system may be driven by a mechanical transmission, such as a flex shaft or hydrostatic transmission coupled to an externally located actuator to reduce moving mass.

In another example embodiment, the gantry 2048 (e.g., first gantry 2050a, second gantry 2050b) may include a cable-driven mechanism, such as a planar parallel cable-driven mechanism including four actuated winches located approximately at the corners of a rectangle slightly larger than the desired workspace. In example embodiments, the cable-driven mechanism may be a cable-driven actuator.

Three actuated degrees of freedom per foot, as described in the disclosure, may be sufficient to allow arbitrary in-plane motion of a user. In one example, a user may be walking in a straight line along a flat simulated surface in a computer-mediated environment. Each of the user's feet may be position tracked by a six degree of freedom motion capture system (or, more generally, a multiple-degree-of-freedom motion capture system having, e.g., two, three, four, five, or six degrees of freedom). In example embodiments, the motion capture system may include a passive optical tracking system, an active optical tracking system, or an electromagnetic motion capture system. During the swing phase of a user's ambulation, the platforms 2128 (e.g., foot platforms 2128a, 2128b) may be actuated so as to substantially match the position of the user's foot projected onto the plane defined by the range of motion of the actuated degrees of freedom of the gantry 2048 (e.g., first gantry 2050a, second gantry 2050b). Simultaneously, both the swing foot and stance foot platforms 2128 may be actuated so as to substantially cancel out the user's net motion vector, as sensed by a position sensor located near a user's center of mass and/or a force sensor (e.g., a force sensor 2120 such as a single or multi-axis force sensor 2120) in the platforms 2128, in a manner similar to the motion of a treadmill. In example embodiments, the force sensor (e.g., force sensor 2120) may include at least three sensed degrees of freedom. In example embodiments, the platforms (e.g., foot platforms 2128) may be actuated to produce motion proportional to a sensed force vector of the force sensor (e.g., force sensor 2120). The force sensor (e.g., force sensor 2120) may be configured to indicate (e.g., output a signal that varies with) a weight of a user. In example embodiments, the force sensor may be configured to sense a contact state (e.g., in contact with or not in contact with) of a user's foot with the platforms (e.g., foot platforms 2128). Finally, in example embodiments, the motion platform 2030 (e.g., as shown in FIG. 15) may be actuated so as to match the acceleration the user would have experienced had their net motion not been offset. The result may be a natural sense of ambulation, closely matching the forces and accelerations the user would experience during comparable real-world ambulation, without the need for a comparable space. Arbitrary slope of the simulated locomotion plane may be accommodated by actuation of the motion platform 2030 (e.g., as shown in FIG. 15) up to the mechanical limits of the device, as described in the “Motion Platform” section of the disclosure.

In another example embodiment, a user may make a turn while walking along the same simulated surface. In this example, the platform 2128 corresponding to the user's plant foot may need to stay fixed as the whole-body haptic device 2000 (e.g., as shown in FIG. 15) and the rest of the user's body may rotate around it. Accordingly, the plant foot platform 2128 may be rotated and translated so as to stay materially fixed in space relative to the user's reference frame. This may typically require simultaneous actuation of all three planar degrees of freedom of the lower-body exoskeleton 2046 for the plant foot.

In another example embodiment, the displacement of platforms 2128 may be modified by at least one property based on an interface or interaction between a representation of a user's foot in a computer-mediated environment and a virtual surface or simulated surface. The representation of the user's foot along with the virtual surface or simulated surface may be represented together in the same computer-mediated environment. For example, a user (e.g., user's feet) may interact with any simulated object or terrain (e.g., flat simulated surface or an uneven surface) in a computer-mediated environment, closely approximating the full set of haptic sensations (e.g., displacement of platforms 2128) which may be present in this interaction with a comparable real-world object or terrain. In another example, there may be a specified number of actuated degrees of freedom (e.g., three degrees of freedom) applied to each foot to allow for ambulation on a predominantly flat surface. Additional degrees of freedom may be applied for accurate simulation of uneven surface having substantial changes of slope over short distances, such as stairs or rough terrain. In example embodiments, actuated degrees of freedom may be further actuated (e.g., causing modification of the displacement of platforms 2128) to match the orientation of the surface (e.g., terrain) in the computer-mediated environment supporting the user's feet when walking over various types of terrain. For example, displacement may be amplified to represent slipping on a low friction surface, like ice, or conversely, displacement may be reduced to represent ambulation across a sticky surface, like tar.

In example embodiments, the lower-body exoskeleton 2046 (e.g., as shown in FIG. 15) may have three actuated degrees of freedom per foot, as described in the disclosure, which may be sufficient to permit basic ambulation on a predominantly flat surface. However, additional degrees of freedom may be required for accurate simulation of uneven surfaces having substantial changes of slope over short distance, such as stairs or rough terrain. Accordingly, in example embodiments, the lower-body exoskeleton 2046 (e.g., as shown in FIG. 15) may include at least two additional actuated degrees of freedom, including: a first actuated degree of freedom configured to permit rotation about the sagittal axis of a user's body, and a second actuated degree of freedom configured to permit rotation about the frontal axis of a user's body.

FIG. 20A shows actuated degrees of freedom configured to permit rotation about a vertical axis such as a longitudinal axis passing through the center of rotation of the user's foot, an actuated degree of freedom configured to permit rotation about a sagittal axis passing through the center of rotation of the user's foot, and an actuated degree of freedom configured to permit rotation about the frontal axis passing through the center of rotation of the user's foot of the lower-body exoskeleton of the example embodiment of FIG. 18. In example embodiments, a servomotor 2076 (e.g., similar to servomotors 2058a, 2058b) may be coupled to a gear reducer 2078, which may be in turn coupled to a crossed roller bearing 2090 to form an actuated degree of freedom 2158 (e.g., similar to the third actuated degree of freedom 2158). The actuated degree of freedom 2158 may be coupled to mounting plates 2080, 2084 which may be joined by fasteners 2082 and spacers 2088. Other fasteners 2086 may join the mounting plate 2080 to the output carriage 2072 (e.g., as shown in FIG. 19). As shown, FIG. 20A also shows the footplate 2074 as described in the disclosure.

In example embodiments, a structural plate 2094 (e.g., base plate) may be coupled to the output flange of the crossed roller bearing 2090 and to crank actuator assemblies 2092a and 2092b by use of fasteners 2096. Each actuator assembly 2092 (e.g., actuator assembly 2092a, 2092b) may include a mounting bracket 2098 joined to a gear reducer 2104 by fasteners 2100. The gear reducer 2104 may be coupled to another servomotor 2108. An output shaft 2102 of the gear reducer 2104, driven by the servomotor 2108, may be coupled to crank arms 2106, 2110, which may be in turn coupled to a shaft 2114. The shaft 2114 may be coupled to a first ball joint rod end 2118, permitting two passive degrees of freedom. The first ball joint rod end 2118 may be coupled to a rod 2122, which may in turn be coupled to a second ball joint rod end 2124. The second ball joint rod end 2124 may terminate at a clevis 2128 by way of a shaft 2126.

Structural members 2130 and 2122, in combination with fasteners 2124 and spacers 2126 may form a substantially rigid structural frame, which may be coupled to clevises 2128 on either end. In example embodiments, the clevises 2128 may be mounted such that they are offset in both planar axes, as shown in FIG. 20A. In example embodiments, a universal joint 2112 may be mounted approximately in the center of the assembly of FIG. 20A, coupling the structural plate 2094 and the structural member 2130. In example embodiments, a single or multi-axis force sensor 2120 may optionally be mounted to the universal joint 2112 by use of a mounting boss 2116. The actuator assemblies 2092a and 2092b, in combination with the universal joint 2112, may form a parallel two degree of freedom mechanism providing controlled motion about the sagittal and frontal axes of a user's body.

In an example embodiment, the degrees of freedom of the motion platform 2030 (e.g., as shown in FIG. 15) permitting rotation about the sagittal and frontal axes of a user's body may be actuated to produce a planar approximation of terrain of a computer-mediated environment and the corresponding actuated degrees of freedom of the lower-body exoskeleton, as described in the disclosure, that may be actuated to substantially match a deviation of non-planar terrain from the planar approximation. In example embodiments, the non-planar terrain that may be generated within the computer-mediated environment may be a computer-generated three-dimensional representation of a real terrain or an artistically created terrain. For example, in simulating ascending a set of stairs in a computer-mediated environment, the motion platform 2030 (e.g., as shown in FIG. 15) may be angled to match the slope of the staircase, and as the user's feet move over the staircase, the platforms 2128 (e.g., foot platforms) of the lower-body exoskeleton 2046 (e.g., as shown in FIG. 18) may be counter-rotated to closely approximate the stair treads. This additive approach to synthesis of uneven terrain may minimize the required range of motion of out-of-plane degrees of freedom of the lower-body exoskeleton 2046 (e.g., as shown in FIG. 18), enabling a substantially less complex, less expensive, and safer device.

In another example embodiment, as shown in FIG. 15, degrees of freedom of the lower-body exoskeleton 2046 permitting rotation about the sagittal and frontal axes of the foot of the user 2002 may be employed to simulate foot controls of a simulated vehicle such as a ground, sea, or air vehicle. For example, the platforms 2128 (e.g., foot platforms 2128) of the lower-body exoskeleton 2046 may be positioned to simulate the gas (e.g., gas pedal), brake (e.g., brake pedal), and/or clutch of a car or truck, or to simulate the rudder pedals of an airplane or aircraft (e.g., emulate an aircraft rudder pedal).

Referring once more to FIG. 20A, the actuated degrees of freedom 2158 and the actuator assemblies 2092a/b of the lower-body exoskeleton 2046 (e.g., as shown in FIG. 15) may be coupled to each platform 2128 (e.g., foot platform 2128). In example embodiments, each platform 2128 may include a bottom portion 2130 and an upper portion 2134 physically separated by insert(s) 2020, and/or membrane(s) 2022, 2024 (e.g., as shown in FIG. 16) during operation and as described in the disclosure. The bottom portion 2130 and the upper portion 2134 each may include a mechanical interface to insert(s) 2020, and/or membrane(s) 2022, 2024 (e.g., as shown in FIG. 16) that may permit in-plane motion with minimal friction. For example, first and second portions (e.g., the bottom portion 2130 and the upper portion 2134) of each platform 2128 may be coupled to the insert(s) 2020 and/or membrane(s) 2022, 2024 by use of the mechanical interface with a coefficient of friction of less than about 0.05. In example embodiments, the mechanical interface may include a rolling element, such as a caster 2142 (e.g., as shown in FIG. 20B) or a ball bearing plate. In another example embodiment, the mechanical interface may include an air bearing. In example embodiments, as shown in FIG. 20A, the cover 2136 may be an upper cover for the upper portion 2134 and another cover 2132 may be a bottom cover for the bottom portion 2130, respectively. The bottom cover 2132 may be the counterpart to the upper cover 2136.

Referring now to FIG. 20B, in example embodiments, the bottom portion 2130 and the upper portion 2134 of the platform 2128 may be coupled through insert(s) 2020, and/or membrane(s) 2022, 2024 (e.g., as shown in FIG. 16) by use of the magnetic coupling 2146. In example embodiments, the magnetic coupling 2146 may include magnetic elements 2150 that may be arranged in a checkerboard-like pattern of alternating polarity (as shown in FIG. 20B) to maximize the shear force required for decoupling relative to the strength of the magnetic elements 2150. In example embodiments, the magnetic elements 2150 may include through holes through which they may be coupled to a threaded rod 2152, which may in turn be coupled to a steel pot 2148 by a nut 2154 in order to constrain and focus the magnetic field of the magnetic elements 2150 in the direction of the coupling. The casters 2142 and the magnetic coupling 2146 may be coupled to chassis 2138 by use of fasteners 2144, 2156 to form a complete functional unit. In example embodiments, the chassis 2138 may include a cutout 2140 to facilitate easy coupling to the cover 2136 (e.g., as shown in FIG. 16) without the need for additional fasteners. The elasticity of the cover 2136 (e.g., as shown in FIG. 16) may keep it in place once stretched over the chassis 2138.

### Torso Exoskeleton

FIG. 15 shows the torso exoskeleton 2160 in accordance with an example embodiment. The torso exoskeleton 2160 may include another actuated degree of freedom 2162 that may be configured to permit translation along the longitudinal axis of a user's body. As shown in FIG. 15, in example embodiments, the torso exoskeleton 2160 may include the first and the second coupled degree of freedom 2162a and 2162b to increase force output and rigidity of the actuated degree of freedom 2162.

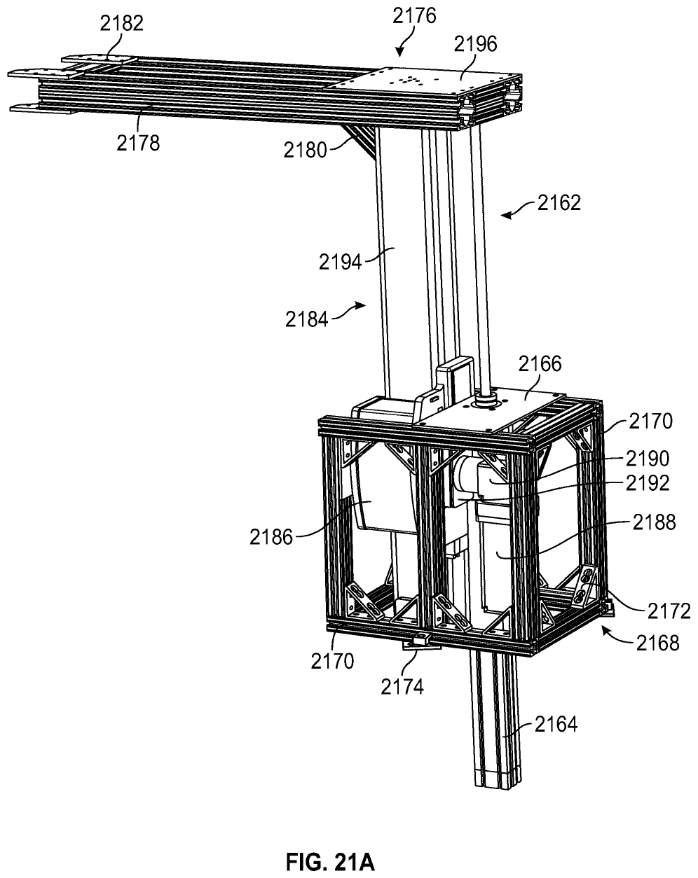

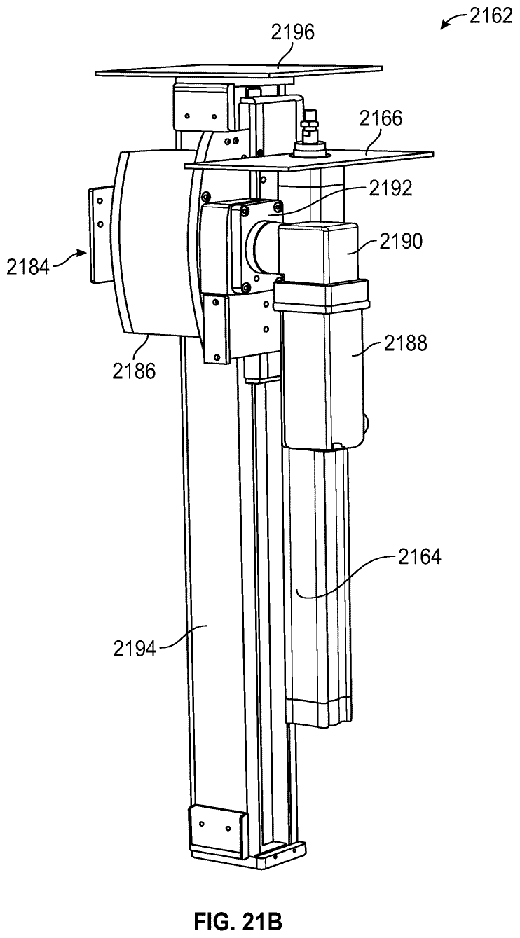

FIG. 21A shows a perspective view of the actuated degree of freedom 2162 of the torso exoskeleton 2160 configured to permit translation along the longitudinal axis of a user's body in accordance with an example embodiment. FIG. 21B is a perspective cutaway view of the actuated degree of freedom 2162 of the torso exoskeleton 2160 of the example embodiment of FIG. 21A omitting structural frames 2168 and 2176 (e.g., lower and upper structural frames 2168, 2176, respectively) for increased clarity.

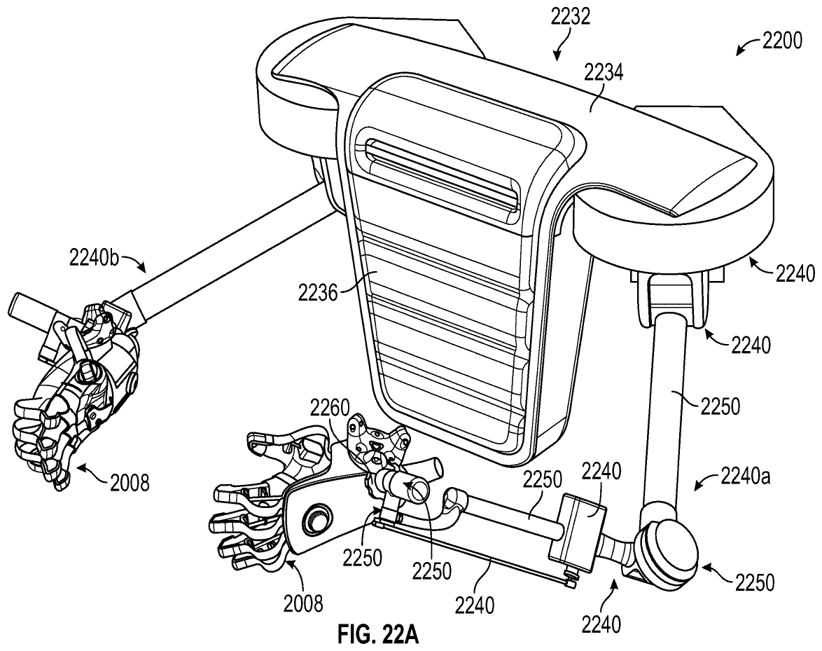

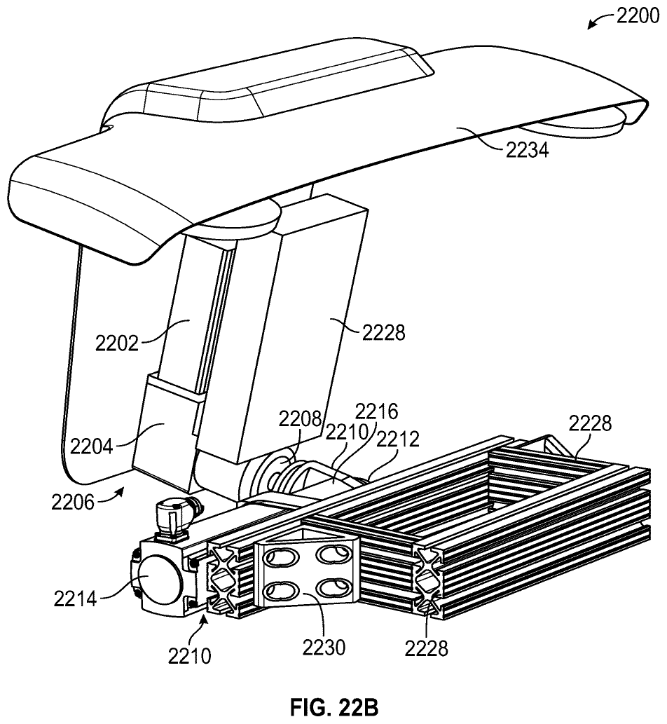

Referring now to FIGS. 21A and 21B, a servomotor 2188 may be coupled to a gear reducer 2190, which may in turn be coupled to an input flange 2192 of a cantilever axis 2184. A belt-drive unit 2186 may translate rotation of the servomotor 2188 into controlled linear displacement of a cantilever 2194. At least one structural frame 2168 may be a lower structural frame 2168. The lower structural frame 2168 may include structural extrusions 2170, gussets 2172, and mounting tabs 2174. The lower structural frame 2168 may couple the cantilever axis 2184 to the structural frame 2010 (e.g., as shown in FIG. 15). The other structural frame 2176 may be an upper structural frame 2176. The upper structural frame 2176 may include structural extrusions 2178 and a diagonal brace 2180 that may be coupled to the cantilever 2194 by use of a mounting plate 2196. Mounting plates 2182 may be configured to couple to the upper-body exoskeleton 2200 (e.g., as shown in FIG. 22A). In example embodiments, as shown in FIGS. 15, 21A, and 21B, the servomotor 2188 may be coupled to the gear reducer 2190, which may in turn be coupled to the input flange 2192 of the cantilever axis 2184 as described in the disclosure. The belt-drive unit 2186 may translate rotation of the servomotor 2188 into controlled linear displacement of the cantilever 2194 which may provide the actuated degree of freedom 2162. In some example embodiments, a pneumatic actuator (e.g., pneumatic cylinder 2164 as shown in FIGS. 21A-21B) may also or alternatively be utilized to provide the actuated degree of freedom 2162.

In example embodiments, a pneumatic cylinder 2164 (e.g., pneumatic actuator) may be coupled to the lower structural frame 2168 by use of a mounting plate 2166 and the upper structural frame 2176 by use of the mounting plate 2196, in parallel with the cantilever axis 2184. The pneumatic cylinder 2164 may be coupled to a pressure regulator, which may control its force output. In example embodiments, the pressure regulator may be configured to output a first pressure generating a force of the pneumatic cylinder 2164 substantially equal and opposite to the sum of the weight of components (e.g., most if not all components) of a whole-body haptic device distal to the pneumatic cylinder 2164 such that the distal components may be substantially maintained in an energetic equilibrium relative to the force of gravity acting on them. There may be a second pressure generating a force of the pneumatic cylinder 2164 substantially equal and opposite to the sum of the weight of components (e.g., most if not all components) of a whole-body haptic device distal to the pneumatic cylinder 2164 plus the weight of a user, such that both the distal components and the user's body may be substantially maintained in an energetic equilibrium relative to the force of gravity acting on them. In another example embodiment, the pressure regulator may be proportional, being configured to further output pressure states between about zero and a maximum rated pressure of the pneumatic cylinder 2164.

In other example embodiments, the actuated degree of freedom 2162 may include solely a fluidic actuator, such as a pneumatic or hydraulic cylinder or solely an electromechanical actuator such as a cantilever axis or other belt-driven actuator, a ball or lead screw actuator, or a crank-based actuator. However, a combination of both a fluidic and electromechanical actuator in parallel, as shown in the example embodiment of FIGS. 21A/B may present significant advantages. The pneumatic cylinder 2164 may supply a constant gravity offset force calibrated to support the weight of distal elements of a whole-body haptic device and/or the weight of a user, as described in the disclosure, with minimal power consumption, while the cantilever axis 2184 may provide higher precision force or position control than may be possible with a fluidic actuator alone. The pressure of the pneumatic cylinder 2164 may additionally be calibrated to partially offset a user's body weight to permit greater ease of ambulation, particularly for disabled users, or even to simulate buoyancy (e.g., in a simulated underwater environment) or gravitational constants different from standard Earth surface gravity.

Referring now to FIG. 15, in an example embodiment, the torso exoskeleton 2160 may include an actuated degree of freedom configured to permit translation along the sagittal axis of a user's body. The actuated degree of freedom may include a cantilever axis substantially similar to the cantilever axis 2184 (e.g., as shown in FIG. 21A/B). This additional degree of freedom may be preferably employed to help keep the upper-body exoskeleton 2200 and the user 2002 substantially centered relative to the lower-body exoskeleton 2046 during movement of the motion platform 2030.

In addition to the gravity compensation functionality described in the disclosure, the torso exoskeleton 2160 may be further employed to simulate sitting on a virtual surface in a computer-mediated environment. In this example embodiment, the torso exoskeleton 2160 may be locked at a height corresponding to the height of a virtual sitting surface to constrain the user 2002 to the virtual surface by use of the interface garment 2006 and then unlocked as the user 2002 stands up.

### Upper-Body Exoskeleton

FIG. 22A shows the upper-body exoskeleton 2200 in accordance with an example embodiment. The upper-body exoskeleton 2200 may include the first manipulator 2240a and the second manipulator 2240b with substantially similar construction. In example embodiments, a manipulator 2240 (e.g., the first manipulator 2240a or the second manipulator 2240b) may include at least three actuated degrees of freedom. In other example embodiments, as shown in the example embodiment of FIG. 22A, the manipulator 2240 (e.g., the first manipulator 2240a or the second manipulator 2240b) may include six or more actuated degrees of freedom.

The base of the manipulator 2240 may include a first actuated degree of freedom 2240 and a second actuated degree of freedom 2240 coupled to a structural member 2250. For example, each manipulator 2240a, 2240b may provide the first actuated degree of freedom 2240 and the second actuated degree of freedom 2240. The structural member 2250 may be further coupled to a third actuated degree of freedom 2250 and a fourth actuated degree of freedom 2240. For example, each manipulator 2240a, 2240b may provide the third actuated degree of freedom 2250 and the fourth actuated degree of freedom 2240 from the coupling to the structural member 2250. A fifth actuated degree of freedom 2250 may be remotely controlled by an actuator assembly 2240, which may be coupled to the fifth actuated degree of freedom 2250 by use of a drive rod 2240 and a structural member 2250. For example, the actuator assembly 2240 may provide the fifth actuated degree of freedom 2250 (e.g., via the drive rod 2240 and the structural member 2250). A sixth actuated degree of freedom 2250 may be coupled to the haptic glove 2008 by use of a mounting bracket 2260. For example, the sixth actuated degree of freedom 2250 may be provided due to the interaction of the haptic glove 2008 with the mounting bracket 2260. The manipulators 2240a and 2240b may produce grounded force feedback on a user's hands by use of haptic gloves 2008. In example embodiments, the components in FIG. 22A may function together to provide the various actuated degrees of freedom 2240, 2240, 2250, 2240, 2250, 2250 as shown in FIG. 22A and described in the disclosure.

The manipulators 2240a and 2240b may be coupled to a back support assembly 2232 that may include a structural frame 2234 and a padded backrest 2236. Referring now to FIG. 22B, in example embodiments, the structural frame 2234 may be coupled to a fluidic drive system 2228, which may control the haptic gloves 2008. In example embodiments, the upper-body exoskeleton 2200 may include at least two additional actuated degrees of freedom, including: a first actuated degree of freedom 2206 configured to permit rotation about the sagittal axis of a user's body, and a second actuated degree of freedom 2210 configured to permit rotation about the frontal axis of a user's body.

The actuated degree of freedom 2206 (e.g., first actuated degree of freedom 2206) may include or be provided by a servomotor 2202 coupled to a gear reducer 2204, which may in turn be coupled to a crossed roller bearing 2208 that permits the rotation about the sagittal axis of the user's body. The actuated degree of freedom 2210 (e.g., the second actuated degree of freedom 2210) may include or be provided by a servomotor 2214 coupled to a gear reducer 2216, which may in turn be coupled to a crossed roller bearing 2210 and a structural member 2212 having a geometry that may permit the rotation about the frontal axis of a user's body. In example embodiments, this second actuated degree of freedom 2210 may permit the rotation of distal elements of the upper-body exoskeleton 2200 about the axis of rotation of the second actuated degree of freedom 2210 without mechanical interference. In example embodiments, the structural frame 2234 may include structural extrusions 2228 and gussets 2230 that may support the upper-body exoskeleton 2200 and may couple it to the torso exoskeleton 2160 (e.g., as shown in FIG. 15).

In example embodiments, the actuated degrees of freedom 2206, 2210 (e.g., the first actuated degree of freedom 2206 and/or the second actuated degree of freedom 2210) may be actuated to substantially match the orientation of the user's upper torso, as reported by a position sensor (e.g., a passive optical type of sensor, an active optical type of sensor, and/or an electromagnetic type of sensor), during operation of a whole-body haptic device. This may minimize the required workspace of manipulators 2240a and 2240b. In example embodiments, the actuated degrees of freedom 2206, 2210 may be further actuated to match the orientation of a surface in a computer-mediated environment supporting a user's back, while the user may be sitting. For example, the actuated degrees of freedom 2206, 2210 may be configured to match the angle of the seatback of a simulated reclining chair. In example embodiments, the orientation of another actuated degree of freedom of the upper-body exoskeleton 2200 may be configured to substantially match an orientation of a user's upper body (e.g., user's upper torso).

### Interface Garment

FIG. 15 shows the interface garment 2006, 2008 of the whole-body haptic device 2000, in accordance with an example embodiment. In example embodiments, the interface garment may include at least a pair of haptic gloves 2008, such as HaptX® Gloves. In an example embodiment, the interface garment 2006 may include a harness-like element coupled to the torso of the user 2002, capable of substantially supporting the weight of the user 2002. In another example embodiment, the interface garment 2006 may also include a load-bearing element coupled to the legs of the user 2002 to permit comfortable support of the body weight of the user 2002 in a sitting position. The interface garment 2006 may help ensure the safety of the user 2002, supporting the user 2002 against accidental falls in the typical manner of a harness.

In an example embodiment, the interface garment 2006 may further include an interface laminate configured to stimulate the torso of the user 2002 with tactile or thermal feedback. The interface laminate may also be extended to the user's extremities, particularly the upper arms and upper legs.

Example Haptic Implementations with Actuator Assemblies

In example embodiments, FIGS. 23-33 show similar but slightly different implementations of the whole-body haptic device or system and its related components. The implementations of FIGS. 23-33 may utilize the same or similar components in order to provide the same or similar degrees of freedom to each of the user's feet, to each of the user's hands, and to the user's torso as shown in FIGS. 15-22B and described in the disclosure. In general, the same or similar degrees of freedom to each of the user's feet, to each of the user's hands, and to the user's torso are being provided between the example embodiments in FIGS. 15-22B and the example embodiments of FIGS. 23-33 with main differences relating to the approaches being used in terms of design configurations to provide the same or similar degrees of freedom to each of the user's feet, to each of the user's hands, and to the user's torso.

FIG. 23 shows another whole-body haptic device 2000 (may also be referred to as a whole-body haptic system 2000) in accordance with an example embodiment that is similar to the whole-body haptic device 2000 of FIG. 15. In example embodiments, the whole-body haptic device or system 2000 may be a holodeck type of system that includes a motion platform and a lower body exoskeleton that may provide various degrees of freedom. FIG. 23 shows the same or similar components in FIG. 15 that may provide the same functionality as described in the disclosure which may be implemented the same, in a similar manner, or slightly different from the implementations in FIG. 15. For example, the user 2002 is shown using the whole-body haptic device 2000 which includes interface garments 2006, 2008 (e.g., haptic glove 2008), a structural frame 2010, a motion platform 2030 having a base 2032, a lower-body exoskeleton, and gantries 2048 (including first gantry 2050a and second gantry 2050b). The whole-body haptic device 2000 may also include footplates 2074a, 2074b and foot platforms 2128a, 2128b for each foot, respectively. The whole-body haptic device 2000 may also include a torso exoskeleton 2160 and an upper-body exoskeleton 2200 that may include a first manipulator 2240a and a second manipulator 2240b. The whole-body haptic device 2000 may also include pneumatic cylinder(s) 2164 and an upper structural frame 2176. In example embodiments, the whole-body haptic device 2000 may include actuated degrees of freedom 2162 including a first coupled degree of freedom 2162a and a second coupled degree of freedom 2162b. As shown in FIG. 23, the whole-body haptic device 2000 may include motion platform motors 2280 that may be attached to the base 2032. In example embodiments, there may be only one motion platform motor 2280 with the other motion platform motors 2280 (e.g., as shown in FIGS. 23 and 24) being replaced with wheels. In another example embodiment, there may be only one motion platform motor 2280 positioned towards the center of the motion platform 2030. In example embodiments, the whole-body haptic device 2000 may include a foot platform actuator assembly 2310 that has foot platform actuator(s) 2314. There may be a foot platform actuator assembly 2310 for each foot as shown in FIG. 23. In example embodiments, the foot platform actuator assembly 2310 may be a Stewart platform type of actuator assembly (e.g., six foot platform actuators 2314). These components may be configured as shown in FIG. 23 and may provide the same or similar functionality as described in the disclosure. Together these components provide degrees of freedom to each of the user's feet, to each of the user's hands, and to the user's torso as shown in FIG. 23 similar to the degrees of freedom to each of the user's feet, to each of the user's hands, and to the user's torso in FIG. 15 as described in the disclosure. It will be appreciated in light of the disclosure that the whole-body haptic system 2000 of FIGS. 15 and 23 and various portions contained therein and combinations thereof contain ornamental features individually and in combination that are separate and apart from the many functional aspects disclosed herein.

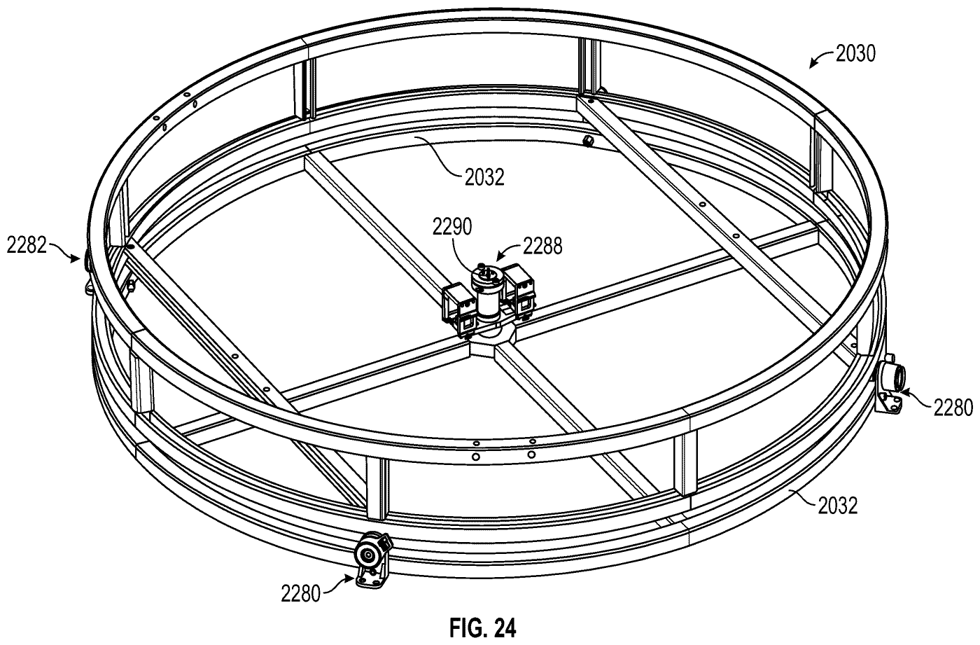

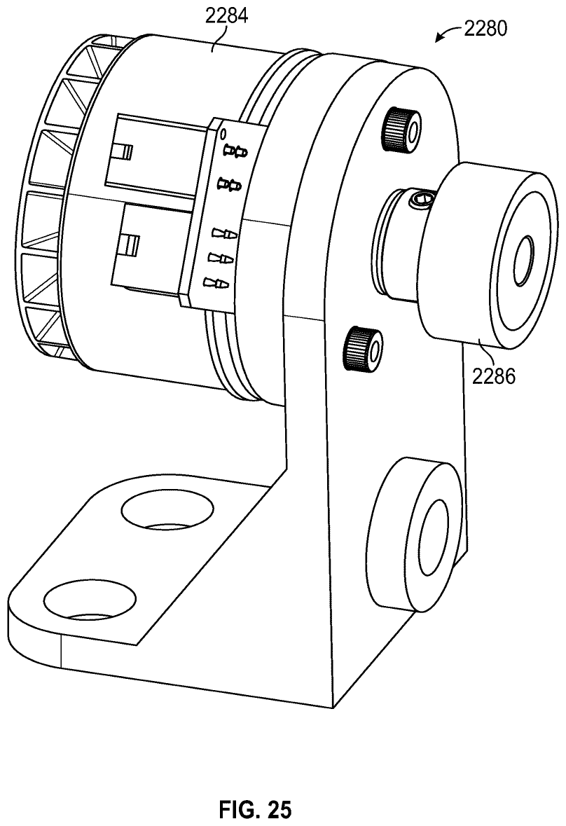

FIG. 24 shows the motion platform 2030 of the whole-body haptic device 2000 of FIG. 23 in accordance with an example embodiment. The motion platform 2030 may be configured to rotate similarly to the rotation of the motion platform 2030 in FIG. 15 but with a slightly different approach with the motion platform 2030 in FIG. 24 being circular in shape providing some ease in providing the rotation. As shown, the motion platform 2030 may include the base 2032. In example embodiments, FIG. 17 also shows motion platform motors 2280 that may be attached to the base 2032 of the motion platform 2030. These motion platform motors may be used in providing movement (e.g., rotational movement around a user's longitudinal axis) for the motion platform 2030. In example embodiments, a closer detailed view of the motion platform motor is shown in FIG. 25.

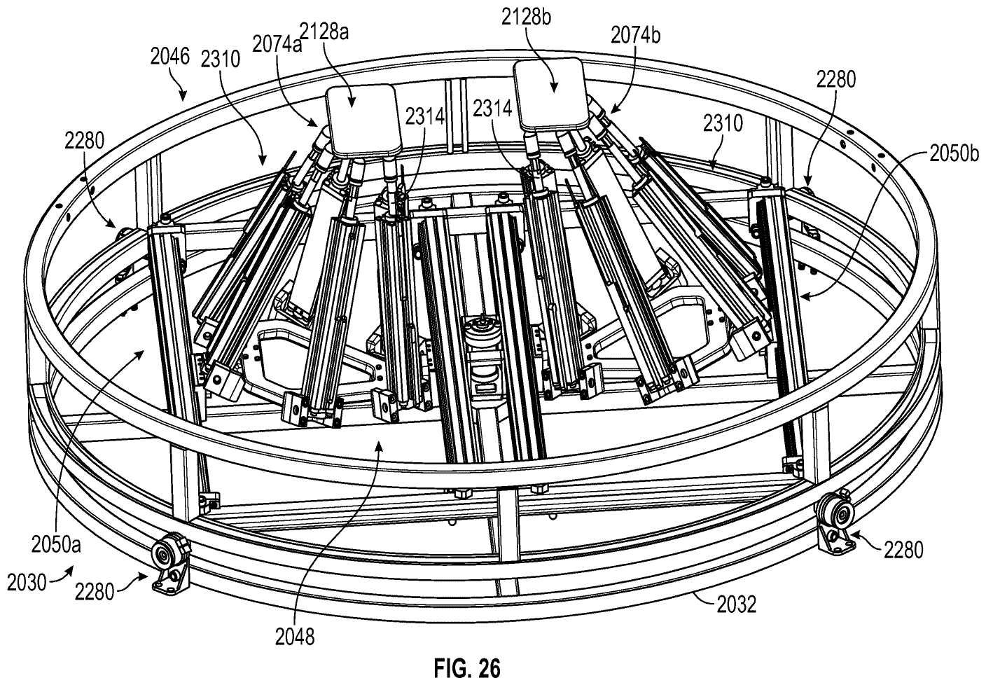

FIG. 26 shows a base assembly of the whole-body haptic device 2000 of FIG. 23 in accordance with an example embodiment. In this example, the base assembly may include the lower-body exoskeleton 2046 and the motion platform 2030 that has the base 2032. As described in the disclosure, there may also be motion platform motors that may be attached to the base 2032 of the base assembly. The base assembly may also include gantries 2050a, 2050b as well as a foot platform actuator assembly 2310 (having foot platform actuator(s) 2314) for providing movement for the user's feet and specifically degrees of freedom as shown in FIGS. 23-33 and described in the disclosure and similar degrees of freedom at each of the user's feet as shown and described for the example embodiment of FIG. 15. The base assembly may also include footplates 2074a, 2074b and foot platforms 2128a, 2128b (e.g., first and second foot platforms) for each foot, respectively as described in the disclosure.

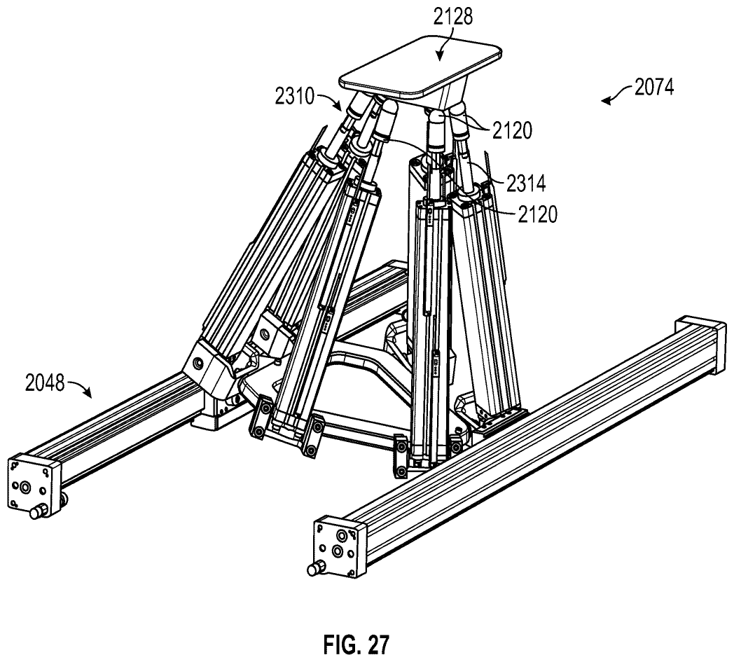

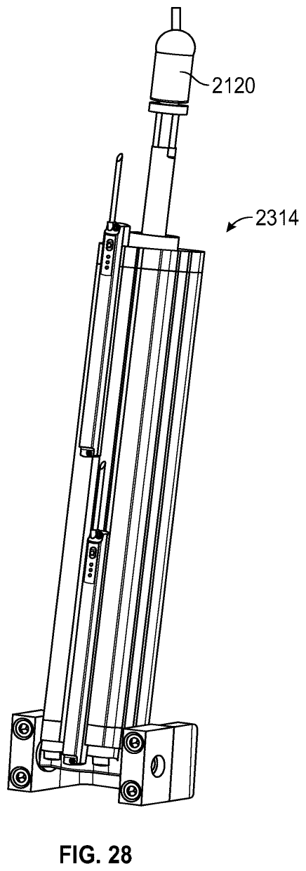

FIG. 27 shows at least one gantry 2048 and the footplate 2074 in accordance with an example embodiment. Each footplate 2074 may include the foot platform actuator assembly 2310 (having the foot platform actuator(s) 2314) for providing movement of the foot platform 2128 in terms of degrees of freedom as described in the disclosure. In example embodiments, as shown in FIG. 28, the foot platform actuator assembly 2310 may utilize the Stewart type of actuator assembly. Each of the platform actuators may include the force sensor 2120 (e.g., single or multi-axis) to assist with providing the degrees of freedom as described in the disclosure. FIG. 28 shows the foot platform actuator 2314 of the foot platform actuator assembly 2310 in accordance with an example embodiment.

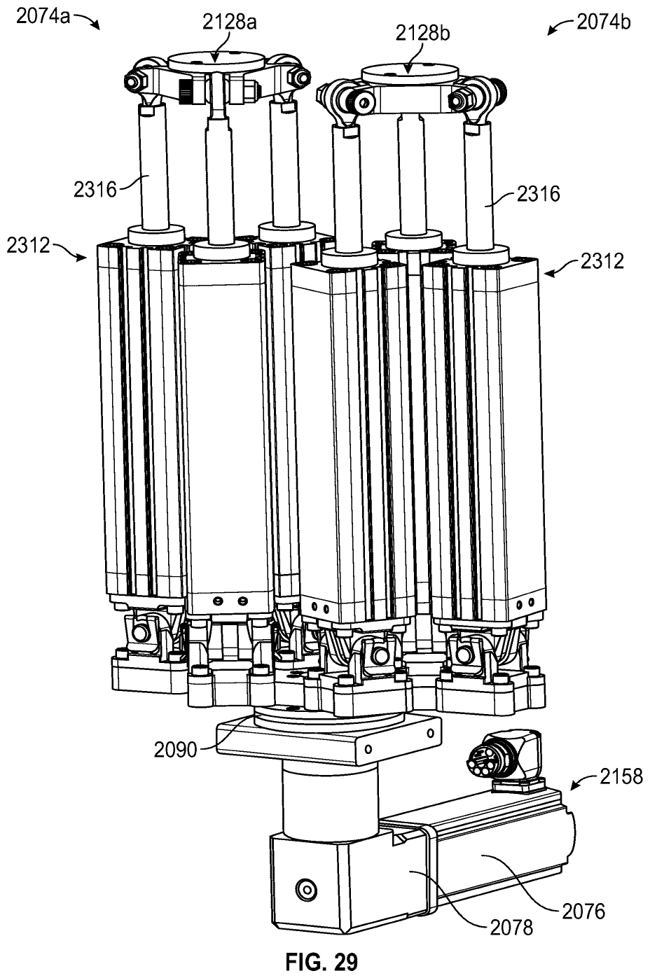

FIG. 29 shows a hybrid example embodiment in relation to the example embodiment of FIG. 15 specifically the example embodiment of FIG. 20A (e.g., showing a footplate 2074). This hybrid example embodiment at least partially combines the example embodiment of FIG. 20A with the example embodiment of FIGS. 26 and 28 in terms of using similar actuator assemblies 2312 as part of the footplates 2074a, 2074b and under the foot platforms 2128a, 2128b. In this example embodiment, there may be several actuated degree(s) of freedom 2158 provided such as an actuated degree of freedom configured to permit rotation about the vertical axis such as the longitudinal axis of a user's foot, an actuated degree of freedom configured to permit rotation about a sagittal axis of the user's foot, an actuated degree of freedom configured to permit rotation about the frontal axis of the user's foot, and an actuated degree of freedom configured to permit translation along an axis extending longitudinally through the user's foot of the lower-body exoskeleton 2046 of the example embodiment of FIG. 26. As shown in FIG. 29, this example embodiment may also include a servomotor 2076, a gear reducer 2078, and a crossed roller bearing 2090 which may assist in providing the various actuated degrees of freedom as similarly described in the disclosure for FIG. 20A. For example, the crossed roller bearing provides for rotation of the foot platforms 2128a, 2128b. As described in the disclosure, there may also be the foot platform actuator assembly 2312 with foot platform actuator(s) 2316 to provide degrees of freedom in relation to the foot platforms 2128. There may be only two foot platform actuator assemblies 2312 for each foot. The foot platform actuator assembly 2312 may be similar to the other foot platform actuator assembly 2310, however, each foot platform actuator assembly 2312 includes three foot platform actuators (instead of six foot platform actuators) providing three degrees of freedom for each actuator assembly and allowing various locations of a user's foot to be positioned independently.

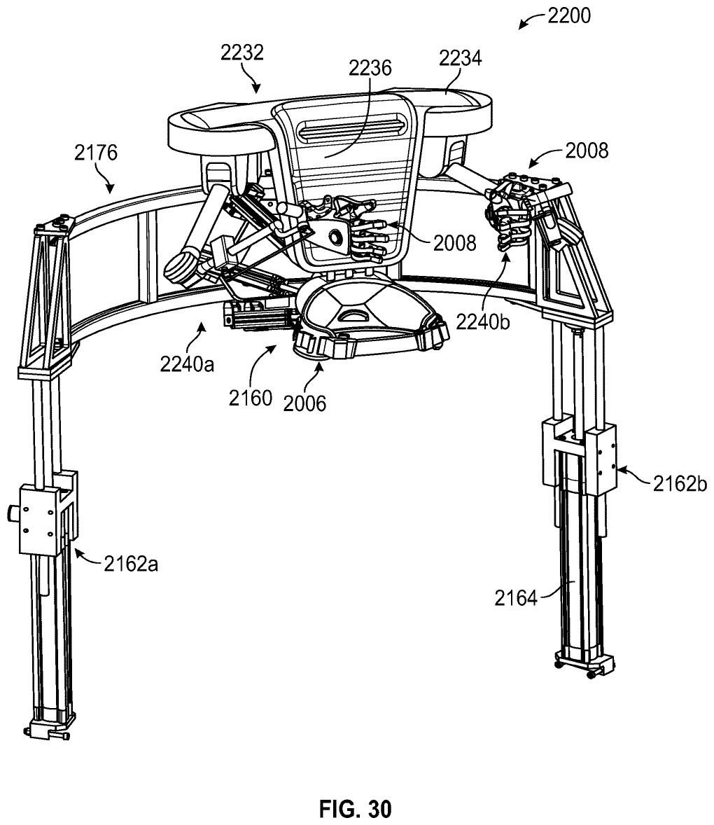

FIG. 30 shows a core assembly of FIG. 23 in accordance with an example embodiment. The core assembly may include the torso exoskeleton 2160 and the upper-body exoskeleton 2200 that may include the first manipulator 2240a and the second manipulator 2240b. The core assembly may also include the upper structural frame 2176. As described in the disclosure, the core assembly may also include interface garments 2006, 2008 (e.g., haptic glove 2008), the pneumatic cylinder(s) 2164 (e.g., two pneumatic cylinders), and the back support assembly 2232 (having the structural frame 2234 and the padded backrest 2236). These components may provide various degrees of freedom (e.g., actuated degree of freedom 2162) for the core assembly such as a first coupled degree of freedom 2162a and a second coupled degree of freedom 2162b may together provide the actuated degree of freedom 2162 for the torso exoskeleton 2160. As described in the disclosure, this actuated degree of freedom 2162 may be configured to permit translation along the longitudinal axis of the user's body.

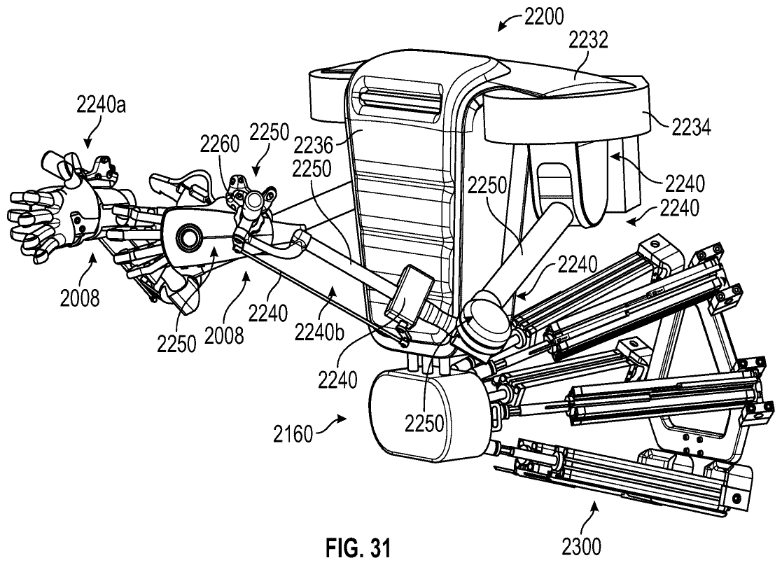

FIG. 31 shows an interface portion of the core assembly of FIG. 30 in accordance with an example embodiment. This interface portion is similar to the example embodiment of FIG. 22A. The interface portion may include the haptic glove 2008 and the upper-body exoskeleton 2200. The upper-body exoskeleton 2200 may include the back support assembly 2232, the structural frame 2234, the padded backrest 2236, and the manipulators (e.g., the first manipulator 2240a and the second manipulator 2240b). The upper-body exoskeleton 2200 may also include the actuator assembly 2240, the drive rod 2240, the structural members 2250, 2250, and the mounting bracket 2260. These components of the interface portion including the components of the upper-body exoskeleton 2200 together provide for the various actuated degrees of freedom as shown in FIG. 31 and described in the disclosure. For example, the actuated degrees of freedom may include the first actuated degree of freedom 2240, the second actuated degree of freedom 2240, the third actuated degree of freedom 2250, the fourth actuated degree of freedom 2240, the fifth actuated degree of freedom 2250, and the sixth actuated degree of freedom 2250. In this example embodiment, there may also be a torso actuator assembly 2300 attached below the upper-body exoskeleton 2200 (e.g., attached to the padded backrest 2236 via its own torso backrest). As shown in FIG. 31, the torso actuator assembly 2300 may include several actuators providing one or more degrees of freedom towards moving the user's torso. In this example embodiment, the torso actuator assembly 2300 may be the Stewart type of actuator assembly (e.g., six actuators) that may provide degrees of freedom such as six degrees of freedom. In example embodiments, the components in FIG. 31 may function together to provide the various actuated degrees of freedom 2240, 2240, 2250, 2240, 2250, 2250 similar to the components in FIG. 22A as shown in FIG. 31 and described in the disclosure. Each of these degrees of freedom may be achieved and provided in FIG. 31 using the same or similar approaches described in the disclosure with respect to FIG. 22A.

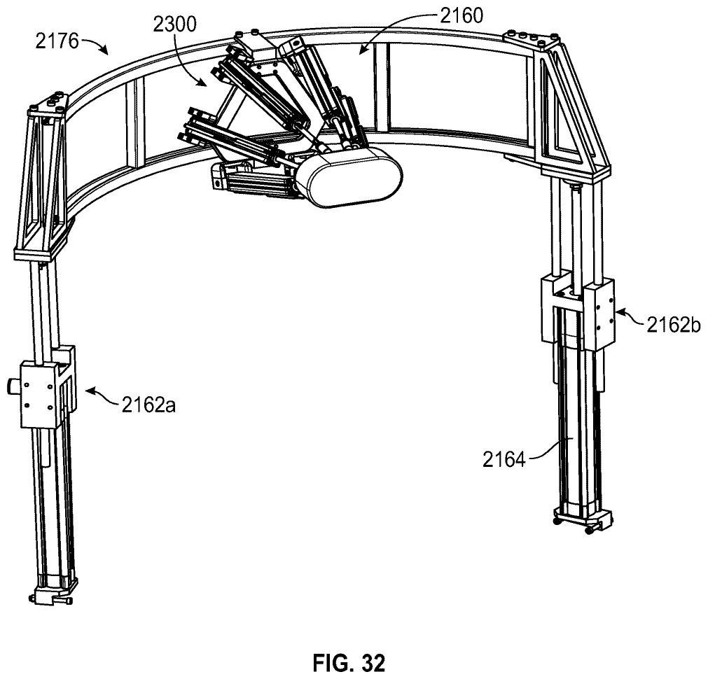

FIG. 32 shows a torso portion of the core assembly of FIG. 30 in accordance with an example embodiment. As shown in previous figures and described in the disclosure, the torso portion includes the torso exoskeleton 2160, the pneumatic cylinders 2164 (e.g., two pneumatic cylinders), the upper structural frame 2176, the upper-body exoskeleton 2200, and the torso actuator assembly 2300 (e.g., including several actuators such as six actuators for a Stewart type of actuator assembly). As shown in FIG. 32 and described in the disclosure, the torso exoskeleton 2160 may include the actuated degrees of freedom 2162 having the first coupled degree of freedom 2162a and the second coupled degree of freedom 2162b that may be provided at least partially by the use of the pneumatic cylinders. In example embodiments, these coupled degrees of freedom 2162a, 2162b may provide increased force output and rigidity for the actuated degree of freedom 2162.

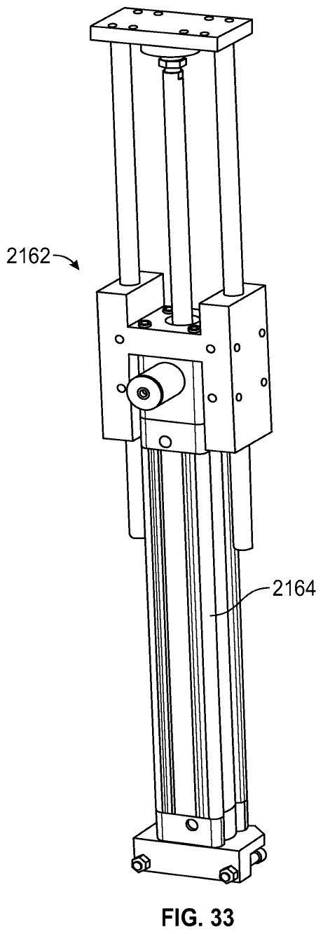

FIG. 33 shows a pneumatic actuator such as the pneumatic cylinder 2164 of the core assembly of FIGS. 30 and 32. In example embodiments, the pneumatic actuator (e.g., pneumatic cylinder 2164) may be a guided linear servo-pneumatic actuator for providing movement along the core Z-axis. Each pneumatic cylinder 2164 may provide for each coupled degree of freedom 2162a relating to the actuated degree of freedom 2162 for the torso exoskeleton 2160.

### Process Examples for Haptic Device Implementations

In example embodiments, there may be a motion platform toward the bottom of the whole-body haptic device 2000 such that its base 2032 may be secured to the ground while the motion platform may operate to rotate a portion of the whole-body haptic device 2000. By way of these examples and with reference to FIGS. 15, 17, 23 and 24, the motion platform may operate to rotate a portion of the whole-body haptic device 2000 to provide a single degree of freedom. By way of these examples, the single degree of freedom may be the bottom rotation such that the user 2002 of the whole-body haptic device 2000 may experience a yawing movement (or a spinning, rotational, etc. movement) about an axis that may be generally orthogonal to the ground on which the base 2032 of the whole-body haptic device 2000 may be secured. For example, rotation of the user 2002 and vast majority of the components of the whole-body haptic device 2000 may rotate (yaw, spin, etc.) in the same reference plan or reference frame.

In example embodiments, the whole-body haptic device 2000 may be configured such that the motion platform may operate to define actual degrees of freedom generally aligned for rotation around the longitudinal axis to the body. In these examples, the whole-body haptic device 2000 may be configured such that the motion platform may generally align the longitudinal axis of the body of the user 2002 with an axis that may be generally orthogonal to the ground on which the base 2032 of the whole-body haptic device 2000 may be secured. In further examples, the lower-body exoskeleton 400 may rotate around a central bearing and slip ring assembly (including, for example, the crossed roller bearing 2090 in FIG. 20A) that may route electrical power and signal through the rotating junction of the setup.

In example embodiments, the whole-body haptic device 2000 may be configured so that such rotation about the motion platform may provide the whole-body haptic device 2000 with its sixth degree of freedom or in some configurations, rotation about the motion platform may provide the seventh degree of freedom. In example embodiments, the motion platform may have six degrees of freedom and those degrees of freedom may align with the actuator axes as shown in FIG. 17, such that each of the six actuator axes provides a degree of freedom and adding rotation (or yawing, spinning, etc.) about the user may then be a seventh degree of freedom.

In example embodiments, the motion platform 2030 of the whole-body haptic device 2000, as depicted in FIGS. 15, 23 and 24, may be configured and later adjusted to provide three degrees of freedom but as described in the disclosure, further functionality may additionally provide four, six or seven degrees of freedom. As described in the disclosure, multiple degrees of freedom may be experienced by each limb of the user, and independently by the torso of the user. It may be appreciated in light of the disclosure that there may be challenges moving such large amounts of mass while still providing the agility and response time required to seamlessly coordinate each of the degrees of freedom. In doing so, there may be significant mass (e.g., hundreds of kilos of mass) spread across the structures of the whole-body haptic device 2000. With this reality in mind, the configuration of the motion platform 2030 may incorporate a specific mass distribution to increase the agility of the whole-body haptic device 2000. By way of these examples, the rigidity may increase the responsiveness of the movement because of the reduced flexibility (e.g., increased rigidity) may make movements crisper when the frame flexes less through the movement. Further specifics with respect to allocating mass throughout the structure of the motion platform 2030 to increase its agility and to increase safety by reducing the power needed to move that mass are further described in the disclosure. In example embodiments, by proper arrangement of the degrees of freedom in a kinematic chain, it may result in a lowering of the mass being distributed across the structures of the whole-body haptic device 2000.

As shown in FIG. 24, in example embodiments, there may be motion platform motors 2280 to facilitate rotation of the platform but not all of the motion platform motors 2280 need to contain a motor. By way of these examples, some of the assemblies can contain passive guide wheels 2282 and then one or more motion platform motors 2280 can contain a side motor 2284 with a friction wheel 2286, as shown in FIG. 25. Returning to FIG. 24, a central motor 2288 may also be used in lieu of one or more side motors 2284 (FIG. 25) to also facilitate central rotation. In example embodiments, there may be a powered rotational degree of freedom about the axis either facilitated by one or more of the side motors 2284 or the central motor 2288. In the various arrangements, the motion platform can include a central slip assembly 2290 through electrical and data connections can pass while the connections continue to rotate.

In example embodiments, as shown in FIG. 15 and described in the disclosure, there may be a six degree of freedom motion platform 2030. For example, one of the degrees of freedom being the rotational (e.g., rotation about the longitudinal axis of the user's body). In example embodiments, the one degree of rotation around the longitudinal axis of the user's body may rotate the whole-body haptic device 2000. In example embodiments, the whole-body haptic device 2000 may be on a three degree of freedom, a four degree of freedom, a six degree of freedom, or a seven degree of freedom motion platform 2030 such that three, four, six, or seven degrees of freedom may be configured. For example, in the four and seven degrees of freedom implementations, the whole-body haptic device 2000 may include a rotary actuator motor 2270 or a motion platform motor 2280 that may be positioned in the middle of the six degree of freedom motion platform 2030 (e.g., Stewart platform) or in the middle of the three degree of freedom Stewart motion platform 2030. For example, the rotary actuator motor 2270 or the motion platform motor 2280 may spin causing the rotation of the platform. This rotary actuator motor 2270 or the motion platform motor 2280 may be positioned under the gantries (e.g., gantries 2048, 2050a, 2050b) of the motion platform 2030. For example, the entire upper assembly may rotate around the long axis of platform. The motor (e.g., the rotary actuator motor 2270 or the motion platform motor 2280) may need to have sufficient power to accommodate the moving mass. For example, the motion platform 2030 may be designed to move significant masses (e.g., about hundreds or thousands of kilos) at relatively high accelerations such that the motor (e.g., rotary actuator motor 2270 or motion platform motor 2280) may be configured to accommodate this type of movement of mass.

In example embodiments, the whole-body haptic device 2000 may be configured to provide six independent degrees of freedom which may be deployed at and bound by the movement of each of the feet and each of the hands of the user 2002, as disclosed herein. By way of these examples, the combination of the six degrees of freedom of the motion platform 2030 may functionally be associated with each of the footplates 2074a, 2074b. It will be appreciated in light of the disclosure that the six degrees of freedom provided to each foot of the user 2002 may, in example embodiments, induce the feeling to the user 2002 that they are climbing a set of stairs. In doing so, the footplates 2074a, 2074b may be titled to induce the feeling of incline. In addition or in the alternative, the footplates 2074a, 2074b may independently but cooperatively adjust an angle of the foot plates 2074a, 2074b to simulate a motion up and down a rise and run of traditional stairs rather than only increasing ramp angle. It may be appreciated in light of the disclosure that the number of degrees of freedom may be deployed by combinations with other components of the whole-body haptic device 2000. By way of these examples, the whole-body haptic device 2000 of FIG. 26 depicts, in example embodiments, six degrees of freedom provided at each of the footplate assemblies (e.g., footplates 2074a, 2074b) but also depicts further degree of freedom in that the portions of the lower-body exoskeleton 2046 may rotate by way of the motion platform motors 2280 or the rotary actuator motor 2270. As such, components of the whole-body haptic device 2000 may cooperatively provide multiple degrees of freedom in the recreation of accurate motion. As such, these example embodiments may vary in design in terms of how these degrees of freedom may be combined and mixed together (e.g., example embodiments may distribute degrees of freedom in various ways).

In example embodiments, the lower body exoskeleton with its two actuated foot platforms 2128a, 2128b may be configured for substantially supporting a user's weight during the user's ambulation. In some example embodiments, each of the actuated foot platforms 2128a, 2128b in FIG. 15 may have five degrees of freedom that may share another (e.g., incorporate an additional) six degrees of freedom provided by further components of the whole-body haptic device 2000 depicted in FIG. 15. In further example embodiments, each of the actuated foot platforms 2128a, 2128b in FIG. 23 may have seven degrees of freedom with six from each of the foot platforms 2128a, 2128b and a further degree of freedom provided by the rotary actuator motor 2270 or the motion platform motor 2280. It will be appreciated in light of the disclosure that the configuration of the whole-body haptic device 2000, which is depicted in FIGS. 23 and 26, may further minimize the effects of moving mass as much as possible relative to the configuration of the whole-body haptic device 2000 depicted in FIGS. 15 and 18. By way of these examples, the whole-body haptic device 2000 may be configured with a stack up of all the different degrees of freedom or in some examples, a single global rotation may provide the degree of freedom that was otherwise provided by the stack up or put another way, the coordinated movement across multiple degrees of freedom may simulate the single simulated degree of freedom. In example embodiments, the whole-body haptic device 2000 may move all of its system mass and, in addition, the mass of the user 2002. In one example embodiment, the whole-body haptic device 2000, which is depicted in FIGS. 23 and 26, may be shown to represent a reduction of about 250 kilos relative to the configuration of the whole-body haptic device 2000 depicted in FIGS. 15 and 18.

In example embodiments where the reduction of mass may be sought, each foot of the user 2002 may connect to something else besides two degrees-of-freedom gantries (e.g., gantries 2048, 2050a, 2050b). By way of these examples, XY gantries may be deployed, e.g., a serial or parallel gantry (e.g., gantry 2048, 2050a, 2050b), that may require relatively limited mass but may supply sufficient degrees of freedom alone or in combination with other systems. In several example embodiments, there may be a single degree of freedom such that each of the footplates 2074a, 2074b may have six degrees of freedom in the form of a pneumatic Stewart platform (as shown in FIG. 23) for each foot platform 2128a, 2128b. In example embodiments, each platform (e.g., foot platform 2128a, 2128b) may further ride on a set pair of vertical rails such as pneumatic cylinder 2164 that move in and out, as shown generally at the coupled degrees of freedom 2162a, 2162b together providing the actuated degree of freedom 2162. This may provide a redundant seventh degree of freedom hybrid manipulator for both of the actuated foot platforms 2128a, 2128b. For example, if a sixth-degree-of-freedom parallel system may be used, then there may be an additional seventh-degree-of-freedom that may move in the primary axis of motion, along the frontal axis of the user. This may be shown to provide additional improvements over other example embodiments in addressing relatively high forces, relatively low moving mass, relatively high speeds, and relatively high precision. In some examples, a non-redundant system may be altered to accommodate the full range of motion to users' legs to obtain six-degrees-of-freedom. By way of these examples, the seventh-degree-of-freedom may be added to provide improvements to the user's range of motion (e.g., side stepping, angular deviation such as stepping up on a rock, etc.). In example embodiments, the six-degrees-of-freedom may be provided by the Stewart type of platform with the redundant degrees along the frontal axis of the user in the direction the user may be moving (e.g., walking).

In the various example embodiments, the whole-body haptic device 2000 may include the lower-body exoskeleton 2046, actuated foot platforms (e.g., two actuated foot platforms 2128a, 2128b), and key degrees of freedom of the platforms that are described herein. There may be several differences between some of the example embodiments as depicted in FIGS. 15 and 23. By way of these examples, the degrees-of-freedom may be arranged differently in the two depicted versions. In some example embodiments, there may be five degrees of freedom per actuated foot platform 2128a, 2128b and in other example embodiments there may be six-degrees-of-freedom with the footplates 2074 (e.g., footplates 2074a, 2074b). There may be other examples providing degrees-of-freedom such that most example embodiments may present a six-degree-of-freedom controllable platform for each foot and that may be implemented in different ways. With some example embodiments, there may be implementations with the two exterior platforms and the seventh redundant linear degree of freedom, as depicted in FIG. 23, which may be different than other example embodiments such as what is depicted in FIG. 15. In example embodiments, the lower body exoskeleton 2046 may include the footplates 2074 such as footplates 2074a, 2074b (e.g., including the foot platforms 2128 such as 2128a, 2128b) for each foot that may include one or more torque sensors. The footplates 2074a, 2074b may control their position and orientation space using their gantry component in combination with the footplate component such as the foot platforms 2128a, 2128b.

In example embodiments, there may be similar modules such that the degree of freedom assemblies may include a six-degree-of-freedom motion platform 2030 supplied by pneumatics (e.g., a Stewart type of platform) and a linear pneumatic actuator (e.g., two Stewart actuation systems for each foot and one Stewart actuation system for the torso as shown in FIG. 23). Such a configuration may be shown to provide a virtual motion platform between all of these degrees of freedom. For example, in a vehicle configuration, the z-axis may be lowered when the user may be in a sitting position. By way of these examples, pedaling may be simulated with the foot platforms 2128a, 2128b of the footplates 2074a, 2074b. In example embodiments, acceleration queuing may occur for vehicle simulations such that the whole-body haptic device 2000 may utilize acceleration simulation by substituting the gravity vector with some degree of tilt for the forward acceleration to use the experienced g-force to provide the needed feel. In example embodiments, there may be a set of ways to essentially trick the vestibular system by combining either tilts or tilts in a relatively small amount of forward acceleration or upper acceleration with washout to create that relative motion. These types of motions may be similar to what may be found in aerospace simulators to induce the feelings (sometimes incorrect feelings) of changing airplane attitude or altitude in the sky. For example, these degrees of freedom may be ranged (or constrained) such as to provide all the same capabilities of that motion platform but no longer have to move around the whole mass (in some examples over 350 kilos) in real time. There may be moving mass at the end effector to minimize the mass of the footplates, the back plate, and the relatively limited moving mass of the actuators. By way of these examples, such an arrangement may eliminate safety concerns that may be necessitated by some of the more complex parts of other example embodiments such as the magnetic floor coupling, which may not be required in other example embodiments. In example embodiments, this may provide at least one linear redundant degree of freedom as described in the disclosure.

In the various example embodiments, there may be the motion platform 2030, the lower and upper body exoskeletons 2046, 2200, and at least two platforms (e.g., foot platforms 2128) configured to substantially support each of the user's feet and their total body weight. By way of these examples, the upper body exoskeleton 2200 with two manipulators 2240a, 2240b may provide at least three actuated degrees of freedom. Example embodiments may be implemented in different ways such that some example embodiments may be relatively more decoupled and decrease the mass that may be moved. In some example embodiments, the motion platform 2030 may have one degree of freedom instead of seven degrees of freedom. There also may be footplates 2074a, 2074b which may each provide seven degrees of freedom that may be implemented in a hybrid design. In example embodiments, there may be six degrees of freedom provided in parallel rather than the five degrees of freedom in a serial hybrid rear design. Across example embodiments, there may be relatively similar motions. For example, same or similar force torque sensors may be provided along with similar controls. By way of these examples, a similar Z-axis may be implemented pneumatically providing a hybrid pneumatic, electro-mechanical approach. In example embodiments, a full six degrees of freedom may be provided in these examples.

In example embodiments, reducing the number of degrees of freedom may be a goal in some designs. In some example embodiments, extra motion platform degrees of freedom may be used. To that end, there may be additional mechanisms on top of the motion platform (e.g., motion platform 2030) when extra motion may be preferred or needed. For example, the rotary electrical coupling may be configured to permit extra degrees of freedom such as the ability for continuous rotation to at least at about 720 degrees. In some examples, the orientation of the center of mass of the user may be adjusted. In some example embodiments, there may be mapping of the motion platform 2030 to the average angle of a ground plane and then the footplates 2074a, 2074b may be used to map some plates to deviations. For example, if a user is walking up the slope, the system may match the motion platform 2030 to the overall slope and the footplates 2074a, 2074b (including foot platforms 2128a, 2128b) that may be configured to provide (that is simulate) the small differences of rough terrain or stairs.

In example embodiments, the lower body exoskeleton 2200 may have similar or the same degrees of freedom. In example embodiments, a belt driven actuator (e.g., wheel robot such as a robot belt drive actuator) may be used and/or a pneumatic actuator may be used for the drive system. In another example, a cable driven actuator may be used for the drive system.

In example embodiments, the motion platform 2030 may have seven degrees of freedom. The motion platform 2030 may move to any position or orientation (e.g., within about a few hundred millimeters displacement at about 30 to about 40 degrees such as 35 degrees). In example embodiments, the motion platform 2030 including the user 2002 may be rotated. This may provide the seventh degree of freedom as combined degrees of freedom. For example, in example embodiments, the whole-body haptic device 2000 may rotate or spin around. In example embodiments, there may be six additional degrees of freedom that move the whole-body haptic device 2000, including forward, backward, any other orientation, etc. Together this may result in seven degrees of freedom. For example, the Stewart type of motion platform 2030 at the base may provide six degrees of freedom in a relatively small area then a full rotation of that frame on top to result in seven degrees of freedom. Thus, it may be considered six degrees of freedom plus one degree of freedom as there may be some redundancy. The Stewart platform may rotate about 30 to about 40 degrees which may provide the six degrees of freedom. The seventh degree of freedom may be provided by the motor that provides the rotation as described in the disclosure such as the motion platform motor 2280 (e.g., motion platform yaw motor) or the rotary actuator motor 2270. In some example embodiments, this motor may spin around the components on top of the Stewart platform. Thus, the entire system (e.g., whole-body haptic device 2000) may rotate in addition to the six degrees of freedom being provided. In these example embodiments, the goal may be to provide each foot with six degrees of freedom independently at least, and then the center of gravity of the user (e.g., user's waist) may also provide six degrees of freedom independently of each foot. In these example embodiments, these degrees of freedom may be all combined and mixed together. In other example embodiments (e.g., as shown in FIGS. 23-33), there may be less combinations between the degrees of freedom at each foot and at the center of gravity. Thus, in example embodiments, there may be six plus one degrees of freedom for the entire system (e.g., whole-body haptic device 2000) plus several degrees of freedom for the feet and the center of gravity. For example, the degrees of freedom may relate to the feet and may relate to moving of the center of gravity around.

As described in the disclosure, FIGS. 15, 18, and 20A show an example embodiment. For example, FIG. 18 shows the that footplates 2074a, 2074b may be moved by assembly to provide three degrees of freedom. In other example embodiments, as shown in FIG. 23, this may occur in parallel with a two degree of freedom parallel mechanism. This may provide tilting in any orientation. In some example embodiments, there may be motion relating to tilt, side to side tilt, and/or front to back movements. Then, the rotation of each footplate 2074 around may result from the bottom rotation (e.g., by motion platform motor 2280 or the rotary actuator motor 2270) as described in the disclosure. Thus, combined together the footplate 2074 on its own may have zero linear degrees of freedom but has all three of the rotational degrees of freedom. In example embodiments, the footplate 2074 may be oriented any which way and/or rotated around. The linear degrees of freedom in this example implementation may be provided by the gantry 2048 (e.g., as shown in FIG. 18). In some example embodiments (e.g., as shown in FIG. 23), the gantry 2048 may provide one degree of freedom per foot. In other example embodiments (e.g., as shown in FIG. 18), the gantry may have two degrees of freedom per foot. These may be linear Cartesian degrees of freedom such that each footplate 2074 may be moved by these gantries 2048 forward, backward, left, right, etc. as described in the disclosure. Each foot may move forward, backward, left, or right such that there may be three rotational degrees of freedom. This may provide five degrees of freedom per foot. The degree of freedom that may not be present in some assemblies may be the Z-X axes (e.g., feet up and down).

In example embodiments, these movements may be based on a combination of the motion platform moving and the footplates moving. In example embodiments (e.g., as shown in FIG. 23), simulating stairs may occur by moving one footplate 2074a forward and up and moving the other footplate 2074b backwards and down. In other example embodiments (e.g., as shown in FIG. 15), the motion platform 2030 may be angled down, which may then drop the back foot down and may pull the front foot up. Then, a counter angle of the footplates 2074a, 2074b may occur such that the motion platform 2030 may be moved up and down as needed. Thus, a combination of the planted foot, the angling, and the counter angling may allow for the plant foot to stay in place while everything else moves. The entire system may be moving around the user's body and the front may provide counter angling such that when the user steps up, they may be able to move up from the user's perspective. The footplates 2074 may be able to move up and down by leveraging these combined degrees of freedom. The seven degrees of freedom in the motion platform 2030 plus the five degrees of freedom per foot may all add up to six degrees of freedom per foot.

With these example embodiments, the motion of the base may affect the center of gravity. These degrees of freedom may be conflated in some example embodiments (e.g., as shown in FIG. 15). In other example embodiments (e.g., as shown in FIG. 23), the degrees of freedom may be separated more distinctly. In example embodiments, some of these degrees of freedom may essentially compensate for the fact that the motion platform 2030 may be moving everything and the degrees of freedom may be moving relative to the motion platform 2030. For example, when taking a step onto a stair, the entire system may have to reorient itself to keep up with the user 2002. In example embodiments, each foot platform 2128 may bend forward or backward or side to side when in use which may be similar to movement of bike pedals. This may occur from the user's body being locomotive and from the influence of gravity (e.g., the user may be falling forward with the user being fixed at the waist). In example embodiments, there may be a plane that intersects the center of rotation of each foot that may be no greater in angle than the motion platform.

As described in the disclosure, FIGS. 21A-21B, 22A-22B, and 23 show example embodiments. In example embodiments, there may be a motion providing movement along the longitudinal axis of a user's body (e.g., a combined electromechanical and pneumatic actuation may be used to provide this motion). In other example embodiments, a pneumatic system only may be used such as a single pneumatic cylinder server. With this longitudinal axis motion, there may be movement raising the entire torso up and down. For example, there may be two degrees of freedom that may angle the back plate (e.g., back support assembly 2232 in FIG. 22A). This may provide angular motion around the frontal and sagittal axes. The two degrees of freedom may be provided and then each of the arms of the haptic glove 2008 may provide six degrees of freedom (e.g., force feedback to the user's arms). FIG. 22A shows an upper-body exoskeleton 2200 that may include two arms that may connect the haptic glove 2008 and the back support assembly to a pneumatic controller such as the fluidic drive system 2228 (e.g., as shown in FIG. 22B). The upper-body exoskeleton 2200 may provide a minimum viable fully immersive motion and force feedback experience. There may be six degrees of freedom provided per arm. For example, the user may virtually ride a motorcycle or a horse. For example, the vehicle simulation may be provided with the motion platform. In example embodiments, this implementation may use a configured robotic type of arm that may provide two degrees of freedom in the shoulder assembly. There may be one degree of freedom in the elbow and there may be three degrees of freedom in the wrist. In other example embodiments, the kinematics may be designed to provide three full degrees of freedom with respect to one elbow, two elbows, and one wrist. Even so, with this example embodiment, six degrees of freedom for the back arm may still be provided. There may be different ways to provide these degrees of freedom, but the specific degree combinations may be generally the same or similar. In most example embodiments, the whole-body haptic device 2000 may provide a full six degrees of freedom, independent control for both feet, both arms, and the torso providing the ability to reproduce most (if not all) human motions or human activities.

In example embodiments, there may be a tracker on the foot to identify where each foot may be located. Each footplate 2074 may be used to project the position of that tracker onto a virtual ground where the footplate 2074 may be located. Thus, each footplate 2074 may not be following each foot but each footplate 2074 may be following a shadow that each foot projects onto the ground surface. This may be an angle that may be essentially a two-dimensional or a two and a half dimensional representation of the shadow.

In example embodiments (e.g., as shown in FIGS. 15, 23 and 27), extra redundant degrees of freedom may be provided in the Stewart type of motion platform to provide improved mobility. For example, nine degrees of freedom may be provided for example embodiments. For example, this may utilize a hybrid system providing extra mobility. In other example embodiments, there may be three-linear degrees of freedom and three rotational degrees of freedom. In other example embodiments, there may be two coupled three degree of freedom platforms. In example embodiments, as shown in FIG. 27, there may be an intermediate hybrid type design that instead of having one six degree of freedom Stewart motion platform, there may be two three degrees of freedom Stewart platforms in parallel, both of which Stewart platforms are in series with one rotational degree of freedom. This example embodiment may provide some flexibility in relation to and between the ball and heel of a user's foot which do have some semi-separate movement with respect to each other and the entire foot.

The example embodiments of FIGS. 15-22B may be compared to the example embodiments of FIGS. 23-33 in terms of degrees of freedom. For example, the motion platform of FIGS. 15-22B may provide six plus one degrees of freedom that may include redundant rotation around a longitudinal axis of a user's body whereas the motion platform of FIGS. 23-33 may provide one degree of freedom that may include rotation around the longitudinal axis of a user's body. For the lower body exoskeleton, FIGS. 15-22B may provide five degrees of freedom per foot including no independent motion along the user's longitudinal axis, whereas FIGS. 23-33 may provide six plus one degrees of freedom per foot including redundant movement along the user's frontal axis. For the actuated motion at the user's torso (e.g., related to the upper body exoskeleton), FIGS. 15-22B may provide two degrees of freedom whereas FIGS. 23-33 may provide six plus one degrees of freedom including redundant movement along the user's longitudinal axis. In example embodiments, FIGS. 15-22B include the motion platform 2030 that may match a ground plane and actuated motion at the user's torso may accommodate motion required by a gravity vector, and the lower body exoskeleton may accommodate deviations required by topology (e.g., stairs or pedaling simulation). In example embodiments, FIGS. 23-33 may provide independent control of movement of the user's torso and each of user's feet in six plus one degrees of freedom each.

### Haptic Glove and Interface System

A haptic feedback glove, which may be an example embodiment of a wearable haptic glove 236, is described below. An interface system 3100 for the haptic feedback glove, which may be an example embodiment of at least some of the components of a haptic interface system 230, is further described below.

Haptic feedback gloves have broad commercial applications, including in entertainment, medical and industrial training, and computer-aided design and manufacturing. The human-computer interfaces described herein have generality, realism, and practicality.

Generality refers to human-computer interfaces with general applicability and have improved flexibility, adaptability, and economy of scale over conventional human-computer interfaces.

Realism refers to realistic touch sensation with multiple sensory modalities for natural interaction, such as cutaneous feedback (mechanical stimulation of the skin) and kinesthetic feedback (net forces applied to the musculoskeletal system). This realism is due, in part, to the resolution, displacement, frequency response, force output, and other performance characteristics to realistically stimulate a particular sensory modality as described herein.

Practicality refers to a light and low-profile design that is comfortable enough to be worn on the hand, and robust enough to survive repeated use in a real-world environment. Features described herein lower the cost of the human-computer interface to promote commercial practicality. Even more features described herein increase the speed at which gloves of the human-computer interface may be donned and doffed.

As used herein, the term “haptic feedback glove” means: a hand portion of a human-computer interface garment. As used herein, the term “finger” means: a digit of the hand, including the thumb. “Digit” and “finger” are used interchangeably throughout the present application. As used herein, the term “mechanical ground” means: a point that is substantially fixed and immovable with respect to a finger of the user. As used herein, the term “position sensor” means: a sensor configured to detect at least one of position and orientation.

### Overview of Human-Computer Interface System

Referring now to FIG. 34, a schematic diagram illustrates a human-computer interface system 3100 in accordance with the teachings of the present disclosure. Human-computer interface system 3100 includes a drive system 3110, gloves 3112 for the left and right hands, a power supply 3114, a headset 3120, transmission sources 3122, a workstation 3126, and an external air supply 3128.

Human-computer interface system 3100 may be operated in a wireless configuration or in a wired configuration. The wireless configuration uses wireless data communication and a battery to provide power. The wired configuration uses an optional power connection for indefinite operation, an optional USB connection for data communication, and an optional external pneumatic connection for providing additional compressed air.

Drive system 3110 includes an air supply, a battery, valves, and electronics to support operation of human-computer interface system 3100, as will be described below. The electronics selectively actuate the valves to control the flow of air to each of gloves 3112.

Drive system 3110 is wearable on the body of the user and the components of drive system 3110 include features that reduce the weight, size, cost, and noise of drive system 3110 relative to conventional systems, as described below.

Gloves 3112 provide haptic feedback to the left and right hands of the user while permitting finger and wrist movement. Gloves 3112 include features such as soft thimbles and manipulation actuators that are improvements over conventional haptic feedback gloves, as discussed below.

In some embodiments, gloves 3112 include an inner glove or interface layer and an outer glove or veneer layer, as illustrated below. An undersuit glove may be donned by the user before donning gloves 3112 to prevent direct skin contact between the user and the inside of the haptic feedback glove. The use of an undersuit glove reduces the need to clean the haptic feedback glove and offers improved hygiene, particularly in cases where a single haptic feedback glove is shared between multiple users.

Power supply 3114 may be any suitable electrical power conversion component to couple available electrical power and electronics of drive system 3110. For example, power supply 3114 may convert 240 volt split phase or 120 volt single phase alternating current electrical power into 24 volt direct current electrical power for use by drive system 3110.

Headset 3120 may be any visual interface or display capable of presenting visual images to the user of human-computer interface system 3100. In the example provided, headset 3120 is an immersive reality headset, which may be commercially described as a virtual reality headset, augmented reality headset, or mixed reality headset.

Transmission sources 3122 may be used to communicate external data to gloves 3112.

Workstation 3126 may be any computer capable of running software to simulate a virtual environment. In the example provided, workstation 3126 connects to drive system 3110 through a wireless data network.

External air supply 3128 may be any source of pressurized air or other inert gas. For example, external air supply 3128 may be a separate compressor or pressurized gas supply.

In the example provided, drive system 3110, gloves 3112, and power supply 3114 are packaged together to be acquired by users as a single product. In such an example, the headset 3120, transmission sources 3122, workstation 3126 hardware, and external air supply 3128 are supplied by the user using other commercially available products. In some embodiments, fewer or more of the components are provided as the single product.

Various communication paths connect the components of human-computer interface system 3100. In the example provided, the communication paths include wireless data paths 3130, wireless data path 3132, wired data path 3134, wired data path 3136, wired data path 3138, electrical power line 3140, glove pneumatic conduits 3142, external pneumatic supply conduit 3144, and external pneumatic exhaust conduit 3146.

It should be appreciated that any of the data paths may be wireless or wired without departing from the scope of the present disclosure. Wireless data paths 3130 couples transmission sources 3122 with gloves 3112 for communication. Wireless data path 3132 couples drive system 3110 with workstation 3126 for communication. Wired data path 3134 couples drive system 3110 with gloves 3112 for communication. Wired data path 3136 couples headset 3120 with workstation 3126 for communication. In the example provided, wired data path 3138 is a USB connection that couples drive system 3110 with workstation 3126 for communication.

Power communication line 3140 may be any suitable power cable compatible with drive system 3110 and power supply 3114. Glove pneumatic conduits 3142 may be any suitable pneumatic conduits (e.g., flexible tubing) capable of communicating pressurized air between drive system 3110 and gloves 3112. External pneumatic supply conduit 3144 and external pneumatic exhaust conduit 3146 may be any suitable pneumatic conduits (e.g., flexible tubing) capable of communicating pressurized air between drive system 3110 and external air supply 3128.

### Electronics of Human-Computer Interface System

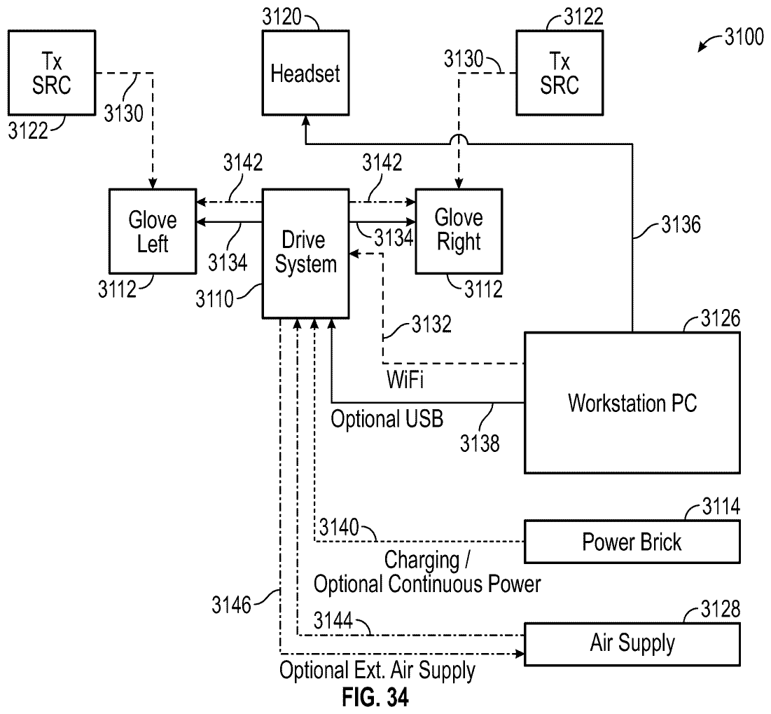

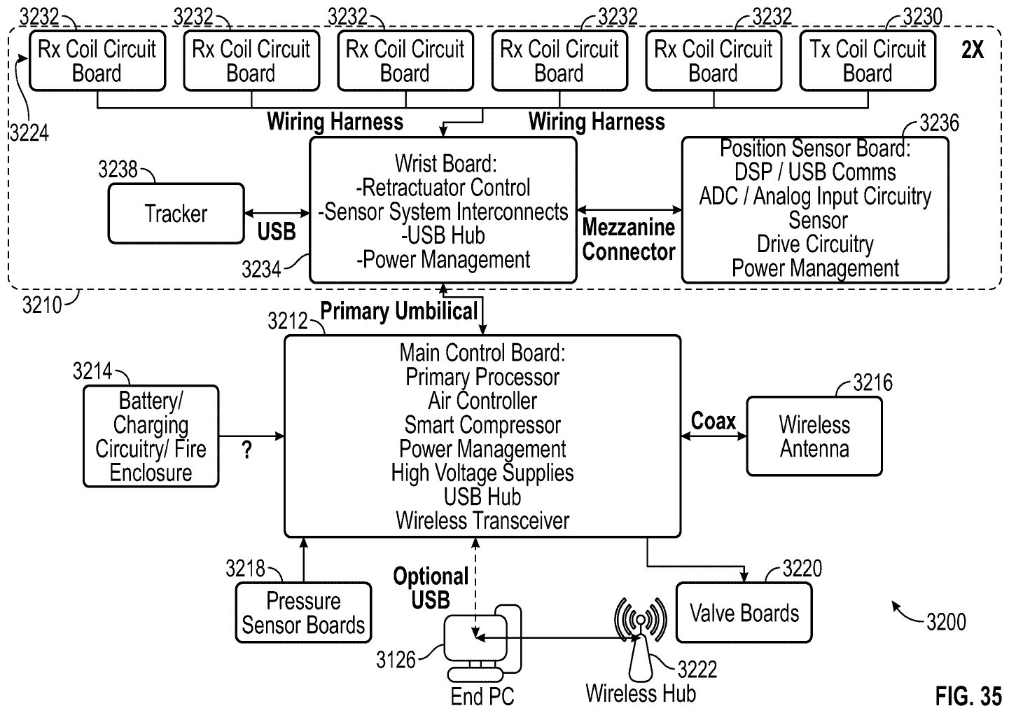

Referring now to FIG. 35, and with continued reference to FIG. 34, a schematic diagram illustrates an electronics system 3200 suitable for use with the haptic glove system of FIG. 34 in accordance with the teachings of the present disclosure. Electronics system 3200 includes various circuitry implemented, for example, with printed circuit boards (PCBs) and flexible printed circuit boards (FPCBs or FCBs).

Electronics system 3200 includes a peripheral assembly 3210, a main control board 3212, battery management circuitry 3214, a wireless antenna 3216, a pressure sensor board 3218, valve boards 3220, workstation 3126, and a wireless hub 3222.

Peripheral assembly 3210 includes a position sensor system 3224, peripheral circuitry 3234, and a motion tracker 3238.

Position sensor system 3224 includes position sensors 3232, magnetic emitter 3230, and position sensor circuitry 3236. Position sensors 3232 are receiving coil sensors that receive a magnetic field emitted by magnetic emitter 3230 to provide finger position tracking with six degrees of freedom. In some embodiments, magnetic emitter 3230 is located remotely from the user.

In some embodiments, position sensor system 3224 includes force sensors configured to transduce a point force on the user's skin, or a net force/torque on a digit of the user's hand to enable closed loop force control. In some embodiments, position sensors 3232 and magnetic emitter 3230 are replaced with an optical sensor.

Position sensor circuitry 3236 includes digital signal processing and USB communications, ADC/Analog input circuitry, sensor drive circuitry, and power management.

Peripheral circuitry 3234 provides manipulation actuator control, position sensor interconnects, a USB hub, and power management.

Motion tracker 3238 provides absolute position of the hand. For example, motion tracker 3238 may provide the absolute position of the hand in space, while the magnetic emitter 3230 and position sensor 3232 provide finger positioning relative to the absolute position. Motion tracker 3238 may be any commercially available motion tracker, such as the VIVE tracker commercially available from HTC.

Main control board 3212 is disposed in drive system 3110. Main control board 3212 includes a primary processor, a high voltage power supply, an air controller, power management, a US hub, and a wireless transceiver.

Battery management circuitry 3214 controls charging and discharging monitoring and control of a battery of drive system 3110. In the example provided, battery management circuitry 3214 is enclosed in a fire enclosure with the battery. In some embodiments, battery management circuitry 3214 and the battery are configured to manage power consumption of about 20 W to about 40 W for greater than four hours of use of human-computer interface system 3100.

Wireless antenna 3216 receives wireless signals for data communication and passes the wireless signals to main control board 3212, such as by a coaxial cable.

Pressure sensor board 3218 measures the pressure at various locations in human-computer interface system 3100. Valve boards 3220 provide actuation control of valves within drive system 3110. In the example provided, valve boards 3220 manage 118 Air Channels with one microcontroller used for every two channels.

### Production Test Flow for Human-Computer Interface System

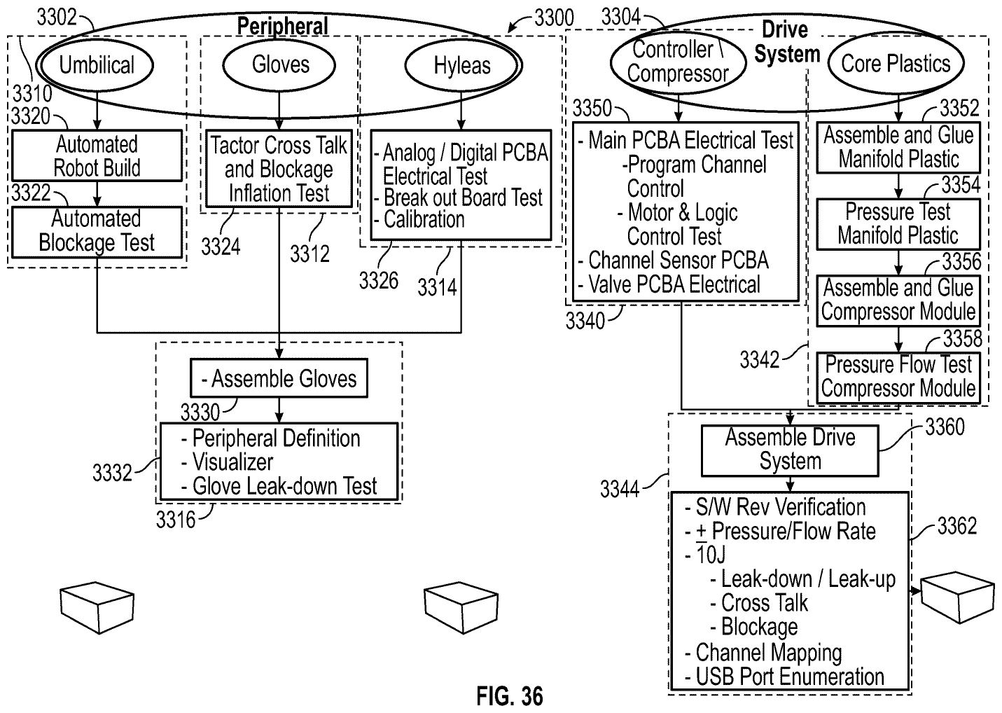

Referring now to FIG. 36, and with continued reference to FIGS. 34-35, a simplified flow diagram illustrates a production test flow 3300 in accordance with the teachings of the present disclosure. Production test flow 3300 includes a peripheral test flow 3302 and a drive system test flow 3304.

Peripheral test flow 3302 includes umbilical process 3310, glove process 3312, position sensor process 3314, and peripheral assembly process 3316. Umbilical process 3310 includes an umbilical build task 3320 and a blockage test 3322.

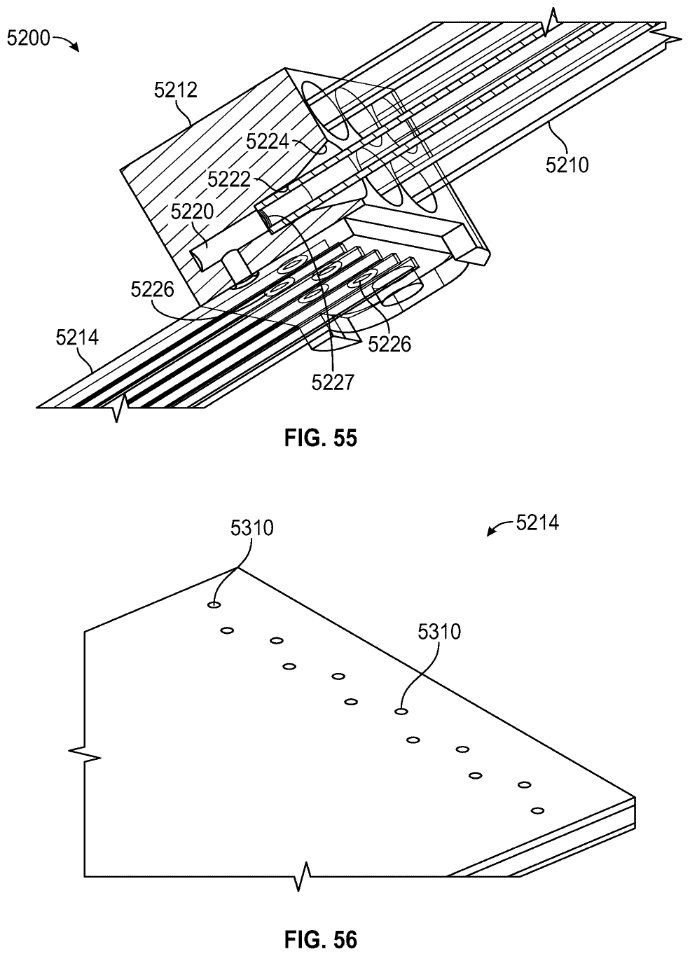

Umbilical build task 3320 utilizes an automated robot to assemble tubing within connectors of a multi-channel pneumatic connector in an umbilical that will connect drive system 3110 with gloves 3112. For example, the robot may assemble the tubing as discussed below with reference to FIGS. 55-56. In some embodiments, the automated robot is a six-axis automated robot. In the example provided, in a first task of umbilical build task 3320, a three-axis robot places the multi-channel pneumatic connector and a top manifold of a wrist mount assembly in a holding device or nest. In a second task of umbilical build task 3320 of the example provided, a six-axis robot pulls tubing from a spool to the designed length and pinches the tubing with fixturing to hold firmly at the measured length. In a third task of umbilical build task 3320 of the example provided, a pivoting and retractable blade cuts the tubing. In a fourth task of umbilical build task 3320 of the example provided, a six-axis robot places a first end of the tube vertically down into the multi-channel pneumatic connector and other end of the tube into the wrist mount top manifold. In a fifth task of 3320 of the example provided, a two-axis robot applies glue to both end pieces. In a sixth task of umbilical build task 3320 of the example provided, a three-axis robot removes the assembly from the holding device or nest. In the example provided, umbilical build task 3320 makes 60 connections.

Blockage test 3322 measures air movement through pneumatic conduits between end points of an umbilical that will connect drive system 3110 with gloves 3112.

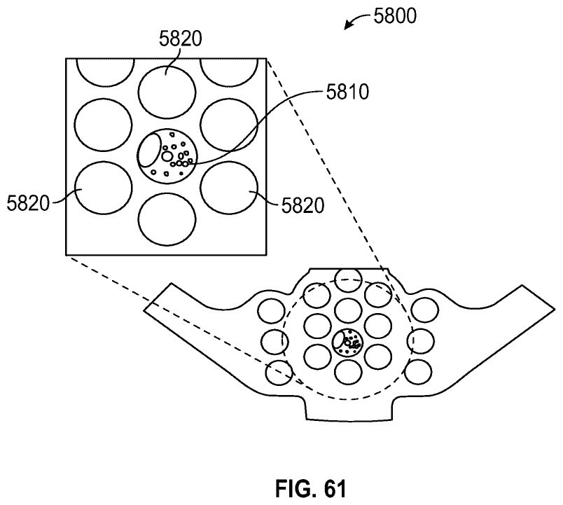

Glove process 3312 includes an inflation test 3324 for identifying tactor cross-talk and inflation problems. For example, glove process 3312 may utilize the computer vision testing further discussed with reference to FIG. 61 below.

Position sensor process 3314 includes electrical testing and calibration 3326. For example, the electrical testing may include analog and/or digital printed circuit board assembly electrical testing, break out board testing, and calibration of the position sensor.

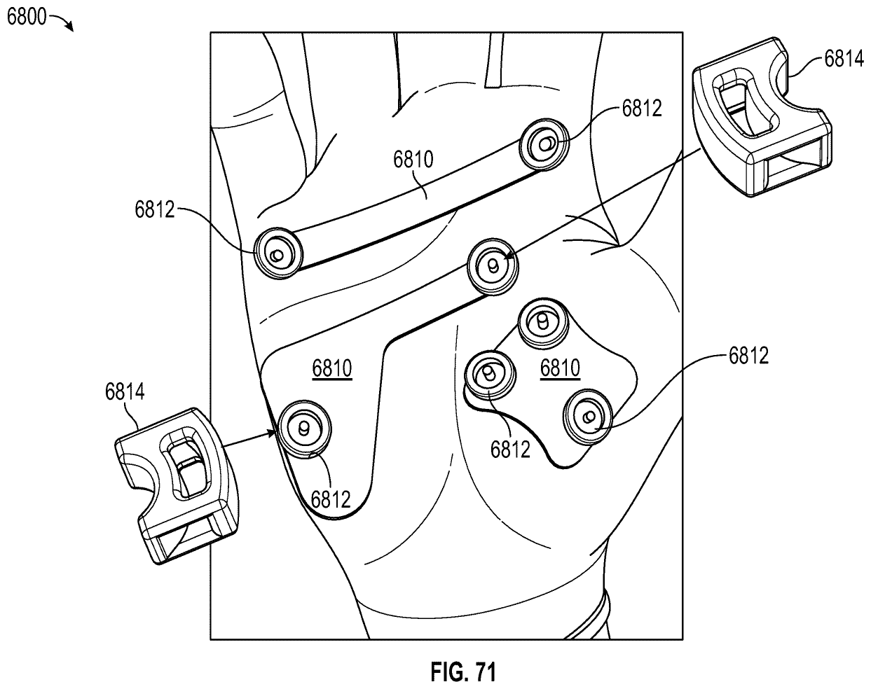

Peripheral assembly process 3316 includes a glove assembly task 3330 and a peripheral completion task 3332. Glove assembly task 3330 assembles gloves 3112 as will become apparent with reference to FIGS. 71-79 below. Peripheral completion task 3332 may include peripheral definition, position sensor visualizer, and glove leak-down testing.

Drive system test flow 3304 includes controller process 3340, core plastics process 3342, and drive system assembly process 3344.

Controller process 3340 includes electrical testing 3350. For example, electrical testing 3350 may include main PCBA electrical tests, channel sensor PCBA tests, and valve PCBA electrical tests. In some embodiments, a main PCBA electrical test includes program channel control and motor and logic control tests.

In the example provided, electrical testing 3350 includes electronic design verification tests for drive system 3110. Electrical testing 3350 includes at least: a WiFi Functional Test, pairing, range, interference immunity, USB communication, communication functionality, and bootload functionality. In the example provided, electrical testing 3350 includes drive channel functional and performance verification for frequency response, stability, and power on/off.

In the example provided, electrical testing 3350 for the compressor includes functional and performance verification for frequency response, stability, and power consumption. In the example provided, electrical testing 3350 for the display functional and performance verification includes display tests and wake/sleep verification.

In the example provided, electrical testing 3350 for power management includes voltage supply verification, current limiting, and supply on/off timing. In the example provided, electrical testing 3350 for primary processor functionality includes log file read/write, reset, and peripherals/communication buses. In the example provided, electrical testing 3350 for safety and compliance includes high voltage cutoff (case open), current Limiting/in-rush current, EMC/ESD pre-scan of prototypes, and thermal cutoff/shutdown.

Core plastics process 3342 includes an assembly task 3352 to assemble and glue manifold plastics, a pressure test 3354 for the assembled manifold plastics, an assembly task 3356 to assemble and glue the compressor module, and a pressure flow test 3358 for the compressor module.

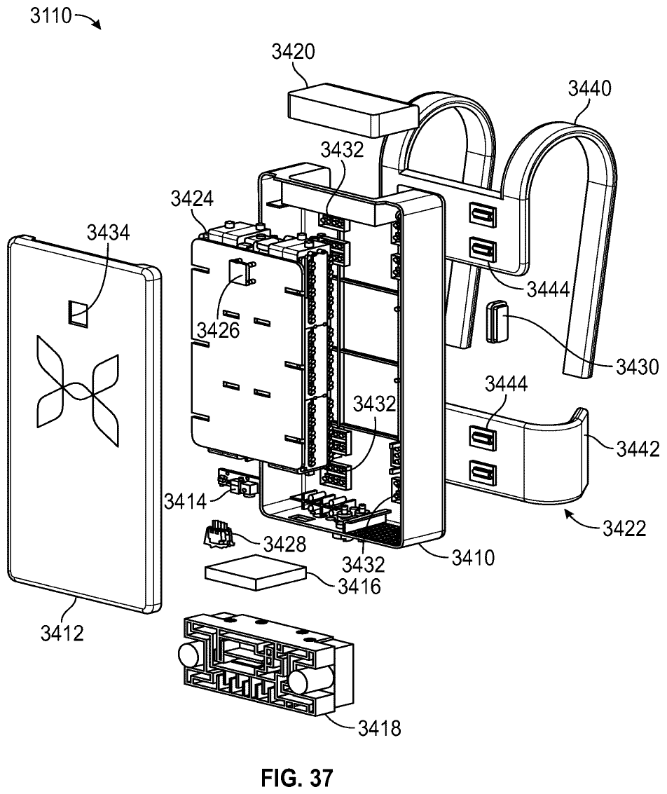

Drive system assembly process 3344 includes an assembly task 3352 and a drive system completion task 3362. Assembly task 3352 includes assembly of the drive system, as will become apparent with reference to FIG. 37 below. Drive system completion task 3362 may include software revision verification, adjustment of pressure and flow rate, lead-down and leak-up testing, cross-talk testing, blockage testing, channel mapping, and USB port enumeration.

### Drive System

Referring now to FIG. 37, and with continued reference to FIGS. 34-36, components of drive system 3110 are illustrated in an exploded view in accordance with the teachings of the present disclosure.

Drive system 3110 includes a bottom enclosure 3410, a top enclosure 3412, an input/output board 3414, a fan 3416, a compressor 3418, a battery 3420, a strap system 3422, a valve core 3424, an LCD display 3426, a power switch 3428, and a glove connector 3430.

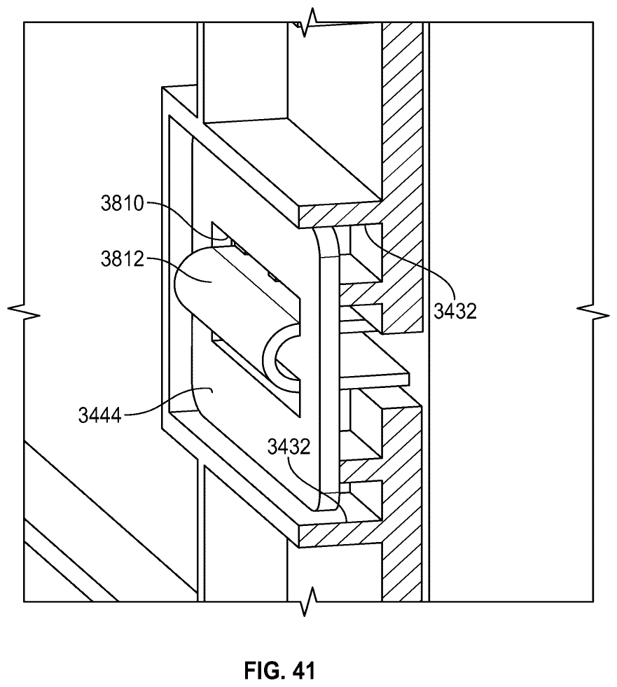

Bottom enclosure 3410 defines a cavity into which other components of drive system 3110 may be placed. For example, bottom enclosure 3410 may integrate valve core 3424, compressor 3418, battery 3420, multi-channel pneumatic connectors (not shown in FIGS. 37-41), fan 3416, and strap system 3422. In the example provided, valve core 3424, compressor 3418, and fan 3416 are captured in features defined by bottom enclosure 3410. Bottom enclosure 3410 further defines slots 3432, as can best be seen in FIG. 41 and are described below.

Top enclosure 3412 secures to bottom enclosure 3410 to enclose and protect the components in a housing or case. For example, top enclosure 3412 may secure to bottom enclosure 3410 with four to eight short screws to promote serviceability. Top enclosure 3412 further defines a window 3434.

Input/output board 3414 includes connections for data, power, and control. In the example provided, output board 3414 has a USB-Type B port, power supply port, and on/off buttons. Fan 3416 moves air through drive system 3110 to cool components within the housing.

Strap system 3422 includes an attachable and detachable set of straps, as discussed below with reference to FIG. 41. The straps include a padded shoulder strap 3440 and padded hip strap 3442. Padded shoulder strap 3440 includes padded arm straps that extend from an upper padded section to padded hip strap 3442. Padded hip strap 3442 interfaces with bottom enclosure 3410 using metal plates 3444 that slip through slots in the Bottom Enclosure, as will be discussed below with reference to FIG. 41.

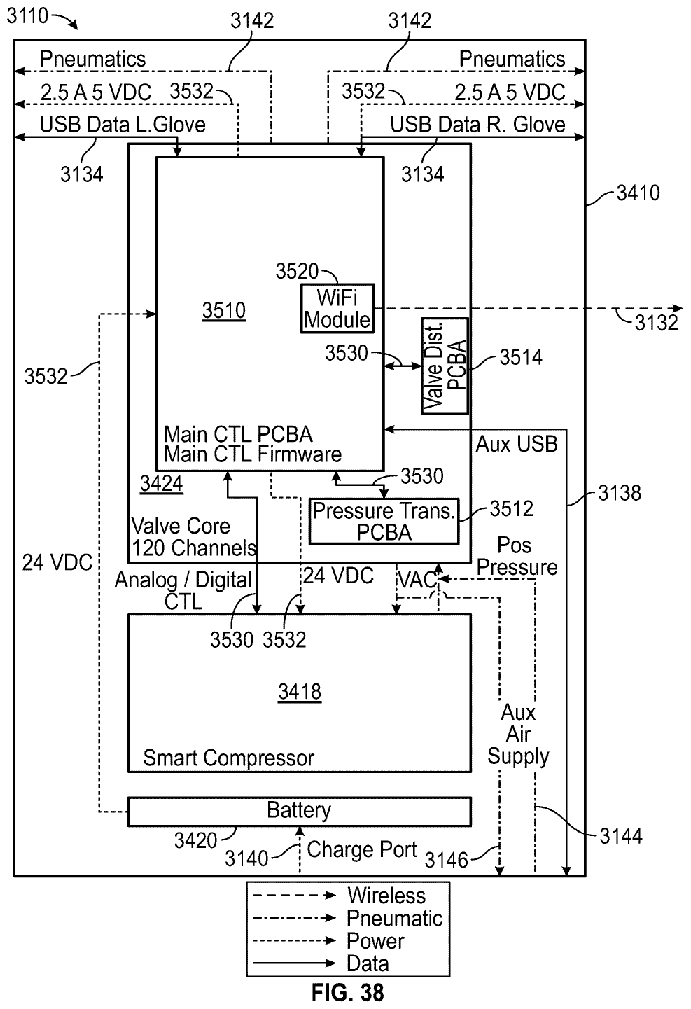

Referring now to FIG. 38, and with continued reference to FIGS. 34-37, a block diagram illustrates additional wiring and electronics of drive system 3110 in accordance with the teachings of the present disclosure. Drive system 3110 further includes a main control board 3510, a pressure transducer PCBA 3512, and a valve distribution PCBA 3514. Main control board 3510 includes a wireless networking module 3520 (e.g., Wi-Fi).

Main control board 3510 includes wireless networking module 3520 for wireless data communication, such as by Wi-Fi. Pressure transducer PCBA 3512 measures pressure within various parts of drive system 3110. Valve distribution PCBA 3514 controls pneumatic valves of drive system 3110, as shown below. The electronics of drive system 3110 communicate across various data communication paths 3530 internal to drive system 3110 and are powered by various low voltage DC power paths 3532 internal to drive system 3110.

### Valve Core-Compressor Assembly

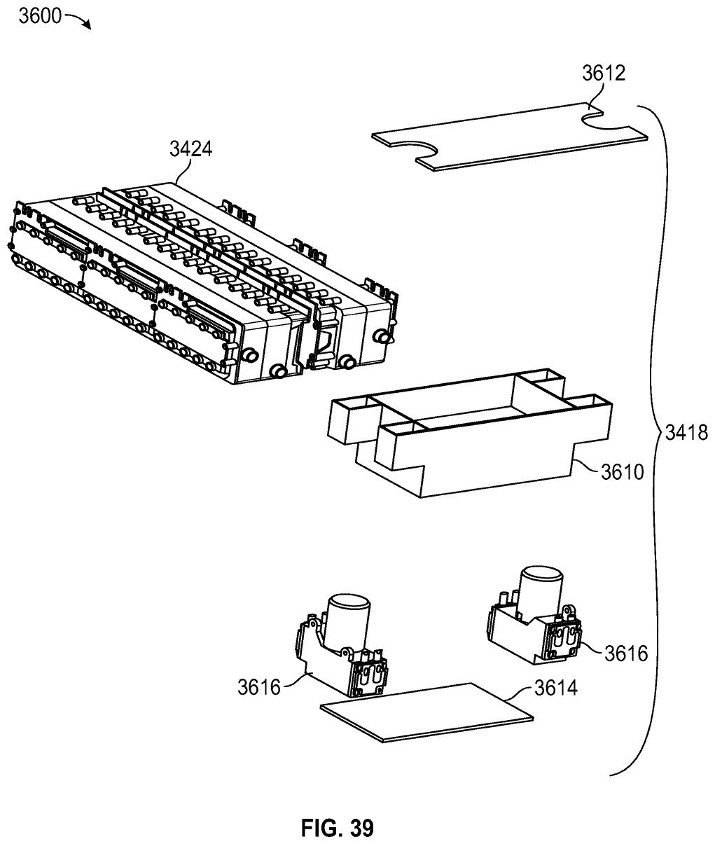

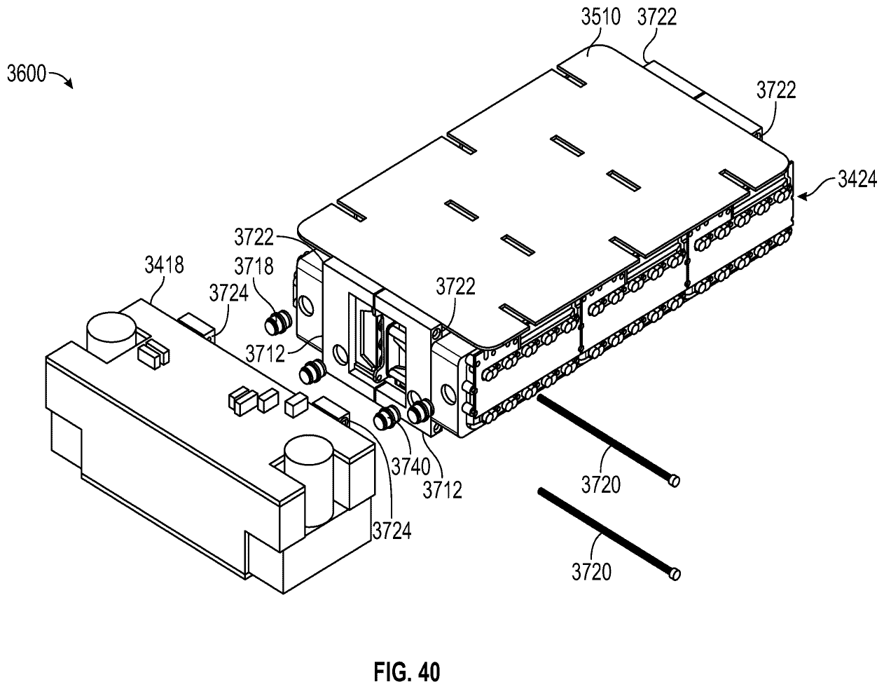

Referring now to FIGS. 39-40, and with continued reference to FIGS. 34-38, a valve core-compressor assembly 3600 is illustrated in exploded views with compressor 3418 in relation to valve core 3424.

Compressor 3418 includes pneumatic circuit body 3610, top cover 3612, bottom cover 3614, and two diaphragm pumps 3616. Valve core 3424 includes two manifold assemblies 3712 and is coupled to compressor with gasketed channels 3710 and tie rods 3720. In the example provided, valve core 3424 defines tie rod through-holes 3722 and pneumatic circuit body 3610 defines tie rod through-holes 3722 through which tie rods 3720 pass to couple valve core 3424 to compressor 3418.

Gasketed channels 3710 insert into valve core 3424 on one end and insert into pneumatic circuit body 3610 of compressor 3418 on the other end. Gasketed channels 3710 permit pneumatic communication between compressor 3418 and valve core 3424 while restricting air leaks with O-rings 3718 and attenuating vibrations from compressor 3418.

The two manifold assemblies 3712 are mounted together using interlocking features in the plastics further secured with screws for serviceability. Main control board 3510 is mounted to the top of valve core 3424 using snap arms. In the example provided, main control board 3510 interfaces with the valve distribution PCBA 3514 and pressure transducer PCBA 3512 using board edge connectors.

### Backpack Strap Assembly

Referring now to FIG. 41, and with continued reference to FIGS. 34-40, components of a strap system are illustrated in accordance with the teachings of the present disclosure. For example, the strap system may be strap system 3422 illustrated in FIG. 37.

In the example provided, metal plates 3444 define slots 3810 through which strap loops 3812 pass. Strap loops 3812 may be formed, for example, from padded shoulder strap 3440 and/or padded hip strap 3442. Metal plates 3444 then slide into slots 3432 of bottom enclosure 3410 and restrict strap loops 3812 from pulling away from bottom enclosure 3410.

Metal plates 3444, slots 3810, and strap loops 3812 define an attachment feature configured to accommodate removal and re-installation of strap system 3422. It should be appreciated that other attachment features may be incorporated without departing from the scope of the present disclosure.

### Manifold Assemblies

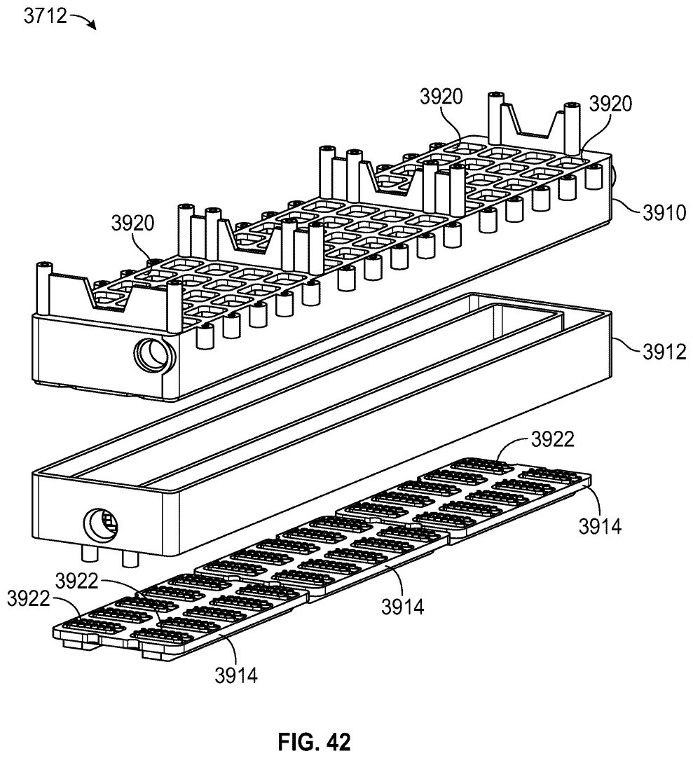

Referring now to FIGS. 42-44, exploded views illustrate manifold assemblies of a valve core in accordance with some embodiments. For example, manifold assemblies may be manifold assemblies 3712 of valve core 3424.

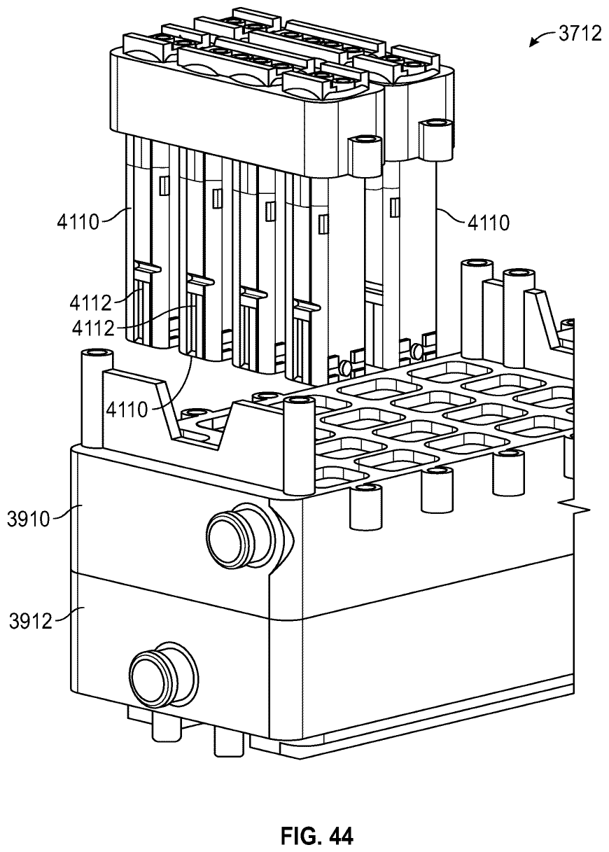

Manifold assemblies 3712 each include a bottom manifold 3910, a middle manifold 3912, and top manifold 3914. Bottom manifold 3910 defines valve cavities 3920 for each valve to be inserted into bottom manifold 3910. Middle manifold 3912 is glued to bottom manifold 3910 and three of top manifolds 3914. Top manifolds 3914 include channel aperture portions 3922 that each defines a plurality of channel apertures selectively coupled with pressurized air within manifold assemblies 3712 by actuation of valves 4110 illustrated in FIG. 44.

In the example provided, bottom manifold 3910, middle manifold 3912, and top manifolds 3914 are injection molded and glued such that manifold assemblies 3712 hold a working pressure of 30 psi with a safety factor of 6×.

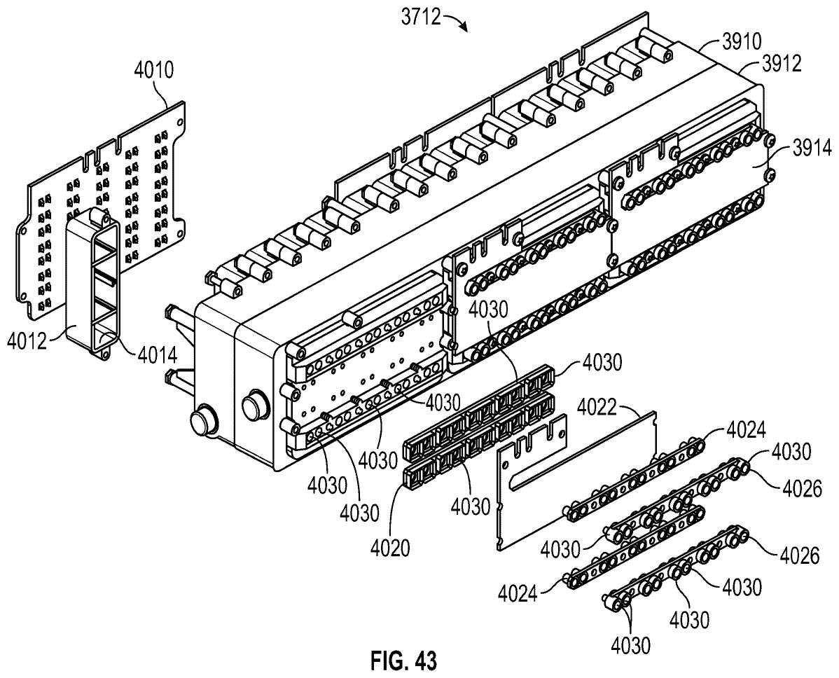

As seen in FIG. 43, valve boards 4010, valve housings 4012 defining valve cavities 4014, sensor gaskets 4020, channel sensor boards 4022, manifold connector gaskets 4024, and manifold connectors 4026 are assembled with manifold assemblies 3712.

Three valve boards 4010 are connected to bottom manifold 3910 with 15 valve housings 4012 collectively defining 60 valve cavities 4014 per manifold assembly 3712.

Six sensor gaskets 4020, three channel sensor boards 4022, six manifold connector gaskets 4024, and six manifold connectors 4026 are coupled to manifold assembly 3712.

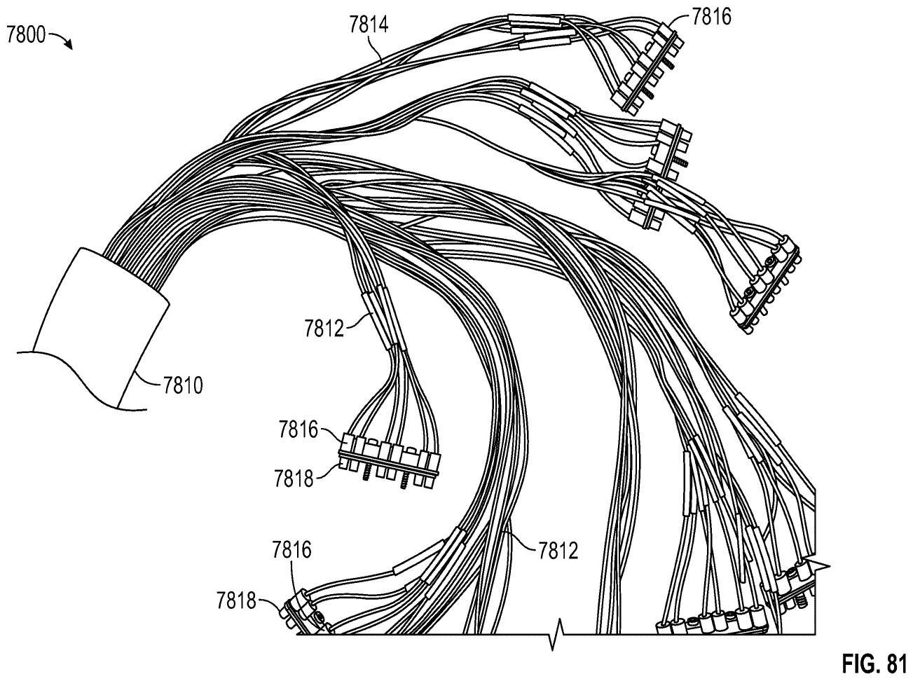

Each of top manifold 3914, sensor gaskets 4020, manifold connector gaskets 4024, and manifold connectors 4026 defines channel apertures 4030. The channel apertures 4030 collectively couple the plurality of channel apertures of channel aperture portions 3922 to a of tubing harness, where each channel aperture 4030 is coupled with a respective tube of a tubing harness, as best seen in FIG. 81. Accordingly, manifold assembly 3712 integrates many channels very tightly and enables a very dense assembly capable of high-performance proportional balance.

As seen in FIG. 44, valves 4110 each have two electrically actuated benders 4112. Each bender selectively blocks a very small air channel of channel aperture portions 3922. This arrangement forms two independent 2-2 valves for fully proportional control of the flow in each individual channel with very high fidelity.

### Compressor

### Pneumatic Flow Circuit

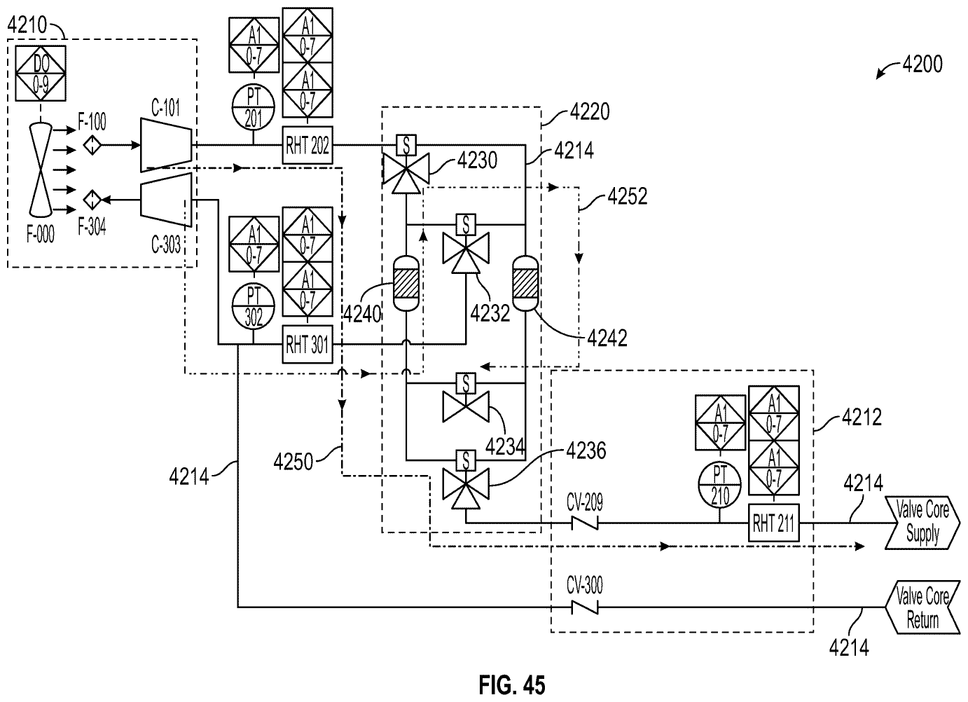

Referring now to FIG. 45, and with continued reference to FIGS. 34-44, a pneumatic diagram illustrates a pneumatic circuit 4200 for a compressor. For example, pneumatic circuit 4200 may illustrate pneumatic flow for compressor 3418. Pneumatic circuit 4200 illustrates how compressor 3418 uses pressure swing adsorption for pulling moisture out of the compressed air. Generally, pressurized air is passed through a desiccant where the desiccant beads will absorb water in the pressurized air. A separate airflow at a low pressure is simultaneously regenerating or taking the moisture back out of a second desiccant. In the example provided, a vacuum generated by compressor 3418 creates the low pressure to regenerate the desiccant faster and more fully than would be achieved with atmospheric pressure.

Pneumatic circuit 4200 includes a compressor and cooler portion 4210, inlet/outlet portion 4212, pneumatic conduits 4214, and desiccant portion 4220. In the example provided, compressor and cooler portion 4210 includes diaphragm pumps 3616. Inlet/outlet portion 4212 defines pressurized air supply and exhaust to valve core 3424.

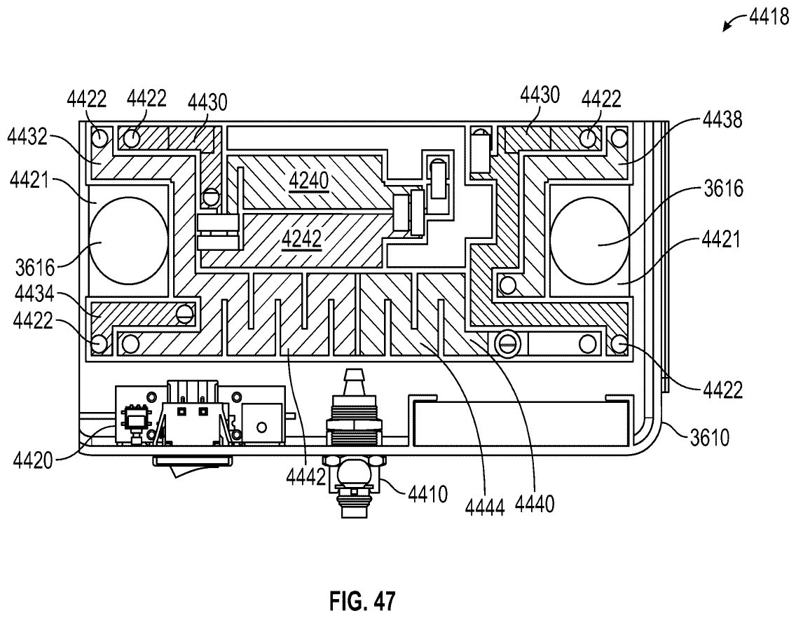

Pneumatic conduits 4214 couple the various parts of compressor 3418 to each other for pneumatic communication. In the example provided, pneumatic conduits 4214 are at least partially defined by pneumatic circuit body 3610, as will be described below with reference to FIG. 47.

Desiccant portion 4220 includes a first valve 4230, a second valve 4232, a third valve 4234, a fourth valve 4236, a first desiccant portion 4240, and a second desiccant portion 4242. Desiccant portion 4220 provides dry air to valve core 3424 with use of one of first desiccant portion 4240 or second desiccant portion 4242 while regenerating the other of first desiccant portion 4240 or second desiccant portion 4242 for continuous flow of dry air.

The valves 4230, 4232, 4234, 4236 operate to selectively provide a usable airflow 4250 and a desiccant regeneration airflow 4252. For the airflows illustrated with a first valve configuration, first valve 4230 directs usable airflow 4250 from compressor and cooler portion 4210 to first desiccant portion 4240 and fourth valve 4236 directs usable airflow 4250 from first desiccant portion 4240 to valve core 3424. For desiccant regeneration airflow 4252, third valve 4234 directs some bypass air from usable airflow 4250 through second desiccant portion 4242 and second valve 4232 directs desiccant regeneration airflow 4252 to a vacuum of compressor and cooler portion 4210. Accordingly, usable airflow 4250 provides a steady stream of dry air using first desiccant portion 4240 while desiccant regeneration airflow 4252 dries second desiccant portion 4242.

When first desiccant portion 4240 becomes saturated, usable airflow 4250 and desiccant regeneration airflow 4252 may be directed along different paths by a second valve configuration (not illustrated). For example, first valve 4230 may direct usable airflow 4250 from compressor and cooler portion 4210 to second desiccant portion 4242 and fourth valve 4236 may direct usable airflow 4250 from second desiccant portion 4242 to valve core 3424. In this configuration, third valve 4234 may direct desiccant regeneration airflow 4252 as bypass air from usable airflow 4250 to first desiccant portion 4240 and second valve 4232 may direct desiccant regeneration airflow 4252 from first desiccant portion 4240 to the exhaust of compressor and cooler portion 4210.

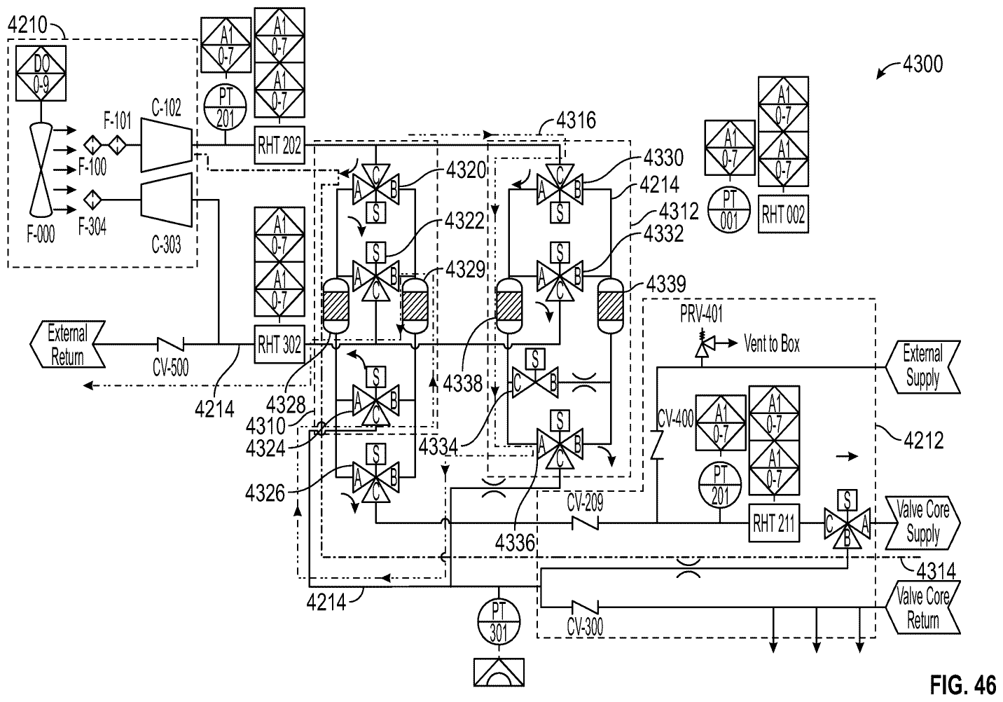

Referring now to FIG. 46, and with continued reference to FIGS. 34-45, a pneumatic diagram illustrates a pneumatic circuit 4300 for a compressor. For example, pneumatic circuit 4300 may illustrate a pneumatic flow for compressor 3418. Pneumatic circuit 4300 is similar to pneumatic circuit 4200, where like numbers refer to like components. Pneumatic circuit 4300, however, includes a first desiccant portion 4310 and a second desiccant portion 4312 that create a usable airflow 4314 and a desiccant regeneration airflow 4316.

First desiccant portion 4310 includes a first valve 4320, a second valve 4322, a third valve 4324, a fourth valve 4326, a first desiccant portion 4328, and a second desiccant portion 4329. Second desiccant portion 4312 includes a first valve 4330, a second valve 4332, a third valve 4334, a fourth valve 4336, a first desiccant portion 4338, and a second desiccant portion 4339.

Usable airflow 4314 continuously flows through one of first desiccant portion 4328 or second desiccant portion 4329. Desiccant regeneration airflow 4316 continuously flows through one of first desiccant portion 4338 or second desiccant portion 4339. First desiccant portion 4338 and second desiccant portion 4339 may be reduced in size relative to desiccants of pneumatic circuit 4200 and desiccant regeneration airflow 4316 may have a reduced flow.

First valve 4320 and fourth valve 4326 cooperate to direct usable airflow 4314 through one of first desiccant portion 4328 and second desiccant portion 4329 from compressor and cooler portion 4210 to valve core 3424. Third valve 4324 and second valve 4322 cooperate to direct desiccant regeneration airflow 4316 through the other of first desiccant portion 4328 and second desiccant portion 4329 from second desiccant portion 4312 to the vacuum of compressor and cooler portion 4210. First valve 4330 and fourth valve 4336 cooperate to direct desiccant regeneration airflow 4316 from compressor and cooler portion 4210 to first desiccant portion 4310.

### Pneumatic Circuit and Sound Suppression Features

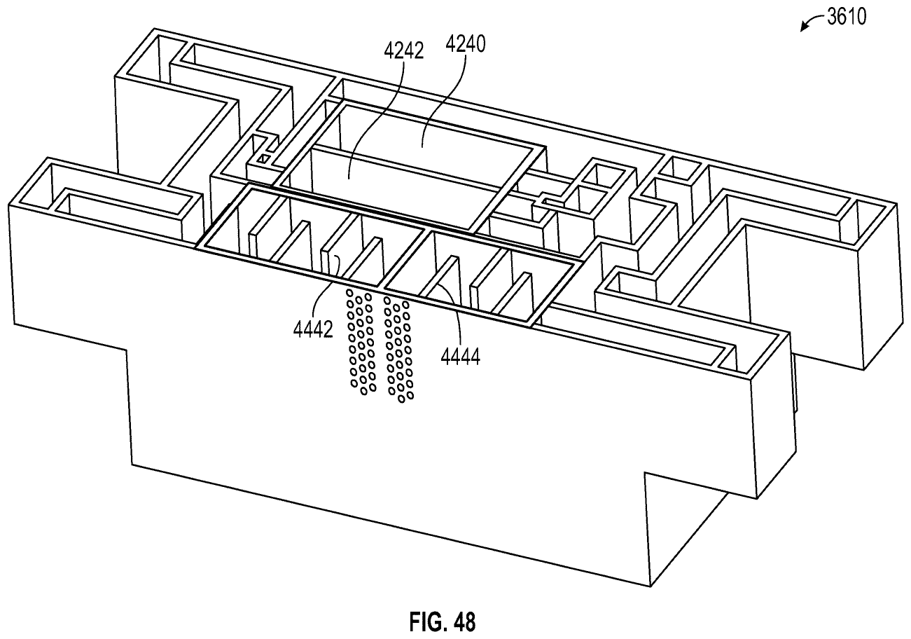

Referring now to FIGS. 47-48, a top view and a perspective view illustrate details of compressor 3418 and pneumatic circuit body 3610. As previously described, features of compressor 3418 enable a compact, lightweight, and quiet drive system 3110 that provides continuous dry air without the need to add new desiccants. As seen in FIG. 47, compressor 3418 further includes supplemental pneumatic connections 4410, an input/output board 4420, and compressor gaskets 4421.

Supplemental pneumatic connections 4410 are optional connections for users that need a higher air demand than the compressor can supply. In the example provided, supplemental pneumatic connections 4410 use quick disconnect fittings for rapid connection and disconnection.

Diaphragm pumps 3616 provide positive pressure and a vacuum. In the example provided, diaphragm pumps 3616 are small pumps conventionally used for medical applications such as in oxygen concentrators. Diaphragm pumps 3616 oppose each other in compressor 3418 and are driven out of phase to cancel out vibrations. For example, the diaphragm pumps 3616 may be cooperatively energized for the out of phase vibration cancelation. In some embodiments, the phase driving and orientation features may be used for about 100 times average vibration energy reduction relative to conventional compressors.

Pneumatic circuit body 3610 defines pneumatic conduits to route usable airflow 4250 and desiccant regeneration airflow 4252 between the various valves and components of compressor 3418. In the example provided, pneumatic circuit body 3610 defines apertures 4422, a first conduit 4430, a second conduit 4432, a third conduit 4434, a fourth conduit 4436, a fifth conduit 4438, and a sixth conduit 4440.

Apertures 4422 couple the various conduits to the various valves and components of compressor 3418. Second conduit 4432 includes a sound absorbing portion 4442 that includes a sound absorbing material. Sixth conduit 4440 includes a sound absorbing portion 4444 that includes a sound absorbing material. In the example provided, the conduits of pneumatic circuit body 3610 are integrally formed in a plastic material of pneumatic circuit body 3610 to provide pneumatic routing to air components, pressure sources, and vacuum sources. Accordingly, tubing within compressor 3418 may be reduced relative to conventional compressor assemblies.

In the example provided, user input/output board 4420 includes a kill switch, a power receptacle, a USB Type-B port, a reset switch, and a WiFi connect button. The kill switch cuts power in the event top enclosure 3412 separates from bottom enclosure 3410. In the example provided, the kill switch is a board mounted optical flag sensor that is triggered by a rib in top enclosure 3412. Input/output board 4420 may be mounted by any suitable method, including by fasteners or by heat staking. A power cable and ribbon cable connect input/output board 4420 to main control board 3510.

Compressor gaskets 4421 are elastomeric and have a shape and arrangement to permit movement of diaphragm pumps 3616 relative to pneumatic circuit body 3610. Permitting movement restricts vibration transmission from diaphragm pumps 3616 to pneumatic circuit body 3610. Additional gaskets at gasketed channels 3710 and connections through to strap system 3422 dampen vibrations to limit vibrations felt by the user. In the example provided, each gasket at each gasketed connection is tuned in thickness, durometer, diameter, shape, and other properties based on the frequency and amplitude of vibrations measured at the gasket location in the absence of the gasket.

In some embodiments, a compressor assembly includes a housing, a first compressor, a second compressor, and an outlet portion. For example, the housing defining a first end and a second end opposing the first end may be pneumatic circuit body 3610, top cover 3612, and bottom cover 3614. The first and second compressor may be diaphragm pumps 3616. The outlet portion for providing compressed air from the compressor assembly may be compressor and cooler portion 4210.

In some embodiments, the compressor assembly includes a main body that defines a pneumatic circuit with a plurality of integral pneumatic conduits. For example, the main body may be pneumatic circuit body 3610 and the internal pneumatic conduits may include first conduit 4430, second conduit 4432, third conduit 4434, fourth conduit 4436, fifth conduit 4438, and/or sixth conduit 4440.

In some embodiments, the compressor assembly further includes a plurality of valves each in pneumatic communication with at least one of the plurality of integral pneumatic conduits. For example, the plurality of valves may include first valve 4230, second valve 4232, and third valve 4234. In another example, the plurality of valves includes first valve 4320, second valve 4322, third valve 4324, fourth valve 4326, first valve 4330, second valve 4332, third valve 4334, and fourth valve 4336.

In some embodiments, the main body defines a first aperture and a second aperture in each of the plurality of integral pneumatic conduits. For example, pneumatic circuit body 3610 may define apertures 4422. In some embodiments, each of the plurality of valves is in direct pneumatic communication with at least one of the first aperture and the second aperture of at least one of the plurality of integral pneumatic conduits.

In some embodiments, the plurality of integral pneumatic conduits defines a first desiccant conduit and a second desiccant conduit, where the first desiccant conduit defines a first desiccant portion between the first aperture and the second aperture of the first desiccant conduit, and wherein the second desiccant conduit defines a second desiccant portion between the first aperture and the second aperture of the second desiccant portion. For example, pneumatic circuit body 3610 may define first desiccant portion 4240 and second desiccant portion 4242.

In some embodiments, the plurality of integral pneumatic conduits define at least one sound absorbing portion configured to muffle sound traveling through the pneumatic circuit. For example, pneumatic circuit body 3610 may define sound absorbing portion 4442 and/or sound absorbing portion 4444. In some embodiments, a sound absorbing material is disposed in the at least one sound absorbing portion.

In some embodiments, the compressor assembly further includes a first desiccant portion, a second desiccant portion, and a plurality of valves configured to direct a first airflow and a second airflow. For example, the first desiccant portion may be first desiccant portion 4240 or first desiccant portion 4328. The second desiccant portion may be, for example, second desiccant portion 4242 or second desiccant portion 4329.

In some embodiments, the plurality of valves has a first configuration and a second configuration. The first configuration directs the first airflow from the first compressor and the second compressor through the first desiccant portion to the outlet. The first configuration further directs the second airflow from the first airflow through the second desiccant portion for desiccant drying in the second desiccant portion. For example, the first configuration may be the valve positions illustrated in FIG. 45 or in FIG. 46 resulting in the illustrated usable airflow 4250, desiccant regeneration airflow 4252, usable airflow 4314, and desiccant regeneration airflow 4316.

In some embodiments, the second configuration directs the first airflow from the first compressor and the second compressor through the second desiccant portion to the outlet. The second configuration further directs the second airflow from the first airflow through the first desiccant portion for desiccant drying in the first desiccant portion. For example, the second configuration may be where first valve 4230 directs usable airflow 4250 through second desiccant portion 4242 or where first valve 4320 directs usable airflow 4314 through second desiccant portion 4329. In some embodiments, first desiccant portion 4338 is a third desiccant portion and second desiccant portion 4339 is a fourth desiccant portion.

In some embodiments, the second airflow begins at a portion of the first airflow. For example, the first configuration may direct desiccant regeneration airflow 4252 beginning at third valve 4234 in pneumatic communication with usable airflow 4250. In some embodiments, the first and the second configuration may direct the second airflow beginning at the first airflow before the first airflow passes through either of the first desiccant portion or the second desiccant portion. For example, first valve 4330 may direct desiccant regeneration airflow 4316 branching from usable airflow 4314 between compressor and cooler portion 4210 and first valve 4320.

### Testing and Assembly Processes for the Drive System

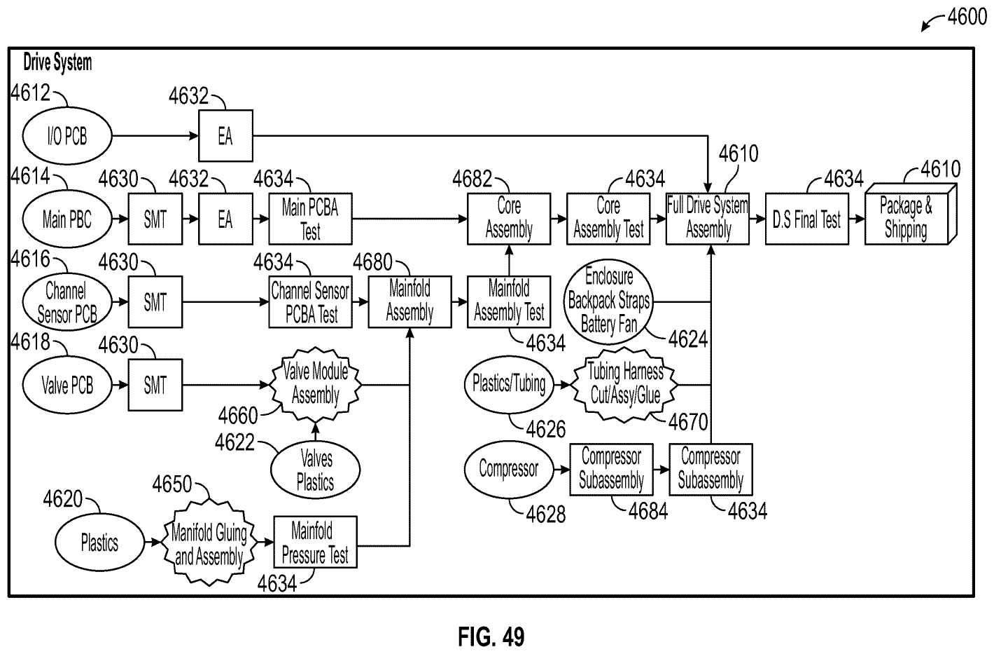

Referring now to FIG. 49, a process diagram illustrates testing and assembly processes 4600 for the drive system 3110 in accordance with the teaching of the present disclosure.

Testing and assembly processes 4600 describe assembly of a full drive system 4610 from an input/output PCB 4612, a main PCB 4614, a channel sensor PCB 4616, a valve PCB 4618, plastic components 4620, valves for plastics 4622, drive system miscellaneous parts 4624, plastics and tubing 4626, and compressor pneumatic circuit 4628.

The processes include SMT electrical processes 4630, EA electrical processes 4632, and suitability tests 4634. The processes further include a manifold gluing and assembly process 4650, a valve module assembly process 4660, and a tubing harness cut/assembly/glue process 4670.

Manifold gluing and assembly process 4650 includes: placing three top manifolds in a holding device, use gluing robot to apply cyanoacrylate glue or similar to the top manifolds, place middle manifold on top manifolds, use gluing robot to apply Cyanoacrylate glue or similar to the middle manifold, place the bottom manifold on the middle manifold, clamp parts together, and pressure test. Clamping continues until curing is complete.

Valve module assembly process 4660 includes: placing two pressure sensor gaskets on each channel sensor board, securing three channel sensor boards to the manifold plastic assembly using screws, and installing three valve boards to the manifold plastic assembly using snap arms.

Tubing harness cut/assembly/glue process 4670 is described below with reference to FIG. 55.

Through the testing and assembly processes 4600, intermediate assemblies for a manifold assembly 4680, a core assembly 4682, and a compressor assembly 4684 are created.

Assembly of full drive system 4610 includes a first task to slip backpack strap buckles through slots in the bottom enclosure and flatten the buckles against the ribs in the bottom enclosure. A second task is to place the valve core and compressor assembly into the bottom enclosure. A third task is to secure multi-channel pneumatic connectors in the bottom enclosure. A fourth task is to insert the cooling fan into the bottom enclosure and connect wires to the main board. A fifth task is to insert the input/output board into the bottom enclosure and use screws or heat staking to secure the input/output board. A sixth task is to insert the power switch into the bottom enclosure and connect the cable harness. A seventh task is to connect wires to the switch and input/output board. An eighth task is to insert quick connect pneumatic fittings into the bottom enclosure. A ninth task is to connect tubing to the compressor housing. A tenth task is to attach a peripheral data cable harness to the bottom enclosure and to the Main Board. An eleventh task is to place the top enclosure on the bottom enclosure and fasten with screws. A twelfth task is to insert the battery. A thirteenth task is to test full drive system 4610.

### Glove Peripherals

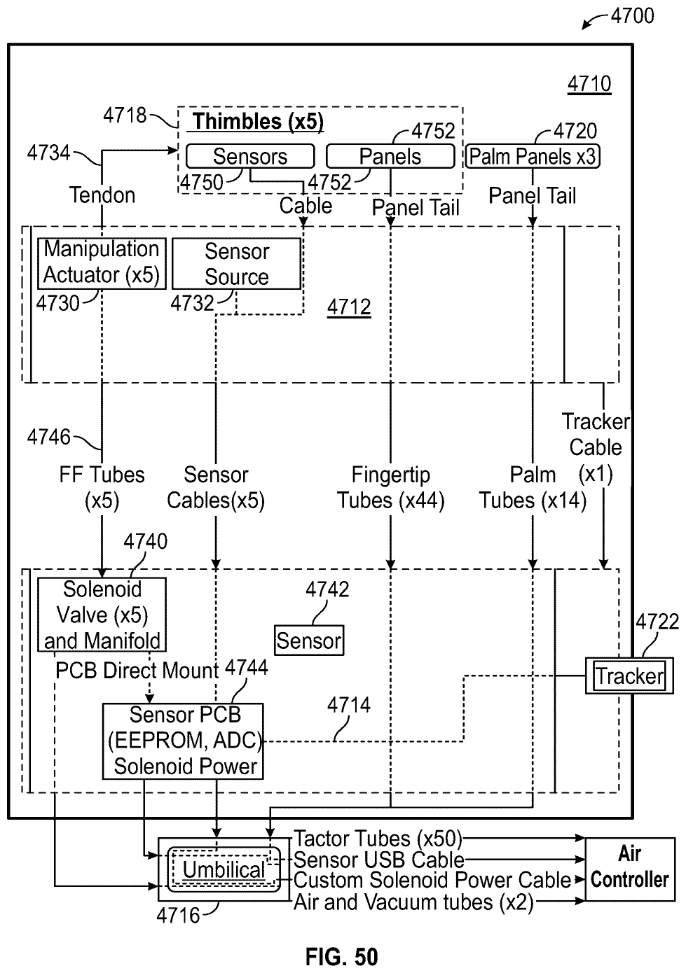

Referring now to FIG. 50, and with continued reference to FIGS. 34-49, electronics of a glove assembly 4700 are illustrated in a simplified block diagram in accordance with the teachings of the present disclosure. Glove assembly 4700 is a haptic feedback glove that includes an interface laminate with a plurality of tactile actuators coupled to the skin of the user's hand. Glove assembly 4700 includes an opisthenar assembly 4712, a wrist assembly 4714, an umbilical assembly 4716, thimble assemblies 4718, palm panels 4720, and a tracker 4722.

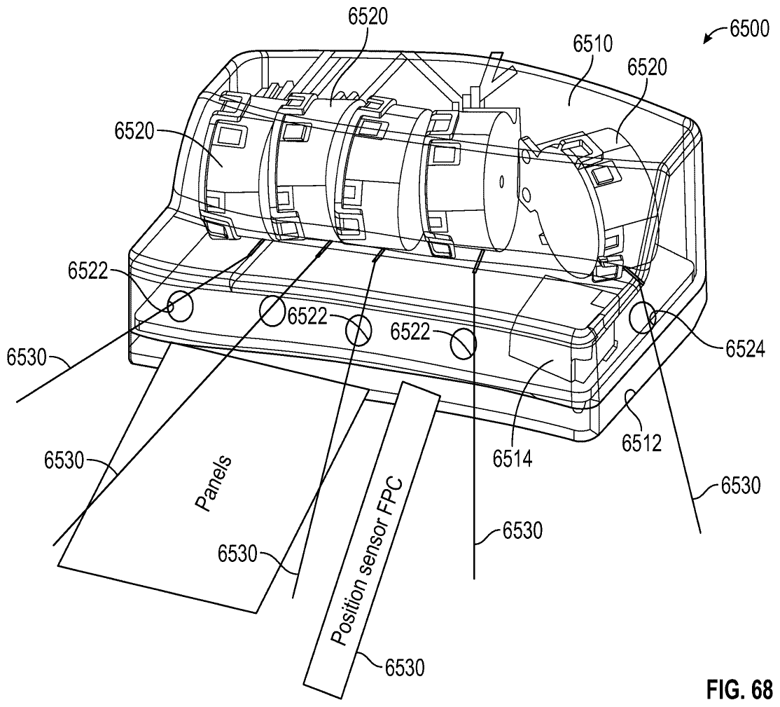

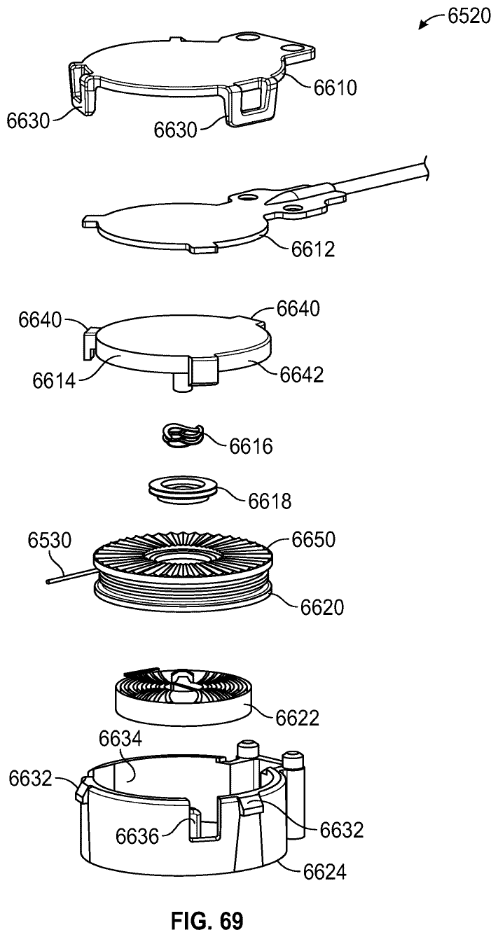

Opisthenar assembly 4712 is disposed on the back of glove assembly 4700 corresponding to the dorsal side of the user's hand. Opisthenar assembly 4712 includes manipulation actuators 4730 and a magnetic emitter 4732. Manipulation actuators 4730 control tendons 4734 that each provides force feedback to a finger of the user's hand, as will be explained below with reference to FIGS. 68-69. Magnetic emitter 4732 may be an example of magnetic emitter 3230.

Wrist assembly 4714 is disposed on a back of the glove corresponding to the back of the user's wrist. Wrist assembly 4714 includes solenoid valves 4740, a position sensor 4742, and a sensor PCB 4744. Solenoid valve 4740 selectively permits compressed air to enter force feedback tubes 4746 for actuation of manipulation actuators 4730. Position sensor 4742 may be an example of position sensors 3232. Sensor PCB 4744 receives signals from position sensors 4750 and position sensor 4742 to calculate the relative position to sensor source 4732. In some embodiments, wrist assembly 4714 includes fewer components. For example, solenoid valve 4740 may be omitted in wrist assembly 4714 in favor of valve control from the drive unit.

Umbilical assembly 4716 connects drive system 3110 to gloves 3112. In the example provided, umbilical assembly 4716 includes 59 pneumatic tubes for actuators in glove assembly 4700, a sensor USB cable, a solenoid power cable, and two air and vacuum tubes for air supply to solenoid valve manifold 4740.

Thimble assemblies 4718 provide tactile feedback to the user, provide counterpressure for the tactile feedback, provide a kinematic termination for tendons 4734, and define the location of position sensors for finger portions of glove assembly 4700. In the example provided, thimble assemblies 4718 include position sensors 4750 and tactile panels 4752.

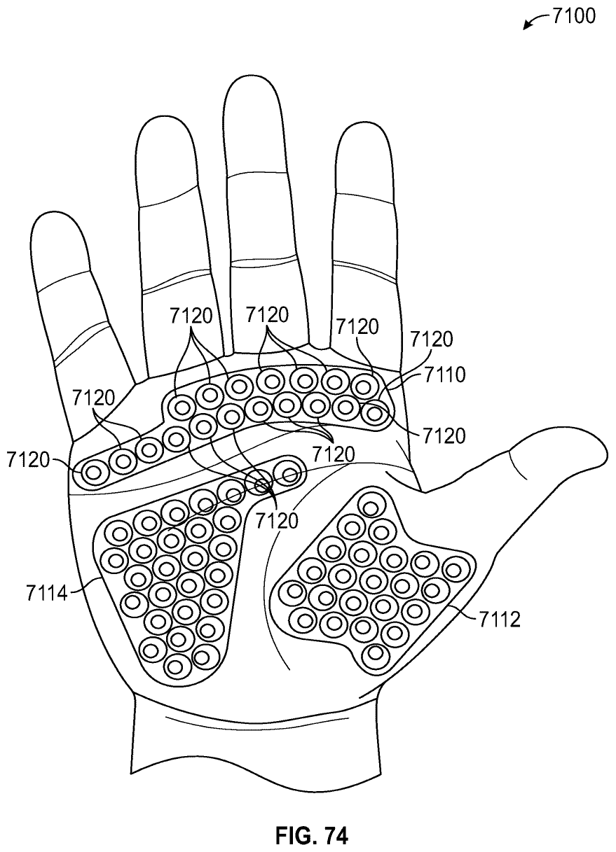

Palm panels 4720 includes tactors for tactile feedback to a palm of the user, as is discussed below with reference to FIG. 74. Tracker 4722 may be an example of motion tracker 3238.

Referring now to FIG. 51, and with continued reference to FIGS. 34-50, a process diagram illustrates testing and assembly processes 4800 for a glove assembly 4810 in accordance with the teaching of the present disclosure. For example, testing and assembly processes 4800 may be used for glove assembly 4700 or gloves 3112.

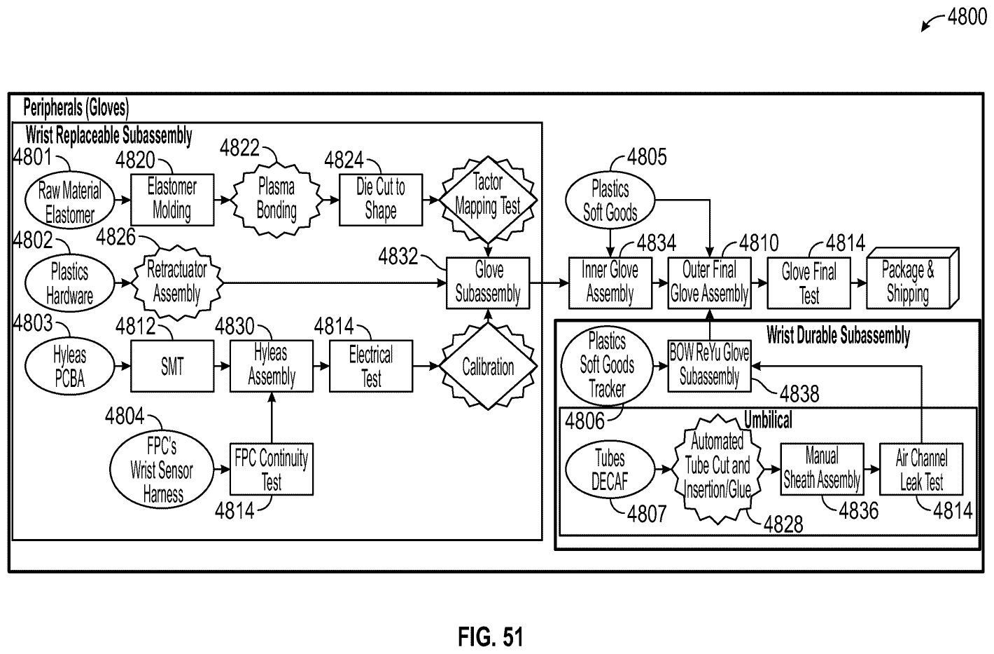

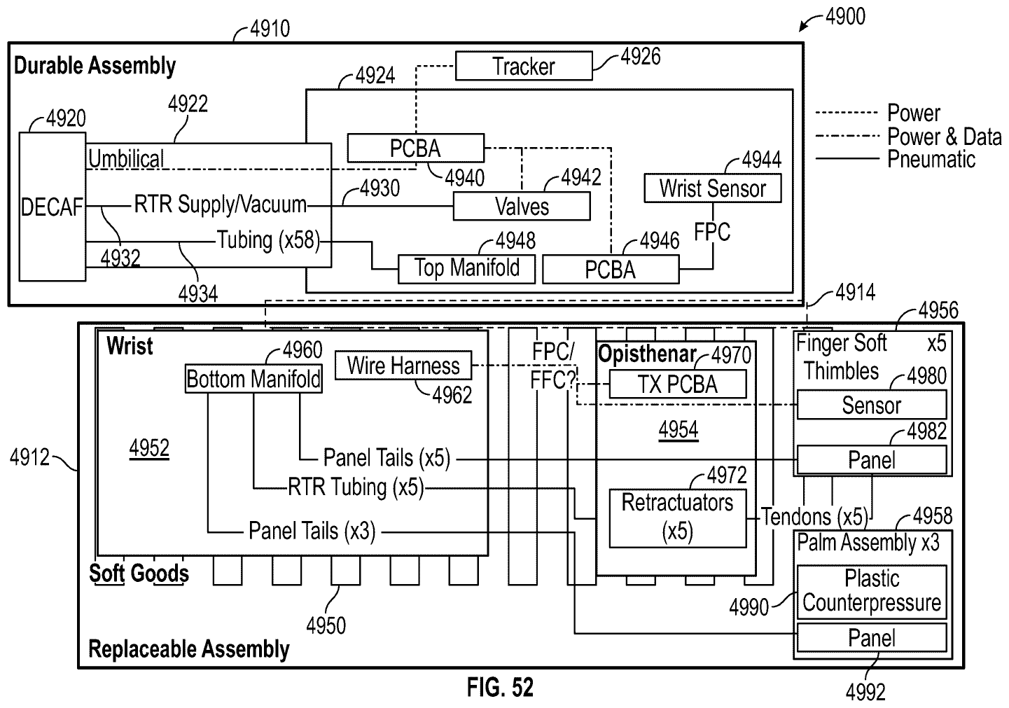

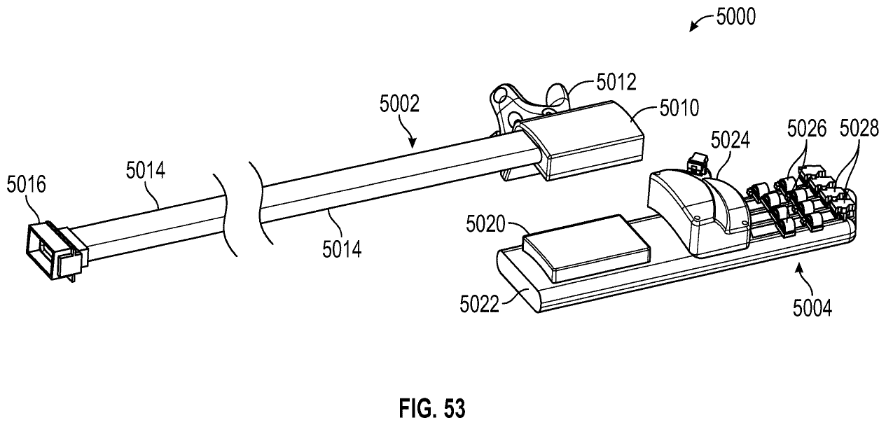

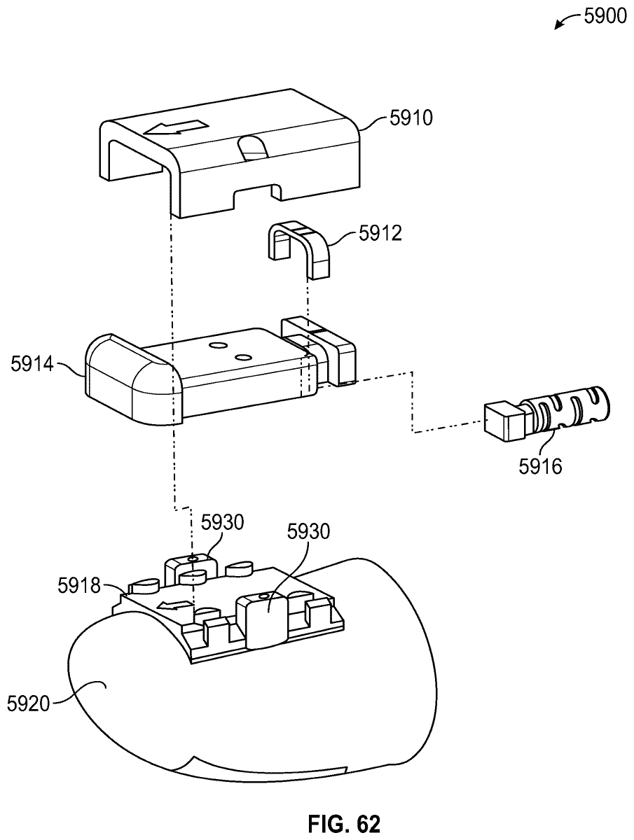

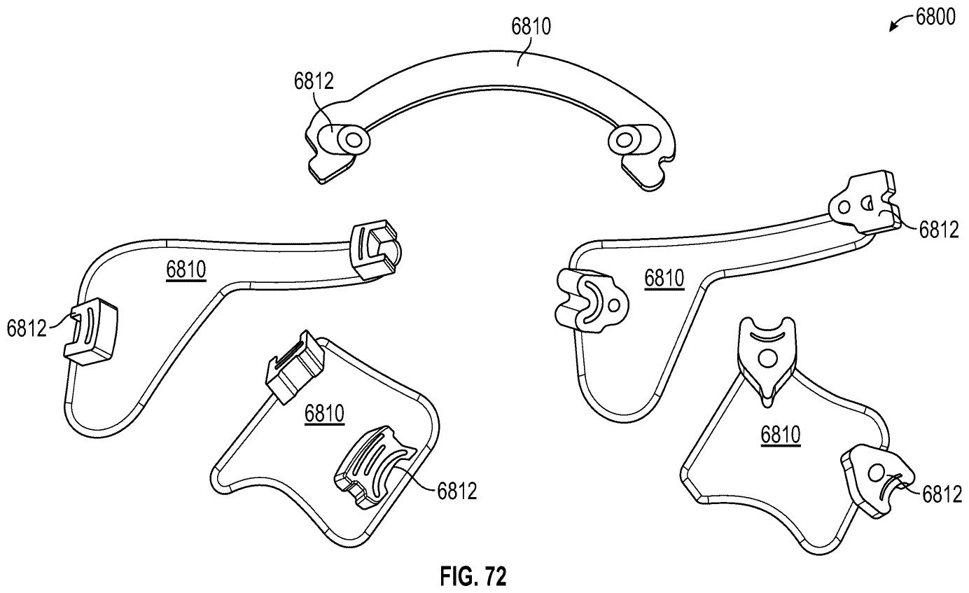

Testing and assembly processes 4800 result in glove assembly 4810 with inputs of an elastomeric material 4801, plastics and hardware 4802, a position sensor PCBA 4803, FPC 4804 for wrist sensor and position sensor harness, plastics and soft goods 4805, plastics and soft goods and tracker 4806, and tubes and multi-channel pneumatic connector 4807. In the example provided, elastomeric material 4801 is a sheet formed from a raw material elastomer, such as a high consistence rubber material, and may also be known as gum stock silicone. Plastics and hardware 4802 include components described with reference to FIG. 72 below. Position sensor PCBA 4803 may be an example of sensor PCB 4744. FPCs 4804 may include various electronic components illustrated in FIG. 52. Plastics and soft goods 4805 may include various components from FIGS. 62-65 described below. Plastics and soft goods and tracker 4806 may include various components from FIG. 53 described below. Tubes and multi-channel pneumatic connector 4807 may include various components shown and described in FIG. 71 below. The inputs may, for example, be assembled or manufactured by the assembling entity in other processes in the same manufacturing facility or by other entities, such as by suppliers.

Testing and assembly processes 4800 include an SMT electrical process 4812, suitability test processes 4814, an elastomer molding process 4820, a plasma bonding process 4822, a die cut to shape process 4824, a manipulation actuator assembly process 4826, and an automated tube cut and insertion/glue process 4828.

Through testing and assembly processes 4800, intermediate assemblies for a position sensor assembly 4830, a replaceable glove subassembly 4832, an inner glove assembly 4834, a manual sheath assembly 4836, and a wrist durable subassembly 4838 are created.

### Replaceable-Durable Assembly

Referring now to FIG. 52, and with continued reference to FIGS. 34-51, a simplified block diagram illustrates a replaceable-durable assembly 4900. Replaceable-durable assembly 4900 includes a durable subassembly 4910 and a replaceable subassembly 4912. Durable subassembly 4910 and replaceable subassembly 4912 each include components on an interface 4914. The physical locations of durable subassembly 4910 and replaceable subassembly 4912 may vary and span several assemblies described elsewhere based on physical location. In the example provided, wrist assembly 4714 spans durable subassembly 4910 and replaceable subassembly 4912.

Durable subassembly 4910 has items with longer service lives than at least some of those of replaceable subassembly 4912. Durable subassembly 4910 includes a multi-channel pneumatic connector 4920, an umbilical 4922, a durable wrist subassembly 4924, and a tracker 4926.

Umbilical 4922 includes a power and data cable 4930, manipulation actuator pneumatic tubing 4932, and tactor tubing 4934. In the example provided, umbilical 4922 includes a protective sheath to limit damage to power and data cable 4930, manipulation actuator pneumatic tubing 4932, and tactor tubing 4934.

Multi-channel pneumatic connector 4920 is a connector for power and data cable 4930, manipulation actuator pneumatic tubing 4932, and tactor tubing 4934 to connect to a drive system, such as drive system 3110. Multi-channel pneumatic connector 4920 may be an example of the multi-channel pneumatic connector described with reference to FIG. 55 below.

Durable wrist subassembly 4924 includes wrist PCBA 4940, miniature pneumatic valves 4942, wrist position sensor 4944, position sensor PCBA 4946, and top manifold 4948. Wrist PCBA 4940 includes electronics to control miniature pneumatic valves 4942, interact with tracker 4926, and to interact with position sensor PCBA 4946. Position sensor PCBA 4946 includes electronics to interact with wrist position sensor 4944.

Miniature pneumatic valves 4942 may be VOVK valves commercially available from FESTO. Tracker 4926 may be an example of motion tracker 3238.

Replaceable subassembly 4912 includes gloves 4950, replaceable wrist subassembly 4952, opisthenar subassembly 4954, finger thimbles 4956, and palm assembly 4958.

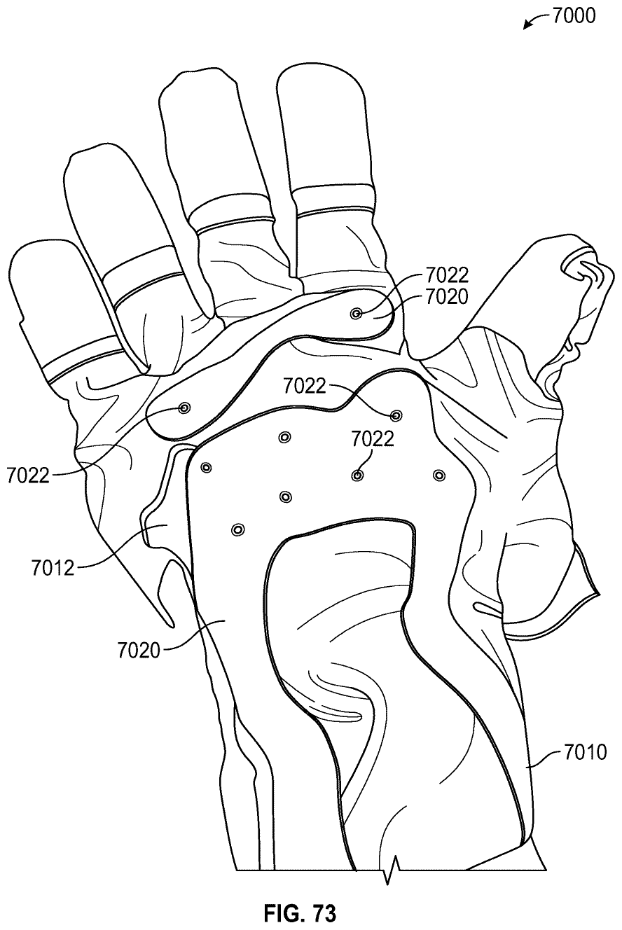

Gloves 4950 may include an inner glove and an outer glove, as described below with reference to FIGS. 73-79. Gloves 4950 may come in various sizes to support different sized hands of users. Gloves 4950 are generally less durable than other components of replaceable-durable assembly 4900 due to wear from use.

Replaceable wrist subassembly 4952 includes a bottom manifold 4960 and a position sensor wire harness 4962. Opisthenar subassembly 4954 includes a magnetic emitter PCBA 4970 and manipulation actuators 4972. Magnetic emitter PCBA 4970 may be an example of magnetic emitter 3230. Manipulation actuators 4972 may be an example of manipulation actuators 4730.

Finger thimbles 4956 each include a position sensor 4980 and a panel 4982. Position sensor 4980 may be an example of position sensors 3232 that track a position of each finger. Panel 4982 may be an example of tactile panels 4752 that provide tactile feedback.

Palm assembly 4958 includes a plastic counterpressure portion 4990 and a panel 4992. Plastic counterpressure portion 4990 supports counterpressure grounded at opisthenar subassembly 4954 as shown below in FIGS. 71-74. Panel 4992 may be an example of palm panel 4720.

In the example provided, interface 4914 is defined in part by connections between top manifold 4948 and bottom manifold 4960. In the example provided, interface 4914 is further defined in part by connections between position sensor PCBA 4946 and position sensor wire harness 4962. The electrical connections may be any suitable connections for power and data. In the example provided, the connection between top manifold 4948 and bottom manifold 4960 utilizes face seals, as discussed below with reference to FIGS. 55-57.

In some embodiments, replaceable subassembly 4912 includes only gloves 4950, finger panels 4982, and palm panel 4992 with the other components of replaceable-durable assembly 4900 disposed in durable subassembly 4910. For example, durable subassembly 4910 may include finger thimbles 4956 without panel 4982 and palms 4958 without panel 4992. In such embodiments, interface 4914 includes pneumatic connections at each of panels 4982 and panel 4992 for actuation of the respective panel 4982 or panel 4992. For example, the pneumatic connections may be similar to the face seals discussed below with reference to FIGS. 55-57.

In some embodiments, replaceable subassembly 4912 includes gloves 4950, finger thimbles 4956, and palms 4958 with the other components of replaceable-durable assembly 4900 disposed in durable subassembly 4910.

In some embodiments, replaceable subassembly 4912 includes gloves 4950, finger thimbles 4956, palm assembly 4958, and sensor signal electronics with the other components of replaceable-durable assembly 4900 disposed in durable subassembly 4910. For example, the sensor signal electronics may include analog to digital conversion electronics to limit the travel and degradation of analog sensor signals. In some embodiments, the sensor signal electronics are integrated with position sensors 4980.

In some embodiments, durable subassembly 4910 includes a top housing that is coupled to a bottom housing of replaceable subassembly 4912 using clips or screws.

Referring now to FIG. 53, and with continued reference to FIGS. 34-52, a perspective view illustrates an example of a replaceable-durable assembly 5000. In the example provided, reusable assembly 5000 is an implementation of replaceable-durable assembly 4900.

Peripheral assembly 3210 includes a durable subassembly 5002 and a replaceable subassembly 5004.

Durable subassembly 5002 includes a wrist reusable assembly 5010, a tracker 5012, an umbilical 5014, and a glove connector 5016. Wrist reusable assembly 5010 may be an example of durable wrist subassembly 4924. Tracker 5012 may be an example of motion tracker 3238. Umbilical 5014 may be an example of umbilical 4922. Glove connector 5016 may have electronic connections and pneumatic connections as described below with reference to FIG. 55.

Replaceable subassembly 5004 includes a wrist replaceable subassembly 5020, soft goods 5022, an opisthenar assembly 5024, tendon guides 5026, and thimble assemblies 5028. Wrist replaceable subassembly 5020 may be an example of replaceable wrist subassembly 4952.

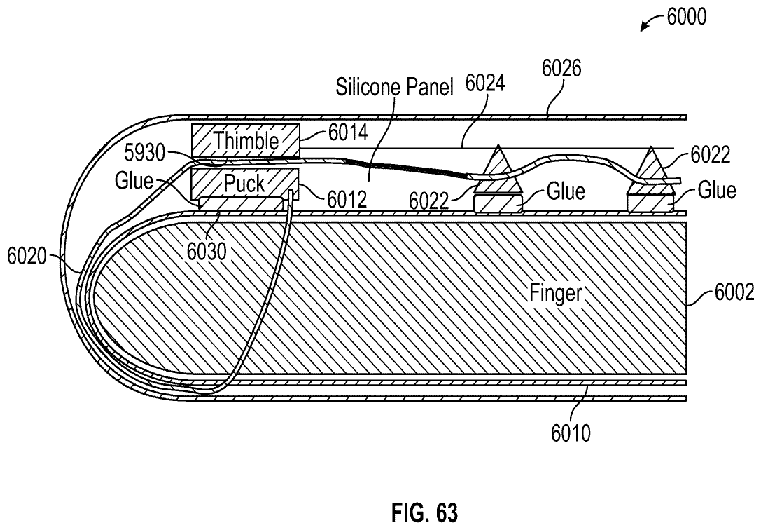

Soft goods 5022 may include gloves, fabrics, flexible rubbers, and other materials and components consistent with the “soft goods” engineering term of art. Opisthenar assembly 5024 may be an example of opisthenar subassembly 4954. Tendon guides 5026 provide guides for force feedback tendons, as will become apparent with reference to FIGS. 63-65 discussed below.

Thimble assemblies 5028 may be examples of finger thimbles 4956 for providing tactile feedback and terminating force feedback to a user's fingers, as will become apparent with reference to FIGS. 62-63, as discussed below.

By including opisthenar assembly 5024 and wrist replaceable subassembly 5020 separated by soft goods 5022, wrist mobility is retained for the user.

### Multi-Channel Pneumatic Connector

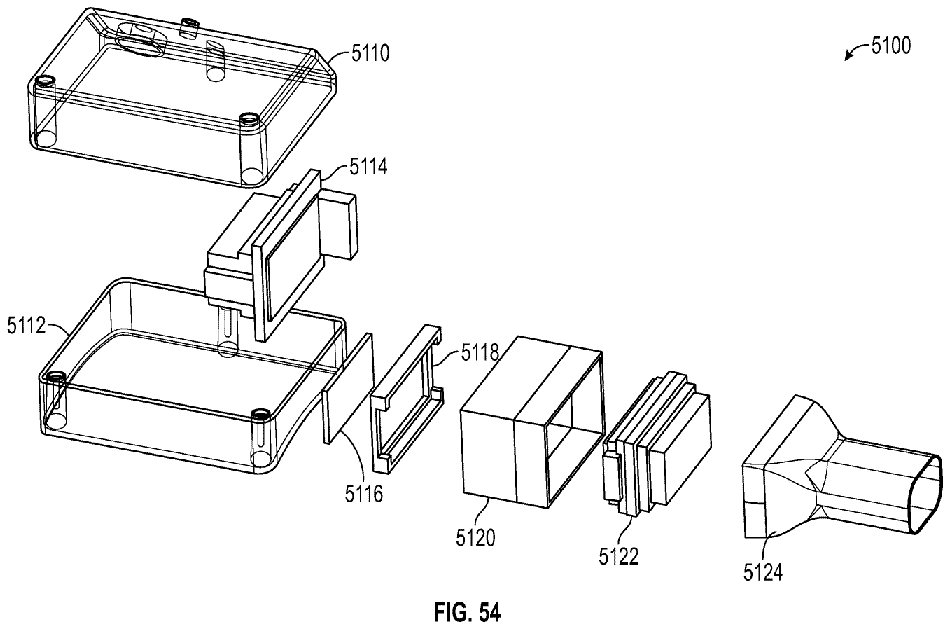

Referring now to FIG. 54, and with continued reference to FIGS. 34-53, an exploded view illustrates a multi-channel pneumatic connector 5100. Multi-channel pneumatic connector 5100 is a compact assembly for connecting a large and dense assembly of tubing to other pneumatic conduits. In the example provided, multi-channel pneumatic connector 5100 connects tubes from drive system 3110 to wrist assembly 4714. In the example provided, multi-channel pneumatic connector 5100 is a straight plug connector. In some embodiments, multi-channel pneumatic connector 5100 is a threaded twist connector.

Multi-channel pneumatic connector 5100 includes a wrist top shell 5110, a wrist bottom shell 5112, a console insert 5114, a gasket 5116, a face plate 5118, a shell 5120, an umbilical insert 5122, and an umbilical sheath 5124.

Wrist top shell 5110 and a wrist bottom shell 5112 couple together to form a housing. Gasket 5116 seals against console insert 5114 and umbilical insert 5122 to restrict air leakage.

Sheath 5124 holds tubing and cables and is captured between shell 5120 and umbilical insert 5122. Shell 5120 and face plate 5118 snap together with umbilical insert 5122.

In the example provided, multi-channel pneumatic connector 5100 is injection molded and couples umbilical insert 5122 and umbilical insert 5122 using clips.

Referring now to FIGS. 55-57, and with continued reference to FIGS. 34-54, a multi-channel pneumatic connector 5200 is illustrated in a cutaway view in accordance with the teachings of the present disclosure. In the example provided, multi-channel pneumatic connector 5200 connects tubing to tactile panels.

Multi-channel pneumatic connector 5200 includes tubing 5210, tubing connector 5212, and pneumatic component 5214. In the example provided, pneumatic component 5214 is a tactile panel. It should be appreciated that multi-channel pneumatic connector 5200 may be used at any tubing termination point without departing from the scope of the present disclosure.

Tubing connector 5212 defines air channels 5220, tubing receiving portions 5222, glue receiving portions 5224, and face seal apertures 5226. Air channel 5220 couples tubing 5210 to the respective face seal aperture 5226 for fluid communication.

In the example provided, tubing receiving portion 5222 is substantially cylindrical with a tubing stop face 5227 against which tubing 5210 may be pressed during assembly. In the example provided, glue receiving portion 5224 is substantially conically shaped with a reducing diameter as glue receiving portion 5224 extends into tubing connector 5212.

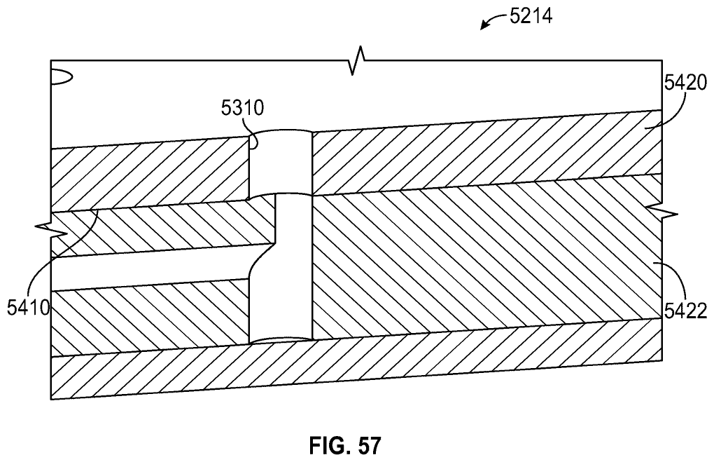

Pneumatic component 5214 defines face seal apertures 5310 and air channels 5410, as can best be seen in FIG. 55 and FIG. 57, respectively. In the example provided, air channels 5410 are each in fluid communication with at least one tactor in a tactile panel.

In the example provided, pneumatic component 5214 is formed from a channel side silicone layer 5420 plasma bonded onto a molded elastomer layer 5422. Face seal apertures 5310 are cut into pneumatic component 5214 to make a connection between the upper surface of channel side silicone layer 5420 and air channels 5410 of molded elastomer layer 5422.

### Tactile Panels

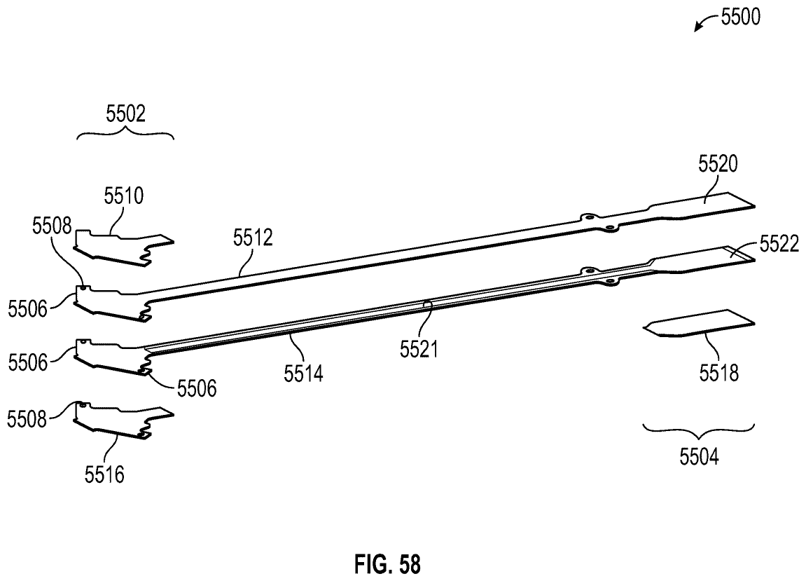

Referring now to FIG. 58, and with continued reference to FIGS. 34-57, a tactile panel assembly 5500 is illustrated in an exploded view in accordance with some embodiments. Tactile panel assembly 5500 includes a reinforced sheeting layer 5510, a channel side silicone layer 5512, a molded elastomer layer 5514, a tactor side silicone layer 5516, and a panel tail silicone layer 5518. Tactile panel assembly 5500 defines a tactor side 5502 and a connector side 5504. Tactor side 5502 defines wings or tabs 5506 with through-holes 5508. In the example provided, tabs 5506 wrap around a finger of a user and through-holes 5508 accommodate securement of tactile panel assembly 5500 to a fingertip assembly of the glove assembly, as will be described below with reference to FIG. 63.

Reinforced sheeting layer 5510 provides backpressure to support flexibility in thimble assemblies. Reinforced sheeting layer 5510 is plasma bonded to channel side silicone layer 5512. In the example provided, reinforced sheeting layer 5510 is formed from a fabric reinforced silicone. Reinforced sheeting layer 5510 has a shape that cooperates with fingertip assembly plastics to provide counter pressure tasks for grounding forces from the tactors and from the force feedback tendon pulling on the user's finger. The fabric reinforced silicone is strong enough for these counterpressure tasks and grounding forces while still permitting tactile panel assembly 5500 to be flexible enough for stretching to accommodate fingertip size variations while still providing sufficient counter pressure for good tactile sensations. The fabric reinforced silicone is further flexible enough for improved realistic interaction with physical props when compared with rigid plastic fingertips.

Channel side silicone layer 5512, tactor side silicone layer 5516, and panel tail silicone layer 5518 are each plasma bonded to molded elastomer layer 5514. Channel side silicone layer 5512 defines a termination portion 5520 through which face seal apertures are cut. For example, face seal apertures 5310 may be cut into channel side silicone layer 5512.

Molded elastomer layer 5514 defines a plurality of channels 5521 and a termination portion 5522 through which face seal apertures are cut. For example, face seal apertures 5310 may be cut through channel side silicone layer 5512 into molded elastomer layer 5514 at termination portion 5522 to channels 3521.

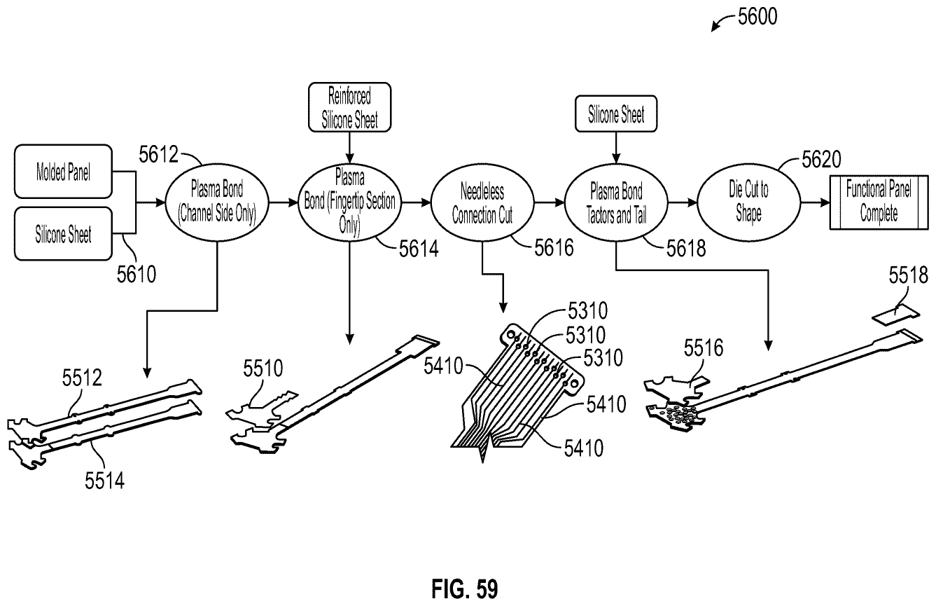

Referring now to FIG. 59, and with continued reference to FIGS. 34-58, a finger panel fabrication process 5600 is illustrated in a flow diagram view. Finger panel fabrication process 5600 may be used, for example, to fabricate tactile panel assembly 5500.

Finger panel fabrication process 5600 includes providing layers 5610, a first plasma bonding task 5612, a second plasma bonding task 5614, a needleless connection cut task 5616, a third plasma bonding task 5618, and a cut to shape task 5620.

In the example provided, providing layers 5610 includes providing channel side silicone layer 5512 and molded elastomer layer 5514.

First plasma bonding task 5612 includes plasma bonding the layers provided in providing layers 5610 task. In the example provided, first plasma bonding task 5612 includes plasma bonding channel side silicone layer 5512 to molded elastomer layer 5514. As is appreciated by those of ordinary skill in the art, plasma bonding is a method of forming a direct chemical connection between the two layers of silicone.

Second plasma bonding task 5614 includes plasma bonding a reinforcement layer onto the assembly produced by first plasma bonding task 5612. In the example provided, reinforced sheeting layer 5510 is plasma bonded onto the already bonded channel side silicone layer 5512 and molded elastomer layer 5514 assembly. In the example provided, second plasma bonding task 5614 further includes an oven heating process after lamination of reinforced sheeting layer 5510 to the assembly.

Needleless connection cut task 5616 punches the needleless connection holes in the panel. For example, needleless connection cut task 5616 may punch face seal apertures 5310 through channel side silicone layer 5512 and at least partially through molded elastomer layer 5514 to air channels 5410.

Third plasma bonding task 5618 includes bonding additional silicone layers to a tactor side and a panel tail side of the assembly. In the example provided, third plasma bonding task 5618 bonds tactor side silicone layer 5516 and panel tail silicone layer 5518 to the bonded and cut assembly of channel side silicone layer 5512 and molded elastomer layer 5514. In the example provided, third plasma bonding task 5618 further includes an oven heating process after lamination of needleless connection cut task 5616 and panel tail silicone layer 5518 to the assembly.

Cut to shape task 5620 includes die cutting the assembly to the final shape.

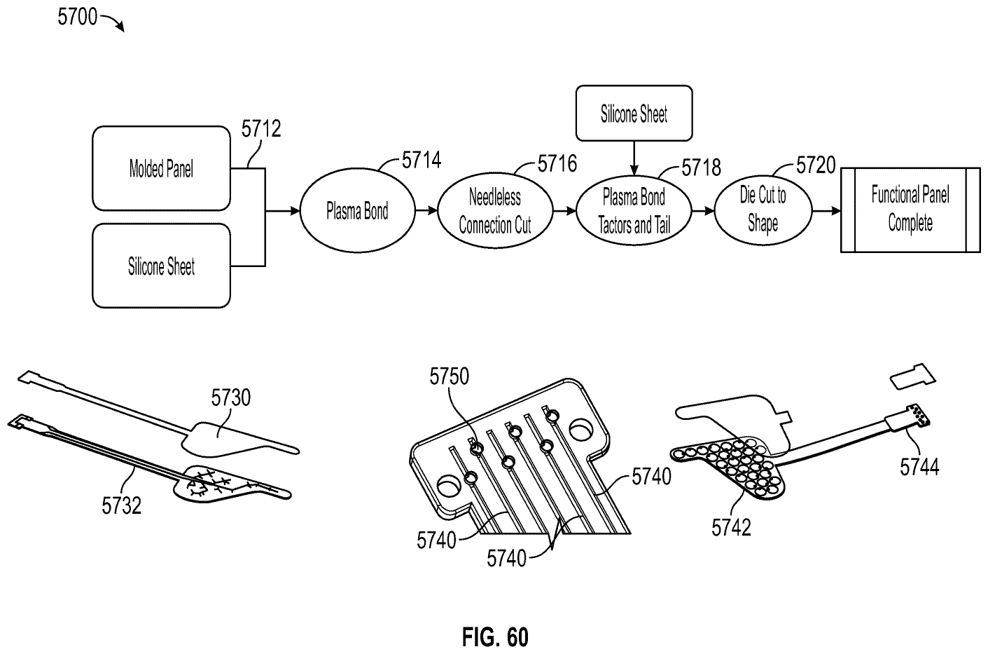

Referring now to FIG. 60, and with continued reference to FIGS. 34-59, a palm panel fabrication process 5700 is illustrated in a flow diagram view. Palm panel fabrication process 5700 may be used, for example, to fabricate palm panel 4720.

Palm panel fabrication process 5700 includes providing layers 5712, a first plasma bonding task 5714, a needleless connection cut task 5716, a second plasma bonding task 5718, and a die cutting task 5720.

Providing layers 5712 task includes providing a sheeting layer 5730 and a molded elastomer layer 5732. In the example provided, channel side silicone layer 5730 is similar to channel side silicone layer 5512 and molded elastomer layer 5732 is similar to molded elastomer layer 5514. Channel side silicone layer 5730 and molded elastomer layer 5732, however, have shapes suited to use with palm panel 4720. In the example provided, the left and right gloves use palm panels with mirrored shapes to fit the left and right hands. Molded elastomer layer 5732 defines air channels 5740, tactor portion 5742, and tail connection portion 5744. The number of air channels 5740 and tactors in tactor portion 5742 is based on the desired haptic feedback to a palm of the user.

First plasma bonding task 5714 includes plasma bonding channel side silicone layer 5730 to molded elastomer layer 5732. In an intermediate task (not illustrated), a reinforced sheet similar to reinforced sheeting layer 5510 may be plasma bonded to the bonded assembly of channel side silicone layer 5730 and molded elastomer layer 5732.

Needleless connection cut task 5716 includes punching needleless connection holes 5750 in the assembly of bonded channel side silicone layer 5730 and molded elastomer layer 5732. Needleless connection holes 5750 are similar to face seal apertures 5310 and define a conduit through which a multi-channel pneumatic connector may make a face seal connection to air channels 5740.

Die cutting task 5720 cuts the bonded and cut assembly to a final shape for use in a glove assembly.

Referring now to FIG. 61, and with continued reference to FIGS. 34-60, tactile panel testing images 5800 are illustrated in a simplified diagram in accordance with the teachings of the present disclosure.

Tactile panel testing images 5800 illustrate a testing process using machine vision to confirm tactor operability and channel mapping. In the example provided, a machine vision system is coupled with a pneumatic valve to inflate each tactor and confirm that each tactor inflates in response to actuation of the respective pneumatic valve. In the example provided, an inflated tactor 5810 is illustrated among a plurality of uninflated tactors 5820.

Accordingly, the vision system may be used to confirm the inflation properties of each tactile panel after fabrication. In the example provided, tactile panels are tested using tactile panel testing images 5800 after fabrication and before being secured to an inner glove of a glove assembly.

### Finger Assembly

Referring now to FIG. 62, and with continued reference to FIGS. 34-61, a fingertip assembly 5900 is illustrated in an exploded view in accordance with the teachings of the present disclosure.

Fingertip assembly 5900 includes a thimble 5910, a tendon clip 5912, a position sensor shell 5914, a cable strain relief 5916, a puck 5918, and a finger portion 5920 of inner glove 6010.

Thimble 5910 is a rigid plastic part that secures tendon clip 5912, position sensor shell 5914, and cable strain relief 5916 to puck 5918. Tendon clip 5912 secures a tendon (illustrated as 6024 in FIG. 63) to fingertip assembly 5900. Position sensor shell 5914 houses finger position sensors. Cable strain relief 5916 provides cable protection for sensor wires for the finger position sensors in position sensor shell 5914.

Puck 5918 is secured to finger portion 5920 over a fingernail portion of the user's expected finger position to ground tactor counterpressure at the user's fingernail. Puck 5918 defines projections 5930 extending away from finger portion 5920 to accommodate a tactile panel assembly, as described below with reference to FIG. 63. For example, puck 5918 may be heat stake riveted or glued to a fabric of inner glove 6010.

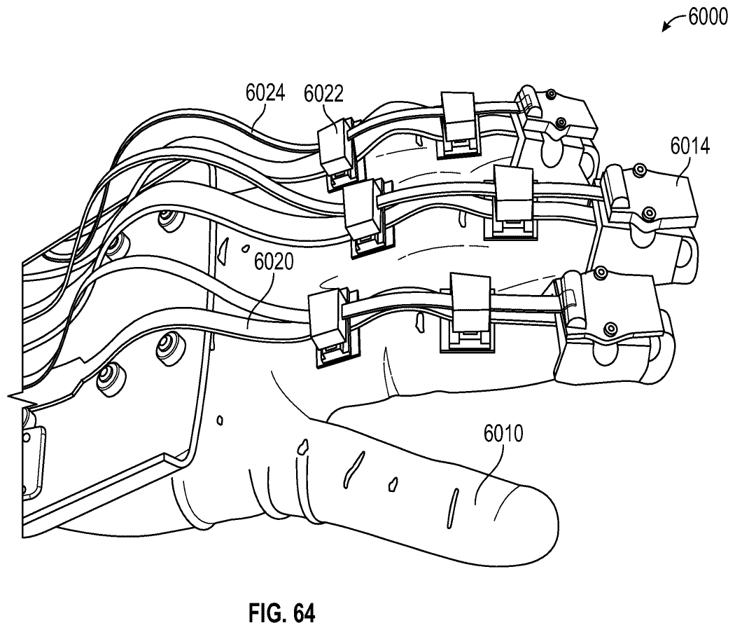

Referring now to FIGS. 63-64, and with continued reference to FIGS. 34-62, a glove assembly 6000 is illustrated in a simplified cutaway side view in accordance with the teachings of the present disclosure.

Glove assembly 6000 is illustrated on a user's finger 6002 and includes an inner glove 6010, a puck 6012, a thimble 6014, a silicone panel 6020, tendon guides 6022, tendons 6024, and an outer glove 6026 (not shown in FIG. 64).

Inner glove 6010 is a flexible glove that serves as an interface layer between the glove assembly and the user's skin. Inner glove 6010 may be made from LYCRA or another lightweight, elastic fabric.

Puck 6012 is an example of puck 5918 and is secured to inner glove 6010 with glue 6030 above an expected location of a user's fingernail. In some embodiments, puck 6012 is riveted to inner glove 6010.

Puck 6012 grounds reaction forces from actuator of tactors at the fingertip of silicone panel 6020. For example, as tactors actuate and press against finger 6002, tensile forces in silicone panel 6020 hold the tactors against finger 6002. The tensile forces in silicone panel 6020 pull against projections 5930 and also present on puck 6012 to create compressive forces against glue 6030 and the fingernail of finger 6002. Because puck 6012 and the fingernail are substantially rigid, the compressive forces are distributed across the surface area of the fingernail to limit tactile sensations from the counterpressure for the user.

Thimble 6014 is an example of thimble 5910 and is secured against puck 6012 to clamp silicone panel 6020 and tendons 6024.

Silicone panel 6020 is an example of tactile panel assembly 5500. Silicone panel 6020 is routed and curved around finger 6002 to puck 6012. In the example provided, projections 5930 are also present on puck 6012 to hold silicone panel 6020 in place on puck 6012. Silicone panel 6020 extends along finger and through tendon guides 6022 and ultimately to a multi-channel pneumatic connector. In the example provided, silicone panel 6020 includes 24 tactile actuators capable of producing a displacement of at least 1 mm.

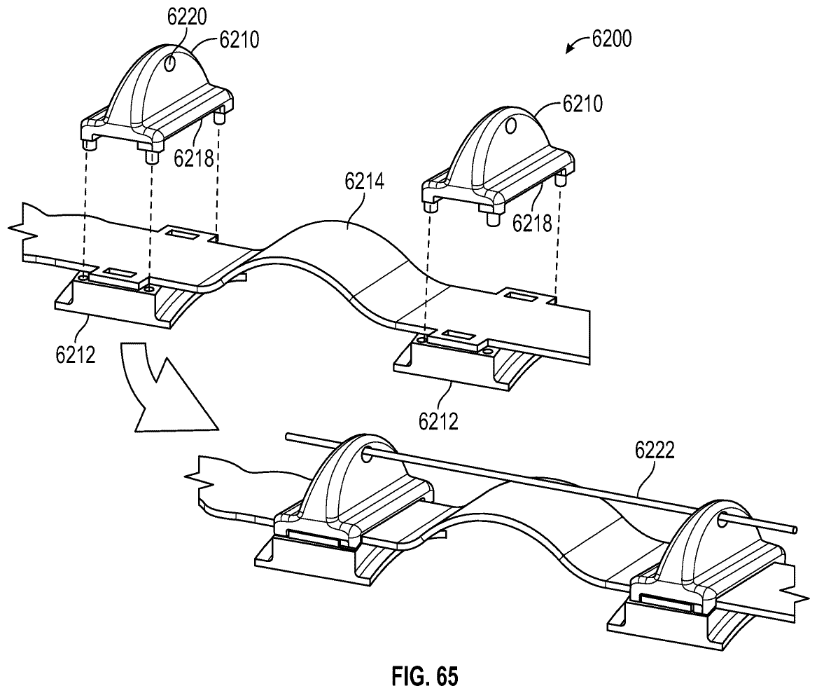

Tendon guides 6022 are secured to inner glove 6010, such as by glue 6030 or rivets. Tendon guides 6022 are described below with reference to FIG. 65.

Tendons 6024 are secured to thimble 6014 and define a load path between the fingertip of finger 6002 and a manipulation actuator, such as manipulation actuators 4972.

In the example provided, tendons 6024 are located on the dorsum of the user's hand and apply forces to the user's finger during grasping motions involving finger flexion while allowing unhindered finger extension. In the example provided, tendons 6024 are 65 lb fishing line. In some embodiments, tendons 6024 are ribbon shaped with a ratio of width to thickness of at least 10.

Finger motion resisted by the manipulation actuator results in reaction forces that are distributed via the load path to the user's finger. In the example provided, the reaction forces terminate at the distal phalange of the finger. In some embodiments, the reaction forces are distributed approximately evenly across the palmar surface of the phalange by silicone panel 6020.

Distributing the net force on the user's fingertip produced by the action of the manipulation actuator promotes approximation of the physical point forces resulting from a particular object interaction. For example, pressing on a simulated pin and a simulated flat surface in a virtual environment might produce identical net forces on the user's fingertip, as rendered by the action of the manipulation actuator. These interactions, however, would produce very different point forces on the skin of the fingertip as rendered by the action of tactile actuators.

Outer glove 6026 may be an outer glove as described below with reference to FIGS. 73-79.

### Tendon Guide Assembly

Referring now to FIG. 65, and with continued reference to FIGS. 34-64, a tendon guide assembly 6200 is illustrated in an exploded view. Tendon guide assembly 6200 includes tendon guide tops 6210, tendon guide bottoms 6212, and FPC 6214 for panel and position sensor.

Tendon guide tops 6210 define an FPC cavity 6218 and a guide aperture 6220 through which tendon 6222 passes. Tendon guide tops 6210 secure to tendon guide bottoms 6212 with, for example, screws or snap features.

Tendon guide bottoms 6212 are glued or riveted to an inner glove of a glove assembly. Tendon guide bottoms 6212 receive FPC 6214 and cooperate with FPC cavity 6218 of tendon guide tops 6210 to restrict movement of FPC 6214.

### Wrist Assembly

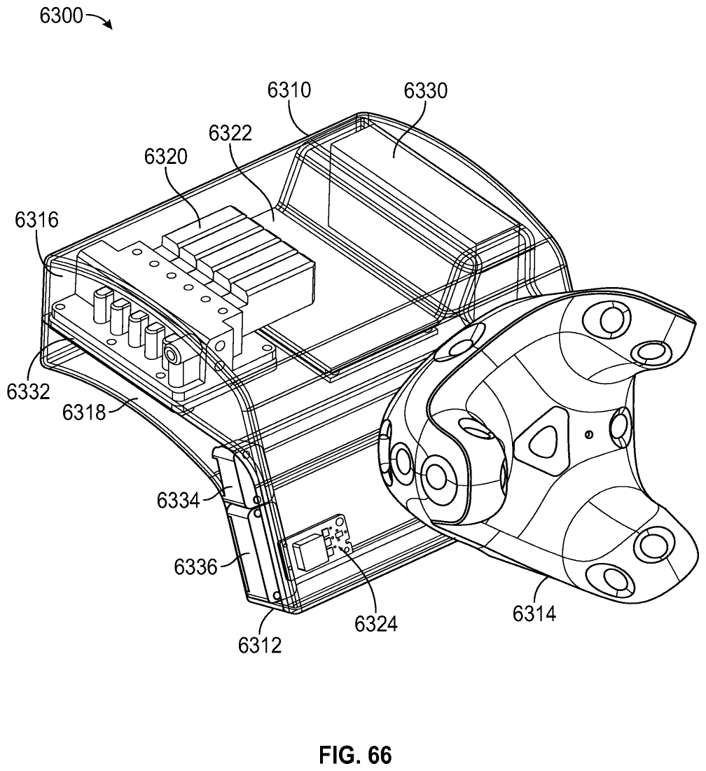

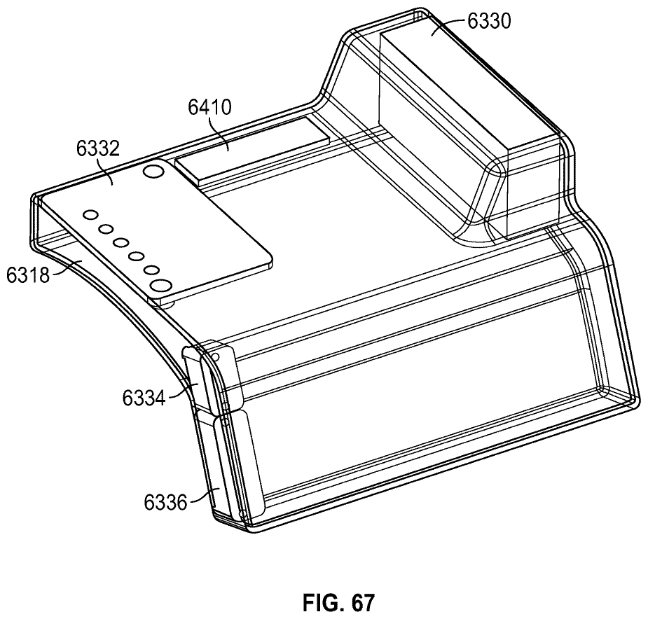

Referring now to FIGS. 66-67, and with continued reference to FIGS. 34-65, a wrist assembly 6300 is illustrated in perspective views. In the example provided, wrist assembly 6300 is mounted to a glove assembly at the back of the user's wrist.

Wrist assembly 6300 includes a durable wrist portion 6310, a replaceable wrist portion 6312, a tracker 6314, an enclosure top 6316, and an enclosure bottom 6318.

Durable wrist portion 6310 is an example of durable subassembly 4910 that attaches to umbilical 4922. Replaceable wrist portion 6312 is an example of replaceable subassembly 4912 connected to the soft goods of the glove assembly. Tracker 6314 is an example of tracker 4926.

Enclosure top 6316 is secured to enclosure bottom 6318 with snaps or screws for user disassembly when replaceable wrist portion 6312 has worn out and must be replaced. For example, the soft goods may rip or become frayed and need replacing after extended use.

Durable wrist portion 6310 includes miniature pneumatic valves and top manifold 6320, position sensor PCBA 6322, and wrist position sensor 6324. Replaceable wrist portion 6312 includes a multi-channel pneumatic connector 6330, a valve bottom manifold 6332, a palm needleless connector 6334, and a thumb needleless connector 6336, a wiring harness 6410, and tubes for panels in Opisthenar (not shown).

Miniature pneumatic valves and top manifold 6320 may be examples of miniature pneumatic valves 4942 and top manifold 4948. Position sensor PCBA 6322 may be an example of position sensor PCBA 4946. Wrist position sensor 6324 may be an example of wrist position sensor 4944.

Multi-channel pneumatic connector 6330 may be an example of multi-channel pneumatic connector 5100. Valve bottom manifold 6332 may be an example of bottom manifold 4960. Palm needleless connector 6334 and a thumb needleless connector 6336 may use face sealing features as shown in FIG. 65. Wiring harness 6410 may be an example of position sensor wire harness 4962.

### Opisthenar Assembly

Referring now to FIG. 68, and with continued reference to FIGS. 34-67, an opisthenar assembly 6500 is illustrated in a perspective view in accordance with the teachings of the present disclosure. Opisthenar assembly 6500 is an example of opisthenar assembly 4712.

Opisthenar assembly 6500 includes an enclosure top 6510, an enclosure bottom 6512, a magnetic emitter 6514, and five manipulation actuators 6520. In the example provided, enclosure top 6510 and enclosure bottom 6512 are injection molded and form a housing with dimensions of about 87 mm wide, 36 mm tall, 66.6 mm long, and a 21 mm ledge height tall. Accordingly, opisthenar assembly 6500 is well sized to be mounted to the glove assembly at the back of the user's hand. Enclosure top 6510 defines finger tendon apertures 6522 and a thumb tendon aperture 6524.

Manipulation actuators 6520 selectively provide force feedback to tendons 6530. Tendons 6530 each pass through one of the four finger tendon apertures 6522 or thumb tendon aperture 6524, route through tendon guides, and connect to thimbles on a respective finger assembly, as discussed above.

In the example provided, manipulation actuators 6520 snap into the housing with snap-fit features. For example, five manipulation actuators 6520 may cooperate with enclosure top 6510 or enclosure bottom 6512 to form an undercut tab and snap feature.

### Manipulation Actuator

Referring now to FIG. 69, and with continued reference to FIGS. 34-68, a manipulation actuator 6520 is illustrated in an exploded view. Manipulation actuator 6520 is a component of a force feedback exoskeleton that produces a net force on a body segment of a user, such as a finger.

Manipulation actuator 6520 includes a cover 6610, a bladder 6612, a brake pad 6614, a wave spring 6616, a retaining ring 6618, a spool 6620, a power spring 6622, and a housing 6624.

Cover 6610 defines clip receiving portions 6630 and housing 6624 defines clip portions 6632. Covers 6610 assembles to housing 6624 such that clip portions 6632 snap into portions 6630 and secure cover 6610 to housing 6624.

Housing 6624 further defines a cavity 6634 and a rotation restriction slot 6636. Cavity 6634 receives power spring 6622, spool 6620, retaining ring 6618, wave spring 6616, brake pad 6614, and bladder 6612.

Bladder 6612 inflates and deflates according to properties of air supplied to bladder 6612 by a drive system, such as drive system 3110. Inflation of bladder 6612 causes brake pad 6614 to contact spool 6620 to apply forces opposing rotation of spool 6620 and extension of tendon 6530, as described below.

Brake pad 6614 defines protrusions 6640 and a Hirth joint mating surface 6642. Protrusions 6640 extend radially out from brake pad 6614 and have shapes and locations corresponding to the shape of rotation restriction slot 6636. Accordingly, protrusions 6640 are disposed within rotation restriction slot 6636 when cover 6610 is installed on housing 6624 and brake pad 6614 is disposed in cavity 6634.

Wave spring 6616 biases brake pad 6614 away from spool 6620 such that brake pad 6614 does not restrict rotation of spool 6620 or extension of tendons 6530 when bladder 6612 is not inflated.

Retaining ring 6618 restrains movement, but not elongation and compression, of wave spring 6616. Retaining ring 6618 in turn is restrained from moving by spool 6620.

Spool 6620 accommodates tendons 6530 and defines a Hirth joint mating surface 6650 opposing Hirth joint mating surface 6642 of brake pad 6614. Hirth joint mating surface 6650 and Hirth joint mating surface 6642 each define substantially triangular teeth. The term “substantially triangular” means that the teeth may have curved faces or other variations that maintain the function of the Hirth joint.

Power spring 6622 increasingly biases spool 6620 to a retracted state in response to rotation of spool 6620 and extension of tendon 6530.

To actuate manipulation actuator 6520, high pressure air inflates bladder 6612. Bladder 6612 presses against both cover 6610 and brake pad 6614. Because cover 6610 is secured to housing 6624, cover 6610 does not substantially move and is able to provide counter pressure as bladder 6612 biases brake pad 6614 toward spool 6620. When actuation forces from bladder 6612 on brake pad 6614 are sufficient to overcome the biasing forces of wave spring 6616, brake pad 6614 translates toward spool 6620.

When Hirth joint mating surface 6642 of brake pad 6614 contacts Hirth joint mating surface 6650 of spool 6620, friction and interference between teeth in the Hirth joint restrict movement of spool 6620. The friction forces include a component that opposes separation of brake pad 6614 and spool 6620. The friction forces further include a component that opposes rotation forces between brake pad 6614 and spool 6620, but this component is less than the forces for flat surfaces at any given actuation force to an extent determined by the angle of teeth in the Hirth joint. The forces required to overcome interference between teeth of the Hirth joint, however, are significantly different from flat surface brake pad assemblies. For example, in the absence of deformation of materials or separation of brake pad 6614 from spool 6620 (such as by movement of bladder 6612), there will be no movement of spool 6620 relative to brake pad 6614. Accordingly, materials and actuation pressures are selected based on these considerations for an intentionally slip-permitting Hirth joint. In the example provided, the Hirth joint is actuated in an on/off control scheme and has a predetermined brake design holding force that may be overcome for limiting component breakage in the human-computer interface system. For example, the brake design holding force may be a threshold force on tendon 6530. Above the threshold force, bladder 6612 may compress enough to permit a yielding translation and relative rotation between brake pad 6614 and spool 6620 even when manipulation actuator 6520 is actuated.

### Glove PCB

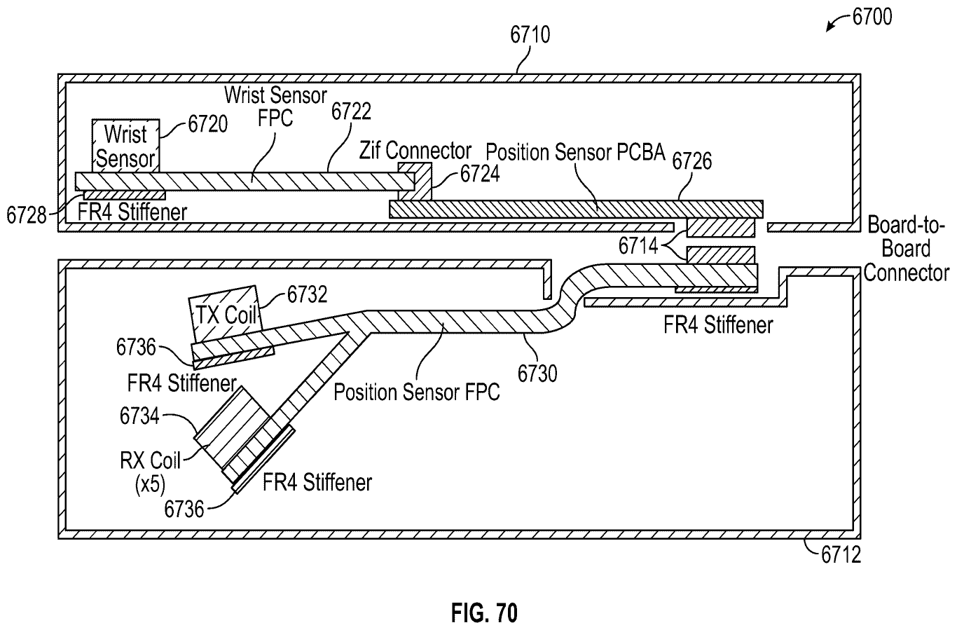

Referring now to FIG. 70, glove electronics 6700 are illustrated in a simplified block diagram. Glove electronics 6700 are implemented as a combination of flexible printed circuits (FPCs) and a rigid circuit board. The shape and angles of the FPCs are based on average hand sizes, and the shapes and angles may be reliably fabricated with an automated FPC process.

In the example provided, glove electronics 6700 includes durable wrist electronics 6710, replaceable electronics 6712, and board connector 6714.

Durable wrist electronics 6710 include a wrist sensor 6720, a wrist sensor FPC 6722, an FPC to PCBA connector 6724, a position sensor PCBA 6726, and a stiffener 6728. Wrist sensor 6720 is an example of wrist position sensor 6324. Wrist sensor FPC 6722 is a flexible printed circuit connecting wrist sensor 6720 to position sensor PCBA 6726 through PCBA connector 6724. FPC to PCBA connector 6724 may be any suitable electronic connector, such as a ZIF connector. Position sensor PCBA 6726 is an example of position sensor PCBA 4946. Stiffener 6728 restricts flexing of the FCB near wrist sensor 6720.

Replaceable electronics 6712 include a position sensor harness FPC 6730, a magnetic emitter 6732, position sensors 6734, and stiffeners 6736.

Position sensor harness FPC 6730 is a flexible printed circuit that connects magnetic emitter 6732 and position sensors 6734 to position sensor PCBA 6726 through board connector 6714. Magnetic emitter 6732 may be an example of magnetic emitter 3230. Position sensors 6734 may be examples of position sensors 3232. Stiffeners 6736 restrict flexing of the FCB near magnetic emitter 6732 and position sensors 6734.

In the example provided, position sensor PCBA 6726 mounts to a durable assembly with screws or heat staking, wrist Sensor FPC 6722 mounts to the durable assembly with screws or heat staking, and position sensor harness FPC 6730 mounts to a replaceable wrist assembly with board connector 6714 exposed to interface with the durable assembly.

### Integration of Hard and Soft Goods

Referring now to FIGS. 71-72, and with continued reference to FIGS. 34-70, a palm assembly 6800 is illustrated in perspective views. Palm assembly 6800 includes substrates 6810, rivets 6812, and lacer guides 6814. Rivets 6812 are secured to substrates 6810, and lacer guides 6814 receive and guide lacers, which are discussed below with reference to FIG. 45. Substrates 6810 are counter pressure features formed into a thin and semi-flexible piece of plastic that is connected to the soft goods by rivets 6812.

Referring now to FIG. 73, and with continued reference to FIGS. 34-72, an outer glove 7000 is illustrated in a perspective view according to the teachings of the present disclosure. Outer glove 7000 includes a cuff portion 7010, a palm portion 7012, and reinforcements 7020. Reinforcements 7020 may be flexible plastic, leather, or other materials. Reinforcements 7020 define rivet holes 7022 through which rivets pass through on assembly of the glove.

Referring now to FIG. 74, and with continued reference to FIGS. 34-73, a palm tactile panel layout 7100 is illustrated in a front view in accordance with some embodiments. Tactile panel layout 7100 includes a first tactile panel 7110, a second tactile panel 7112, and a third tactile panel 7114. With reference back to FIG. 73, it can be seen that the locations of the tactile panels correspond to the locations of reinforcements 7020. Accordingly, counterpressure to the tactile panels may be spread across reinforcements 7020 and into outer glove 7000.

Individual tactors within tactile panels may be grouped into zones, as indicated by zones 7120 of first tactile panel 7110. In the example provided, each tactor within a zone is actuated by the same pneumatic channel as the other tactors in the same zone.

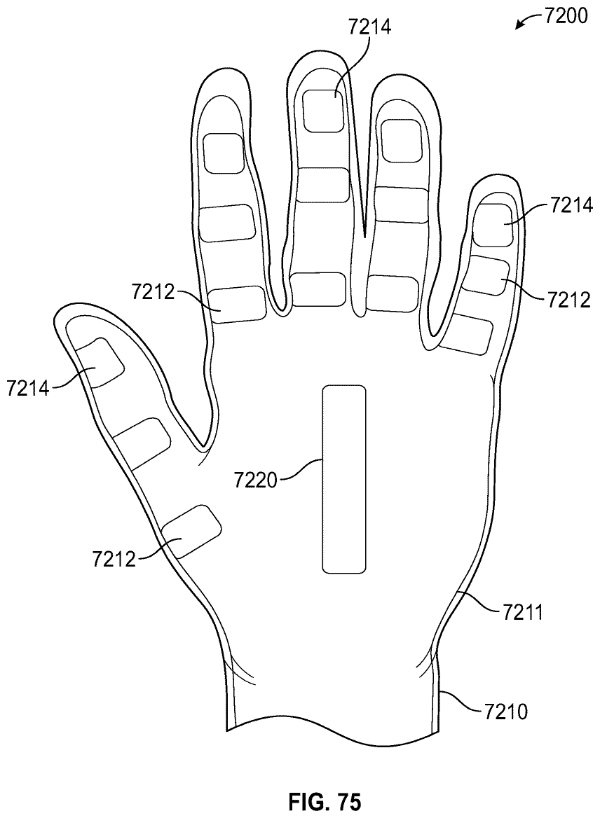

Referring now to FIG. 75, and with continued reference to FIGS. 34-74, a glove assembly 7200 is illustrated in a simplified diagram in accordance with the teachings of the present disclosure. Glove assembly 7200 includes an outer glove 7210, tendon guides 7212, and pucks 7214. Outer glove 7210 may be an example of outer glove 6026. Tendon guides 7212 may be an example of tendon guides 6022. Pucks 7214 may be examples of puck 6012.

Outer glove 7210 defines a service slot 7220 through which inner glove 7211 may be inserted or removed.

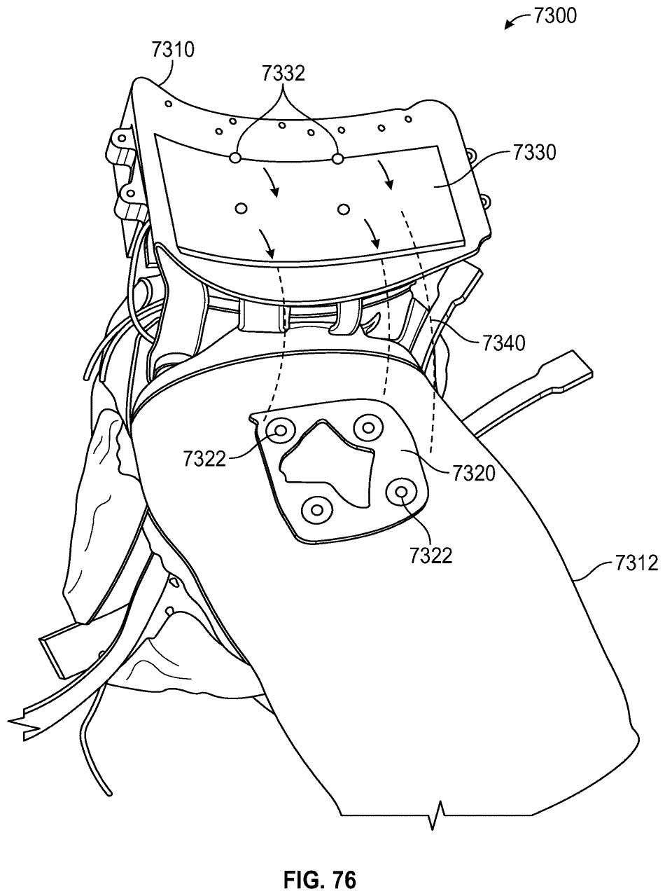

Referring now to FIG. 76, and with continued reference to FIGS. 34-75, an opisthenar and glove assembly 7300 is illustrated in a perspective view in accordance with some embodiments. Opisthenar and glove assembly 7300 includes opisthenar assembly 7310 and outer glove 7312. Outer glove 7312 includes a mounting component 7320 that defines locating features 7322 and has a hook and loop surface. Opisthenar assembly 7310 includes a hook and loop portion 7330 and locating features 7332. In the example provided, mounting component 7320 is sewn into outer glove 7312.

During assembly of opisthenar assembly 7310 to outer glove 7312, features 7322 align with features 7332 to ensure a correct alignment of opisthenar assembly 7310 on outer glove 7312. It should be appreciated that similar alignment features may be used on other complementary connectors having complementary connector components without departing from the scope of the present disclosure. The hook and loop surface of mounting component 7320 couples with hook and loop portion 7330 to secure opisthenar assembly 7310 to outer glove 7312. Opisthenar assembly 7310 installs onto outer glove 7312 as indicated by alignment indicator lines 7340.

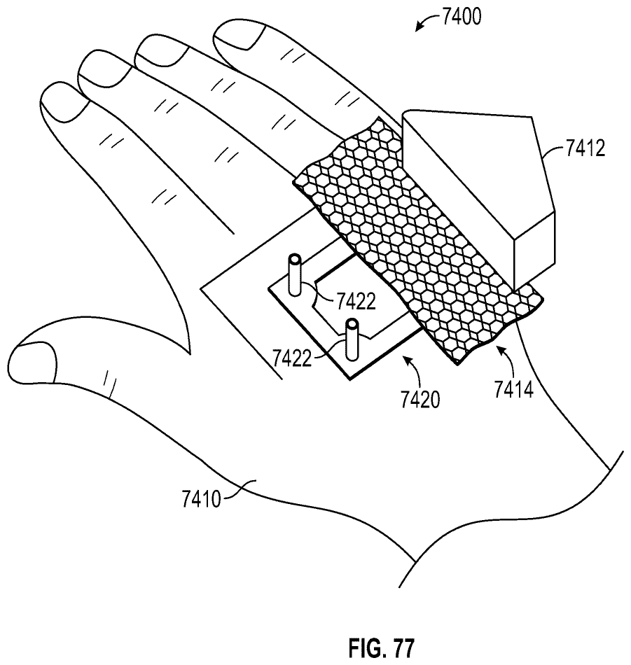

Referring now to FIG. 77, and with continued reference to FIGS. 34-76, an opisthenar and glove assembly 7400 is illustrated in a perspective view in accordance with the teachings of the present disclosure. Opisthenar and glove assembly 7400 includes a glove 7410, an opisthenar assembly 7412, and a mesh layer 7414.

Glove 7410 includes a rigid plate 7420 sewn into mesh layer 7414 and the fabric of glove 7410. Rigid plate 7420 defines locating bosses 7422 configured to interact with and align opisthenar assembly 7412. During assembly of opisthenar and glove assembly 7400, opisthenar assembly 7412 may be secured to rigid plate 7420 with screws interacting with threaded bores formed in plate 7420.

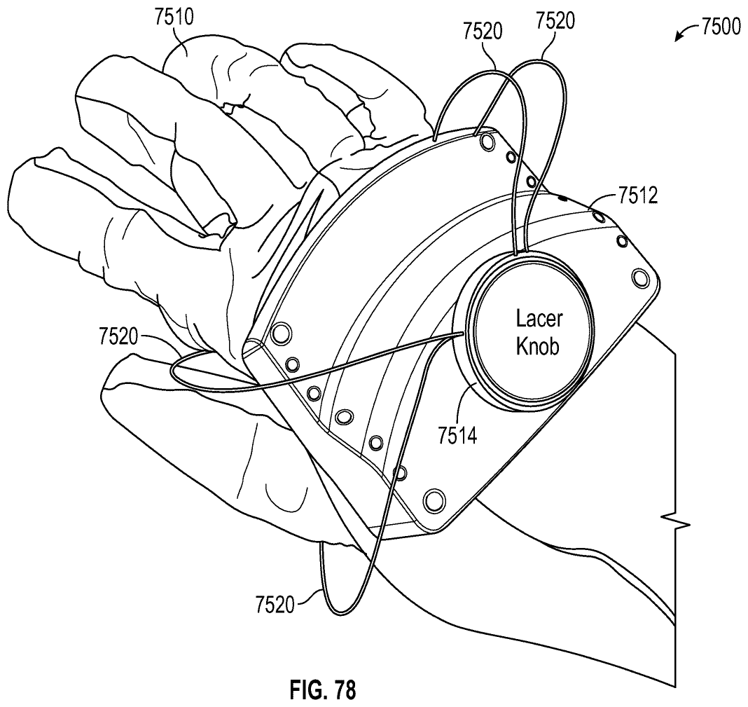

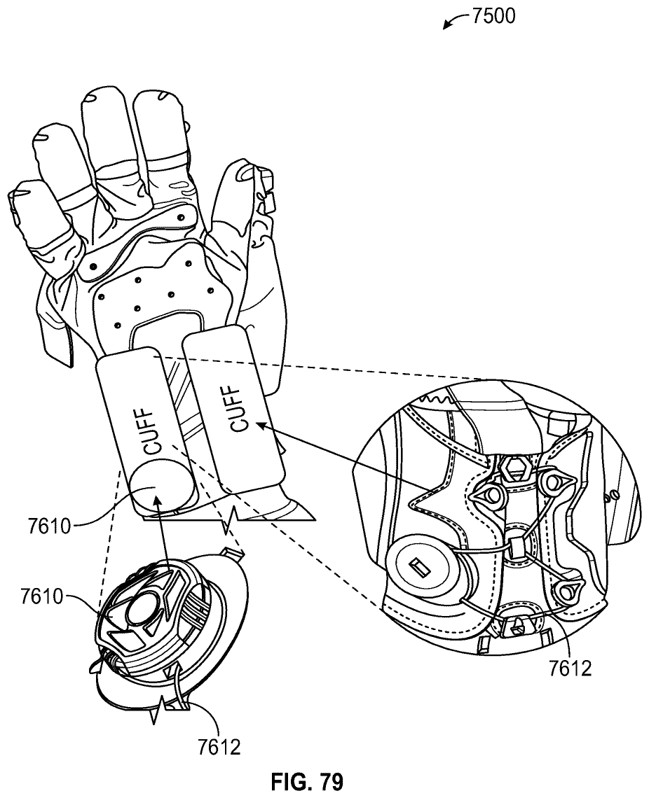

Referring now to FIGS. 78-79, and with continued reference to FIGS. 34-77, a glove assembly 7500 is illustrated in a perspective view according to the teachings of the present disclosure. Glove assembly 7500 includes a glove 7510, an opisthenar assembly 7512, and a lacer knob 7514. Glove 7510 includes a cuff portion 7516. Lacer knob 7514 includes lacers 7520. Lacer knob 7514 is configured to tighten lacers 7520, such as by turning lacer knob 7514. Tightening lacers 7520 tightens the opisthenar assembly by way of lacer guides 6814.

Glove assembly 7500 further includes a cuff lacer 7610. Cuff lacer 7610 is disposed on cuff portion 7516 and includes lacer 7612. Cuff lacer 7610 tightens lacer 7612 to tighten cuff portion 7516, as can be seen in FIG. 79. The use of two separate lacers improves the grounding of forces in the glove assembly to the body of the user.

### Pneumatic Routing

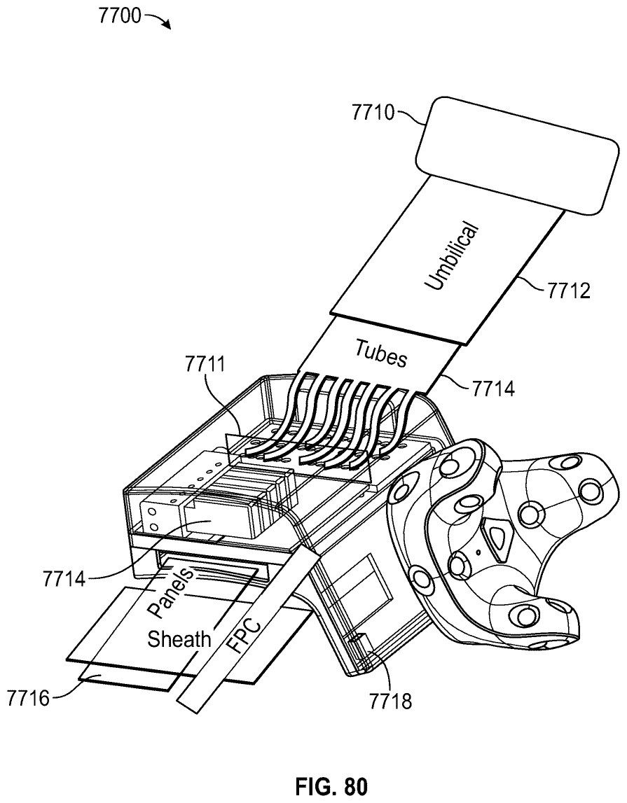

Referring now to FIG. 80, a pneumatic routing assembly 7700 is illustrated in a simplified block diagram. Pneumatic routing assembly 7700 illustrates the route taken by supply and exhaust air between a drive system and tactile panels in a glove assembly.

Pneumatic routing assembly 7700 includes an umbilical 7712 and a wrist assembly 7714. Umbilical 7712 may be an example of umbilical assembly 7716. In the example provided, umbilical assembly 7716 includes a first multi-channel pneumatic connector 7710 and a second multi-channel pneumatic connector 7710. Wrist assembly 7714 is an example of wrist assembly 6300 and includes a top manifold and multi-channel pneumatic connector, such as multi-channel pneumatic connector 5100.

Referring now to FIG. 81, a tubing harness 7800 is illustrated in a perspective view. Tubing harness 7800 illustrates how the supply and exhaust air is routed between a drive system manifold 3712 and pneumatic routing assembly 7700.

Tubing harness 7800 includes a multi-channel pneumatic connector 7810, tubing 7812, tube management features 7814, manifold connectors 7816, and manifold connector gaskets 7818. Manifold connectors 7816 interface with valve core manifolds of a drive system, such as at manifold connectors 4026 of manifold assemblies 3712. In the example provided, multi-channel pneumatic connector 7810 is an example of first multi-channel pneumatic connector 7710. In the example provided, tubing 7812 includes 60 lengths of Tygon® brand tubing, manifold connectors 7816 include six connectors, and manifold connector gaskets 7818 include six gaskets.

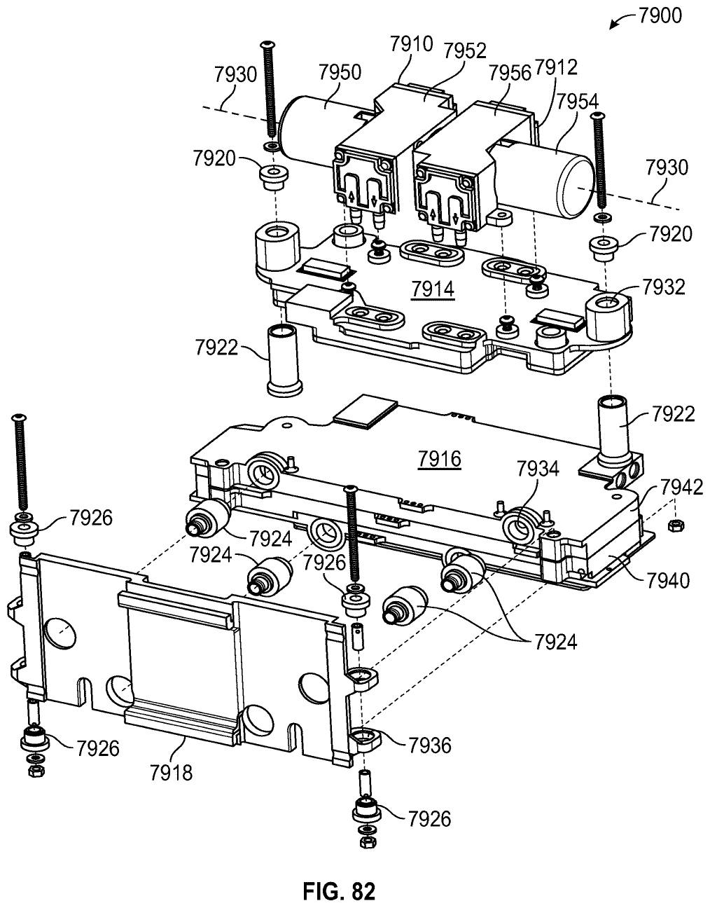

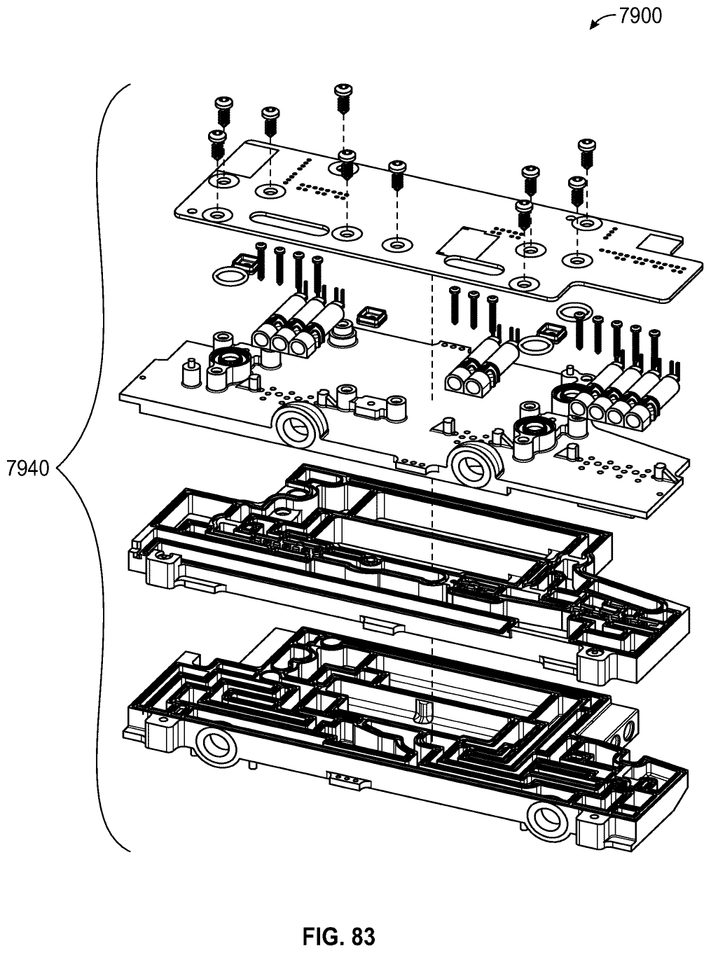

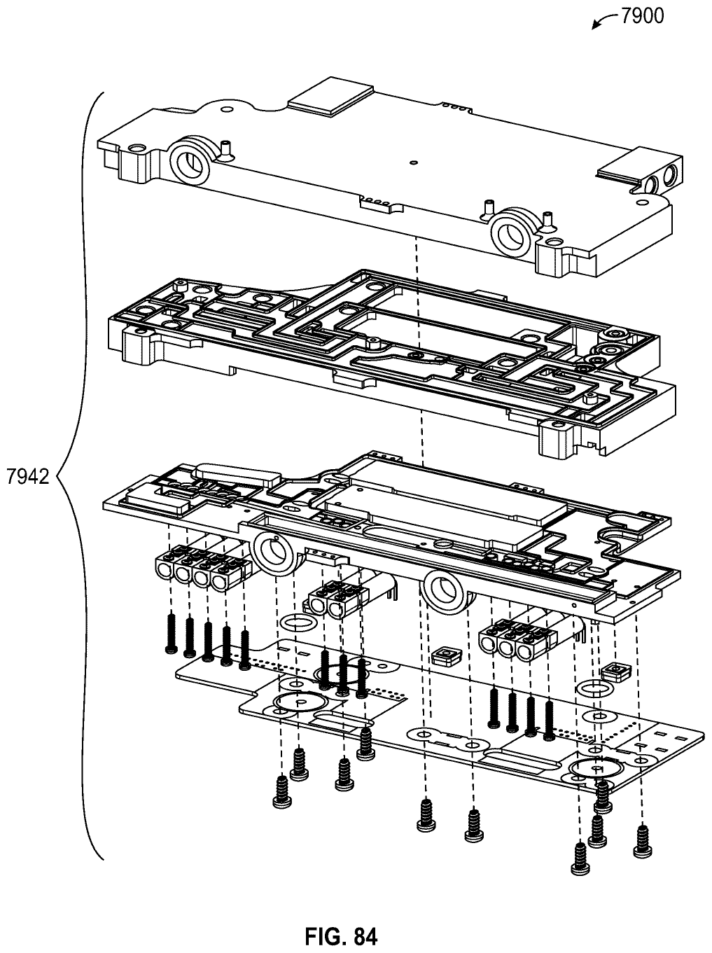

Referring now to FIGS. 82-85, and with continued reference to FIGS. 1-81, a compressor assembly 7900 is illustrated according to some embodiments of the disclosure. In some embodiments, compressor assembly 7900 includes a motor assembly 7910, a second motor assembly 7912, a motor mounting plate 7914, a pneumatic circuit 7916, an assembly mounting plate 7918, first dampers 7920, second dampers 7922, third dampers 7924, and fourth dampers 7926.

The motor assembly 7910 and the second motor assembly 7912 include rotors (not illustrated) that rotate about the axis of rotation 7930. The first motor assembly 7910 includes a first motor 7950 and a first compression portion 7952. The second motor assembly 7912 includes a second motor 7954 and a second compression portion 7956.

The motor mounting plate 7914 defines damper receiving bore 7932.

The pneumatic circuit 7916 defines a damper receiving bore 7934 and includes a bottom portion 7940 and a top portion 7942.

The assembly mounting plate 7918 defines a damper receiving bore 7936.

The first dampers 7920, second dampers 7922, third dampers 7924, and fourth dampers 7926 damp vibrations between the coupled components.

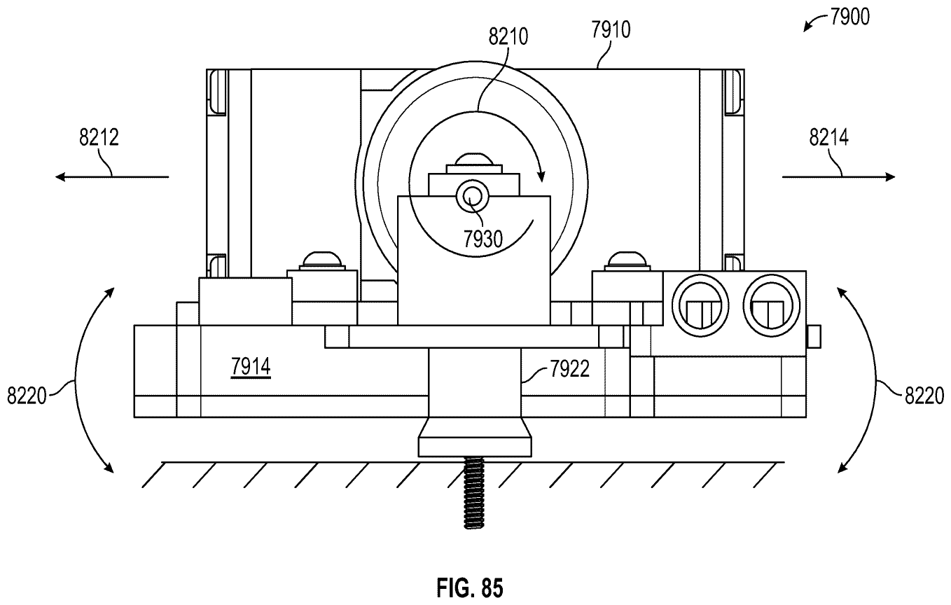

Referring now to FIG. 85, opposing forces during operation of compressor assembly 7900 are illustrated in accordance with some embodiments.

Rotation motion 8210 results in a first force 8212 and a second force 8214 from momentum during a cam stroke of the compression portion. The first force 8212 and the second force 8214 oppose each other and occur during different portions of the motor operation.

The first force 8212 and the second force 8214 transfer through motor mounting plate 7914 to cause swinging motion 8220 of the motor mounting plate 7914. The first motor 7910 and the second motor 7912 are controlled as described herein to reduce swinging motion 8220.

### Motor Phase Shifting

Phase shifting of the motors and compressors uses a principle of constructive and destructive interference. The two motors are physically aligned on the same axis of rotation 7930 and on a vibration damping swing 8220, this allows motion in the direction of motor momentum 8212 and 8214. The rotation of the motor causes the cam shaft and “pistons” within the motor head to create oscillating forces. This shifts momentum back and forth during each stroke. During these events, the swinging mount can also pivot about the center axis to dissipate this excess motion without transmitting it further into the system.

When one motor spins up and oscillates back and forth the other motor can spin in the opposite direction and oppose the prior motions. When timed correctly the two motors can rotate at the same speed in sync but with opposing direction of momentum. This mirroring of motion allows a majority of the vibration, produced individually by each motor, to be partially canceled out by the combined motion of the whole swing assembly.

In embodiments, to achieve this effect one motor will be run to meet the system requirements (compressor for pressurized air needs). The second motor will be spun up to match the same rotation speed via the internal rotational sensors. Once they are rotating together in this physically mirrored orientation the vibration and the acoustic noise begin to interfere periodically. This is identified by a pulsing intensity of both noise and vibration.

Once they are synchronized together via the rotation speed they need to be placed in opposite phase. This will be achieved by slowly throttling the speed of the vacuum motor such that the rotational position of the motor drifts relative to the compressor motor position. The goal is to place them 180 degrees out of phase, or in other words, the hardware is physically at opposite orientations (opposing stroke positions) during each rotation. While the motors are rotating in tandem and with the correct offset, the internal mechanisms produce opposing forces that help to cancel out a large portion of the vibration load.

In the example provided, the motors have equally spaced pulses to identify the speed of rotations, but no internal sensors to identify piston position or rotation position. Vibration intensity is monitored to track the overall magnitude of acceleration produced by the motors. This is done by measuring the amplitude with board level accelerometers on the system PCBAs.

In some embodiments, a vibration source is located nearby each compressor motor to specifically cancel out the vibrations caused by the respective motor using accelerometer data. For example, in an embodiment: 1) The accelerometer is mounted directly to the top of the compressor; 2) Data from the accelerometer is processed by a local microcontroller; 3) The microcontroller computes a canceling waveform that outputs to a Cymbal piezo actuator, and 4) The piezo actuator that is sandwiched between the bottom of the compressor and mounting pad/frame counteracts the vibration of the compressor.

In some embodiments, the system includes: 1) Using analog circuitry between the accelerometer and piezo actuator instead of the microprocessor to reduce computation and communication delay from the microprocessor, and/or 2) using the piezo actuator as both a vibration measurement device and as an actuator to eliminate the accelerometer. An advantage of this method may be that each of the two motors in the system will have its own active canceling device, potentially making the vibration isolation more effective. These potential benefits may be weighed against: 1) mechanical complexity associated with assembling the 3-layers of mount/frame, piezo actuator, and compressor, 2) additional cost of the piezo actuator, and 3) finding a suitable piezo actuator if the existing units in the market are not adequate.

### CONCLUSION

Clause 1. A method comprising: receiving, by a haptic interface module that is configured to interact with one or more haptic interface devices and an application that generates a computer-mediated environment comprising an avatar corresponding to a user wearing the one or more haptic interface devices, respective sensor data for each respective haptic interface device, wherein the respective sensor data for a respective haptic interface device indicates respective positioning of respective sensors of the respective haptic interface device; processing, by the haptic interface module, the respective sensor data to generate respective relative location data for each respective haptic interface device, wherein the relative location data is relative to a reference location defined with respect to the corresponding haptic interface device; receiving, by the haptic interface module, tracked location data from one or more motion tracking sensors, wherein the tracked location data indicates respective locations of the one or more haptic interface devices relative to a spatial environment of the user; generating, by the haptic interface module, a series of motion capture frames based on the tracked location data and the respective relative location data for each respective haptic interface device, wherein each respective motion capture frame indicates a set of locations and orientations for each respective haptic interface device at a given time; generating, by the haptic interface module, a series of kinematic frames based on the series of motion capture frames and one or more mediation processes that collectively convert, for each of the motion capture frames, the set of locations and orientations of the one or more respective haptic interface devices into a set of intended locations and intended orientations for configuring the avatar in the computer-mediated environment; and outputting the series of kinematic frames to the application, wherein the kinematic frames are provided to the application as user input.

Clause 2. The method of clause 1, wherein the avatar is a computer-mediated representation of a telerobot, wherein the set of intended locations and intended orientations are usable by the application to configure the telerobot.

Clause 3. The method of clause 1, wherein the computer-mediated environment is a game or simulation.

Clause 4. The method of clause 1, wherein the one or more mediation processes comprise performing touch compensation to simulate a detected touch intent of the user.

Clause 5. The method of clause 4, wherein performing touch compensation comprises: determining that the user has made a self-touch gesture based on the relative location data corresponding to two or more body parts of the user, wherein the two or more body parts of the user are not physically touching; updating the kinematic frame to indicate that the two or more body parts are touching in response to the determining that the user has made the self-touch gesture.

Clause 6. The method of clause 5, wherein at least one of the one or more haptic interface devices is a haptic glove, wherein the two or more body parts include a first finger and a second finger of the user, and wherein updating the kinematic frame comprises generating respective updated locations of at least one of the first finger and the second finger such that the kinematic frame indicates that the first finger is in contact with the second finger.

Clause 7. The method of clause 6, wherein the series of kinematic frames cause a first avatar component corresponding to the first finger of the user to touch a second avatar component corresponding to the second finger in the computer-mediated environment.

Clause 8. The method of clause 6, wherein determining the self-touch gesture comprises: detecting that a distance between a first relative location associated with the first finger and a second relative location associated with the second finger is less than a threshold distance.

Clause 9. The method of clause 8, wherein the threshold distance is defined based on a respective thickness of at least one of a first finger thimble of the haptic glove that receives the first finger and a second finger thimble that receives the second finger.

Clause 10. The method of clause 1, wherein the avatar is associated with different dimensions compared to the user, wherein generating the set of intended locations and orientations comprises one or more of: adjusting for a scale difference between the user and the avatar; or adjusting for a morphology difference between the user and the avatar.

Clause 11. The method of clause 1, further comprising: detecting a predefined gesture based on the series of motion capture frames; and outputting the detected gesture to the application.

Clause 12. A method of providing haptic feedback to one or more haptic interface devices, the method comprising: receiving, by a haptic feedback controller: first data indicating properties of one or more objects within a computer-mediated environment comprising an avatar corresponding to a user wearing the one or more haptic interface devices; and second data indicating a haptic effect associated with a current state of the computer-mediated environment; processing, by the haptic feedback controller, the first data and the second data to determine haptic feedback for the user based on an amount and type of contact of the avatar with the one or more objects within the computer-mediated environment and the haptic effect associated with the current state of the computer-mediated environment; generating, by the haptic feedback controller a series of haptic frames based on the determined haptic feedback, each haptic frame specifying a plurality of displacement distances for simulating the amount and type of contact and the haptic effect at a particular point in time; generating, by the haptic feedback controller, a series of actuator frames based on the series of haptic frames, each actuator frame specifying respective amounts of pressure to be provided to tactile actuators of the one or more haptic interface devices to provide a high precision simulation of the amount and type of contact and the haptic effect; and transmitting a plurality of instructions to respective actuator controls of the haptic interface devices, wherein the plurality of instructions are configured to cause actuation of the tactile actuators using the specified respective amounts of pressure to provide the high precision simulation of the amount and type of contact and the haptic effect to the user.

Clause 13. The method of clause 12, wherein the avatar is a digital twin of a telerobot, wherein the one or more objects are one or more digital twins of real objects in the environment of the telerobot.

Clause 14. The method of clause 13, wherein the digital twin is a haptic digital twin that has one or more of a different scale, a different morphology, or a different location than the telerobot.

Clause 15. The method of clause 12, wherein the computer-mediated environment is a game or simulation.

Clause 16. The method of clause 12, wherein the series of haptic frames simulate a soft-body deformation generated by a soft-body physics engine implemented by the haptic feedback controller, wherein the soft-body physics engine is not implemented by an application that generates the computer-mediated environment.

Clause 17. The method of clause 12, wherein processing the first data comprises: generating a ray trace originating from each of a plurality of locations associated with the avatar; and detecting intersections of each ray trace with the one or more objects within the computer-mediated environment.

Clause 18. The method of clause 12, wherein the first data indicates a stiffness or compliance of the one or more objects.

Clause 19. The method of clause 12, wherein the second data indicates one or more of an object effect associated with a haptic wave form that simulates the feel of contact with a moving object, a spatial effect associated with a haptic wave form that simulates the feel of a specific environmental effect, or a direct effect associated with a specific pattern for actuating the tactile actuators.

Clause 20. The method of clause 12, wherein generating each haptic frame comprises: calculating a first set of displacement distances associated with the amount and type of contact with the one or more objects; calculating a second set of displacement distances associated with the haptic effect, wherein the haptic effect is a time-varying haptic effect; and combining the first set of displacement distances and the second set of displacement distances to yield the plurality of displacement distances for simulating the amount and type of contact at the particular point in time.

Clause 21. The method of clause 12, wherein the displacement distances for simulating the amount and type of contact at the particular point in time are based on a simulated amount of force applied between the avatar and the one or more objects within the computer-mediated environment.

Clause 22. The method of clause 12, wherein the properties of the one or more objects comprise a temperature property, wherein the series of haptic frames further specify an amount of thermal flux associated with the contact, wherein the plurality of instructions indicate thermal properties of a fluid used to cause actuation of the tactile actuators.

Clause 23. The method of clause 12, wherein the series of actuator frames further specify an amount of resistive feedback to be provided to a plurality of brake actuators of the one or more haptic interface devices.

Clause 24. The method of clause 12, wherein the series of actuator frames further specify an amount of force feedback to be provided to a plurality of magnetorheological actuators of the one or more haptic interface devices.

Clause 25. A system for interfacing between a haptic glove and a computer-mediated environment generated by an application, the system comprising: a motion capture module configured to perform steps comprising: receiving sensor data from a plurality of sensors arranged on the haptic glove and at least one tracked location determined by a motion tracker arranged on the haptic glove; processing the sensor data to generate relative location data specifying relative locations and orientations of a plurality of components of the haptic glove; generating a series of motion capture frames based on the at least one tracked location and the relative locations and orientations, wherein each motion capture frame indicates a spatial arrangement of the plurality of components of the haptic glove at a specific point in time; generating a series of kinematic frames based on the series of motion capture frames, wherein the series of kinematic frames map the spatial arrangement of the plurality of components of the haptic glove to a hand model corresponding to an avatar within the computer-mediated environment; and outputting the series of kinematic frames to the application, wherein the series of kinematic frames cause the application to reposition a hand of the avatar within the computer-mediated environment; and a haptic feedback module configured to perform steps comprising: receiving data indicating properties of one or more objects within the computer-mediated environment; processing the received data to determine an amount and type of contact of the hand of the avatar with the one or more objects within the computer-mediated environment; generating a series of haptic frames, each haptic frame specifying a plurality of displacement distances for simulating the amount and type of contact at a particular point in time; generating a series of actuator frames based on the series of haptic frames, each actuator frame specifying: respective amounts of pressure to be provided to tactile actuators of the haptic glove; and respective amounts of resistance to be applied to actuate finger brakes of the haptic glove; and transmitting a plurality of instructions to respective actuator controls of the haptic glove based on the series of actuator frames, wherein the plurality of instructions are configured to cause actuation of the tactile actuators using the specified respective amounts of pressure and the finger brakes using the specified amount of resistance to provide a high precision simulation of the amount and type of contact to the user.

Clause 26. The system of clause 25, wherein the avatar is a haptic digital twin of a telerobotic hand, wherein the series of kinematic frames further cause the application to transmit instructions to the telerobotic hand that cause repositioning of the telerobotic hand.

Clause 27. The system of clause 25, wherein the computer-mediated environment is a game or simulation.

Clause 28. The system of clause 25, further comprising adjusting the series of motion capture frames by performing touch compensation to simulate a detected touch intent.

Clause 29. The system of clause 28, wherein the detected touch intent is a touch involving a first finger and a second finger of the user, wherein adjusting the motion capture frames comprises adjusting a location associated with a first finger so that the first finger touches a second finger of the avatar, the haptic feedback module further configured to perform steps comprising: detecting the touch intent based on the location associated with the first finger and a location associated with the second finger being within a threshold distance, wherein the threshold distance is defined based on a size of a finger thimble of a haptic glove.

Clause 30. The system of clause 25, wherein mapping the spatial arrangement of the plurality of components of the haptic glove to the hand model corresponding to the avatar within the computer-mediated environment comprises optimizing the position of the hand model to compensate for one or more size differences between the user's hand and the avatar's hand.

Clause 31. The system of clause 25, further comprising: detecting a gesture being performed by the user's hand based on the series of motion capture frames; and outputting the detected gesture to the application, wherein the application is configured to perform an action based on the detected gesture.

Clause 32. The system of clause 25, wherein the series of haptic frames simulate a soft-body deformation of the hand.

Clause 33. The system of clause 25, wherein processing the received data to determine an amount and type of contact of the hand of the avatar with the one or more objects within the computer-mediated environment comprises: generating a ray trace originating from each of a plurality of locations of the hand of the avatar, where each location corresponds to a tactile actuator of the haptic glove; and detecting intersections of each ray trace with the one or more objects within the computer-mediated environment.

Clause 34. The system of clause 25, wherein the received data indicates a stiffness or compliance of the one or more objects within the computer-mediated environment.

Clause 35. The system of clause 25, wherein the received data further indicates one or more of an object effect associated with a haptic waveform that simulates the feel of contact with a moving object, a spatial effect associated with a haptic waveform that simulates the feel of a specific environmental effect, or a direct effect associated with a specific pattern for actuating the tactile actuators.

Clause 36. The system of clause 25, wherein the plurality of displacement distances for simulating the amount and type of contact at the particular point in time are based on a simulated amount of force applied between the hand of the avatar and the one or more objects within the computer-mediated environment.

Clause 37. The system of clause 25, wherein the properties of the one or more objects comprise a temperature property, wherein the series of haptic frames further specify an amount of thermal flux associated with the contact, wherein the plurality of instructions indicate thermal properties of a fluid used to cause actuation of the tactile actuators.

Clause 38. The system of clause 25, wherein the received data further indicates a haptic effect associated with a state of the computer-mediated environment, wherein generating the series of haptic frames further comprises simulating the haptic effect.

Clause 39. The system of clause 38, wherein the haptic effect is one or more of an object effect associated with a haptic wave form that simulates the feel of contact with a moving object, a spatial effect associated with a haptic wave form that simulates the feel of a specific environmental effect, or a direct effect associated with a specific pattern for actuating the tactile actuators.

Clause 40. The system of clause 38, wherein generating each haptic frame comprises: calculating a first set of displacement distances associated with the amount and type of contact with the one or more objects; calculating a second set of displacement distances associated with the haptic effect, wherein the haptic effect is a time-varying haptic effect; and adding the first set of displacement distances and the second set of displacement distances to yield the plurality of displacement distances for simulating the amount and type of contact at the particular point in time.

Clause 41. A system for interfacing between a haptic glove and a computer-mediated application for controlling a telerobot, the system comprising: a motion capture module configured to perform steps comprising: receiving sensor data from a plurality of sensors arranged on one or more haptic interface devices and at least one tracked location determined by respective motion trackers arranged on the one or more haptic interface devices; processing the sensor data to generate relative location data specifying relative locations and orientations of a plurality of components of each respective haptic interface device; generating a series of motion capture frames based on the at least one tracked location and the relative locations and orientations, wherein each motion capture frame indicates a spatial arrangement of the plurality of components of each respective haptic interface device at a specific point in time; generating a series of kinematic frames based on the series of motion capture frames, wherein the series of kinematic frames map the spatial arrangement of the plurality of components of the respective haptic interface device to a model of an avatar of the user; and outputting the series of kinematic frames to the application, wherein the series of kinematic frames cause the application to reposition the avatar within a haptic digital twin of the environment of the telerobot based on the series of kinematic frames, wherein the application is further configured to transmit commands to reposition the telerobot based on the avatar; and a haptic feedback module configured to perform steps comprising: receiving data that is descriptive of one or more objects within an environment of the telerobot, wherein the data is generated by the application using the haptic digital twin of the environment of the telerobot; processing the received data to determine an amount and type of simulated contact of the avatar with the one or more objects; generating a series of haptic frames, each haptic frame specifying a plurality of displacement distances for simulating the contact at a particular point in time; generating a series of actuator frames based on the series of haptic frames, each actuator frame specifying respective amounts of pressure to be provided to tactile actuators of the one or more haptic interface devices to provide a high precision simulation of the contact; and transmitting a plurality of instructions to respective actuator controls of the haptic interface devices, wherein the plurality of instructions are configured to cause actuation of the tactile actuators using the specified respective amounts of pressure to provide the high precision simulation of the contact to the user.

Clause 42. The system of clause 41, wherein the avatar and the telerobot differ in one or more of scale or morphology.

Clause 43. The system of clause 41, wherein the user and the avatar differ in one or more of scale or morphology.

Clause 44. The system of clause 41, further comprising adjusting the series of motion capture frames by performing touch compensation to simulate a detected touch intent.

Clause 45. The system of clause 44, wherein the detected touch intent is a touch involving a first finger and a second finger of the user, wherein adjusting the motion capture frames comprises adjusting a location associated with the first finger so that the first finger touches a second finger of the avatar, the haptic feedback module configured to perform steps comprising: detecting the touch intent based on the location associated with the first finger and a location associated with the second finger being within a threshold distance, wherein the threshold distance is defined based on a size of a finger thimble of a haptic glove, wherein the haptic glove is one of the haptic interface devices.

Clause 46. The system of clause 41, wherein mapping the spatial arrangement of the plurality of components of the one or more haptic interface devices to the model of the avatar comprises optimizing a position of a hand of the avatar to compensate for one or more size differences between a hand of the user and the hand of the avatar.

Clause 47. The system of clause 41, further comprising: detecting a gesture being performed by a hand of the user based on the series of motion capture frames; and outputting the detected gesture to the application, wherein the application is configured to perform an action based on the detected gesture.

Clause 48. The system of clause 41, wherein the series of haptic frames simulate a soft-body deformation of the hand.

Clause 49. The system of clause 41, wherein processing the received data to determine the amount and type of simulated contact of the avatar with the one or more objects comprises: generating a ray trace originating from each of a plurality of locations of the avatar, where each location corresponds to a tactile actuator of the one or more haptic interface device; and detecting intersections of each ray trace with the one or more objects.

Clause 50. The system of clause 41, wherein the received data indicates properties of the one or more objects based on sensor data received from the telerobot.

Clause 51. A compressor assembly, comprising: a first compressor with a first motor having an axis of rotation; a second compressor with a second motor, the second motor opposing and coaxial with the first motor by having the axis of rotation; a pneumatic circuit body in pneumatic communication with the first compressor and the second compressor; an assembly mounting plate coupled to the pneumatic circuit body; at least one compressor damper coupled to damp vibration between the pneumatic circuit body and both the first compressor and the second compressor; and at least one pneumatic body damper coupled to damp vibration between the pneumatic circuit body and the assembly mounting plate.

Clause 52. The compressor assembly of clause 51, wherein the first compressor has a first compression portion and the second compressor has a second compression portion, and wherein the first compression portion is aligned with the second compression portion to oppose forces of operating the second compression portion.

Clause 53. The compressor assembly of clause 52, wherein the first compression portion and the second compression portion are cam driven piston compressors positioned to have piston travel directions parallel to and offset from each other.

Clause 54. The compressor assembly of clause 51, further comprising a compressor plate, and wherein the first compressor and the second compressor are rigidly mounted to the compressor plate.

Clause 55. The compressor assembly of clause 54, wherein the compressor plate defines at least one damper receiving portion configured to receive a corresponding compression damper of the at least one compressor damper, and wherein the at least one compressor damper is disposed at least partially within the at least one damper receiving portion.

Clause 56. The compressor assembly of clause 55, wherein the at least one compressor damper is positioned to permit and damp a swinging motion of the compressor plate.

Clause 57. The compressor assembly of clause 56, wherein the at least one compressor damper has a longitudinal axis that is substantially aligned to intersect the axis of rotation.

Clause 58. The compressor assembly of clause 51, wherein the pneumatic circuit body defines a plurality of pneumatic circuits.

Clause 59. The compressor assembly of clause 51, wherein the first compressor and the second compressor collectively provide a pressurized air source and a vacuum source.

Clause 60. A method of controlling a compressor assembly, the method comprising: commanding a first compressor to operate at a first frequency; commanding a second compressor vibrationally coupled with the first compressor to operate at the first frequency; phase shifting of second compressor components of the second compressor relative to the first compressor by commanding the second compressor to operate at a second frequency that is different from the first frequency; aligning the second compressor components to be substantially opposing momentum from operation of first compressor components of the first compressor using the phase shifting; and operating the first compressor and the second compressor at the first frequency in response to aligning the second compressor components to be substantially opposing momentum from operation of first compressor components.

Clause 61. The method of clause 60, further comprising measuring a vibration caused by operating the first compressor and the second compressor at the first frequency, and wherein aligning the second compressor components is based on minimizing the vibration.

Clause 62. The method of clause 60, wherein the first frequency and the second frequency vary with a demand on the compressor assembly.

Clause 63. A method of performing motion capture on sensor data received from a wearable haptic interface, the method comprising: receiving, by a simulation engine, the sensor data from the wearable haptic interface, wherein the sensor data indicates one or more locations associated with the wearable haptic interface; processing, by the simulation engine, the sensor data to generate a motion capture frame, wherein the processing comprises: mapping the location data to a model corresponding to an avatar that is simulated by the simulation engine; and adjusting the mapped data to compensate for the wearable haptic interface; and modifying the simulated avatar based on the motion capture frame.

Clause 64. The method of clause 63, wherein adjusting the mapped data to compensate for the wearable haptic interface comprises performing touch compensation to adjust for a detected touch intent.

Clause 65. The method of clause 64, wherein the detected touch intent is a touch involving a first finger and a second finger, wherein the adjusting comprises adjusting a position of the first finger such that the first finger touches the second finger.

Clause 66. The method of clause 65, wherein the adjusting is based on a size of a finger thimble of a wearable haptic glove of the wearable haptic interface.

Clause 67. The method of clause 63, wherein adjusting the mapped data to compensate for the wearable haptic interface comprises adjusting the mapped data to compensate for sensor slip.

Clause 68. The method of clause 63, wherein the sensor data comprises tracking data from one or more motion tracking sensors and relative location data from one or more magnetic sensors.

Clause 69. A method of providing haptic feedback to a wearable haptic interface, the method comprising: receiving, from a simulation application, first data indicating a state of an avatar and second data indicating a state of a simulated environment containing the avatar; processing the first data and the second data to detect a contact of the avatar with an entity that exists within the simulated environment; calculating an estimated soft-body deformation resulting from the contact; and actuating a plurality of tactile actuators of the wearable haptic interface based on the estimated soft-body deformation.

Clause 70. The method of clause 69, wherein calculating the estimated soft-body deformation is performed by an on-board physics engine that is separate from the simulation application.

Clause 71. The method of clause 69, wherein processing the first data and the second data to detect a contact of the avatar with an entity that exists within the simulated environment comprises: generating a field of ray traces associated with the avatar; and detecting intersections of the field of ray traces with the entity that exists within the simulated environment.

Clause 72. The method of clause 69, wherein the estimated soft-body deformation is based on a simulated amount of force applied between the avatar and the entity that exists within the simulated environment.

Clause 73. The method of clause 69, wherein the estimated soft-body deformation is based on a distance between the avatar and the entity that exists within the simulated environment.

Clause 74. The method of clause 69, wherein calculating the estimated soft-body deformation comprises applying one or more of a low-pass filter or a high-pass filter to body contour data associated with the simulated entity.

Clause 75. A method of providing interaction assistance within a simulated environment for a user of a wearable haptic interface, the method comprising: determining, based on first data indicating a state of an avatar corresponding to the user and second data indicating a state of a simulated entity within the simulated environment, an intended interaction of the avatar with the simulated entity; adjusting one or more simulated physics properties within a region of the simulated environment that corresponds to the avatar and the simulated entity; determining an end of the intended interaction of the avatar with the simulated entity; and resetting the one or more adjusted simulated physics properties.

Clause 76. The method of clause 75, wherein the intended interaction is a grasp interaction.

Clause 77. The method of clause 76, wherein determining the intended interaction comprises determining that a hand or finger of the avatar is applying pressure to the simulated entity within the simulated environment.

Clause 78. The method of clause 76, wherein determining the intended interaction comprises detecting at least two forces associated with an avatar that are directed towards the simulated entity within the simulated environment.

Clause 79. The method of clause 78, wherein a first force of the at least two forces is associated with a first finger and a second force of the at least two forces is associated with a second finger.

Clause 80. The method of clause 75, wherein adjusting the one or more simulated physics properties comprises damping a contact between the avatar and the simulated entity to allow the avatar to more easily hold the simulated entity.

Clause 81. A method of providing haptic feedback to a wearable haptic interface, the method comprising: receiving, from a simulation application, first data indicating a state of an avatar and second data indicating a state of a simulated environment containing the avatar; processing the first data and the second data to detect a contact of the avatar with an entity that exists within the simulated environment; determining haptic feedback instructions to provide to the wearable haptic interface based on a simulated force associated with the contact; determining, based on one or more governance standards, to modify the haptic feedback instructions in order to reduce an amount of haptic feedback applied to a user of the wearable haptic interface; and providing the modified haptic feedback instructions to the wearable haptic interface.

Clause 82. The method of clause 81, wherein the governance standards comprise one or more safety limitations.

Clause 83. The method of clause 82, wherein the safety limitations specify a maximum acceleration associated with force feedback applied to a user.

Clause 84. The method of clause 82, wherein the safety limitations specify a maximum range of motion associated with a body part of a user.

Clause 85. The method of clause 82, wherein the safety limitations specify a maximum amount of thermal flux for a user.

Clause 86. The method of clause 81, wherein the governance standards comprise one or more user preferences for haptic feedback.

While only a few embodiments of the disclosure have been shown and described, it will be obvious to those skilled in the art that many changes and modifications may be made thereunto without departing from the spirit and scope of the disclosure as described in the following claims. All patent applications and patents, both foreign and domestic, and all other publications referenced herein are incorporated herein in their entireties to the full extent permitted by law.

The methods and systems described herein may be deployed in part or in whole through machines that execute computer software, program codes, and/or instructions on a processor. The disclosure may be implemented as a method on the machine(s), as a system or apparatus as part of or in relation to the machine(s), or as a computer program product embodied in a computer readable medium executing on one or more of the machines. In embodiments, the processor may be part of a server, cloud server, client, network infrastructure, mobile computing platform, stationary computing platform, or other computing platforms. A processor may be any kind of computational or processing device capable of executing program instructions, codes, binary instructions and the like, including a central processing unit (CPU), a general processing unit (GPU), a logic board, a chip (e.g., a graphics chip, a video processing chip, a data compression chip, or the like), a chipset, a controller, a system-on-chip (e.g., an RF system on chip, an AI system on chip, a video processing system on chip, or others), an integrated circuit, an application specific integrated circuit (ASIC), a field programmable gate array (FPGA), an approximate computing processor, a quantum computing processor, a parallel computing processor, a neural network processor, or other type of processor. The processor may be or may include a signal processor, digital processor, data processor, embedded processor, microprocessor or any variant such as a co-processor (math co-processor, graphic co-processor, communication co-processor, video co-processor, AI co-processor, and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more threads. The thread may spawn other threads that may have assigned priorities associated with them; the processor may execute these threads based on priority or any other order based on instructions provided in the program code. The processor, or any machine utilizing one, may include non-transitory memory that stores methods, codes, instructions and programs as described herein and elsewhere. The processor may access a non-transitory storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache, network-attached storage, server-based storage, and the like.

A processor may include one or more cores that may enhance speed and performance of a multiprocessor. In embodiments, the process may be a dual core processor, quad core processors, other chip-level multiprocessor and the like that combine two or more independent cores (sometimes called a die).

The methods and systems described herein may be deployed in part or in whole through machines that execute computer software on various devices including a server, client, firewall, gateway, hub, router, switch, infrastructure-as-a-service, platform-as-a-service, or other such computer and/or networking hardware or system. The software may be associated with a server that may include a file server, print server, domain server, internet server, intranet server, cloud server, infrastructure-as-a-service server, platform-as-a-service server, web server, and other variants such as secondary server, host server, distributed server, failover server, backup server, server farm, and the like. The server may include one or more of memories, processors, computer readable media, storage media, ports (physical and virtual), communication devices, and interfaces capable of accessing other servers, clients, machines, and devices through a wired or a wireless medium, and the like. The methods, programs, or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers, social networks, and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs, or codes as described herein and elsewhere may be executed by the client. In addition, other devices required for the execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of programs across the network. The networking of some or all of these devices may facilitate parallel processing of a program or method at one or more locations without deviating from the scope of the disclosure. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements. The methods and systems described herein may be adapted for use with any kind of private, community, or hybrid cloud computing network or cloud computing environment, including those which involve features of software as a service (Saas), platform as a service (PaaS), and/or infrastructure as a service (IaaS).

The methods, program codes, and instructions described herein and elsewhere may be implemented on a cellular network with multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, 4G, 5G, LTE, EVDO, mesh, or other network types.

The methods, program codes, and instructions described herein and elsewhere may be implemented on or through mobile devices. The mobile devices may include navigation devices, cell phones, mobile phones, mobile personal digital assistants, laptops, palmtops, netbooks, pagers, electronic book readers, music players and the like. These devices may include, apart from other components, a storage medium such as flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer-to-peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g., USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, network-attached storage, network storage, NVME-accessible storage, PCIE connected storage, distributed storage, and the like.

The methods and systems described herein may transform physical and/or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable code using a processor capable of executing program instructions stored thereon as a monolithic software structure, as standalone software modules, or as modules that employ external routines, code, services, and so forth, or any combination of these, and all such implementations may be within the scope of the disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices, artificial intelligence, computing devices, networking equipment, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described in the disclosure may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described in the disclosure, and steps associated therewith, may be realized in hardware, software or any combination of hardware and software suitable for a particular application. The hardware may include a general-purpose computer and/or dedicated computing device or specific computing device or particular aspect or component of a specific computing device. The processes may be realized in one or more microprocessors, microcontrollers, embedded microcontrollers, programmable digital signal processors or other programmable devices, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine-readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the devices described in the disclosure, as well as heterogeneous combinations of processors, processor architectures, or combinations of different hardware and software, or any other machine capable of executing program instructions. Computer software may employ virtualization, virtual machines, containers, dock facilities, portainers, and other capabilities.

Thus, in one aspect, methods described in the disclosure and combinations thereof may be embodied in computer executable code that, when executing on one or more computing devices, performs the steps thereof. In another aspect, the methods may be embodied in systems that perform the steps thereof and may be distributed across devices in a number of ways, or all of the functionality may be integrated into a dedicated, standalone device or other hardware. In another aspect, the means for performing the steps associated with the processes described in the disclosure may include any of the hardware and/or software described in the disclosure. All such permutations and combinations are intended to fall within the scope of the disclosure.

While the disclosure has been disclosed in connection with the preferred embodiments shown and described in detail, various modifications and improvements thereon will become readily apparent to those skilled in the art. Accordingly, the spirit and scope of the disclosure is not to be limited by the foregoing examples, but is to be understood in the broadest sense allowable by law.

The use of the terms “a” and “an” and “the” and similar referents in the context of describing the disclosure (especially in the context of the following claims) is to be construed to cover both the singular and the plural, unless otherwise indicated herein or clearly contradicted by context. The terms “comprising,” “with,” “including,” and “containing” are to be construed as open-ended terms (i.e., meaning “including, but not limited to,”) unless otherwise noted. Recitations of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. The term “set” may include a set with a single member. No language in the specification should be construed as indicating any non-claimed element as essential to the practice of the disclosure.

While the foregoing written description enables one skilled to make and use what is considered presently to be the best mode thereof, those skilled in the art will understand and appreciate the existence of variations, combinations, and equivalents of the specific embodiment, method, and examples herein. The disclosure should therefore not be limited by the above-described embodiment, method, and examples, but by all embodiments and methods within the scope and spirit of the disclosure.

All documents referenced herein are hereby incorporated by reference as if fully set forth herein.

1-11. (canceled)

12. A method of providing haptic feedback to one or more haptic interface devices, the method comprising:
receiving, by a haptic feedback controller:
first data indicating properties of one or more objects within a computer-mediated environment comprising an avatar corresponding to a user wearing the one or more haptic interface devices; and
second data indicating a haptic effect associated with a current state of the computer-mediated environment;
processing, by the haptic feedback controller, the first data and the second data to determine haptic feedback for the user based on an amount and type of contact of the avatar with the one or more objects within the computer-mediated environment and the haptic effect associated with the current state of the computer-mediated environment;
generating, by the haptic feedback controller a series of haptic frames based on the determined haptic feedback, each haptic frame specifying a plurality of displacement distances for simulating the amount and type of contact and the haptic effect at a particular point in time;
generating, by the haptic feedback controller, a series of actuator frames based on the series of haptic frames, each actuator frame specifying respective amounts of pressure to be provided to tactile actuators of the one or more haptic interface devices to provide a high precision simulation of the amount and type of contact and the haptic effect; and
transmitting a plurality of instructions to respective actuator controls of the haptic interface devices, wherein the plurality of instructions are configured to cause actuation of the tactile actuators using the specified respective amounts of pressure to provide the high precision simulation of the amount and type of contact and the haptic effect to the user.

13. The method of claim 12, wherein the avatar is a digital twin of a telerobot, wherein the one or more objects are one or more digital twins of real objects in the environment of the telerobot.

14. The method of claim 13, wherein the digital twin is a haptic digital twin that has one or more of a different scale, a different morphology, or a different location than the telerobot.

15. The method of claim 12, wherein the computer-mediated environment is a game or simulation.

16. The method of claim 12, wherein the series of haptic frames simulate a soft-body deformation generated by a soft-body physics engine implemented by the haptic feedback controller, wherein the soft-body physics engine is not implemented by an application that generates the computer-mediated environment.

17. The method of claim 12, wherein processing the first data comprises:
generating a ray trace originating from each of a plurality of locations associated with the avatar; and
detecting intersections of each ray trace with the one or more objects within the computer-mediated environment.

18. The method of claim 12, wherein the first data indicates a stiffness or compliance of the one or more objects.

19. The method of claim 12, wherein the second data indicates one or more of an object effect associated with a haptic wave form that simulates a feel of contact with a moving object, a spatial effect associated with a haptic wave form that simulates a feel of a specific environmental effect, or a direct effect associated with a specific pattern for actuating the tactile actuators.

20. The method of claim 12, wherein generating each haptic frame comprises:
calculating a first set of displacement distances associated with the amount and type of contact with the one or more objects;
calculating a second set of displacement distances associated with the haptic effect, wherein the haptic effect is a time-varying haptic effect; and
combining the first set of displacement distances and the second set of displacement distances to yield the plurality of displacement distances for simulating the amount and type of contact at the particular point in time.

21. The method of claim 12, wherein the displacement distances for simulating the amount and type of contact at the particular point in time are based on a simulated amount of force applied between the avatar and the one or more objects within the computer-mediated environment.

22. The method of claim 12, wherein the properties of the one or more objects comprise a temperature property, wherein the series of haptic frames further specify an amount of thermal flux associated with the contact, wherein the plurality of instructions indicate thermal properties of a fluid used to cause actuation of the tactile actuators.

23. The method of claim 12, wherein the series of actuator frames further specify an amount of resistive feedback to be provided to a plurality of brake actuators of the one or more haptic interface devices.

24. The method of claim 12, wherein the series of actuator frames further specify an amount of force feedback to be provided to a plurality of magnetorheological actuators of the one or more haptic interface devices.

25-40. (canceled)

41. A system for interfacing between a haptic glove and a computer-mediated application for controlling a telerobot, the system comprising:
a motion capture module configured to perform steps comprising:
receiving sensor data from a plurality of sensors arranged on one or more haptic interface devices and at least one tracked location determined by respective motion trackers arranged on the one or more haptic interface devices;
processing the sensor data to generate relative location data specifying relative locations and orientations of a plurality of components of each respective haptic interface device;
generating a series of motion capture frames based on the at least one tracked location and the relative locations and orientations, wherein each motion capture frame indicates a spatial arrangement of the plurality of components of each respective haptic interface device at a specific point in time;
generating a series of kinematic frames based on the series of motion capture frames, wherein the series of kinematic frames map the spatial arrangement of the plurality of components of the respective haptic interface device to a model of an avatar of a user of the one or more haptic interface devices; and
outputting the series of kinematic frames to the application, wherein the series of kinematic frames cause the application to reposition the avatar within a haptic digital twin of an environment of the telerobot based on the series of kinematic frames, wherein the application is further configured to transmit commands to reposition the telerobot based on the avatar; and
a haptic feedback module configured to perform steps comprising:
receiving data that is descriptive of one or more objects within an environment of the telerobot, wherein the data is generated by the application using the haptic digital twin of the environment of the telerobot;
processing the received data to determine an amount and type of simulated contact of the avatar with the one or more objects;
generating a series of haptic frames, each haptic frame specifying a plurality of displacement distances for simulating the contact at a particular point in time;
generating a series of actuator frames based on the series of haptic frames, each actuator frame specifying respective amounts of pressure to be provided to tactile actuators of the one or more haptic interface devices to provide a high precision simulation of the contact; and
transmitting a plurality of instructions to respective actuator controls of the haptic interface devices, wherein the plurality of instructions are configured to cause actuation of the tactile actuators using the specified respective amounts of pressure to provide the high precision simulation of the contact to the user.

42. The system of claim 41, wherein the avatar and the telerobot differ in one or more of scale or morphology.

43. The system of claim 41, wherein the user and the avatar differ in one or more of scale or morphology.

44. The system of claim 41, wherein the motion capture module is further configured to adjust the series of motion capture frames by performing touch compensation to simulate a detected touch intent.

45. The system of claim 44, wherein the detected touch intent is a touch involving a first finger and a second finger of the user, wherein adjusting the motion capture frames comprises adjusting a location associated with the first finger so that the first finger touches a second finger of the avatar, the haptic feedback module configured to perform steps comprising:
detecting the touch intent based on the location associated with the first finger and a location associated with the second finger being within a threshold distance, wherein the threshold distance is defined based on a size of a finger thimble of a haptic glove, wherein the haptic glove is one of the haptic interface devices.

46. The system of claim 41, wherein mapping the spatial arrangement of the plurality of components of the one or more haptic interface devices to the model of the avatar comprises optimizing a position of a hand of the avatar to compensate for one or more size differences between a hand of the user and the hand of the avatar.

47. The system of claim 41, further comprising:
detecting a gesture being performed by a hand of the user based on the series of motion capture frames; and
outputting the detected gesture to the application, wherein the application is configured to perform an action based on the detected gesture.

48. The system of claim 41, wherein the series of haptic frames simulate a soft-body deformation of a hand.

49. The system of claim 41, wherein processing the received data to determine the amount and type of simulated contact of the avatar with the one or more objects comprises:
generating a ray trace originating from each of a plurality of locations of the avatar, where each location corresponds to a tactile actuator of the one or more haptic interface device; and
detecting intersections of each ray trace with the one or more objects.

50. The system of claim 41, wherein the received data indicates properties of the one or more objects based on sensor data received from the telerobot.

51-86. (canceled)
